(19) United States
(12) Patent Application Publication
(10) Pub. No.: US 2026/0104781 A1
(43) Pub. Date: Apr. 16, 2026

(54) METHODS OF FACILITATING AND INTERACTING WITH VIRTUAL WORKSPACES IN A THREE-DIMENSIONAL ENVIRONMENT

(71) Applicant: Apple Inc., Cupertino, CA (US)

(72) Inventors: Aaron M. BURNS, Keyworth (GB); Charilaos PAPADOPOULOS, San Mateo, CA (US); Jia WANG, Redmond, WA (US); Scott A. GREENLAY, Redmond, WA (US); Jamie J. MARCONI, Bellevue, WA (US); Yik Chun Jonathan CHAN, Seattle, WA (US); Jonathan R. DASCOLA, San Francisco, CA (US); Christopher D. MCKENZIE, Burlingame, CA (US); Stephen O. LEMAY, Palo Alto, CA (US); Michael E. BUERLI, San Francisco, CA (US); Edwin ISKANDAR, San Jose, CA (US); Olivier GUTKNECHT, San Francisco, CA (US); Enrica CASUCCI, Los Altos, CA (US); Jeffrey S. NORRIS, Saratoga, CA (US); Shih-Sang CHIU, San Francisco, CA (US)

(21) Appl. No.: 19/310,603

(22) Filed: Aug. 26, 2025

Related U.S. Application Data
(60) Provisional application No. 63/698,507, filed on Sep. 24, 2024.

(51) Int. Cl. G06F 3/04815; G06F 3/0485

(52) U.S. Cl. CPC G06F 3/04815; G06F 3/0485

(57) ABSTRACT

In some embodiments, a computer system facilitates interaction with virtual objects associated with virtual workspaces in a three-dimensional environment. In some embodiments, a computer system facilitates multi-user collaboration with content associated with a virtual workspace in a three-dimensional environment. In some embodiments, a computer system facilitates display of content associated with a virtual workspace in different physical environments.

### CROSS REFERENCE TO RELATED APPLICATIONS

This application claims the benefit of U.S. Provisional Application No. 63/698,507, filed Sep. 24, 2024, the entire disclosure of which is herein incorporated by reference for all purposes.

### TECHNICAL FIELD

The present disclosure relates generally to computer systems that provide computer-generated experiences, including, but not limited to, electronic devices that provide virtual reality and mixed reality experiences via a display.

### BACKGROUND

The development of computer systems for augmented reality has increased significantly in recent years. Example augmented reality environments include at least some virtual elements that replace or augment the physical world. Input devices, such as cameras, controllers, joysticks, touch-sensitive surfaces, and touch-screen displays for computer systems and other electronic computing devices are used to interact with virtual/augmented reality environments. Example virtual elements include virtual objects, such as digital images, video, text, icons, and control elements such as buttons and other graphics.

### SUMMARY

Some methods and interfaces for interacting with environments that include at least some virtual elements (e.g., applications, augmented reality environments, mixed reality environments, and virtual reality environments) are cumbersome, inefficient, and limited. For example, systems that provide insufficient feedback for performing actions associated with virtual objects, systems that require a series of inputs to achieve a desired outcome in an augmented reality environment, and systems in which manipulation of virtual objects are complex, tedious, and error-prone, create a significant cognitive burden on a user, and detract from the experience with the virtual/augmented reality environment. In addition, these methods take longer than necessary, thereby wasting energy of the computer system. This latter consideration is particularly important in battery-operated devices.

Accordingly, there is a need for computer systems with improved methods and interfaces for providing computer-generated experiences to users that make interaction with the computer systems more efficient and intuitive for a user. Such methods and interfaces optionally complement or replace conventional methods for providing extended reality experiences to users. Such methods and interfaces reduce the number, extent, and/or nature of the inputs from a user by helping the user to understand the connection between provided inputs and device responses to the inputs, thereby creating a more efficient human-machine interface.

The above deficiencies and other problems associated with user interfaces for computer systems are reduced or eliminated by the disclosed systems. In some embodiments, the computer system is a desktop computer with an associated display. In some embodiments, the computer system is portable device (e.g., a notebook computer, tablet computer, or handheld device). In some embodiments, the computer system is a personal electronic device (e.g., a wearable electronic device, such as a watch, or a head-mounted device). In some embodiments, the computer system has a touchpad. In some embodiments, the computer system has one or more cameras. In some embodiments, the computer system has (e.g., includes or is in communication with) a display generation component (e.g., a display device such as a head-mounted device (HMD), a display, a projector, a touch-sensitive display (also known as a “touch screen” or “touch-screen display”), or other device or component that presents visual content to a user, for example on or in the display generation component itself or produced from the display generation component and visible elsewhere). In some embodiments, the computer system has one or more eye-tracking components. In some embodiments, the computer system has one or more hand-tracking components. In some embodiments, the computer system has one or more output devices in addition to the display generation component, the output devices including one or more tactile output generators and/or one or more audio output devices. In some embodiments, the computer system has a graphical user interface (GUI), one or more processors, memory and one or more modules, programs or sets of instructions stored in the memory for performing multiple functions. In some embodiments, the user interacts with the GUI through a stylus and/or finger contacts and gestures on the touch-sensitive surface, movement of the user's eyes and hand in space relative to the GUI (and/or computer system) or the user's body as captured by cameras and other movement sensors, and/or voice inputs as captured by one or more audio input devices. In some embodiments, the functions performed through the interactions optionally include image editing, drawing, presenting, word processing, spreadsheet making, game playing, telephoning, video conferencing, e-mailing, instant messaging, workout support, digital photographing, digital videoing, web browsing, digital music playing, note taking, and/or digital video playing. Executable instructions for performing these functions are, optionally, included in a transitory and/or non-transitory computer readable storage medium or other computer program product configured for execution by one or more processors.

There is a need for electronic devices with improved methods and interfaces for interacting with a three-dimensional environment. Such methods and interfaces may complement or replace conventional methods for interacting with a three-dimensional environment. Such methods and interfaces reduce the number, extent, and/or the nature of the inputs from a user and produce a more efficient human-machine interface. For battery-operated computing devices, such methods and interfaces conserve power and increase the time between battery charges.

In some embodiments, a computer system facilitates interaction with virtual objects associated with virtual workspaces in a three-dimensional environment. In some embodiments, a computer system facilitates multi-user collaboration with content associated with a virtual workspace in a three-dimensional environment. In some embodiments, a computer system facilitates display of content associated with a virtual workspace in different physical environments.

Note that the various embodiments described above can be combined with any other embodiments described herein. The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the inventive subject matter.

### BRIEF DESCRIPTION OF THE DRAWINGS

For a better understanding of the various described embodiments, reference should be made to the Description of Embodiments below, in conjunction with the following drawings in which like reference numerals refer to corresponding parts throughout the Figures.

FIG. 1A is a block diagram illustrating an operating environment of a computer system for providing extended reality experiences in accordance with some embodiments.

FIGS. 1B-1P are examples of a computer system for providing XR experiences in the operating environment of FIG. 1A.

FIG. 2 is a block diagram illustrating a controller of a computer system that is configured to manage and coordinate a XR experience for the user in accordance with some embodiments.

FIG. 3A is a block diagram illustrating a display generation component of a computer system that is configured to provide a visual component of the XR experience to the user in accordance with some embodiments.

FIGS. 3B-3G illustrate the use of Application Programming Interfaces (APIs) to perform operations.

FIG. 4 is a block diagram illustrating a hand tracking unit of a computer system that is configured to capture gesture inputs of the user in accordance with some embodiments.

FIG. 5 is a block diagram illustrating an eye tracking unit of a computer system that is configured to capture gaze inputs of the user in accordance with some embodiments.

FIG. 6 is a flowchart illustrating a glint-assisted gaze tracking pipeline in accordance with some embodiments.

FIGS. 7A-7V illustrate examples of a computer system facilitating interaction with virtual objects associated with virtual workspaces in a three-dimensional environment in accordance with some embodiments.

FIG. 8 is a flowchart illustrating an exemplary method of facilitating interaction with virtual objects associated with virtual workspaces in a three-dimensional environment in accordance with some embodiments.

FIGS. 9A-9J illustrate examples of a computer system facilitating multi-user collaboration with content associated with a virtual workspace in a three-dimensional environment in accordance with some embodiments.

FIG. 10 is a flowchart illustrating an exemplary method of facilitating multi-user collaboration with content associated with a virtual workspace in a three-dimensional environment in accordance with some embodiments.

FIGS. 11A-11P illustrate examples of a computer system facilitating display of content associated with a virtual workspace in a three-dimensional environment based on physical properties of a physical environment in accordance with some embodiments.

FIG. 12 is a flowchart illustrating an exemplary method of facilitating display of content associated with a virtual workspace in a three-dimensional environment based on physical properties of a physical environment in accordance with some embodiments.

### DESCRIPTION OF EMBODIMENTS

The present disclosure relates to user interfaces for providing an extended reality (XR) experience to a user, in accordance with some embodiments.

The systems, methods, and GUIs described herein improve user interface interactions with virtual/augmented reality environments in multiple ways.

In some embodiments, a computer system facilitates interaction with virtual objects associated with virtual workspaces in a three-dimensional environment. In some embodiments, while displaying, via one or more display generation components, a first group of objects in a three-dimensional environment, wherein the first group of objects has one or more first visual characteristics, including a first spatial arrangement, wherein the first spatial arrangement is a three-dimensional arrangement of the first group of objects in the three-dimensional environment, the computer system detects, via one or more input devices, a first input corresponding to a request to display one or more graphical user interface objects. In some embodiments, in response to detecting the first input, the computer system displays, via the one or more display generation components, a user interface including a plurality of graphical user interface objects in the three-dimensional environment. In some embodiments, while displaying the user interface that includes the plurality of graphical user interface objects, the computer system detects, via the one or more input devices, a second input that includes selection of a respective graphical user interface object of the one or more graphical user interface objects. In some embodiments, in response to detecting the second input, in accordance with a determination that the second input includes selection of a first graphical user interface object that represents the first group of objects, the computer system redisplays, via the one or more display generation components, the first group of objects with the one or more first visual characteristics, including the first spatial arrangement, in the three-dimensional environment. In some embodiments, in accordance with a determination that the second input includes selection of a second graphical user interface object that represents a second group of objects, different from the first graphical user interface object, the computer system displays the second group of objects in the three-dimensional environment, wherein the second group of objects has one or more second visual characteristics different from the one or more first visual characteristics, including a second spatial arrangement, wherein the second spatial arrangement is a three-dimensional arrangement of the second group of objects in the three-dimensional environment that is different from the first spatial arrangement in the three-dimensional environment.

In some embodiments, a first computer system facilitates multi-user collaboration with content associated with a virtual workspace in a three-dimensional environment. In some embodiments, while an environment is visible via one or more display generation components, the first computer system detects, via one or more input devices, a first input corresponding to a request to display a first group of objects, wherein the request is received from a user of a first computer system who is a first participant in shared management of the first group of objects with one or more other participants, including a second participant different from the first participant, wherein the second participant is a user of a second computer system, different from the first computer system. In some embodiments, in response to detecting the first input, the first computer system displays, via the one or more display generation components, the first group of objects in a first spatial arrangement. In some embodiments, the first computer system displays a first object associated with a first application at a first location in the environment relative to a viewpoint of the first participant, wherein the first location in the first spatial arrangement is determined based on prior user activity of the first participant at the first computer system. In some embodiments, the first computer system displays a second object, different from the first object, associated with a second application, different from the first application, at a second location, different from the first location, in the environment relative to the viewpoint of the first participant, wherein the second location in the first spatial arrangement is determined based on prior user activity of the second participant at the second computer system.

In some embodiments, a computer system facilitates display of content associated with a virtual workspace in different physical environments. In some embodiments, while a respective environment is visible via one or more display generation components, the computer system detects, via one or more input devices, a first input corresponding to a request to display a first group of objects in the respective environment, wherein, prior to detecting the first input, the first group of objects was last interacted with in a first environment and wherein the first group of objects had one or more first visual properties in the first environment. In some embodiments, in response to detecting the first input, in accordance with a determination that the respective environment corresponds to a second environment, different from the first environment, the computer system displays, via the one or more display generation components, the first group of objects with one or more second visual properties, different from the one or more first visual properties, in the second environment based on one or more differences between a space available for displaying the first group of objects in the first environment and a space available for displaying the first group of objects in the second environment.

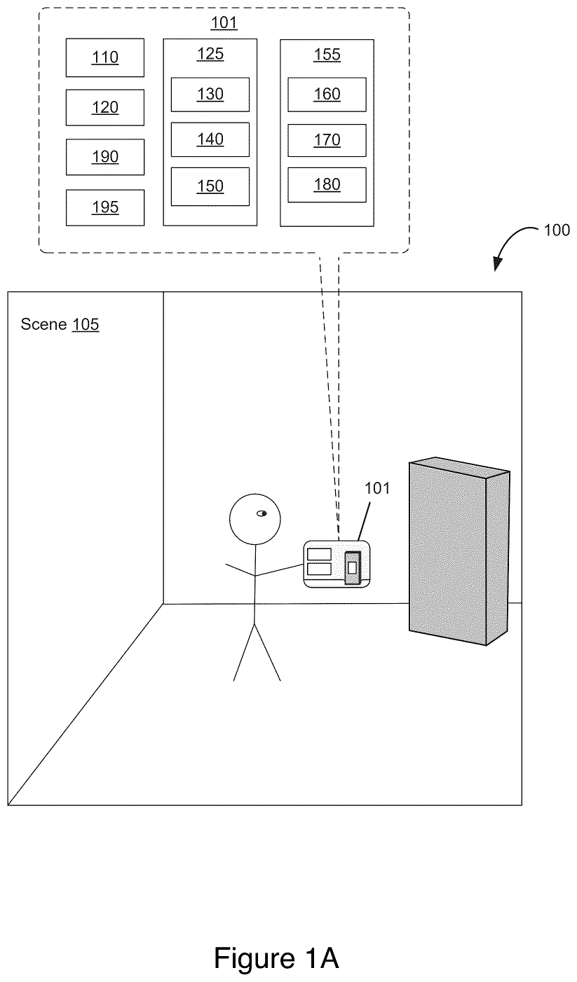

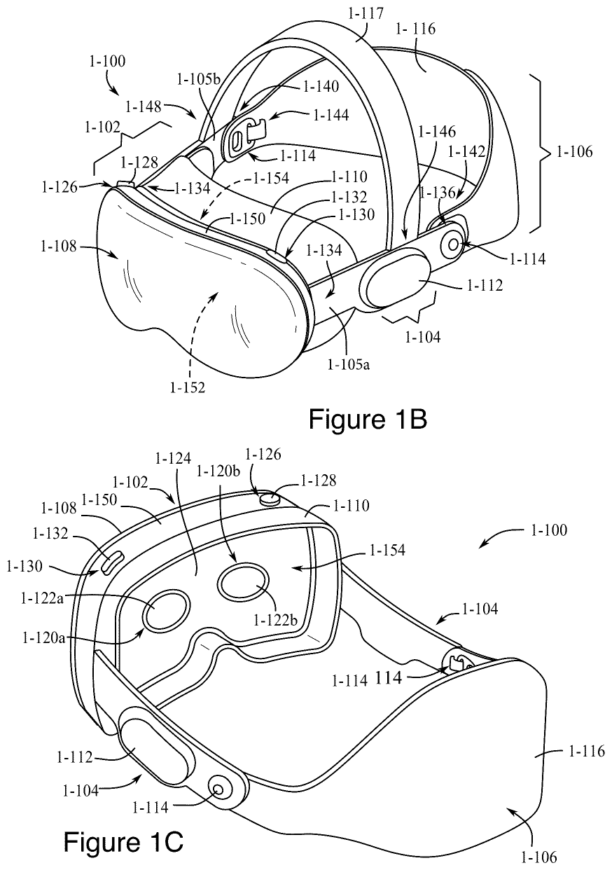

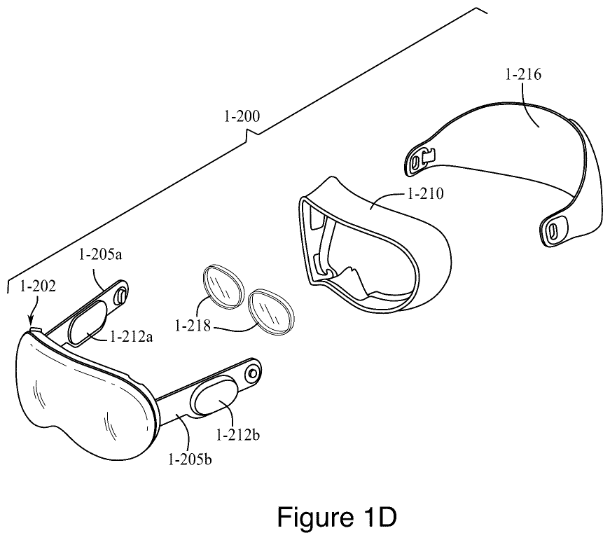

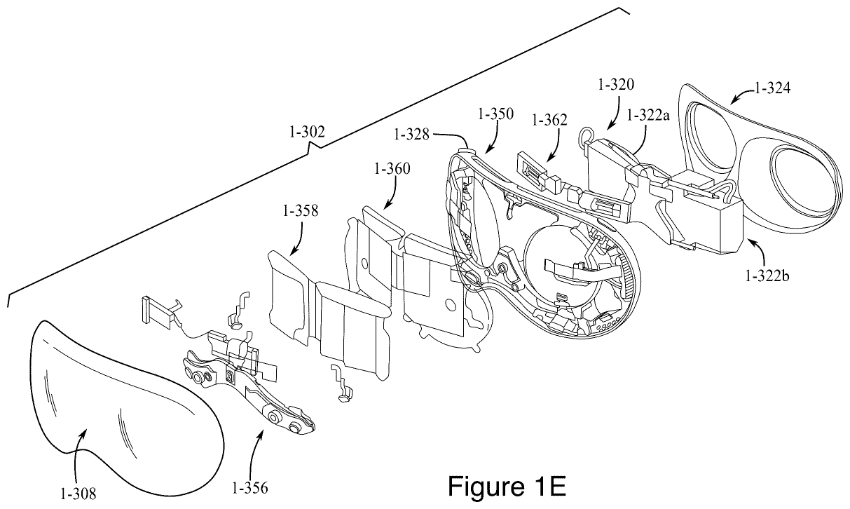

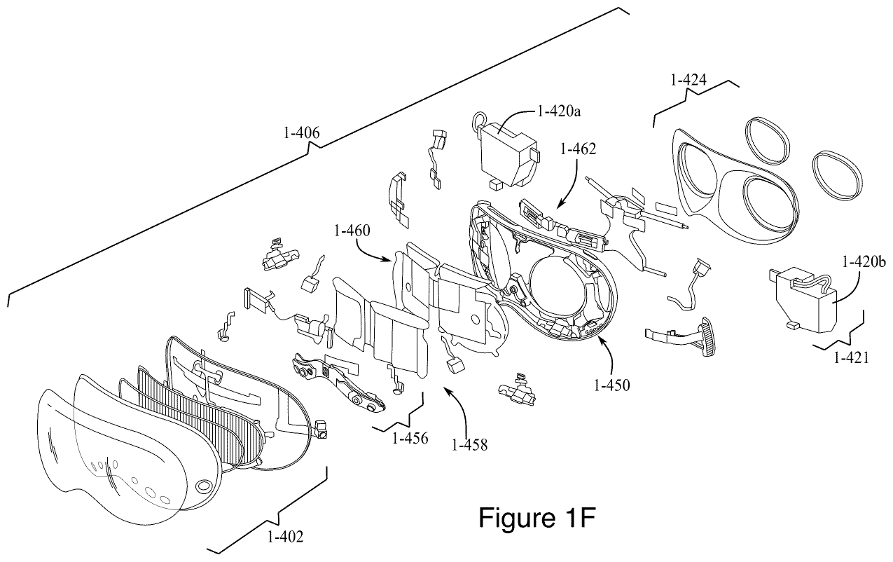

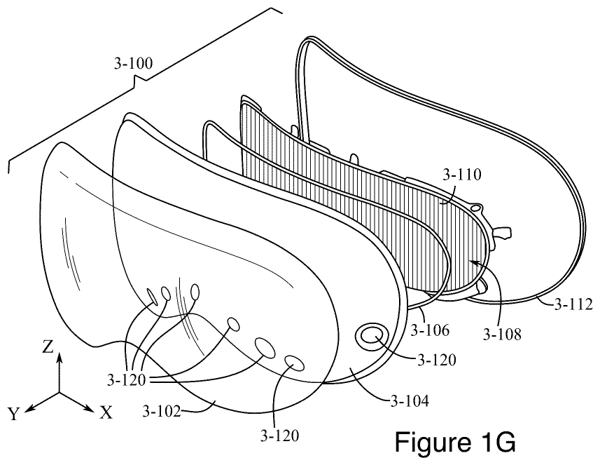

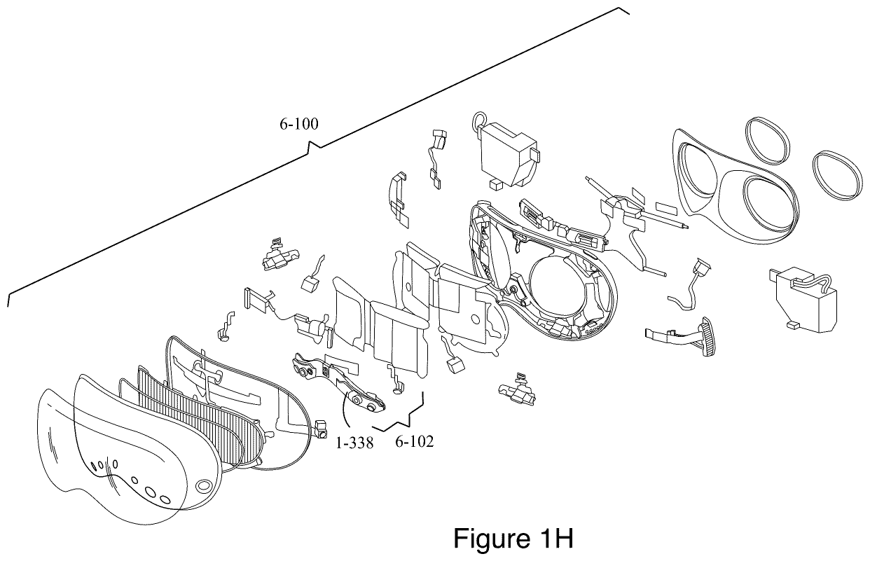

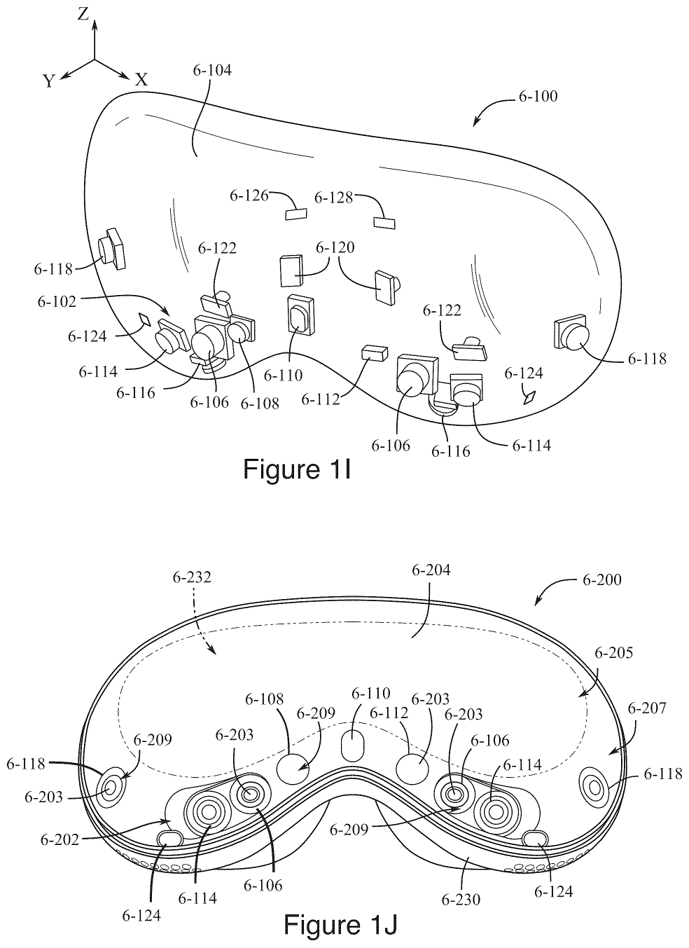

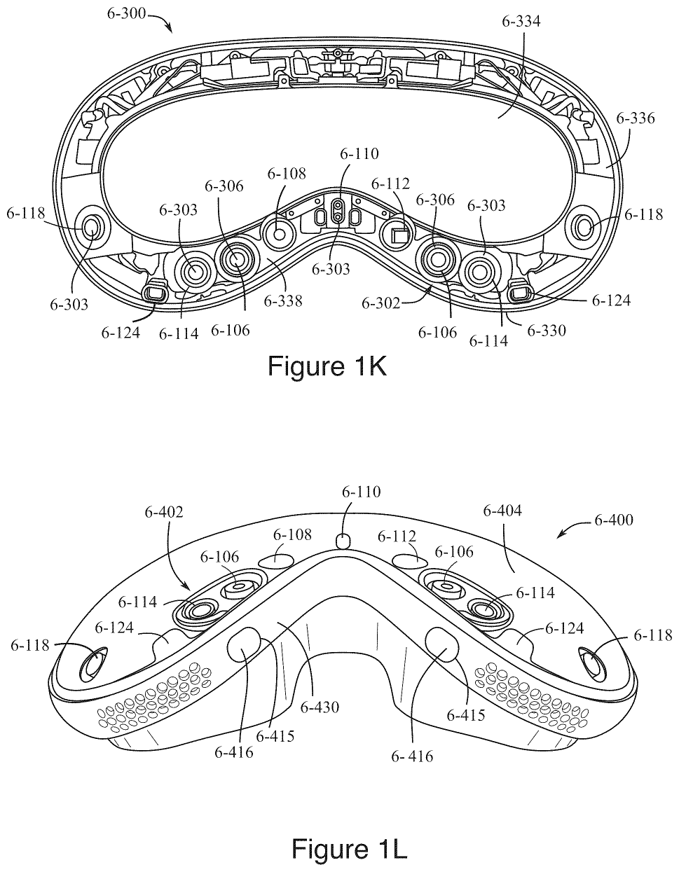

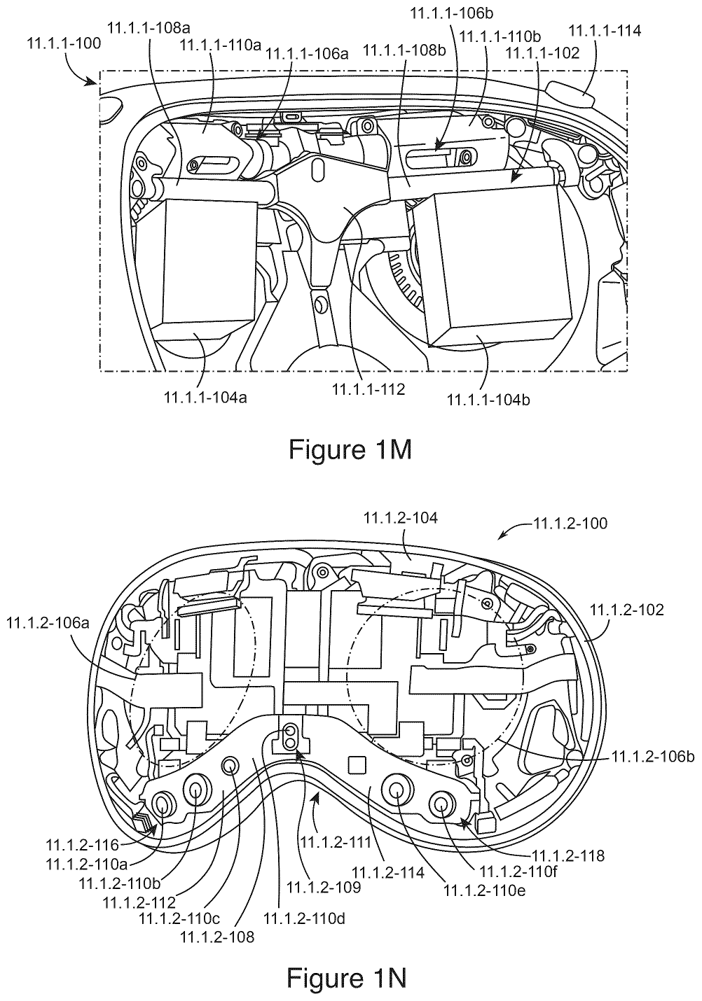

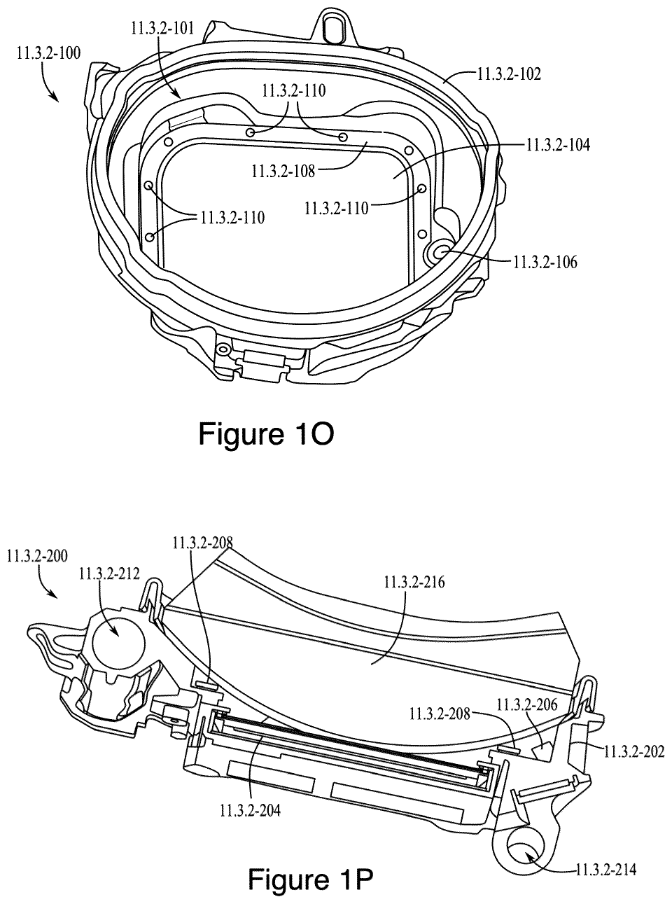

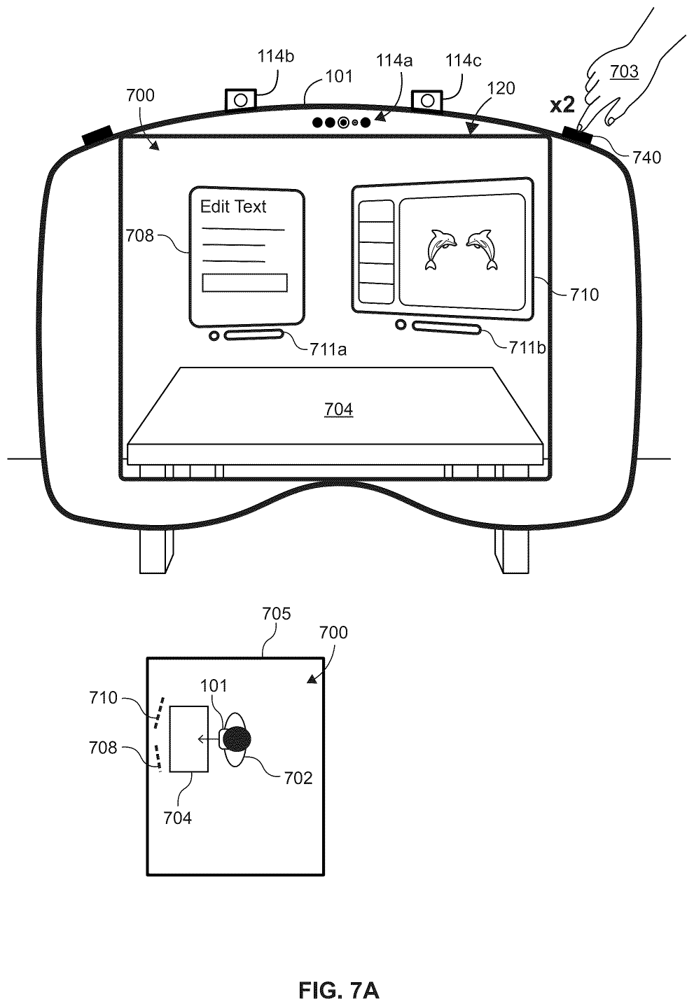

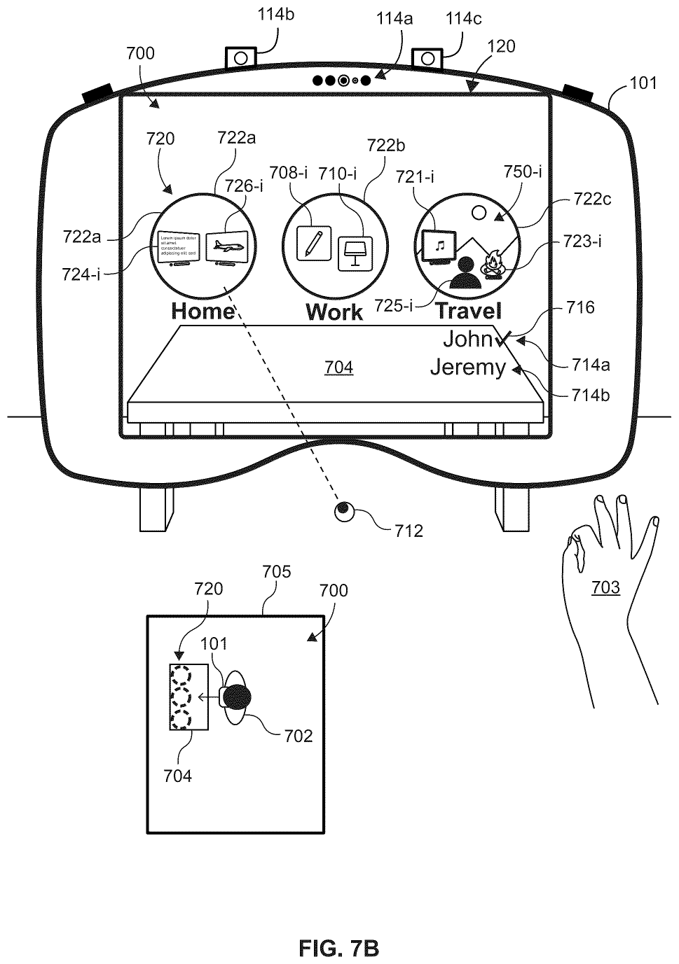

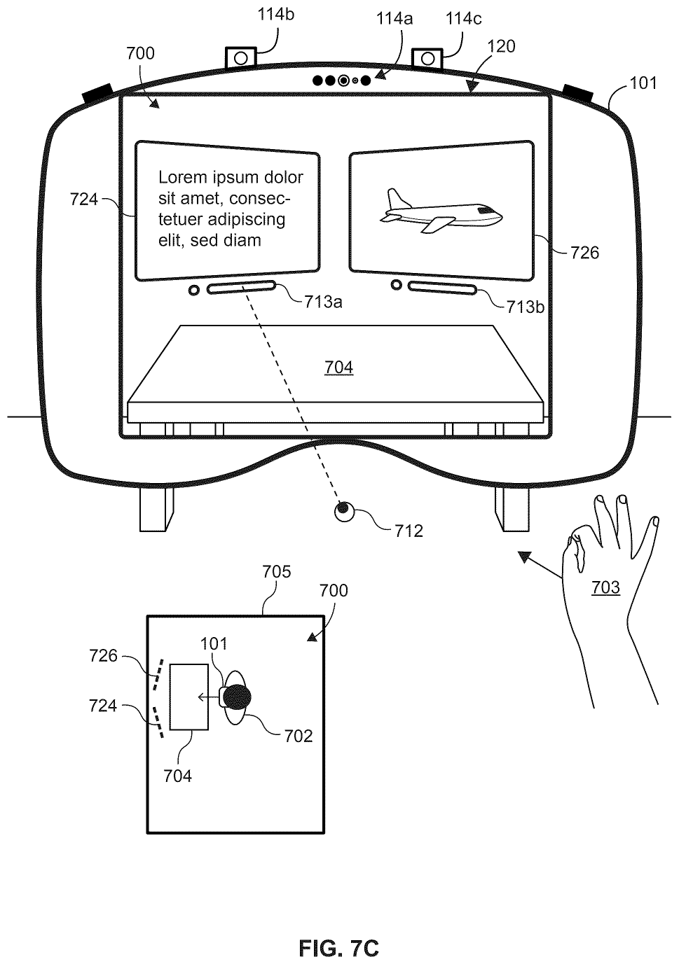

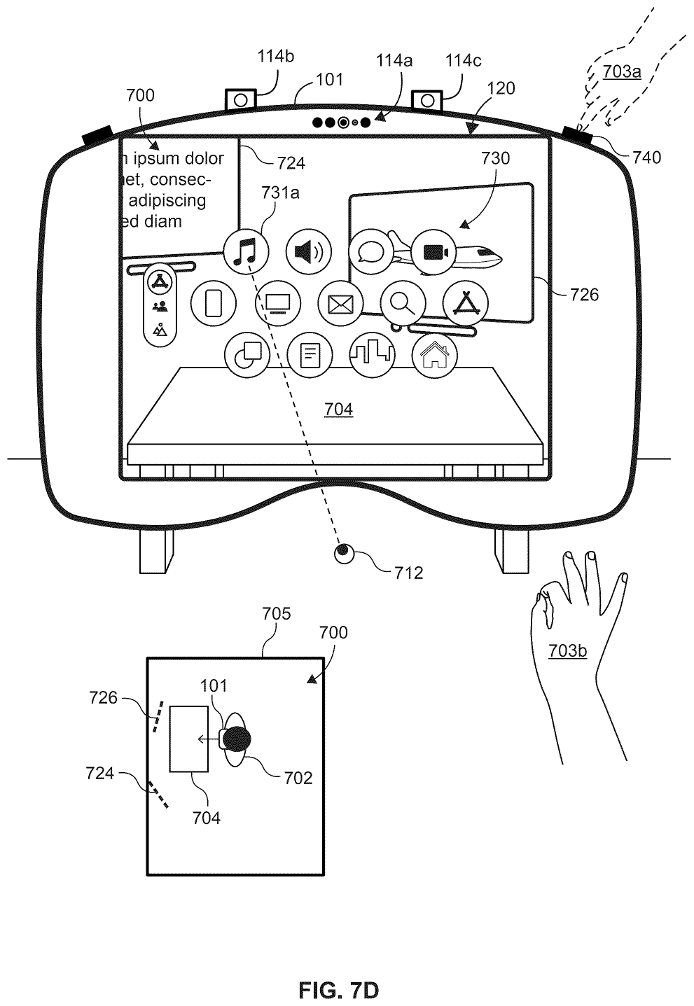

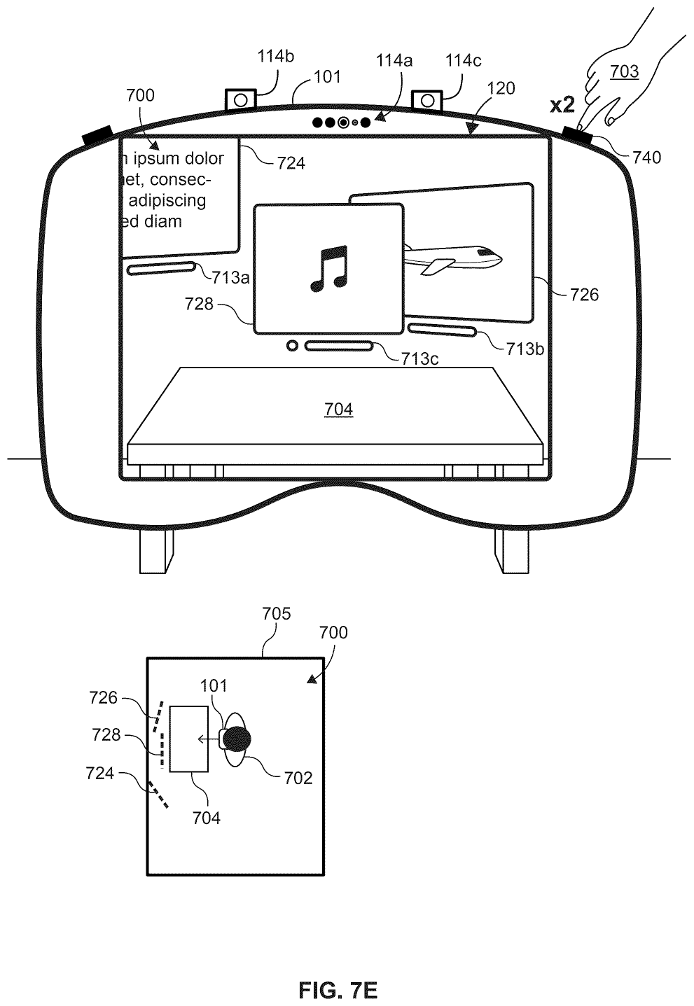

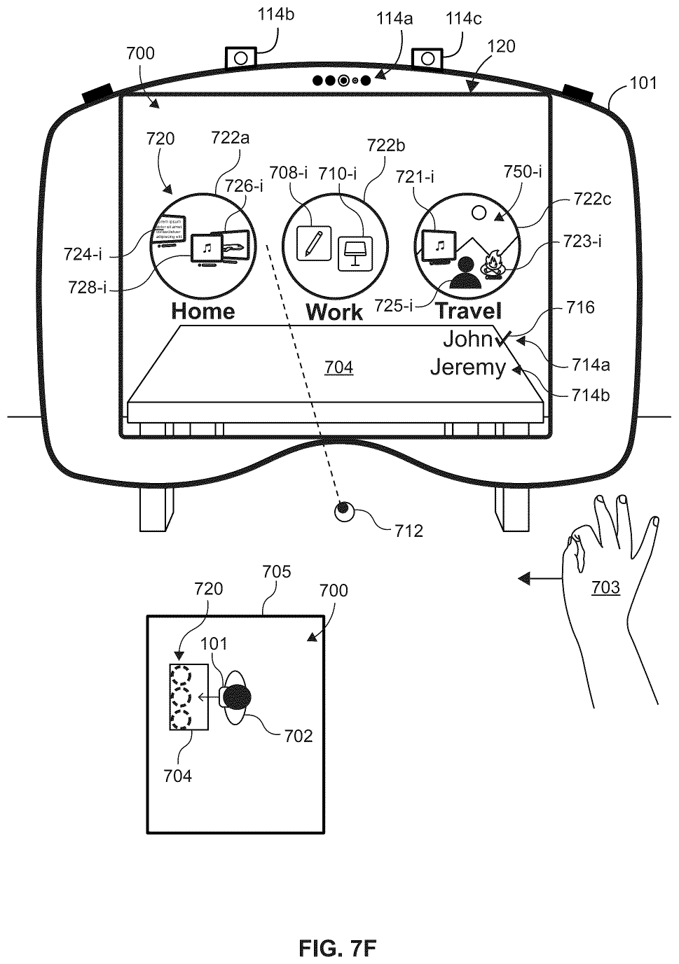

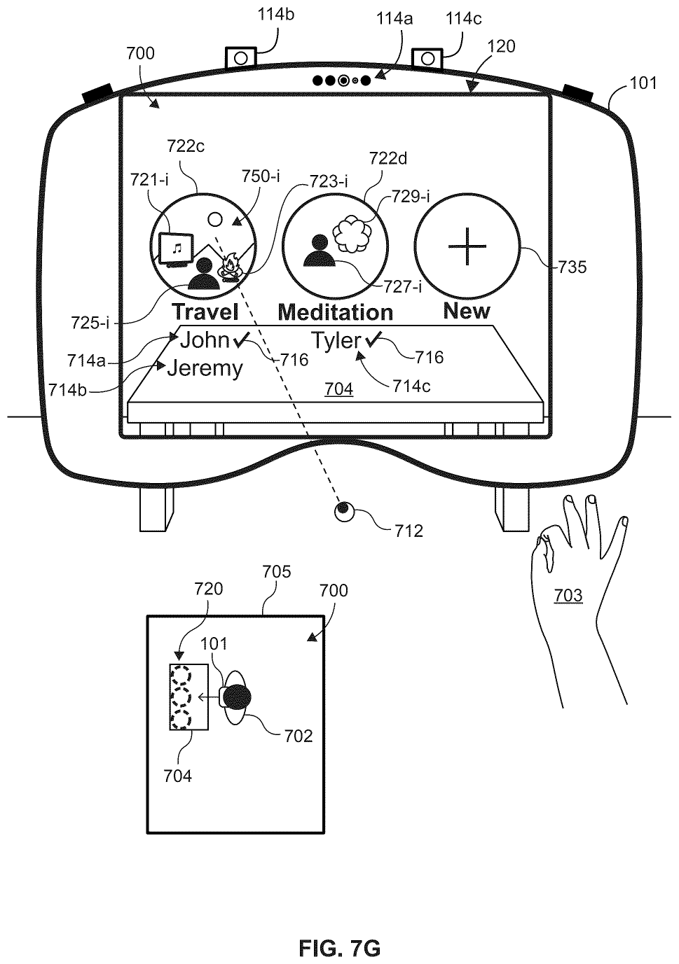

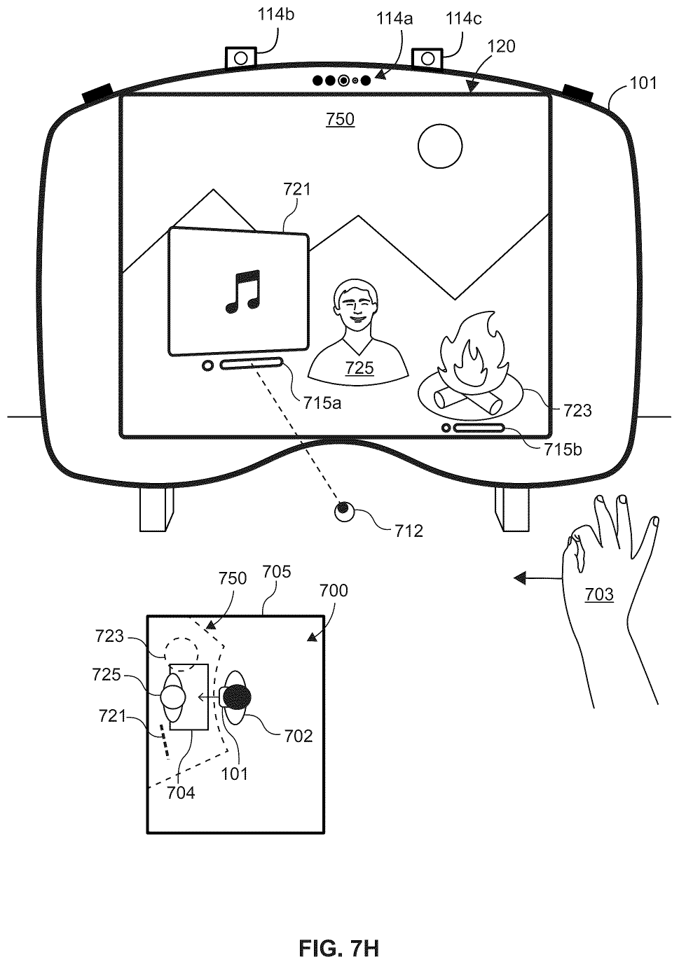

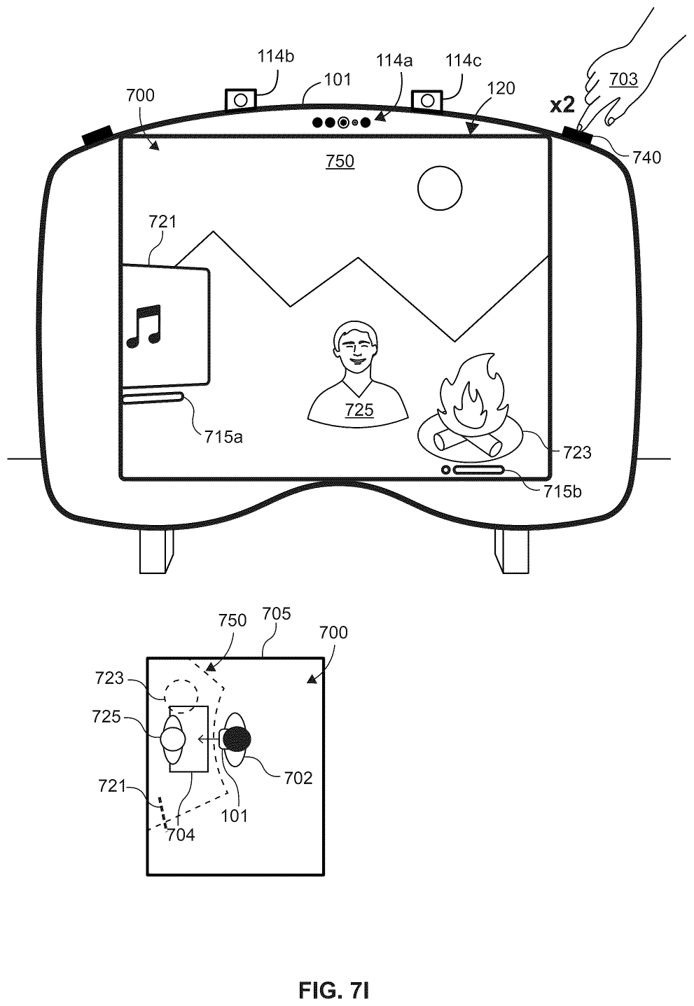

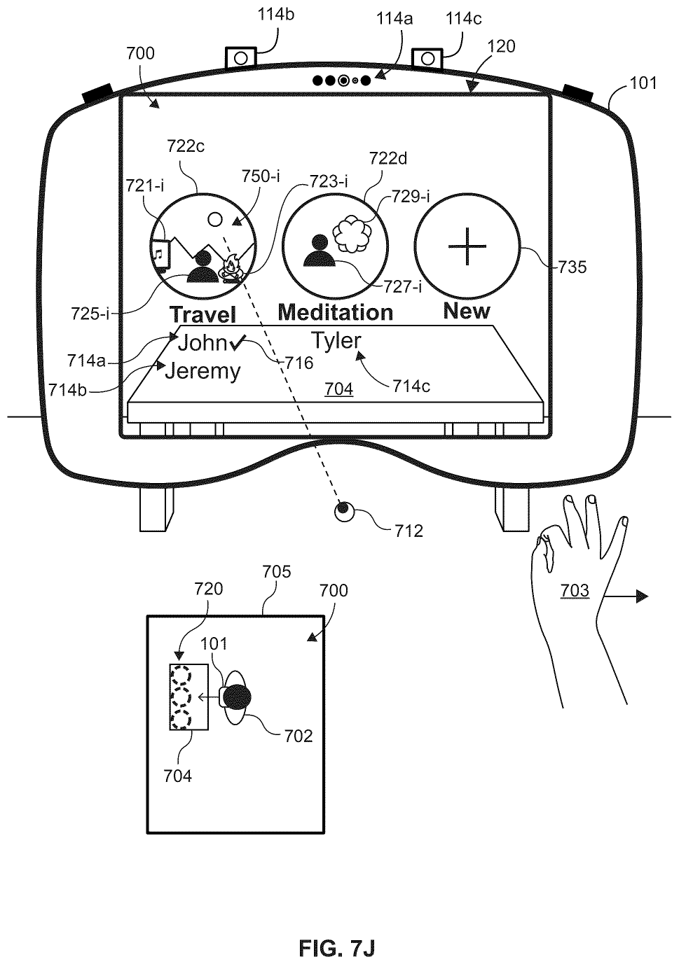

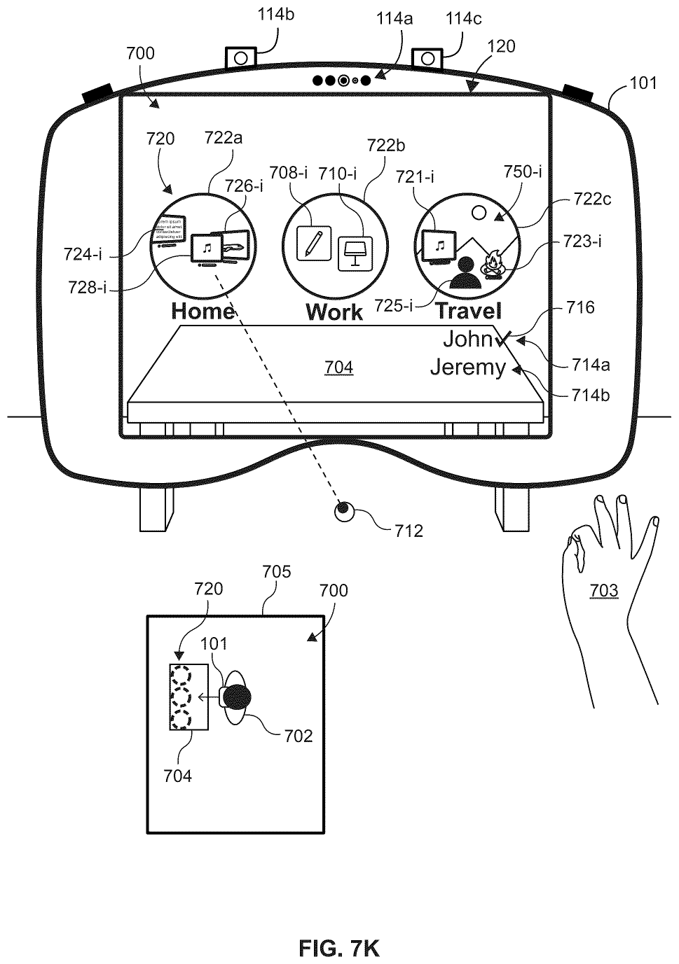

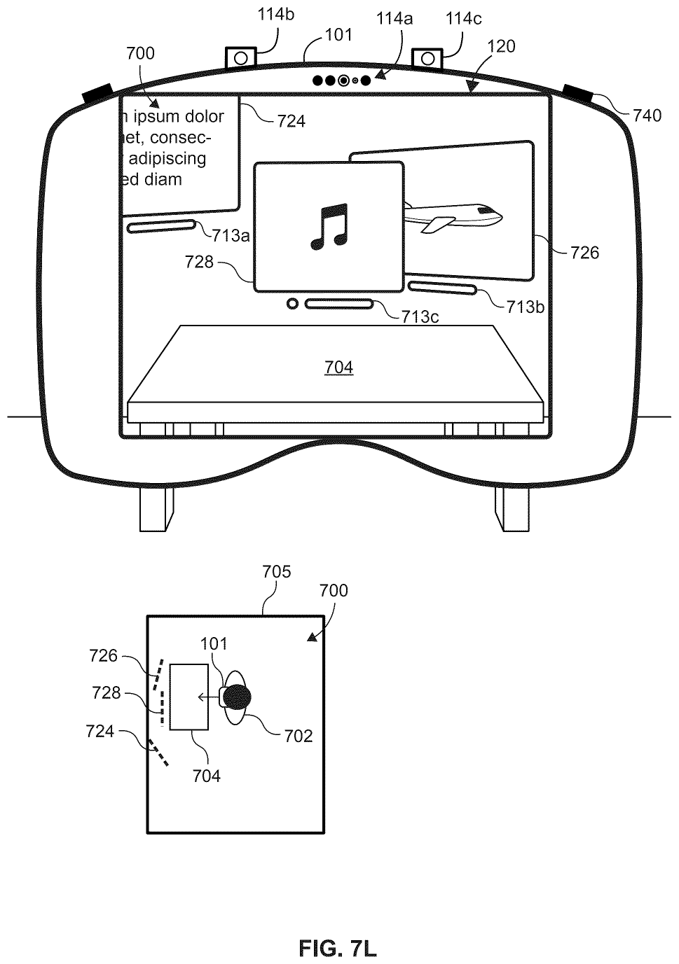

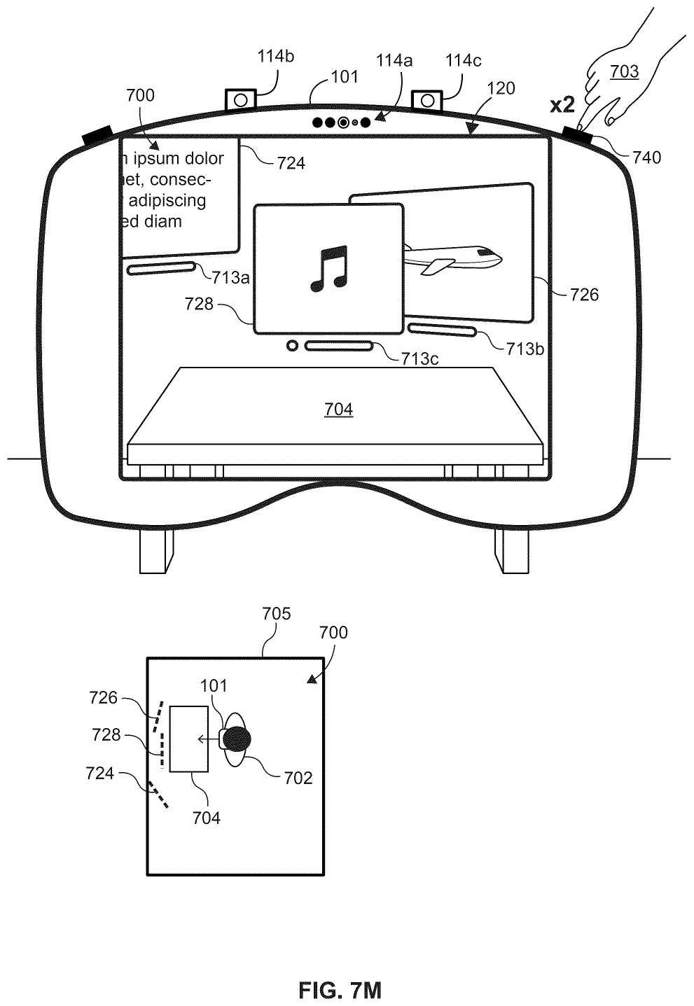

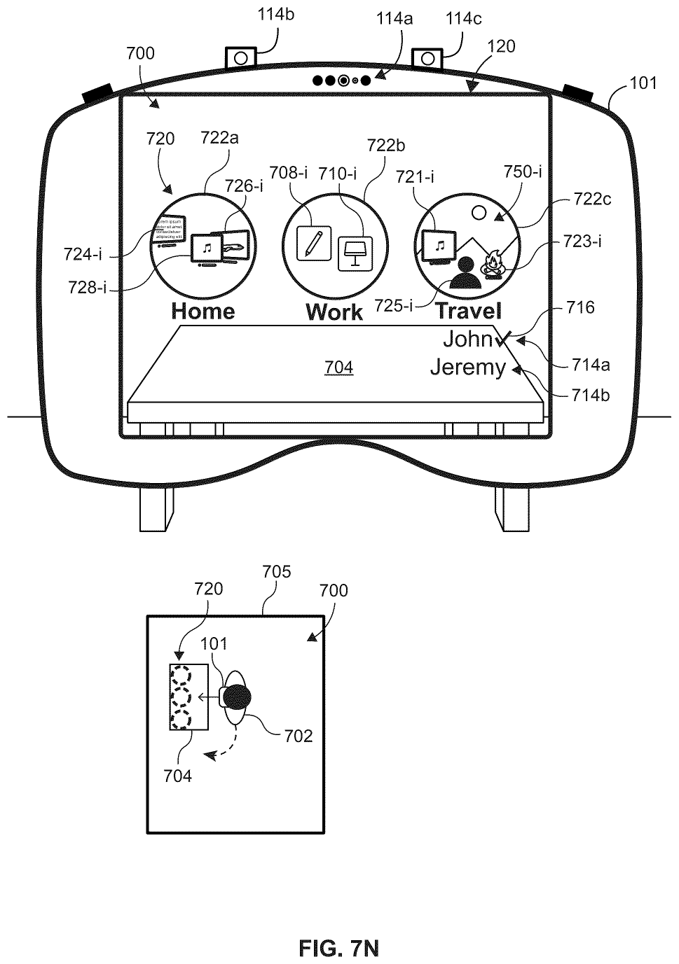

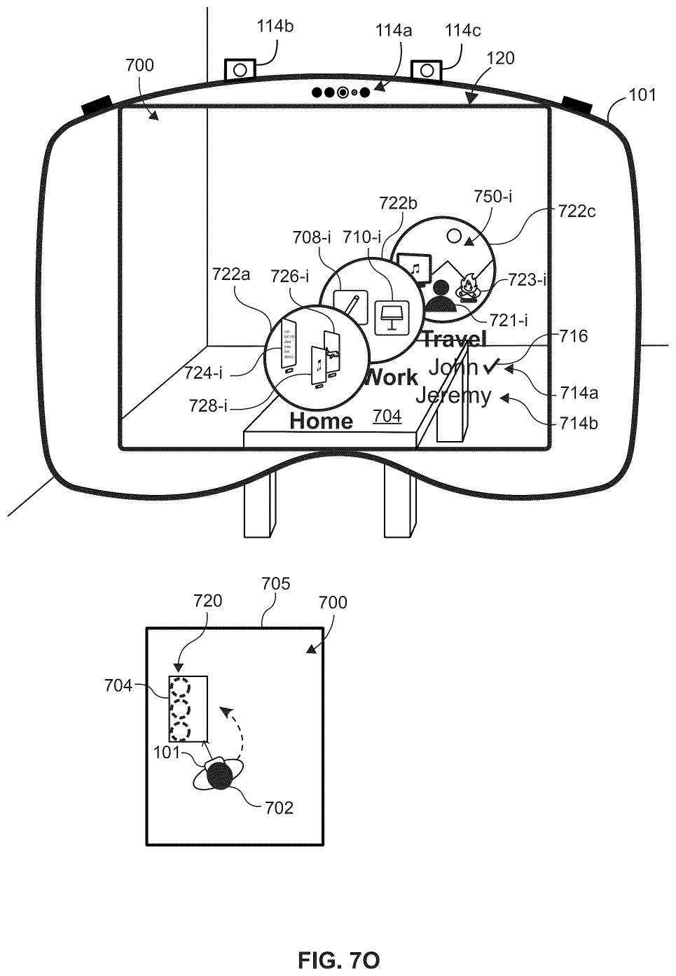

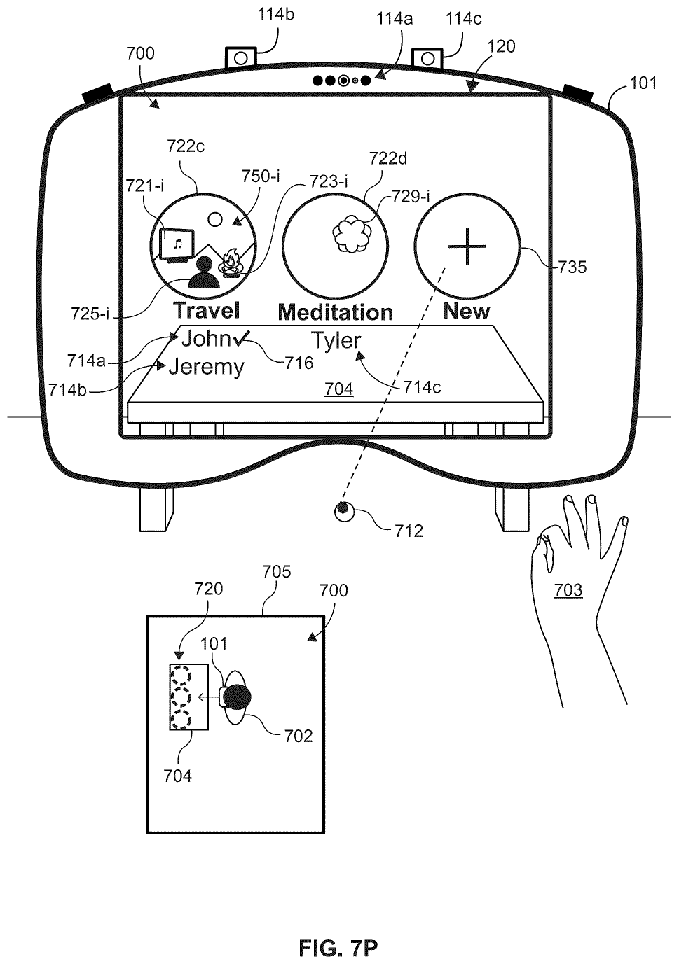

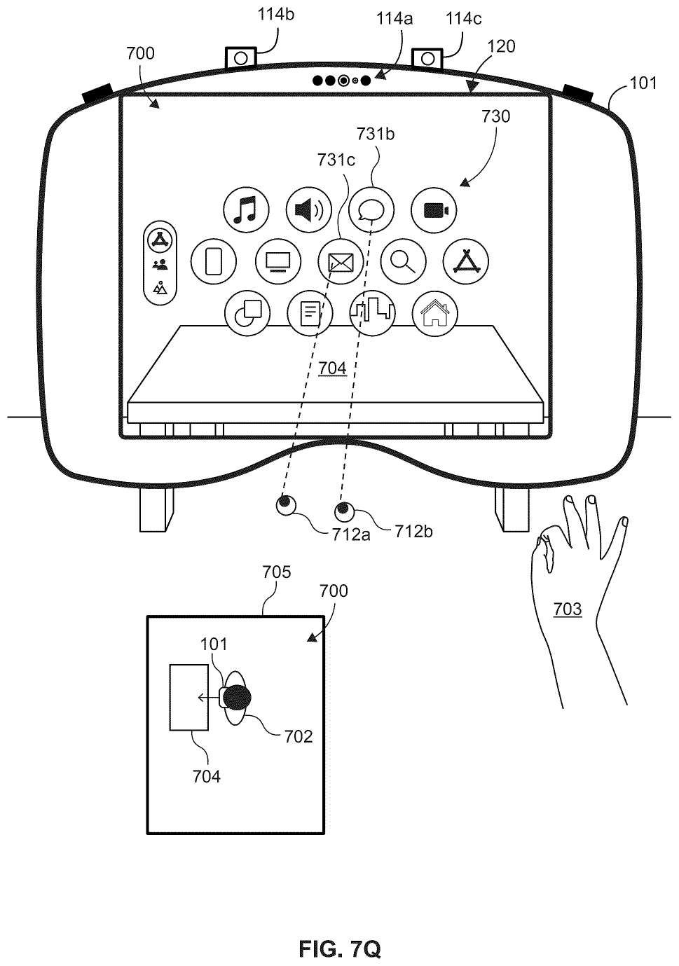

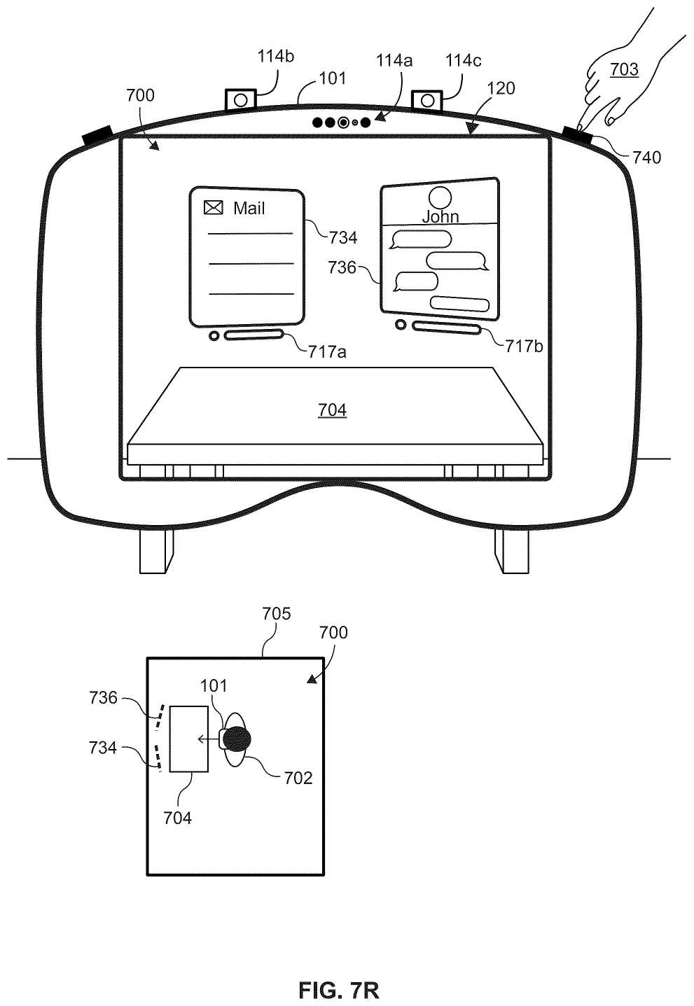

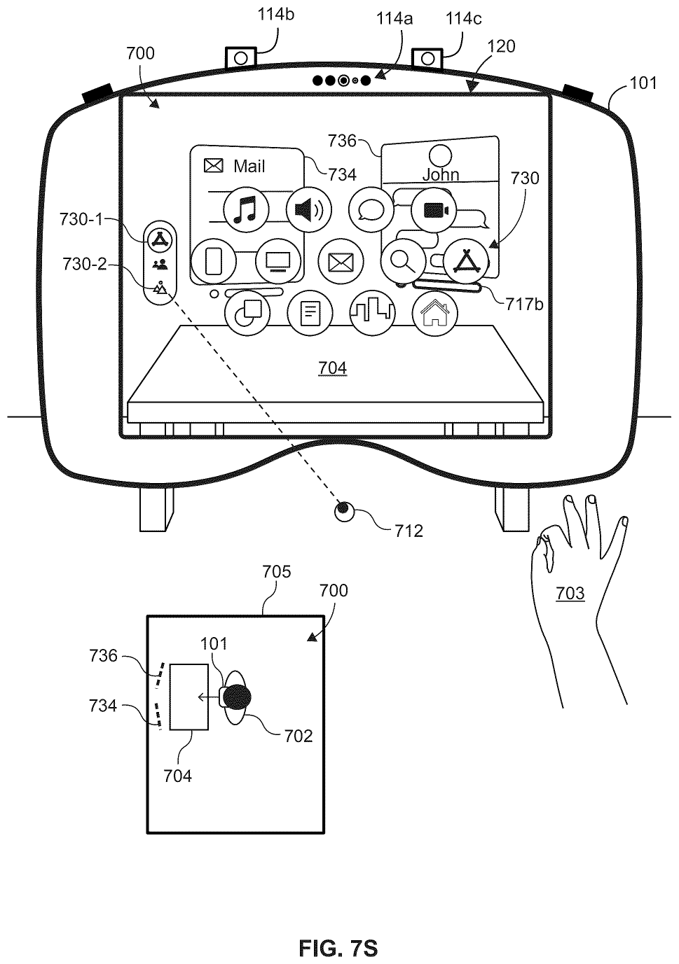

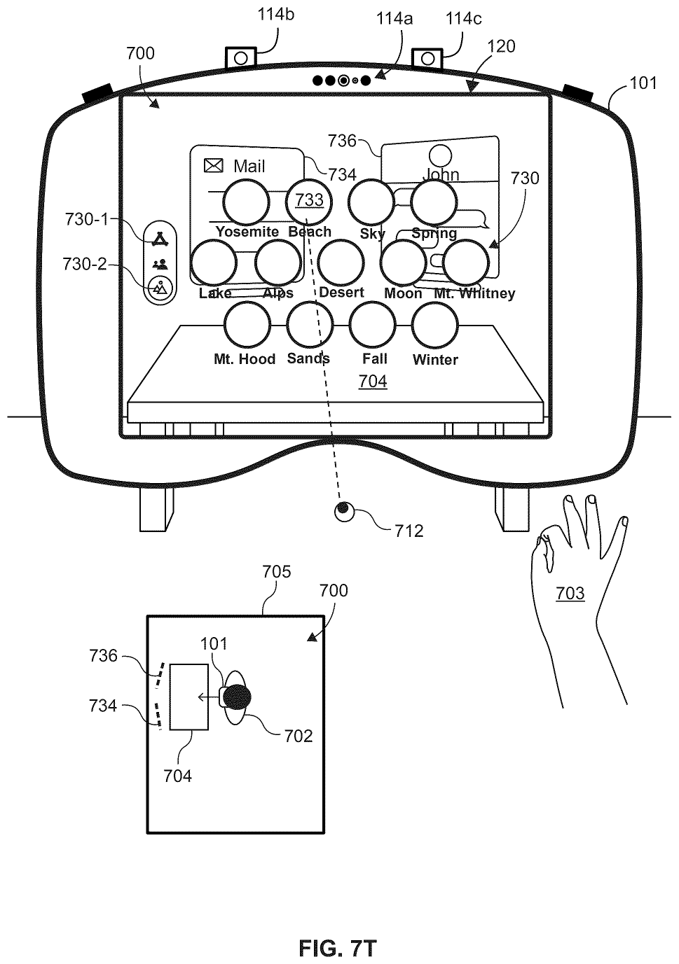

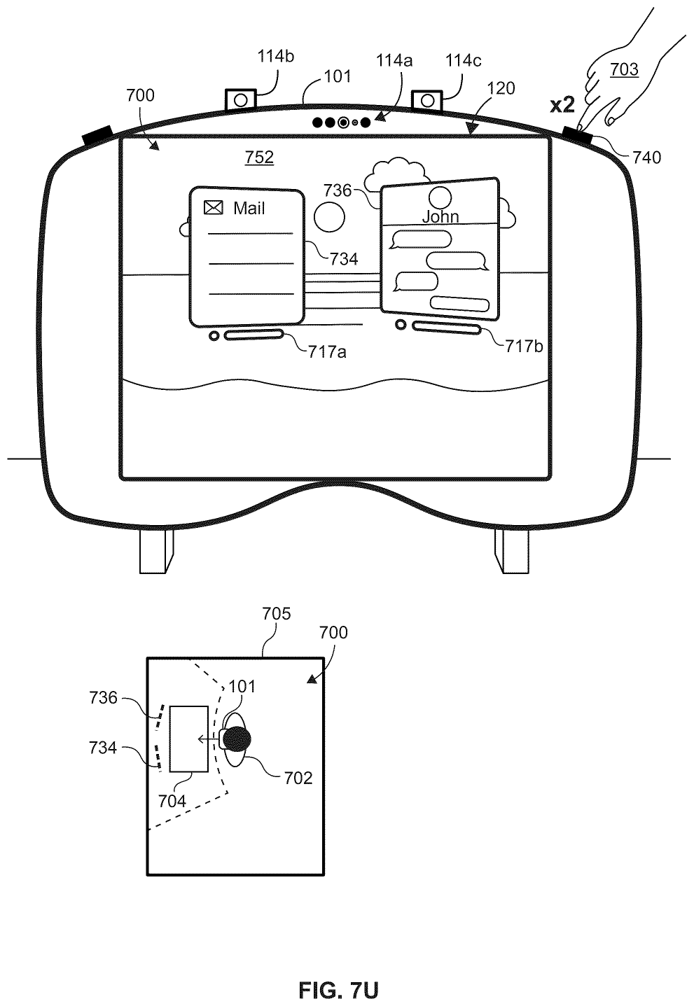

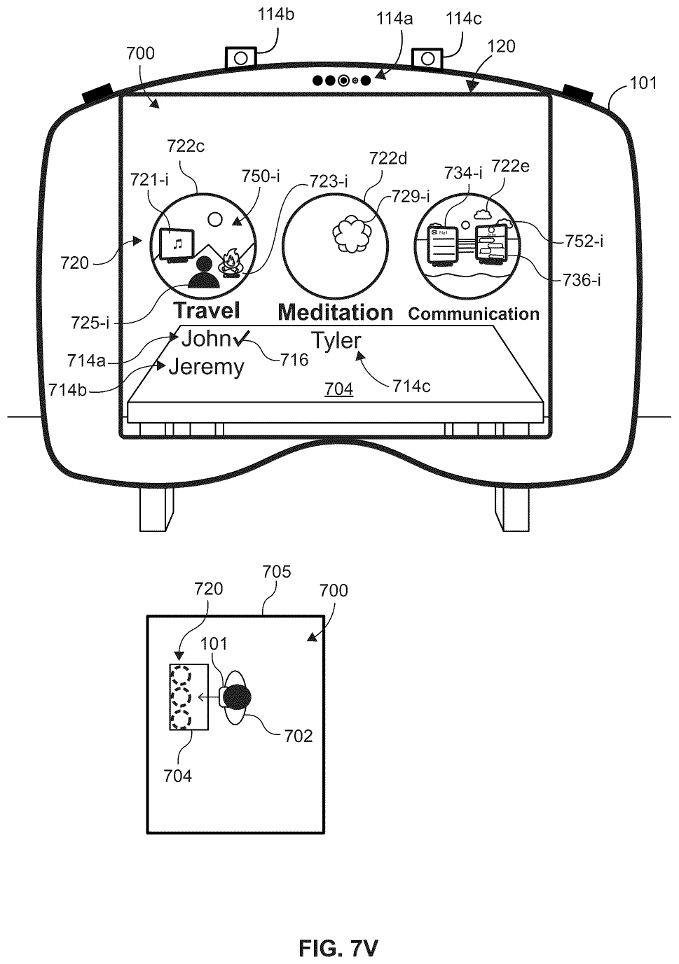

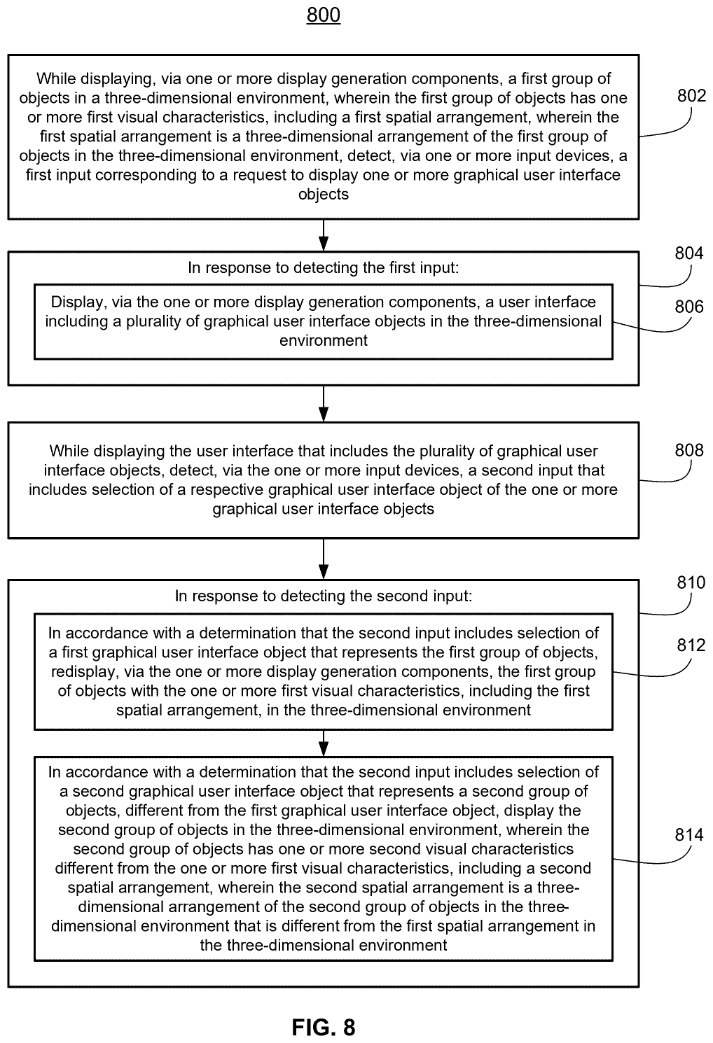

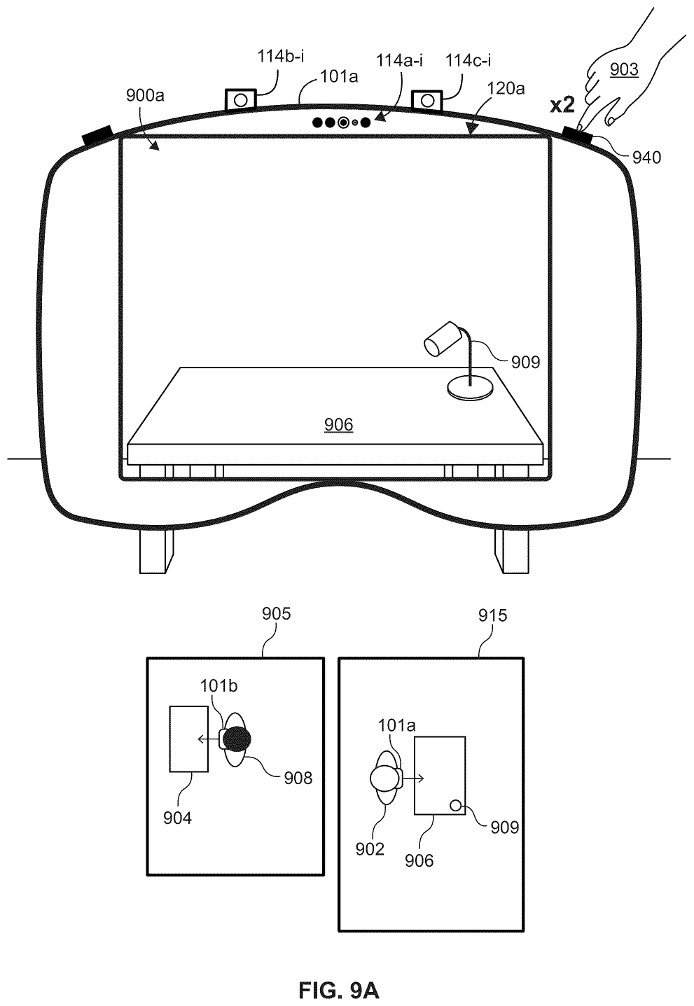

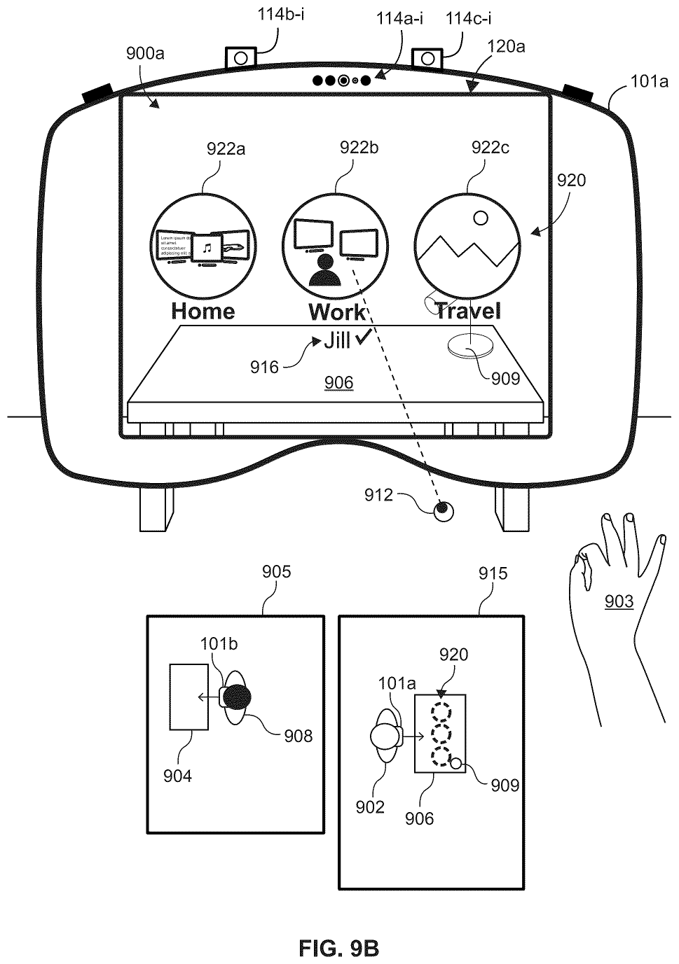

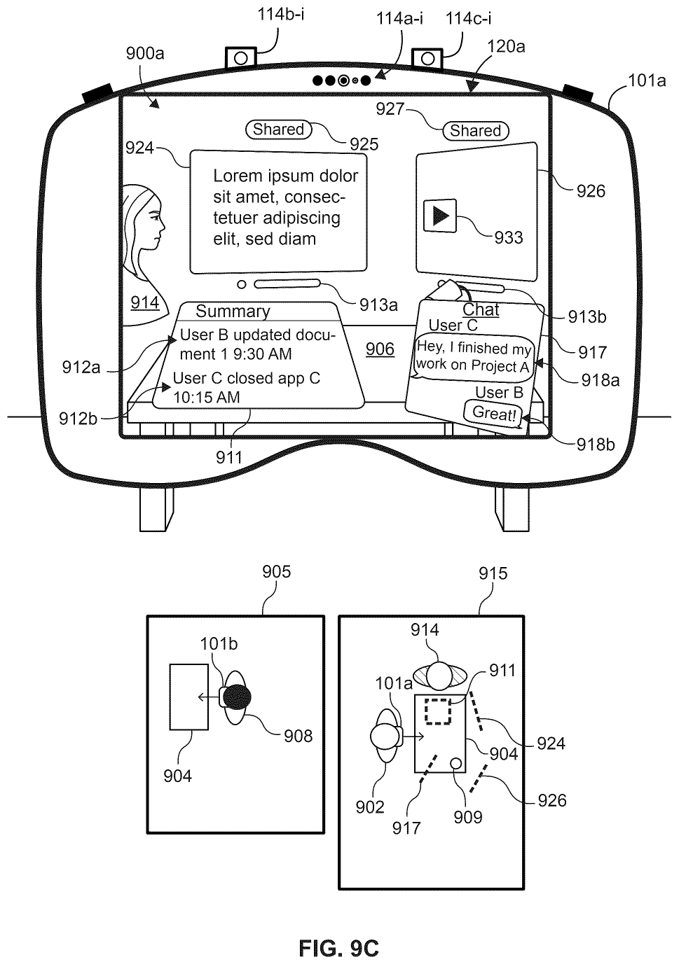

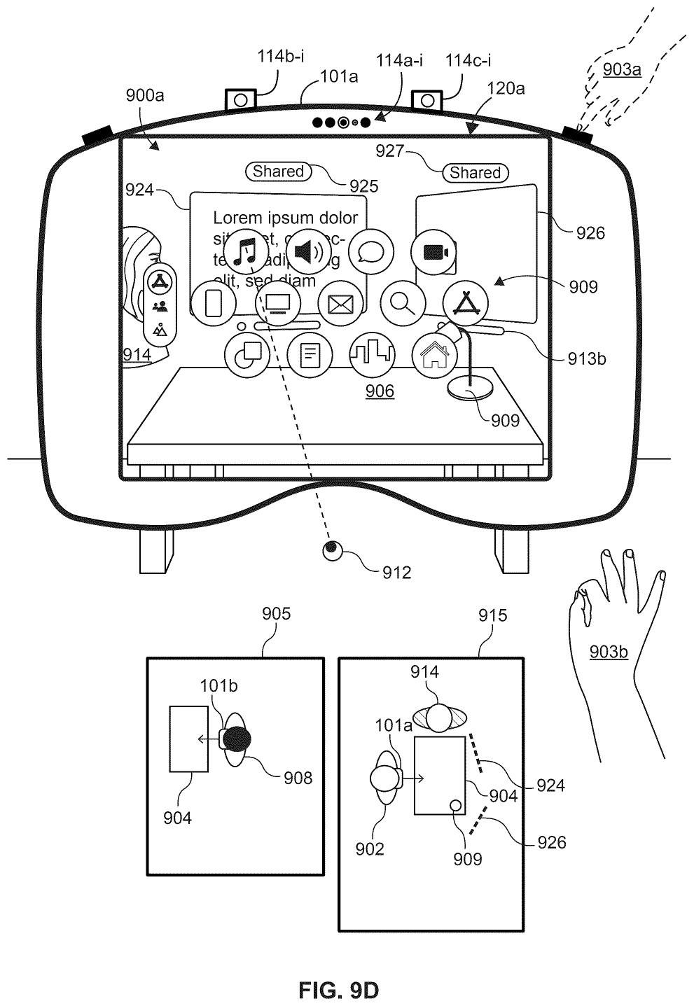

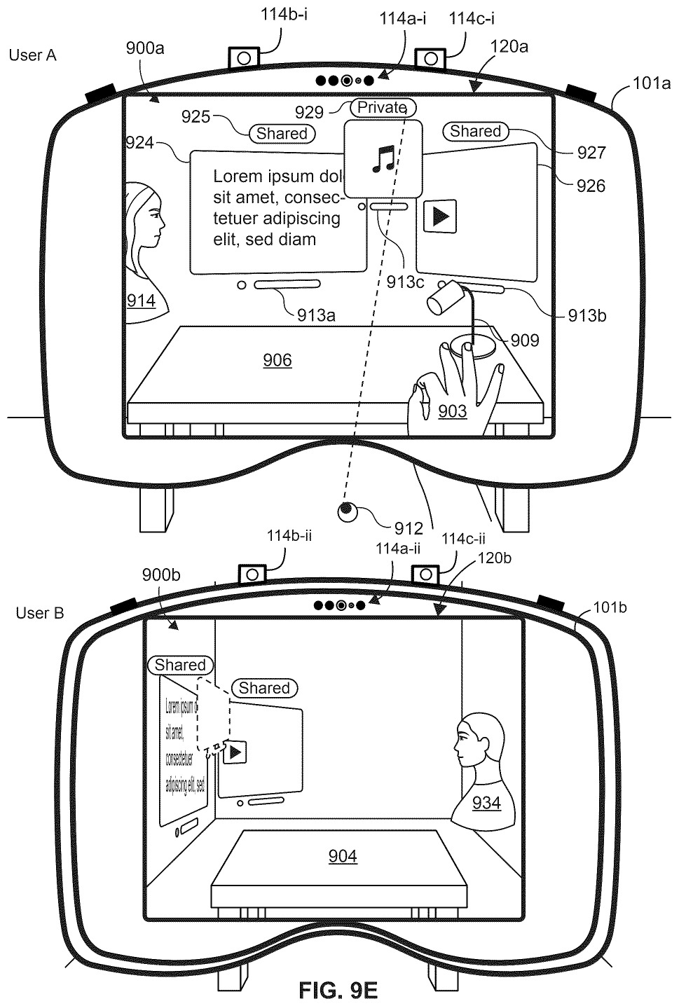

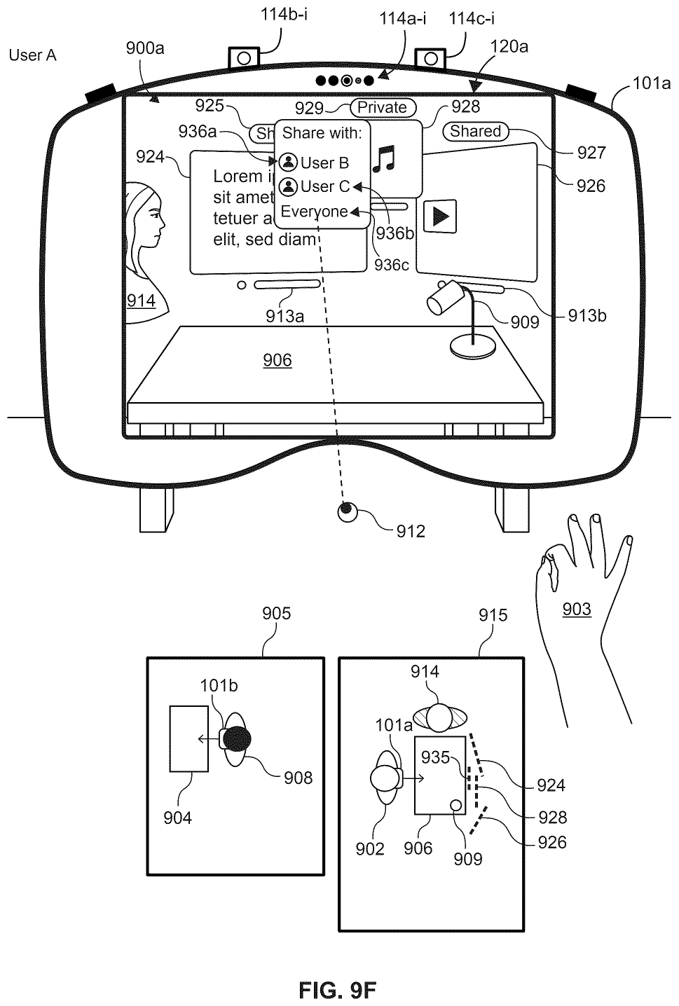

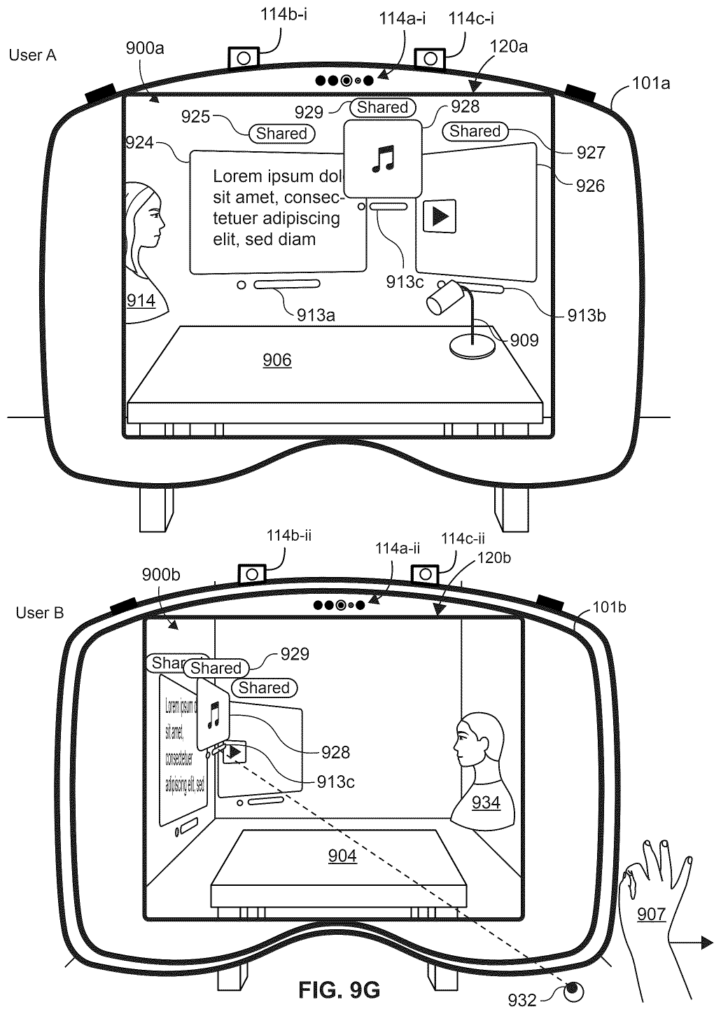

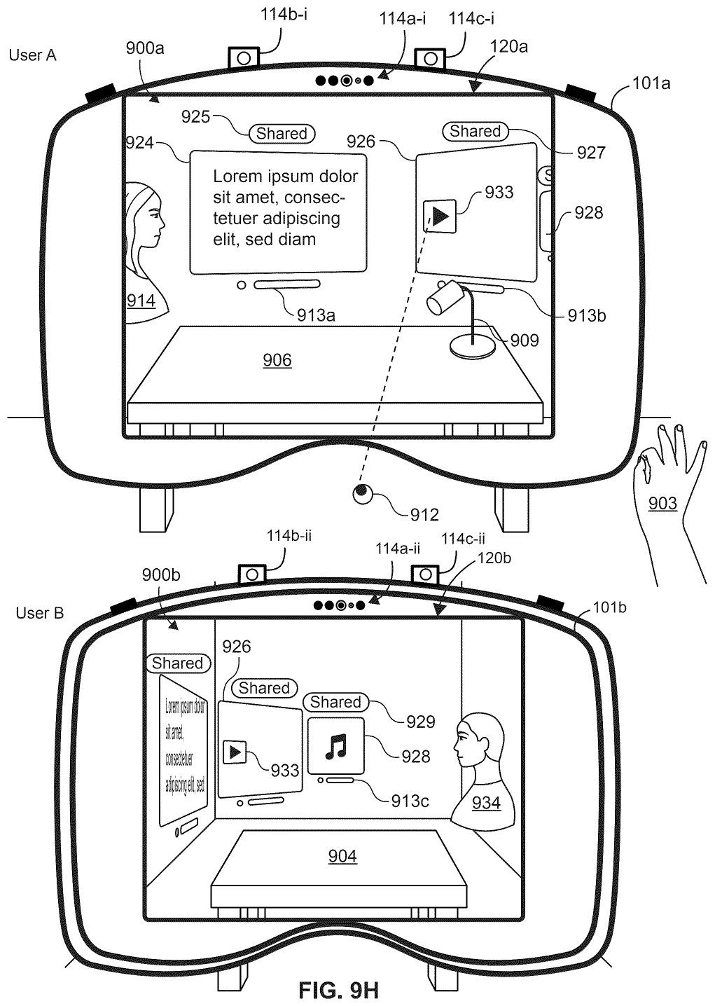

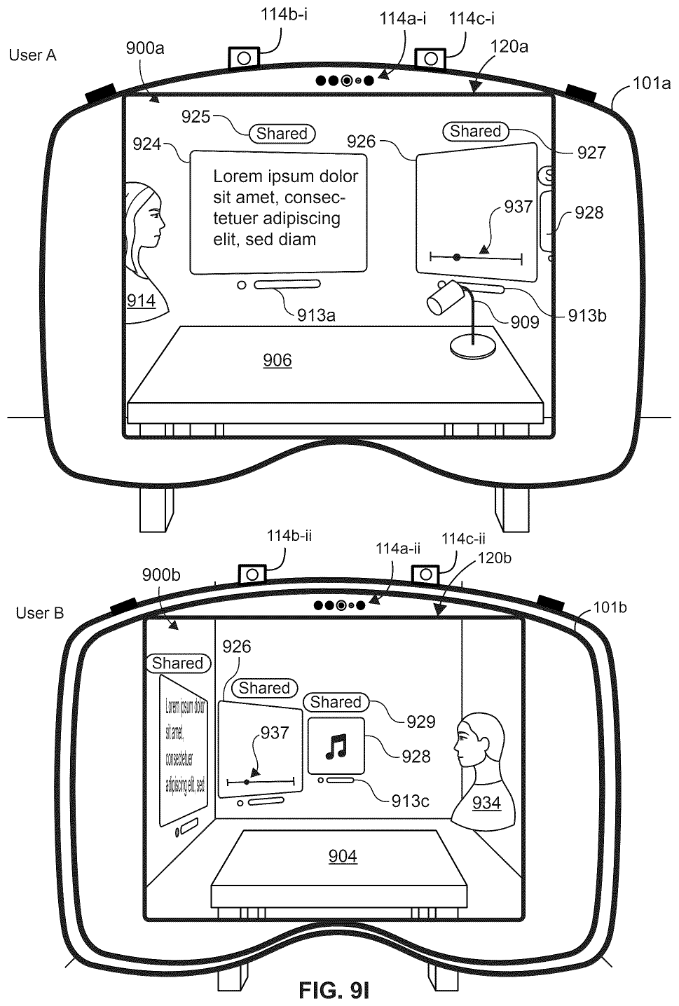

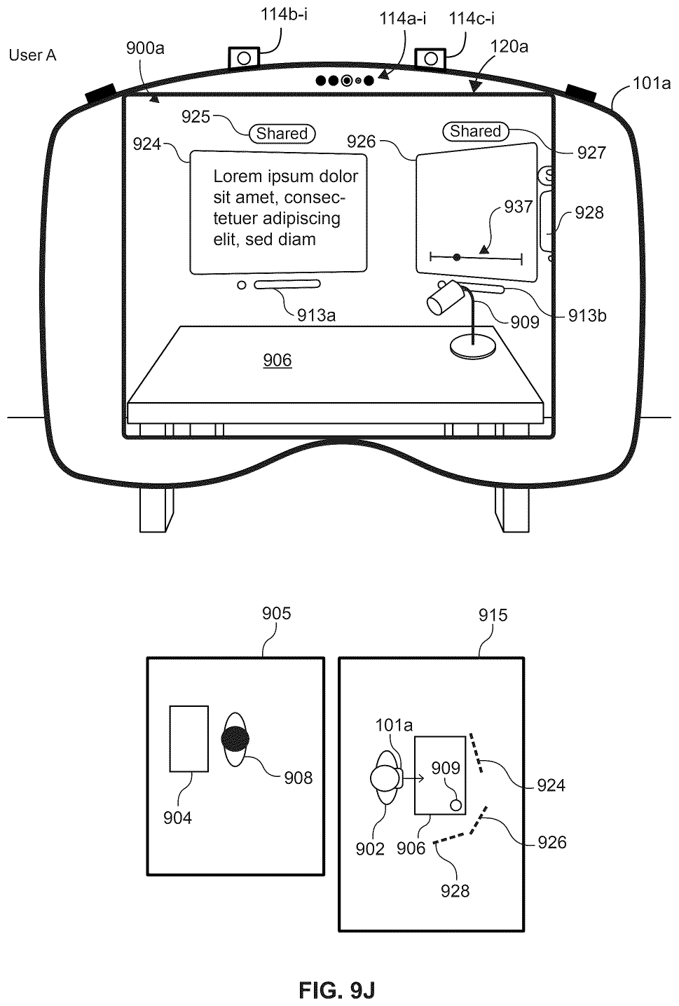

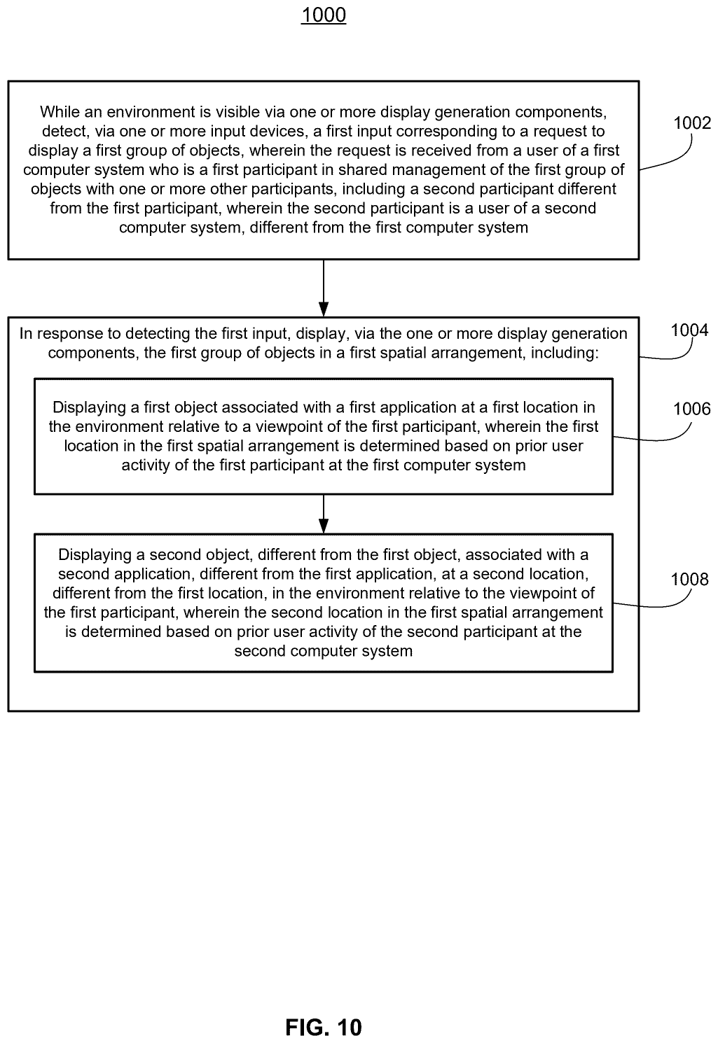

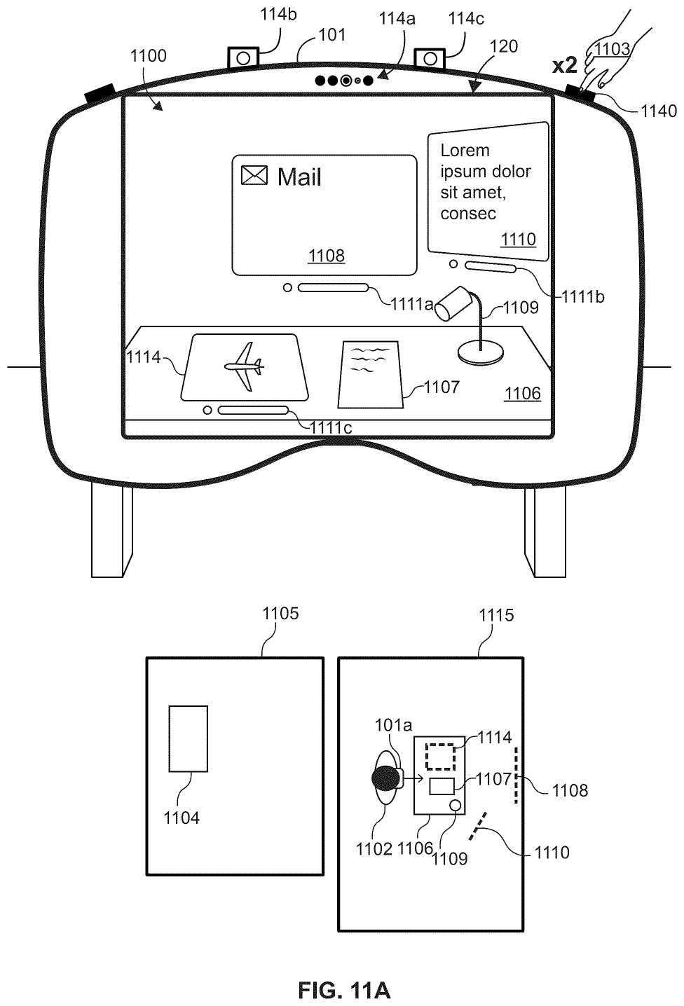

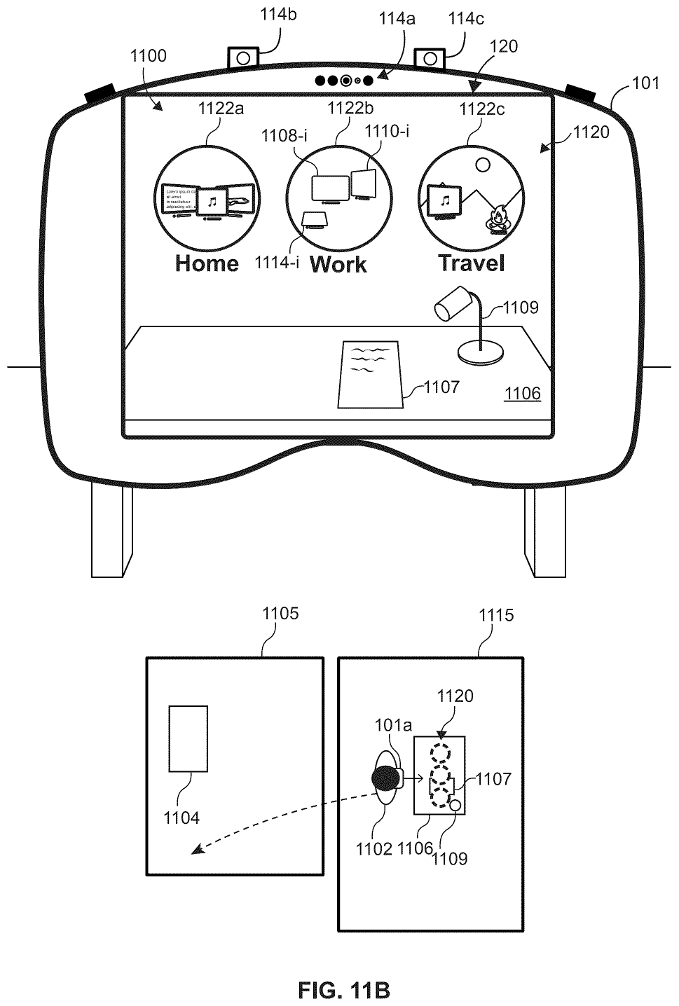

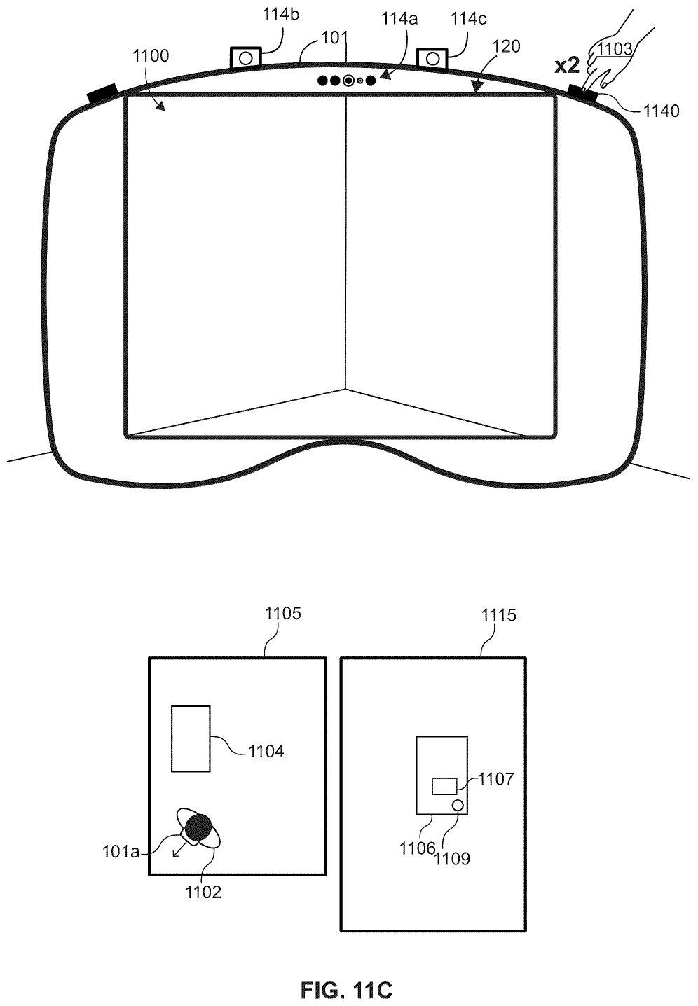

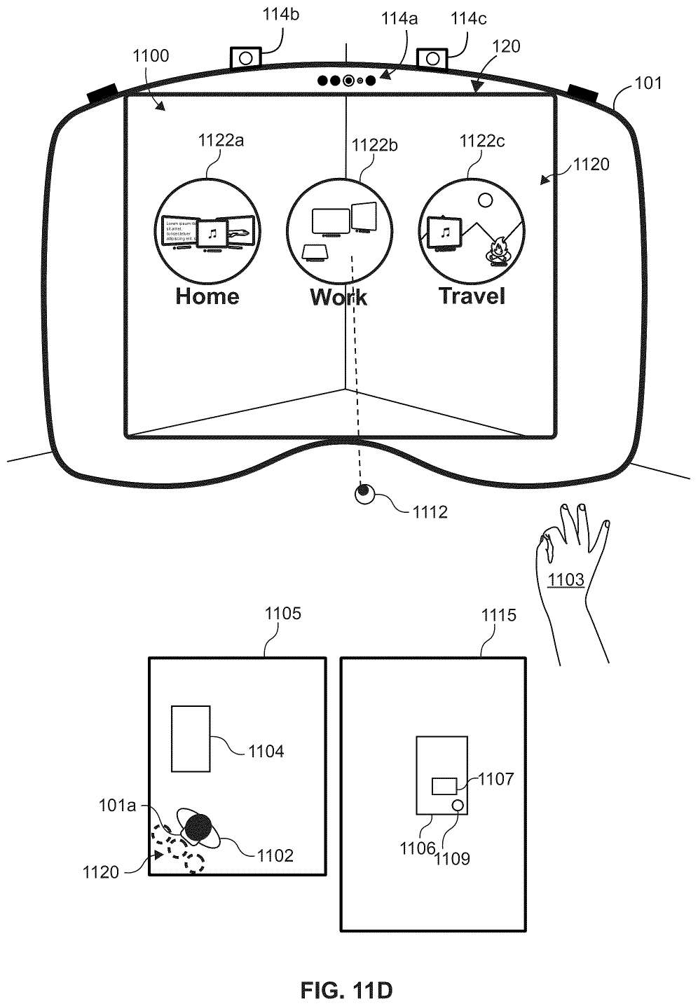

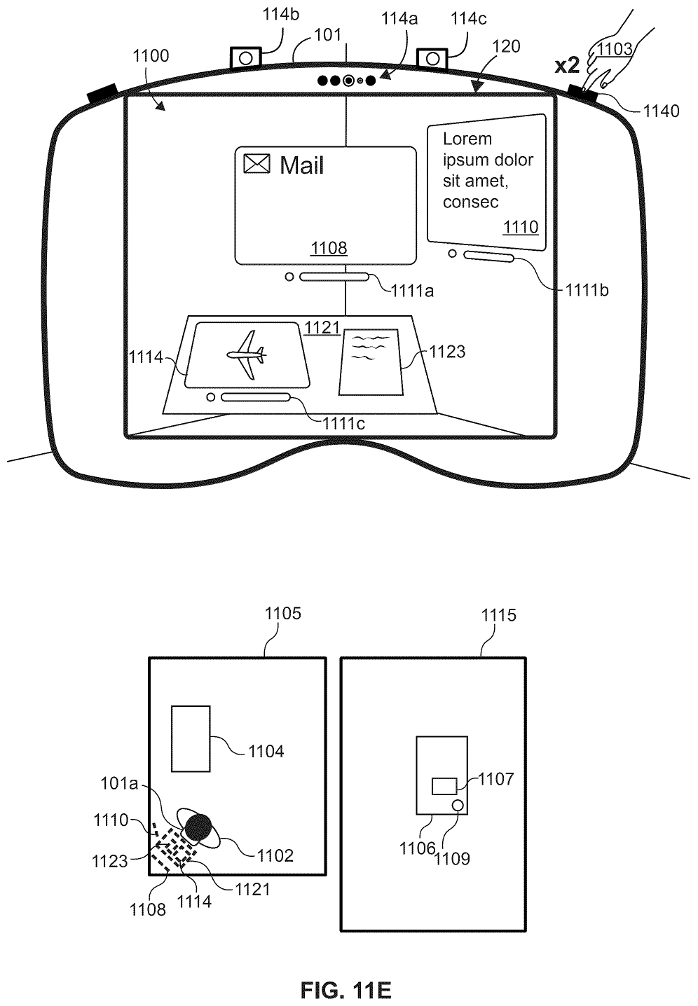

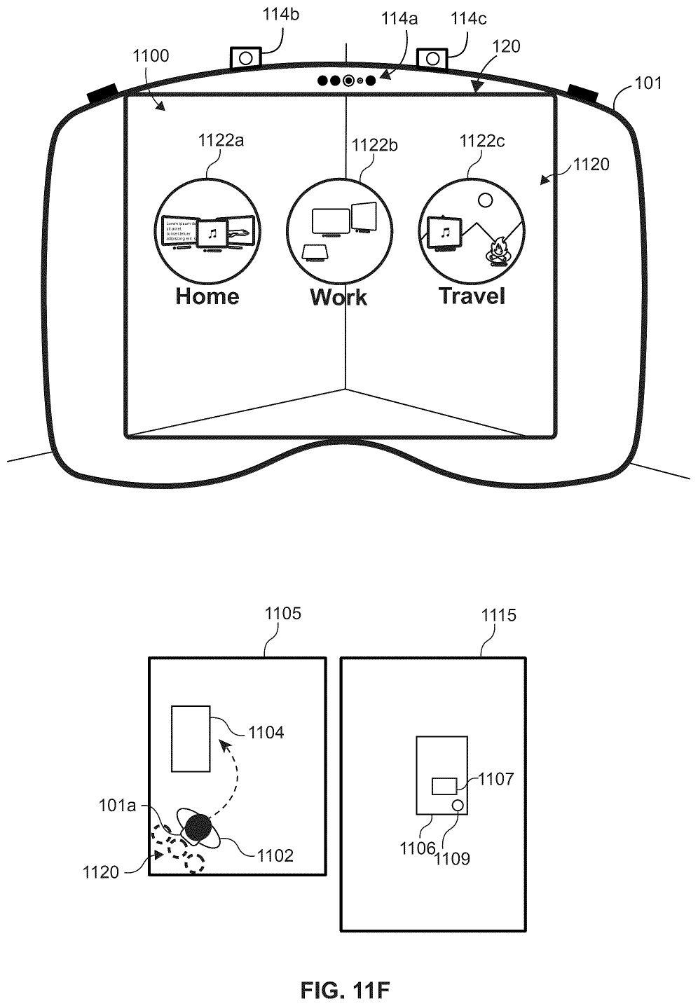

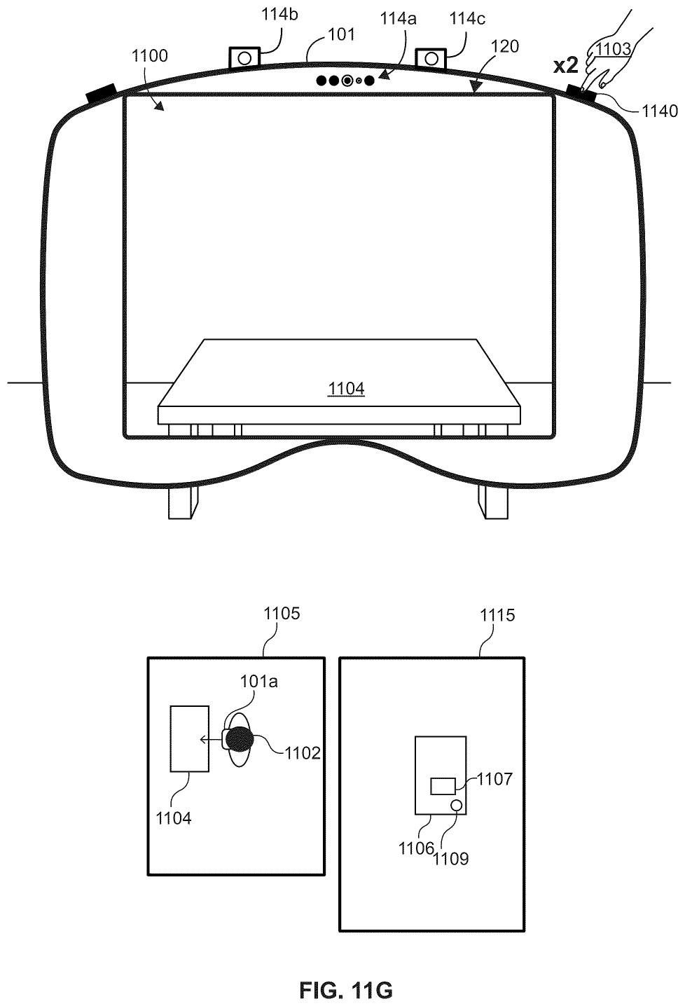

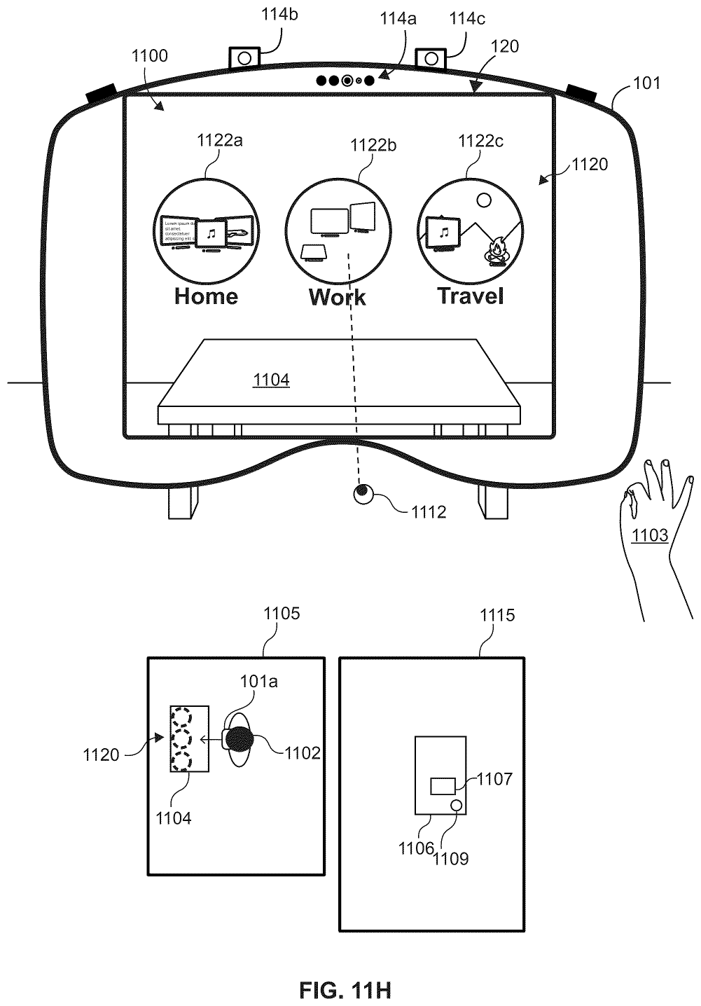

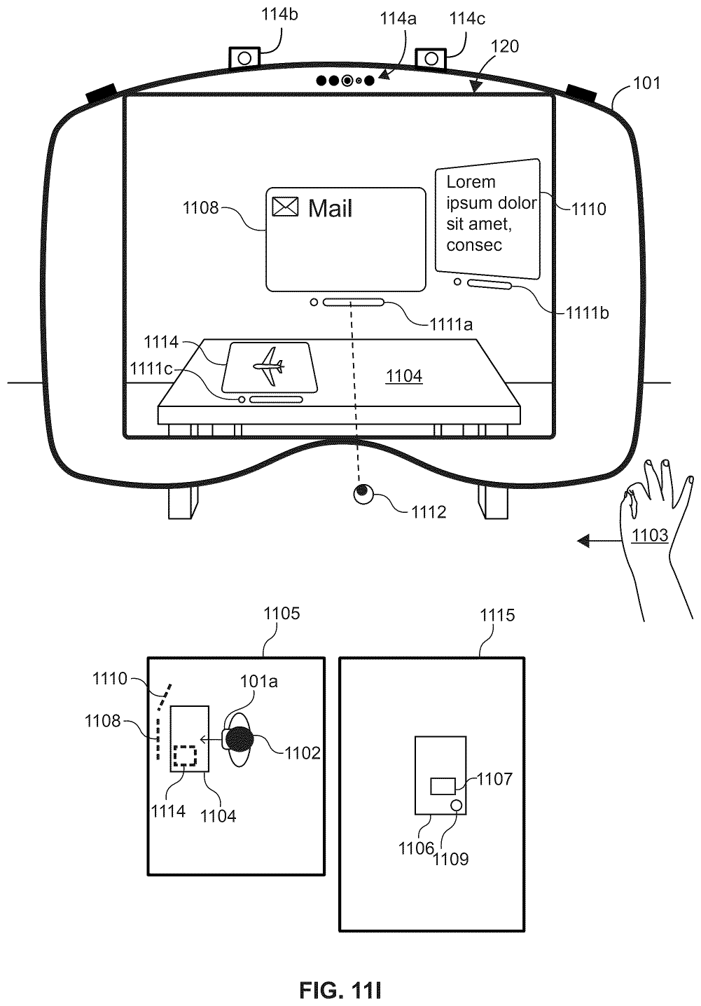

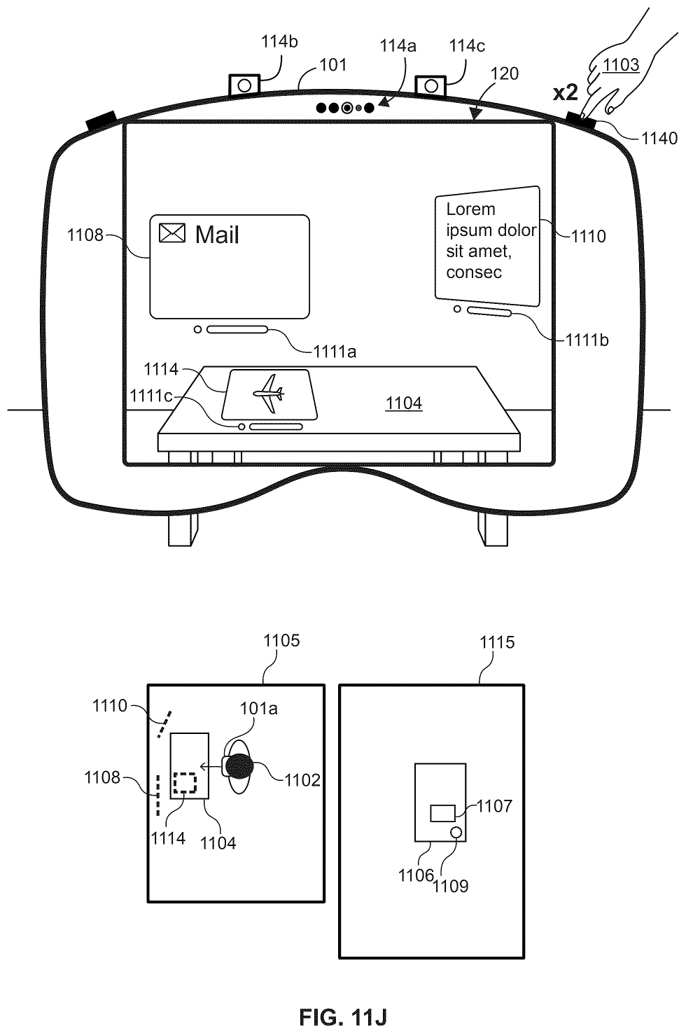

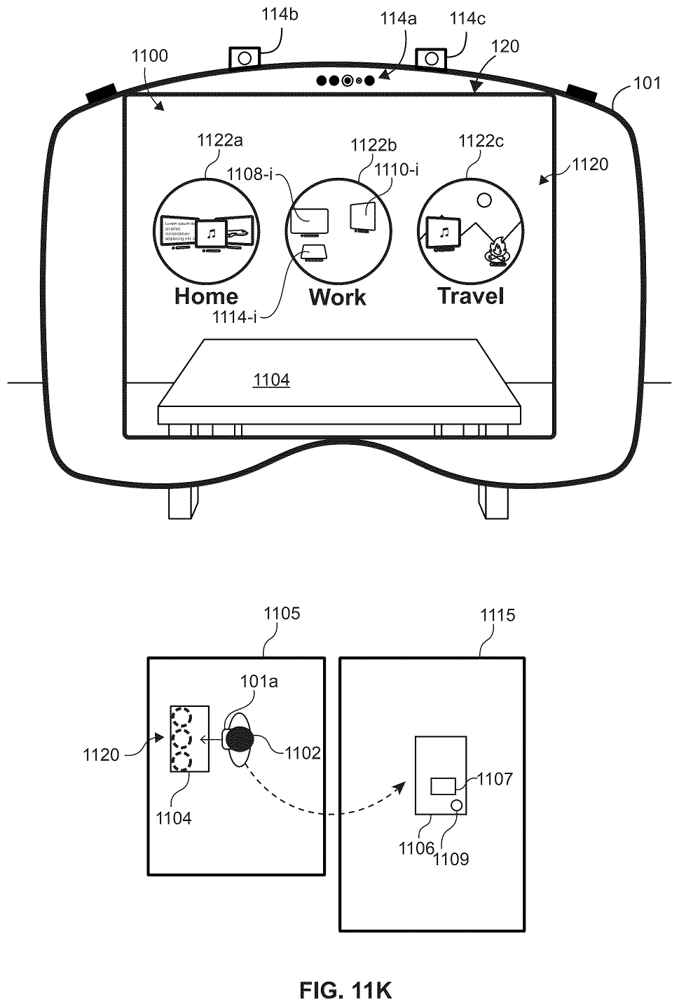

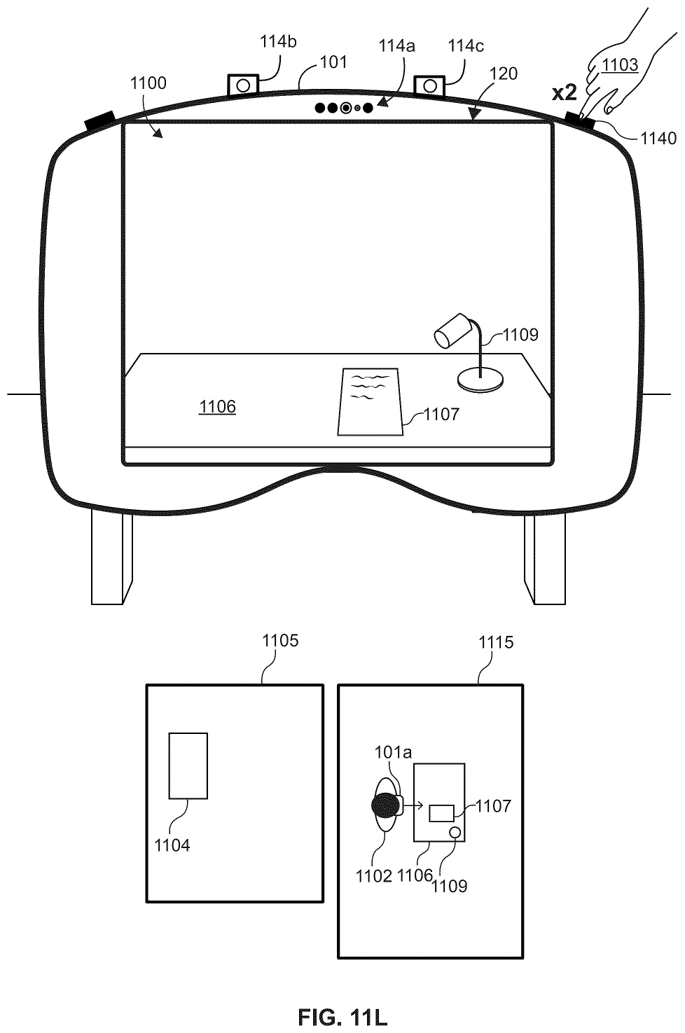

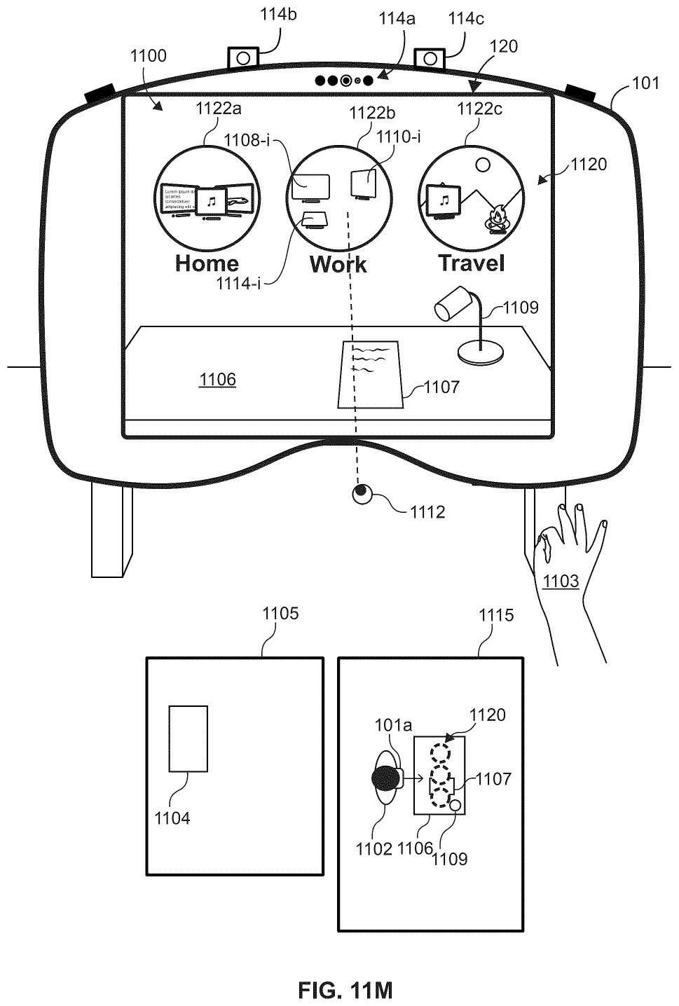

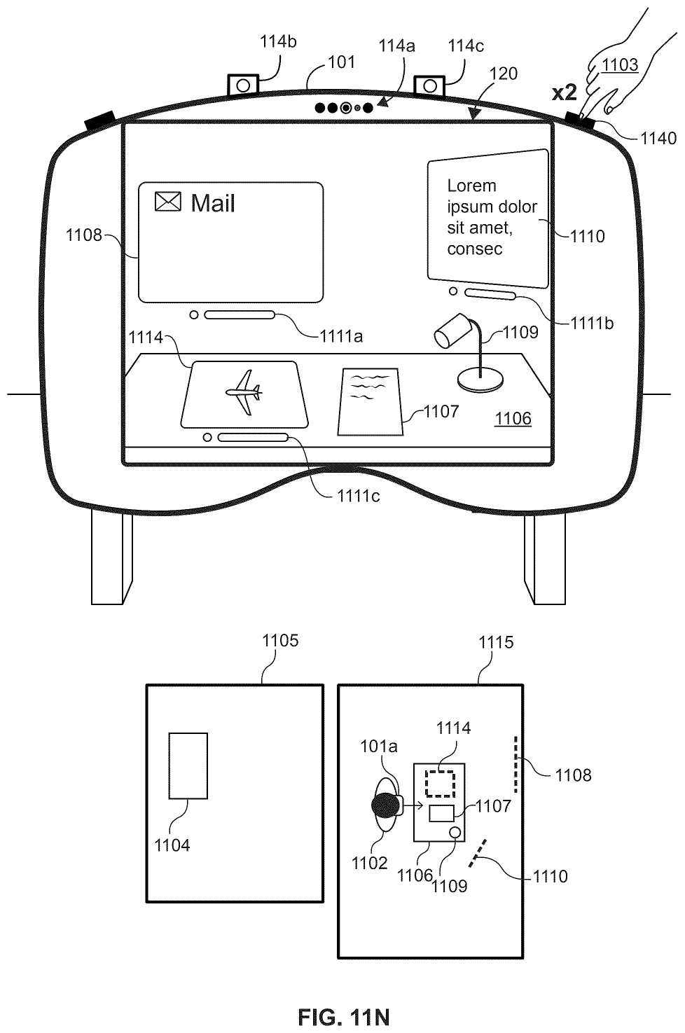

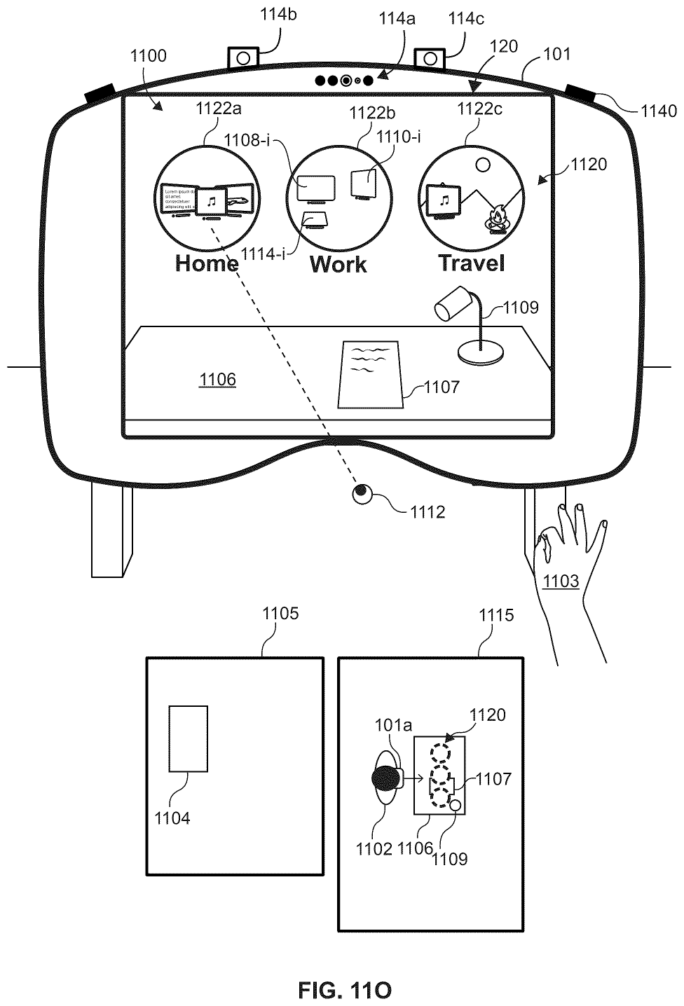

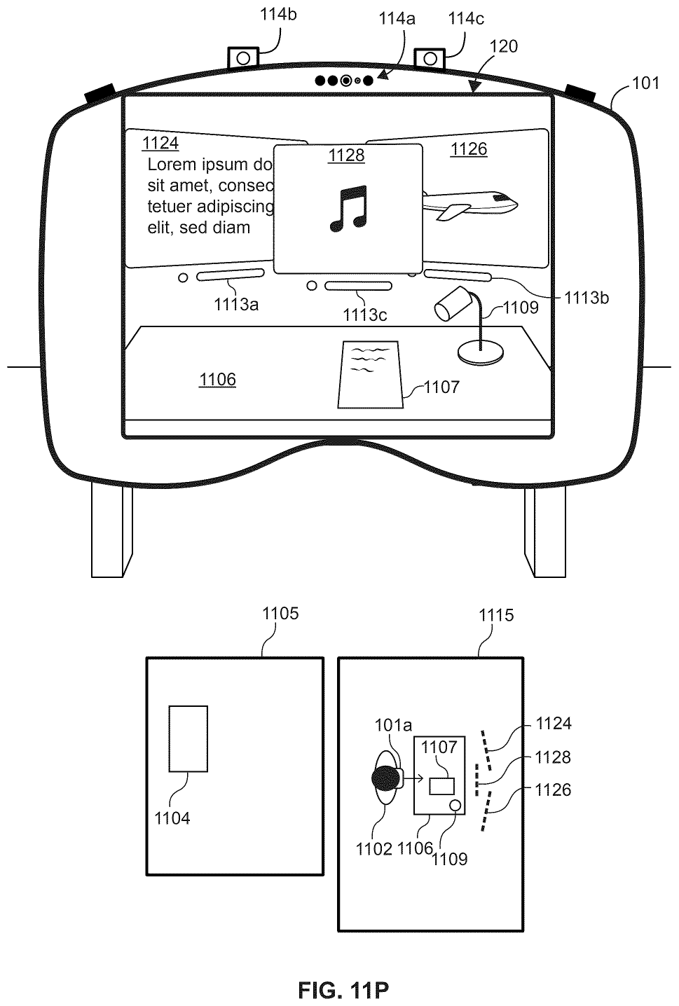

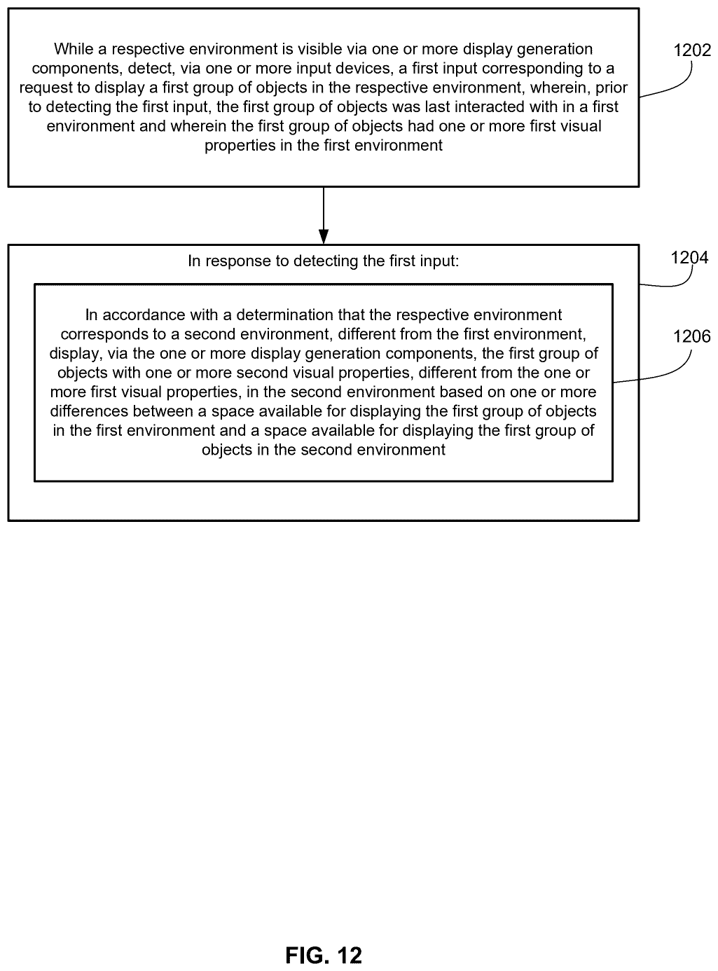

FIGS. 1A-6 provide a description of example computer systems for providing XR experiences to users (such as described below with respect to methods 800, 1000 and/or 1200). FIGS. 7A-7V illustrate examples of a computer system facilitating interaction with virtual objects associated with virtual workspaces in a three-dimensional environment in accordance with some embodiments. FIG. 8 is a flowchart of methods of facilitating interaction with virtual objects associated with virtual workspaces in a three-dimensional environment in accordance with some embodiments. The user interfaces in FIGS. 7A-7V are used to illustrate the processes in FIG. 8. FIGS. 9A-9J illustrate examples of a computer system facilitating multi-user collaboration with content associated with a virtual workspace in a three-dimensional environment in accordance with some embodiments. FIG. 10 is a flowchart of methods of facilitating multi-user collaboration with content associated with a virtual workspace in a three-dimensional environment in accordance with some embodiments. The user interfaces in FIGS. 9A-9J are used to illustrate the processes in FIG. 10. FIGS. 11A-11P illustrate examples of a computer system facilitating display of content associated with a virtual workspace in a three-dimensional environment based on physical properties of a physical environment in accordance with some embodiments. FIG. 12 is a flowchart of methods of facilitating display of content associated with a virtual workspace in a three-dimensional environment based on physical properties of a physical environment in accordance with some embodiments. The user interfaces in FIGS. 11A-11P are used to illustrate the processes in FIG. 12.

The processes described below enhance the operability of the devices and make the user-device interfaces more efficient (e.g., by helping the user to provide proper inputs and reducing user mistakes when operating/interacting with the device) through various techniques, including by providing improved visual feedback to the user, reducing the number of inputs needed to perform an operation, providing additional control options without cluttering the user interface with additional displayed controls, performing an operation when a set of conditions has been met without requiring further user input, improving privacy and/or security, providing a more varied, detailed, and/or realistic user experience while saving storage space, and/or additional techniques. These techniques also reduce power usage and improve battery life of the device by enabling the user to use the device more quickly and efficiently. Saving on battery power, and thus weight, improves the ergonomics of the device. These techniques also enable real-time communication, allow for the use of fewer and/or less-precise sensors resulting in a more compact, lighter, and cheaper device, and enable the device to be used in a variety of lighting conditions. These techniques reduce energy usage, thereby reducing heat emitted by the device, which is particularly important for a wearable device where a device well within operational parameters for device components can become uncomfortable for a user to wear if it is producing too much heat.

In addition, in methods described herein where one or more steps are contingent upon one or more conditions having been met, it should be understood that the described method can be repeated in multiple repetitions so that over the course of the repetitions all of the conditions upon which steps in the method are contingent have been met in different repetitions of the method. For example, if a method requires performing a first step if a condition is satisfied, and a second step if the condition is not satisfied, then a person of ordinary skill would appreciate that the claimed steps are repeated until the condition has been both satisfied and not satisfied, in no particular order. Thus, a method described with one or more steps that are contingent upon one or more conditions having been met could be rewritten as a method that is repeated until each of the conditions described in the method has been met. This, however, is not required of system or computer readable medium claims where the system or computer readable medium contains instructions for performing the contingent operations based on the satisfaction of the corresponding one or more conditions and thus is capable of determining whether the contingency has or has not been satisfied without explicitly repeating steps of a method until all of the conditions upon which steps in the method are contingent have been met. A person having ordinary skill in the art would also understand that, similar to a method with contingent steps, a system or computer readable storage medium can repeat the steps of a method as many times as are needed to ensure that all of the contingent steps have been performed.

In some embodiments, as shown in FIG. 1A, the XR experience is provided to the user via an operating environment 100 that includes a computer system 101. The computer system 101 includes a controller 110 (e.g., processors of a portable electronic device or a remote server), a display generation component 120 (e.g., a head-mounted device (HMD), a display, a projector, a touch-screen, etc.), one or more input devices 125 (e.g., an eye tracking device 130, a hand tracking device 140, other input devices 150), one or more output devices 155 (e.g., speakers 160, tactile output generators 170, and other output devices 180), one or more sensors 190 (e.g., image sensors, light sensors, depth sensors, tactile sensors, orientation sensors, proximity sensors, temperature sensors, location sensors, motion sensors, velocity sensors, etc.), and optionally one or more peripheral devices 195 (e.g., home appliances, wearable devices, etc.). In some embodiments, one or more of the input devices 125, output devices 155, sensors 190, and peripheral devices 195 are integrated with the display generation component 120 (e.g., in a head-mounted device or a handheld device).

When describing an XR experience, various terms are used to differentially refer to several related but distinct environments that the user may sense and/or with which a user may interact (e.g., with inputs detected by a computer system 101 generating the XR experience that cause the computer system generating the XR experience to generate audio, visual, and/or tactile feedback corresponding to various inputs provided to the computer system 101). The following is a subset of these terms:

Physical environment: A physical environment refers to a physical world that people can sense and/or interact with without aid of electronic systems. Physical environments, such as a physical park, include physical articles, such as physical trees, physical buildings, and physical people. People can directly sense and/or interact with the physical environment, such as through sight, touch, hearing, taste, and smell.

Extended reality: In contrast, an extended reality (XR) environment refers to a wholly or partially simulated environment that people sense and/or interact with via an electronic system. In XR, a subset of a person's physical motions, or representations thereof, are tracked, and, in response, one or more characteristics of one or more virtual objects simulated in the XR environment are adjusted in a manner that comports with at least one law of physics. For example, a XR system may detect a person's head turning and, in response, adjust graphical content and an acoustic field presented to the person in a manner similar to how such views and sounds would change in a physical environment. In some situations (e.g., for accessibility reasons), adjustments to characteristic(s) of virtual object(s) in a XR environment may be made in response to representations of physical motions (e.g., vocal commands). A person may sense and/or interact with a XR object using any one of their senses, including sight, sound, touch, taste, and smell. For example, a person may sense and/or interact with audio objects that create a 3D or spatial audio environment that provides the perception of point audio sources in 3D space. In another example, audio objects may enable audio transparency, which selectively incorporates ambient sounds from the physical environment with or without computer-generated audio. In some XR environments, a person may sense and/or interact only with audio objects.

Examples of XR include virtual reality and mixed reality.

Virtual reality: A virtual reality (VR) environment refers to a simulated environment that is designed to be based entirely on computer-generated sensory inputs for one or more senses. A VR environment comprises a plurality of virtual objects with which a person may sense and/or interact. For example, computer-generated imagery of trees, buildings, and avatars representing people are examples of virtual objects. A person may sense and/or interact with virtual objects in the VR environment through a simulation of the person's presence within the computer-generated environment, and/or through a simulation of a subset of the person's physical movements within the computer-generated environment.

Mixed reality: In contrast to a VR environment, which is designed to be based entirely on computer-generated sensory inputs, a mixed reality (MR) environment refers to a simulated environment that is designed to incorporate sensory inputs from the physical environment, or a representation thereof, in addition to including computer-generated sensory inputs (e.g., virtual objects). On a virtuality continuum, a mixed reality environment is anywhere between, but not including, a wholly physical environment at one end and virtual reality environment at the other end. In some MR environments, computer-generated sensory inputs may respond to changes in sensory inputs from the physical environment. Also, some electronic systems for presenting an MR environment may track location and/or orientation with respect to the physical environment to enable virtual objects to interact with real objects (that is, physical articles from the physical environment or representations thereof). For example, a system may account for movements so that a virtual tree appears stationary with respect to the physical ground.

Examples of mixed realities include augmented reality and augmented virtuality.

Augmented reality: An augmented reality (AR) environment refers to a simulated environment in which one or more virtual objects are superimposed over a physical environment, or a representation thereof. For example, an electronic system for presenting an AR environment may have a transparent or translucent display through which a person may directly view the physical environment. The system may be configured to present virtual objects on the transparent or translucent display, so that a person, using the system, perceives the virtual objects superimposed over the physical environment. Alternatively, a system may have an opaque display and one or more imaging sensors that capture images or video of the physical environment, which are representations of the physical environment. The system composites the images or video with virtual objects, and presents the composition on the opaque display. A person, using the system, indirectly views the physical environment by way of the images or video of the physical environment, and perceives the virtual objects superimposed over the physical environment. As used herein, a video of the physical environment shown on an opaque display is called “pass-through video,” meaning a system uses one or more image sensor(s) to capture images of the physical environment, and uses those images in presenting the AR environment on the opaque display. Further alternatively, a system may have a projection system that projects virtual objects into the physical environment, for example, as a hologram or on a physical surface, so that a person, using the system, perceives the virtual objects superimposed over the physical environment. An augmented reality environment also refers to a simulated environment in which a representation of a physical environment is transformed by computer-generated sensory information. For example, in providing pass-through video, a system may transform one or more sensor images to impose a select perspective (e.g., viewpoint) different than the perspective captured by the imaging sensors. As another example, a representation of a physical environment may be transformed by graphically modifying (e.g., enlarging) portions thereof, such that the modified portion may be representative but not photorealistic versions of the originally captured images. As a further example, a representation of a physical environment may be transformed by graphically eliminating or obfuscating portions thereof.

Augmented virtuality: An augmented virtuality (AV) environment refers to a simulated environment in which a virtual or computer-generated environment incorporates one or more sensory inputs from the physical environment. The sensory inputs may be representations of one or more characteristics of the physical environment. For example, an AV park may have virtual trees and virtual buildings, but people with faces photorealistically reproduced from images taken of physical people. As another example, a virtual object may adopt a shape or color of a physical article imaged by one or more imaging sensors. As a further example, a virtual object may adopt shadows consistent with the position of the sun in the physical environment.

In an augmented reality, mixed reality, or virtual reality environment, a view of a three-dimensional environment is visible to a user. The view of the three-dimensional environment is typically visible to the user via one or more display generation components (e.g., a display or a pair of display modules that provide stereoscopic content to different eyes of the same user) through a virtual viewport that has a viewport boundary that defines an extent of the three-dimensional environment that is visible to the user via the one or more display generation components. In some embodiments, the region defined by the viewport boundary is smaller than a range of vision of the user in one or more dimensions (e.g., based on the range of vision of the user, size, optical properties or other physical characteristics of the one or more display generation components, and/or the location and/or orientation of the one or more display generation components relative to the eyes of the user). In some embodiments, the region defined by the viewport boundary is larger than a range of vision of the user in one or more dimensions (e.g., based on the range of vision of the user, size, optical properties or other physical characteristics of the one or more display generation components, and/or the location and/or orientation of the one or more display generation components relative to the eyes of the user). The viewport and viewport boundary typically move as the one or more display generation components move (e.g., moving with a head of the user for a head mounted device or moving with a hand of a user for a handheld device such as a tablet or smartphone). A viewpoint of a user determines what content is visible in the viewport, a viewpoint generally specifies a location and a direction relative to the three-dimensional environment, and as the viewpoint shifts, the view of the three-dimensional environment will also shift in the viewport. For a head mounted device, a viewpoint is typically based on a location an direction of the head, face, and/or eyes of a user to provide a view of the three-dimensional environment that is perceptually accurate and provides an immersive experience when the user is using the head-mounted device. For a handheld or stationed device, the viewpoint shifts as the handheld or stationed device is moved and/or as a position of a user relative to the handheld or stationed device changes (e.g., a user moving toward, away from, up, down, to the right, and/or to the left of the device). For devices that include display generation components with virtual passthrough, portions of the physical environment that are visible (e.g., displayed, and/or projected) via the one or more display generation components are based on a field of view of one or more cameras in communication with the display generation components which typically move with the display generation components (e.g., moving with a head of the user for a head mounted device or moving with a hand of a user for a handheld device such as a tablet or smartphone) because the viewpoint of the user moves as the field of view of the one or more cameras moves (and the appearance of one or more virtual objects displayed via the one or more display generation components is updated based on the viewpoint of the user (e.g., displayed positions and poses of the virtual objects are updated based on the movement of the viewpoint of the user)). For display generation components with optical passthrough, portions of the physical environment that are visible (e.g., optically visible through one or more partially or fully transparent portions of the display generation component) via the one or more display generation components are based on a field of view of a user through the partially or fully transparent portion(s) of the display generation component (e.g., moving with a head of the user for a head mounted device or moving with a hand of a user for a handheld device such as a tablet or smartphone) because the viewpoint of the user moves as the field of view of the user through the partially or fully transparent portions of the display generation components moves (and the appearance of one or more virtual objects is updated based on the viewpoint of the user).

In some embodiments a representation of a physical environment (e.g., displayed via virtual passthrough or optical passthrough) can be partially or fully obscured by a virtual environment. In some embodiments, the amount of virtual environment that is displayed (e.g., the amount of physical environment that is not displayed) is based on an immersion level for the virtual environment (e.g., with respect to the representation of the physical environment). For example, increasing the immersion level optionally causes more of the virtual environment to be displayed, replacing and/or obscuring more of the physical environment, and reducing the immersion level optionally causes less of the virtual environment to be displayed, revealing portions of the physical environment that were previously not displayed and/or obscured. In some embodiments, at a particular immersion level, one or more first background objects (e.g., in the representation of the physical environment) are visually de-emphasized (e.g., dimmed, blurred, and/or displayed with increased transparency) more than one or more second background objects, and one or more third background objects cease to be displayed. In some embodiments, a level of immersion includes an associated degree to which the virtual content displayed by the computer system (e.g., the virtual environment and/or the virtual content) obscures background content (e.g., content other than the virtual environment and/or the virtual content) around/behind the virtual content, optionally including the number of items of background content displayed and/or the visual characteristics (e.g., colors, contrast, and/or opacity) with which the background content is displayed, the angular range of the virtual content displayed via the display generation component (e.g., 60 degrees of content displayed at low immersion, 120 degrees of content displayed at medium immersion, or 180 degrees of content displayed at high immersion), and/or the proportion of the field of view displayed via the display generation component that is consumed by the virtual content (e.g., 33% of the field of view consumed by the virtual content at low immersion, 66% of the field of view consumed by the virtual content at medium immersion, or 100% of the field of view consumed by the virtual content at high immersion). In some embodiments, the background content is included in a background over which the virtual content is displayed (e.g., background content in the representation of the physical environment). In some embodiments, the background content includes user interfaces (e.g., user interfaces generated by the computer system corresponding to applications), virtual objects (e.g., files or representations of other users generated by the computer system) not associated with or included in the virtual environment and/or virtual content, and/or real objects (e.g., pass-through objects representing real objects in the physical environment around the user that are visible such that they are displayed via the display generation component and/or a visible via a transparent or translucent component of the display generation component because the computer system does not obscure/prevent visibility of them through the display generation component). In some embodiments, at a low level of immersion (e.g., a first level of immersion), the background, virtual and/or real objects are displayed in an unobscured manner. For example, a virtual environment with a low level of immersion is optionally displayed concurrently with the background content, which is optionally displayed with full brightness, color, and/or translucency. In some embodiments, at a higher level of immersion (e.g., a second level of immersion higher than the first level of immersion), the background, virtual and/or real objects are displayed in an obscured manner (e.g., dimmed, blurred, or removed from display). For example, a respective virtual environment with a high level of immersion is displayed without concurrently displaying the background content (e.g., in a full screen or fully immersive mode). As another example, a virtual environment displayed with a medium level of immersion is displayed concurrently with darkened, blurred, or otherwise de-emphasized background content. In some embodiments, the visual characteristics of the background objects vary among the background objects. For example, at a particular immersion level, one or more first background objects are visually de-emphasized (e.g., dimmed, blurred, and/or displayed with increased transparency) more than one or more second background objects, and one or more third background objects cease to be displayed. In some embodiments, a null or zero level of immersion corresponds to the virtual environment ceasing to be displayed and instead a representation of a physical environment is displayed (optionally with one or more virtual objects such as application, windows, or virtual three-dimensional objects) without the representation of the physical environment being obscured by the virtual environment. Adjusting the level of immersion using a physical input element provides for quick and efficient method of adjusting immersion, which enhances the operability of the computer system and makes the user-device interface more efficient.

Viewpoint-locked virtual object: A virtual object is viewpoint-locked when a computer system displays the virtual object at the same location and/or position in the viewpoint of the user, even as the viewpoint of the user shifts (e.g., changes). In embodiments where the computer system is a head-mounted device, the viewpoint of the user is locked to the forward facing direction of the user's head (e.g., the viewpoint of the user is at least a portion of the field-of-view of the user when the user is looking straight ahead); thus, the viewpoint of the user remains fixed even as the user's gaze is shifted, without moving the user's head. In embodiments where the computer system has a display generation component (e.g., a display screen) that can be repositioned with respect to the user's head, the viewpoint of the user is the augmented reality view that is being presented to the user on a display generation component of the computer system. For example, a viewpoint-locked virtual object that is displayed in the upper left corner of the viewpoint of the user, when the viewpoint of the user is in a first orientation (e.g., with the user's head facing north) continues to be displayed in the upper left corner of the viewpoint of the user, even as the viewpoint of the user changes to a second orientation (e.g., with the user's head facing west). In other words, the location and/or position at which the viewpoint-locked virtual object is displayed in the viewpoint of the user is independent of the user's position and/or orientation in the physical environment. In embodiments in which the computer system is a head-mounted device, the viewpoint of the user is locked to the orientation of the user's head, such that the virtual object is also referred to as a “head-locked virtual object.”

Environment-locked virtual object: A virtual object is environment-locked (alternatively, “world-locked”) when a computer system displays the virtual object at a location and/or position in the viewpoint of the user that is based on (e.g., selected in reference to and/or anchored to) a location and/or object in the three-dimensional environment (e.g., a physical environment or a virtual environment). As the viewpoint of the user shifts, the location and/or object in the environment relative to the viewpoint of the user changes, which results in the environment-locked virtual object being displayed at a different location and/or position in the viewpoint of the user. For example, an environment-locked virtual object that is locked onto a tree that is immediately in front of a user is displayed at the center of the viewpoint of the user. When the viewpoint of the user shifts to the right (e.g., the user's head is turned to the right) so that the tree is now left-of-center in the viewpoint of the user (e.g., the tree's position in the viewpoint of the user shifts), the environment-locked virtual object that is locked onto the tree is displayed left-of-center in the viewpoint of the user. In other words, the location and/or position at which the environment-locked virtual object is displayed in the viewpoint of the user is dependent on the position and/or orientation of the location and/or object in the environment onto which the virtual object is locked. In some embodiments, the computer system uses a stationary frame of reference (e.g., a coordinate system that is anchored to a fixed location and/or object in the physical environment) in order to determine the position at which to display an environment-locked virtual object in the viewpoint of the user. An environment-locked virtual object can be locked to a stationary part of the environment (e.g., a floor, wall, table, or other stationary object) or can be locked to a moveable part of the environment (e.g., a vehicle, animal, person, or even a representation of portion of the users body that moves independently of a viewpoint of the user, such as a user's hand, wrist, arm, or foot) so that the virtual object is moved as the viewpoint or the portion of the environment moves to maintain a fixed relationship between the virtual object and the portion of the environment.

In some embodiments a virtual object that is environment-locked or viewpoint-locked exhibits lazy follow behavior which reduces or delays motion of the environment-locked or viewpoint-locked virtual object relative to movement of a point of reference which the virtual object is following. In some embodiments, when exhibiting lazy follow behavior the computer system intentionally delays movement of the virtual object when detecting movement of a point of reference (e.g., a portion of the environment, the viewpoint, or a point that is fixed relative to the viewpoint, such as a point that is between 5-300 cm from the viewpoint) which the virtual object is following. For example, when the point of reference (e.g., the portion of the environment or the viewpoint) moves with a first speed, the virtual object is moved by the device to remain locked to the point of reference but moves with a second speed that is slower than the first speed (e.g., until the point of reference stops moving or slows down, at which point the virtual object starts to catch up to the point of reference). In some embodiments, when a virtual object exhibits lazy follow behavior the device ignores small amounts of movement of the point of reference (e.g., ignoring movement of the point of reference that is below a threshold amount of movement such as movement by 0-5 degrees or movement by 0-50 cm). For example, when the point of reference (e.g., the portion of the environment or the viewpoint to which the virtual object is locked) moves by a first amount, a distance between the point of reference and the virtual object increases (e.g., because the virtual object is being displayed so as to maintain a fixed or substantially fixed position relative to a viewpoint or portion of the environment that is different from the point of reference to which the virtual object is locked) and when the point of reference (e.g., the portion of the environment or the viewpoint to which the virtual object is locked) moves by a second amount that is greater than the first amount, a distance between the point of reference and the virtual object initially increases (e.g., because the virtual object is being displayed so as to maintain a fixed or substantially fixed position relative to a viewpoint or portion of the environment that is different from the point of reference to which the virtual object is locked) and then decreases as the amount of movement of the point of reference increases above a threshold (e.g., a “lazy follow” threshold) because the virtual object is moved by the computer system to maintain a fixed or substantially fixed position relative to the point of reference. In some embodiments the virtual object maintaining a substantially fixed position relative to the point of reference includes the virtual object being displayed within a threshold distance (e.g., 1, 2, 3, 5, 15, 20, 50 cm) of the point of reference in one or more dimensions (e.g., up/down, left/right, and/or forward/backward relative to the position of the point of reference).

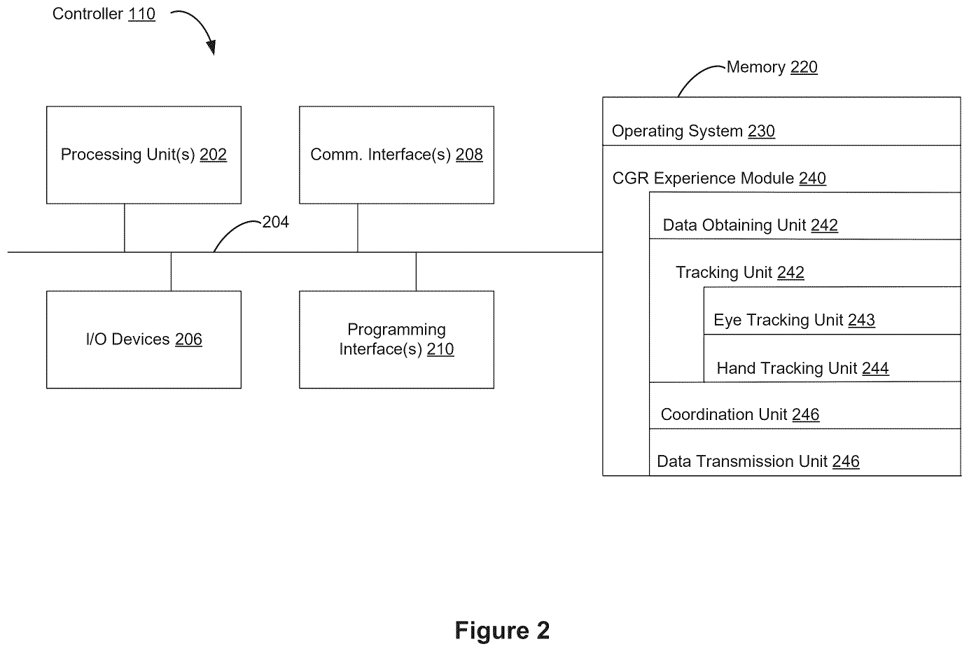

Hardware: There are many different types of electronic systems that enable a person to sense and/or interact with various XR environments. Examples include head-mounted systems, projection-based systems, heads-up displays (HUDs), vehicle windshields having integrated display capability, windows having integrated display capability, displays formed as lenses designed to be placed on a person's eyes (e.g., similar to contact lenses), headphones/earphones, speaker arrays, input systems (e.g., wearable or handheld controllers with or without haptic feedback), smartphones, tablets, and desktop/laptop computers. A head-mounted system may have one or more speaker(s) and an integrated opaque display. Alternatively, a head-mounted system may be configured to accept an external opaque display (e.g., a smartphone). The head-mounted system may incorporate one or more imaging sensors to capture images or video of the physical environment, and/or one or more microphones to capture audio of the physical environment. Rather than an opaque display, a head-mounted system may have a transparent or translucent display. The transparent or translucent display may have a medium through which light representative of images is directed to a person's eyes. The display may utilize digital light projection, organic light emitting diodes (OLEDs), light emitting diodes (LEDs), micro light emitting diodes (u LEDs), liquid crystal on silicon, laser scanning light source, or any combination of these technologies. The medium may be an optical waveguide, a hologram medium, an optical combiner, an optical reflector, or any combination thereof. In one embodiment, the transparent or translucent display may be configured to become opaque selectively. Projection-based systems may employ retinal projection technology that projects graphical images onto a person's retina. Projection systems also may be configured to project virtual objects into the physical environment, for example, as a hologram or on a physical surface. In some embodiments, the controller 110 is configured to manage and coordinate a XR experience for the user. In some embodiments, the controller 110 includes a suitable combination of software, firmware, and/or hardware. The controller 110 is described in greater detail below with respect to FIG. 2. In some embodiments, the controller 110 is a computing device that is local or remote relative to the scene 105 (e.g., a physical environment). For example, the controller 110 is a local server located within the scene 105. In another example, the controller 110 is a remote server located outside of the scene 105 (e.g., a cloud server, central server, etc.). In some embodiments, the controller 110 is communicatively coupled with the display generation component 120 (e.g., an HMD, a display, a projector, a touch-screen, etc.) via one or more wired or wireless communication channels 144 (e.g., BLUETOOTH, IEEE 802.11x, IEEE 802.16x, IEEE 802.3x, etc.). In another example, the controller 110 is included within the enclosure (e.g., a physical housing) of the display generation component 120 (e.g., an HMD, or a portable electronic device that includes a display and one or more processors, etc.), one or more of the input devices 125, one or more of the output devices 155, one or more of the sensors 190, and/or one or more of the peripheral devices 195, or share the same physical enclosure or support structure with one or more of the above.

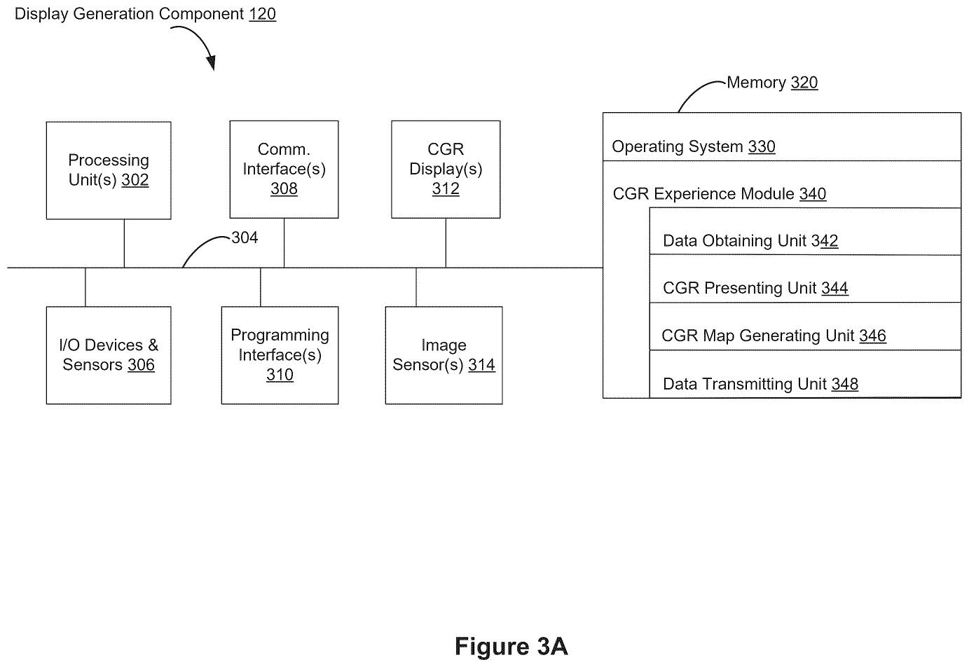

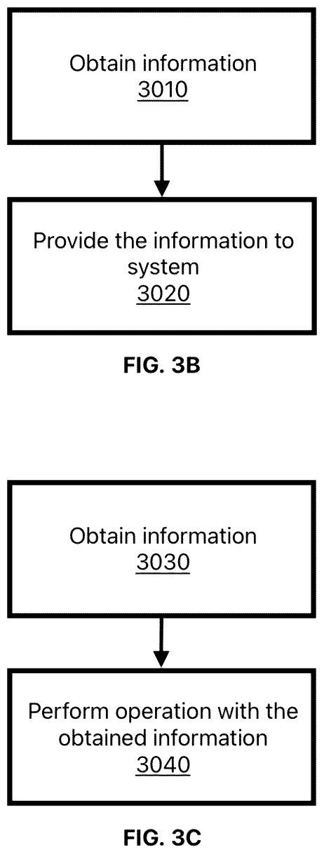

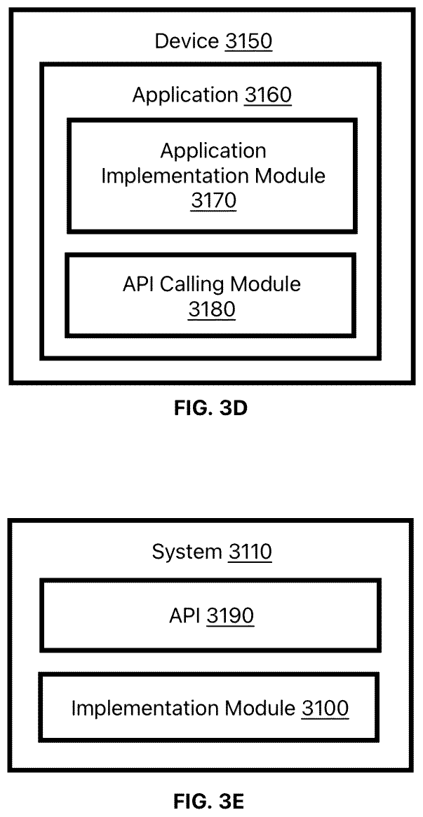

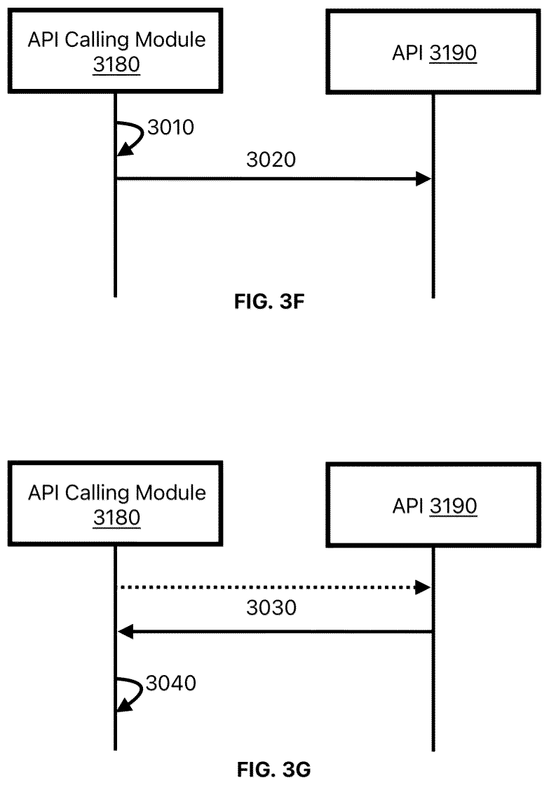

In some embodiments, the display generation component 120 is configured to provide the XR experience (e.g., at least a visual component of the XR experience) to the user. In some embodiments, the display generation component 120 includes a suitable combination of software, firmware, and/or hardware. The display generation component 120 is described in greater detail below with respect to FIG. 3A. In some embodiments, the functionalities of the controller 110 are provided by and/or combined with the display generation component 120.

According to some embodiments, the display generation component 120 provides an XR experience to the user while the user is virtually and/or physically present within the scene 105.

In some embodiments, the display generation component is worn on a part of the user's body (e.g., on his/her head, on his/her hand, etc.). As such, the display generation component 120 includes one or more XR displays provided to display the XR content. For example, in various embodiments, the display generation component 120 encloses the field-of-view of the user. In some embodiments, the display generation component 120 is a handheld device (such as a smartphone or tablet) configured to present XR content, and the user holds the device with a display directed towards the field-of-view of the user and a camera directed towards the scene 105. In some embodiments, the handheld device is optionally placed within an enclosure that is worn on the head of the user. In some embodiments, the handheld device is optionally placed on a support (e.g., a tripod) in front of the user. In some embodiments, the display generation component 120 is a XR chamber, enclosure, or room configured to present XR content in which the user does not wear or hold the display generation component 120. Many user interfaces described with reference to one type of hardware for displaying XR content (e.g., a handheld device or a device on a tripod) could be implemented on another type of hardware for displaying XR content (e.g., an HMD or other wearable computing device). For example, a user interface showing interactions with XR content triggered based on interactions that happen in a space in front of a handheld or tripod mounted device could similarly be implemented with an HMD where the interactions happen in a space in front of the HMD and the responses of the XR content are displayed via the HMD. Similarly, a user interface showing interactions with XR content triggered based on movement of a handheld or tripod mounted device relative to the physical environment (e.g., the scene 105 or a part of the user's body (e.g., the user's eye(s), head, or hand)) could similarly be implemented with an HMD where the movement is caused by movement of the HMD relative to the physical environment (e.g., the scene 105 or a part of the user's body (e.g., the user's eye(s), head, or hand)).

While pertinent features of the operating environment 100 are shown in FIG. 1A, those of ordinary skill in the art will appreciate from the present disclosure that various other features have not been illustrated for the sake of brevity and so as not to obscure more pertinent aspects of the example embodiments disclosed herein.

FIGS. 1A-1P illustrate various examples of a computer system that is used to perform the methods and provide audio, visual and/or haptic feedback as part of user interfaces described herein. In some embodiments, the computer system includes one or more display generation components (e.g., first and second display assemblies 1-120a, 1-120b and/or first and second optical modules 11.1.1-104a and 11.1.1-104b) for displaying virtual elements and/or a representation of a physical environment to a user of the computer system, optionally generated based on detected events and/or user inputs detected by the computer system. User interfaces generated by the computer system are optionally corrected by one or more corrective lenses 11.3.2-216 that are optionally removably attached to one or more of the optical modules to enable the user interfaces to be more easily viewed by users who would otherwise use glasses or contacts to correct their vision. While many user interfaces illustrated herein show a single view of a user interface, user interfaces in a HMD are optionally displayed using two optical modules (e.g., first and second display assemblies 1-120a, 1-120b and/or first and second optical modules 11.1.1-104a and 11.1.1-104b), one for a user's right eye and a different one for a user's left eye, and slightly different images are presented to the two different eyes to generate the illusion of stereoscopic depth, the single view of the user interface would typically be either a right-eye or left-eye view and the depth effect is explained in the text or using other schematic charts or views. In some embodiments, the computer system includes one or more external displays (e.g., display assembly 1-108) for displaying status information for the computer system to the user of the computer system (when the computer system is not being worn) and/or to other people who are near the computer system, optionally generated based on detected events and/or user inputs detected by the computer system. In some embodiments, the computer system includes one or more audio output components (e.g., electronic component 1-112) for generating audio feedback, optionally generated based on detected events and/or user inputs detected by the computer system. In some embodiments, the computer system includes one or more input devices for detecting input such as one or more sensors (e.g., one or more sensors in sensor assembly 1-356, and/or FIG. 1I) for detecting information about a physical environment of the device which can be used (optionally in conjunction with one or more illuminators such as the illuminators described in FIG. 1I) to generate a digital passthrough image, capture visual media corresponding to the physical environment (e.g., photos and/or video), or determine a pose (e.g., position and/or orientation) of physical objects and/or surfaces in the physical environment so that virtual objects ban be placed based on a detected pose of physical objects and/or surfaces. In some embodiments, the computer system includes one or more input devices for detecting input such as one or more sensors for detecting hand position and/or movement (e.g., one or more sensors in sensor assembly 1-356, and/or FIG. 1I) that can be used (optionally in conjunction with one or more illuminators such as the illuminators 6-124 described in FIG. 1I) to determine when one or more air gestures have been performed. In some embodiments, the computer system includes one or more input devices for detecting input such as one or more sensors for detecting eye movement (e.g., eye tracking and gaze tracking sensors in FIG. 1I) which can be used (optionally in conjunction with one or more lights such as lights 11.3.2-110 in FIG. 10) to determine attention or gaze position and/or gaze movement which can optionally be used to detect gaze-only inputs based on gaze movement and/or dwell. A combination of the various sensors described above can be used to determine user facial expressions and/or hand movements for use in generating an avatar or representation of the user such as an anthropomorphic avatar or representation for use in a real-time communication session where the avatar has facial expressions, hand movements, and/or body movements that are based on or similar to detected facial expressions, hand movements, and/or body movements of a user of the device. Gaze and/or attention information is, optionally, combined with hand tracking information to determine interactions between the user and one or more user interfaces based on direct and/or indirect inputs such as air gestures or inputs that use one or more hardware input devices such as one or more buttons (e.g., first button 1-128, button 11.1.1-114, second button 1-132, and or dial or button 1-328), knobs (e.g., first button 1-128, button 11.1.1-114, and/or dial or button 1-328), digital crowns (e.g., first button 1-128 which is depressible and twistable or rotatable, button 11.1.1-114, and/or dial or button 1-328), trackpads, touch screens, keyboards, mice and/or other input devices. One or more buttons (e.g., first button 1-128, button 11.1.1-114, second button 1-132, and or dial or button 1-328) are optionally used to perform system operations such as recentering content in three-dimensional environment that is visible to a user of the device, displaying a home user interface for launching applications, starting real-time communication sessions, or initiating display of virtual three-dimensional backgrounds. Knobs or digital crowns (e.g., first button 1-128 which is depressible and twistable or rotatable, button 11.1.1-114, and/or dial or button 1-328) are optionally rotatable to adjust parameters of the visual content such as a level of immersion of a virtual three-dimensional environment (e.g., a degree to which virtual-content occupies the viewport of the user into the three-dimensional environment) or other parameters associated with the three-dimensional environment and the virtual content that is displayed via the optical modules (e.g., first and second display assemblies 1-120a, 1-120b and/or first and second optical modules 11.1.1-104a and 11.1.1-104b).

FIG. 1B illustrates a front, top, perspective view of an example of a head-mountable display (HMD) device 1-100 configured to be donned by a user and provide virtual and altered/mixed reality (VR/AR) experiences. The HMD 1-100 can include a display unit 1-102 or assembly, an electronic strap assembly 1-104 connected to and extending from the display unit 1-102, and a band assembly 1-106 secured at either end to the electronic strap assembly 1-104. The electronic strap assembly 1-104 and the band 1-106 can be part of a retention assembly configured to wrap around a user's head to hold the display unit 1-102 against the face of the user.

In at least one example, the band assembly 1-106 can include a first band 1-116 configured to wrap around the rear side of a user's head and a second band 1-117 configured to extend over the top of a user's head. The second strap can extend between first and second electronic straps 1-105a, 1-105b of the electronic strap assembly 1-104 as shown. The strap assembly 1-104 and the band assembly 1-106 can be part of a securement mechanism extending rearward from the display unit 1-102 and configured to hold the display unit 1-102 against a face of a user.

In at least one example, the securement mechanism includes a first electronic strap 1-105a including a first proximal end 1-134 coupled to the display unit 1-102, for example a housing 1-150 of the display unit 1-102, and a first distal end 1-136 opposite the first proximal end 1-134. The securement mechanism can also include a second electronic strap 1-105b including a second proximal end 1-138 coupled to the housing 1-150 of the display unit 1-102 and a second distal end 1-140 opposite the second proximal end 1-138. The securement mechanism can also include the first band 1-116 including a first end 1-142 coupled to the first distal end 1-136 and a second end 1-144 coupled to the second distal end 1-140 and the second band 1-117 extending between the first electronic strap 1-105a and the second electronic strap 1-105b. The straps 1-105a-b and band 1-116 can be coupled via connection mechanisms or assemblies 1-114. In at least one example, the second band 1-117 includes a first end 1-146 coupled to the first electronic strap 1-105a between the first proximal end 1-134 and the first distal end 1-136 and a second end 1-148 coupled to the second electronic strap 1-105b between the second proximal end 1-138 and the second distal end 1-140.

In at least one example, the first and second electronic straps 1-105a-b include plastic, metal, or other structural materials forming the shape the substantially rigid straps 1-105a-b. In at least one example, the first and second bands 1-116, 1-117 are formed of elastic, flexible materials including woven textiles, rubbers, and the like. The first and second bands 1-116, 1-117 can be flexible to conform to the shape of the user' head when donning the HMD 1-100.

In at least one example, one or more of the first and second electronic straps 1-105a-b can define internal strap volumes and include one or more electronic components disposed in the internal strap volumes. In one example, as shown in FIG. 1B, the first electronic strap 1-105a can include an electronic component 1-112. In one example, the electronic component 1-112 can include a speaker. In one example, the electronic component 1-112 can include a computing component such as a processor.

In at least one example, the housing 1-150 defines a first, front-facing opening 1-152. The front-facing opening is labeled in dotted lines at 1-152 in FIG. 1B because the display assembly 1-108 is disposed to occlude the first opening 1-152 from view when the HMD 1-100 is assembled. The housing 1-150 can also define a rear-facing second opening 1-154. The housing 1-150 also defines an internal volume between the first and second openings 1-152, 1-154. In at least one example, the HMD 1-100 includes the display assembly 1-108, which can include a front cover and display screen (shown in other figures) disposed in or across the front opening 1-152 to occlude the front opening 1-152. In at least one example, the display screen of the display assembly 1-108, as well as the display assembly 1-108 in general, has a curvature configured to follow the curvature of a user's face. The display screen of the display assembly 1-108 can be curved as shown to compliment the user's facial features and general curvature from one side of the face to the other, for example from left to right and/or from top to bottom where the display unit 1-102 is pressed.

In at least one example, the housing 1-150 can define a first aperture 1-126 between the first and second openings 1-152, 1-154 and a second aperture 1-130 between the first and second openings 1-152, 1-154. The HMD 1-100 can also include a first button 1-128 disposed in the first aperture 1-126 and a second button 1-132 disposed in the second aperture 1-130. The first and second buttons 1-128, 1-132 can be depressible through the respective apertures 1-126, 1-130. In at least one example, the first button 1-126 and/or second button 1-132 can be twistable dials as well as depressible buttons. In at least one example, the first button 1-128 is a depressible and twistable dial button and the second button 1-132 is a depressible button.

FIG. 1C illustrates a rear, perspective view of the HMD 1-100. The HMD 1-100 can include a light seal 1-110 extending rearward from the housing 1-150 of the display assembly 1-108 around a perimeter of the housing 1-150 as shown. The light seal 1-110 can be configured to extend from the housing 1-150 to the user's face around the user's eyes to block external light from being visible. In one example, the HMD 1-100 can include first and second display assemblies 1-120a, 1-120b disposed at or in the rearward facing second opening 1-154 defined by the housing 1-150 and/or disposed in the internal volume of the housing 1-150 and configured to project light through the second opening 1-154. In at least one example, each display assembly 1-120a-b can include respective display screens 1-122a, 1-122b configured to project light in a rearward direction through the second opening 1-154 toward the user's eyes.

In at least one example, referring to both FIGS. 1B and 1C, the display assembly 1-108 can be a front-facing, forward display assembly including a display screen configured to project light in a first, forward direction and the rear facing display screens 1-122a-b can be configured to project light in a second, rearward direction opposite the first direction. As noted above, the light seal 1-110 can be configured to block light external to the HMD 1-100 from reaching the user's eyes, including light projected by the forward facing display screen of the display assembly 1-108 shown in the front perspective view of FIG. 1B. In at least one example, the HMD 1-100 can also include a curtain 1-124 occluding the second opening 1-154 between the housing 1-150 and the rear-facing display assemblies 1-120a-b. In at least one example, the curtain 1-124 can be clastic or at least partially elastic.

Any of the features, components, and/or parts, including the arrangements and configurations thereof shown in FIGS. 1B and 1C can be included, either alone or in any combination, in any of the other examples of devices, features, components, and parts shown in FIGS. 1D-IF and described herein. Likewise, any of the features, components, and/or parts, including the arrangements and configurations thereof shown and described with reference to FIGS. 1D-IF can be included, either alone or in any combination, in the example of the devices, features, components, and parts shown in FIGS. 1B and 1C.

FIG. 1D illustrates an exploded view of an example of an HMD 1-200 including various portions or parts thereof separated according to the modularity and selective coupling of those parts. For example, the HMD 1-200 can include a band 1-216 which can be selectively coupled to first and second electronic straps 1-205a, 1-205b. The first securement strap 1-205a can include a first electronic component 1-212a and the second securement strap 1-205b can include a second electronic component 1-212b. In at least one example, the first and second straps 1-205a-b can be removably coupled to the display unit 1-202.

In addition, the HMD 1-200 can include a light seal 1-210 configured to be removably coupled to the display unit 1-202. The HMD 1-200 can also include lenses 1-218 which can be removably coupled to the display unit 1-202, for example over first and second display assemblies including display screens. The lenses 1-218 can include customized prescription lenses configured for corrective vision. As noted, each part shown in the exploded view of FIG. 1D and described above can be removably coupled, attached, re-attached, and changed out to update parts or swap out parts for different users. For example, bands such as the band 1-216, light seals such as the light seal 1-210, lenses such as the lenses 1-218, and electronic straps such as the straps 1-205a-b can be swapped out depending on the user such that these parts are customized to fit and correspond to the individual user of the HMD 1-200.

Any of the features, components, and/or parts, including the arrangements and configurations thereof shown in FIG. 1D can be included, either alone or in any combination, in any of the other examples of devices, features, components, and parts shown in FIGS. 1B, 1C, and 1E-1F and described herein. Likewise, any of the features, components, and/or parts, including the arrangements and configurations thereof shown and described with reference to FIGS. 1B, 1C, and 1E-1F can be included, either alone or in any combination, in the example of the devices, features, components, and parts shown in FIG. 1D.

FIG. 1E illustrates an exploded view of an example of a display unit 1-306 of a HMD. The display unit 1-306 can include a front display assembly 1-308, a frame/housing assembly 1-350, and a curtain assembly 1-324. The display unit 1-306 can also include a sensor assembly 1-356, logic board assembly 1-358, and cooling assembly 1-360 disposed between the frame assembly 1-350 and the front display assembly 1-308. In at least one example, the display unit 1-306 can also include a rear-facing display assembly 1-320 including first and second rear-facing display screens 1-322a, 1-322b disposed between the frame 1-350 and the curtain assembly 1-324.

In at least one example, the display unit 1-306 can also include a motor assembly 1-362 configured as an adjustment mechanism for adjusting the positions of the display screens 1-322a-b of the display assembly 1-320 relative to the frame 1-350. In at least one example, the display assembly 1-320 is mechanically coupled to the motor assembly 1-362, with at least one motor for each display screen 1-322a-b, such that the motors can translate the display screens 1-322a-b to match an interpupillary distance of the user's eyes.

In at least one example, the display unit 1-306 can include a dial or button 1-328 depressible relative to the frame 1-350 and accessible to the user outside the frame 1-350. The button 1-328 can be electronically connected to the motor assembly 1-362 via a controller such that the button 1-328 can be manipulated by the user to cause the motors of the motor assembly 1-362 to adjust the positions of the display screens 1-322a-b.

Any of the features, components, and/or parts, including the arrangements and configurations thereof shown in FIG. 1E can be included, either alone or in any combination, in any of the other examples of devices, features, components, and parts shown in FIGS. 1B-1D and 1F and described herein. Likewise, any of the features, components, and/or parts, including the arrangements and configurations thereof shown and described with reference to FIGS. 1B-1D and 1F can be included, either alone or in any combination, in the example of the devices, features, components, and parts shown in FIG. 1E.

FIG. 1F illustrates an exploded view of another example of a display unit 1-406 of an HMD device similar to other HMD devices described herein. The display unit 1-406 can include a front display assembly 1-402, a sensor assembly 1-456, a logic board assembly 1-458, a cooling assembly 1-460, a frame assembly 1-450, a rear-facing display assembly 1-421, and a curtain assembly 1-424. The display unit 1-406 can also include a motor assembly 1-462 for adjusting the positions of first and second display sub-assemblies 1-420a, 1-420b of the rear-facing display assembly 1-421, including first and second respective display screens for interpupillary adjustments, as described above.

The various parts, systems, and assemblies shown in the exploded view of FIG. 1F are described in greater detail herein with reference to FIGS. 1B-1E as well as subsequent figures referenced in the present disclosure. The display unit 1-406 shown in FIG. 1F can be assembled and integrated with the securement mechanisms shown in FIGS. 1B-1E, including the electronic straps, bands, and other components including light seals, connection assemblies, and so forth.

Any of the features, components, and/or parts, including the arrangements and configurations thereof shown in FIG. 1F can be included, cither alone or in any combination, in any of the other examples of devices, features, components, and parts shown in FIGS. 1B-1E and described herein. Likewise, any of the features, components, and/or parts, including the arrangements and configurations thereof shown and described with reference to FIGS. 1B-1E can be included, either alone or in any combination, in the example of the devices, features, components, and parts shown in FIG. 1F.

FIG. 1G illustrates a perspective, exploded view of a front cover assembly 3-100 of an HMD device described herein, for example the front cover assembly 3-1 of the HMD 3-100 shown in FIG. 1G or any other HMD device shown and described herein. The front cover assembly 3-100 shown in FIG. 1G can include a transparent or semi-transparent cover 3-102, shroud 3-104 (or “canopy”), adhesive layers 3-106, display assembly 3-108 including a lenticular lens panel or array 3-110, and a structural trim 3-112. The adhesive layer 3-106 can secure the shroud 3-104 and/or transparent cover 3-102 to the display assembly 3-108 and/or the trim 3-112. The trim 3-112 can secure the various components of the front cover assembly 3-100 to a frame or chassis of the HMD device.

In at least one example, as shown in FIG. 1G, the transparent cover 3-102, shroud 3-104, and display assembly 3-108, including the lenticular lens array 3-110, can be curved to accommodate the curvature of a user's face. The transparent cover 3-102 and the shroud 3-104 can be curved in two or three dimensions, e.g., vertically curved in the Z-direction in and out of the Z-X plane and horizontally curved in the X-direction in and out of the Z-X plane. In at least one example, the display assembly 3-108 can include the lenticular lens array 3-110 as well as a display panel having pixels configured to project light through the shroud 3-104 and the transparent cover 3-102. The display assembly 3-108 can be curved in at least one direction, for example the horizontal direction, to accommodate the curvature of a user's face from one side (e.g., left side) of the face to the other (e.g., right side). In at least one example, each layer or component of the display assembly 3-108, which will be shown in subsequent figures and described in more detail, but which can include the lenticular lens array 3-110 and a display layer, can be similarly or concentrically curved in the horizontal direction to accommodate the curvature of the user's face.

In at least one example, the shroud 3-104 can include a transparent or semi-transparent material through which the display assembly 3-108 projects light. In one example, the shroud 3-104 can include one or more opaque portions, for example opaque ink-printed portions or other opaque film portions on the rear surface of the shroud 3-104. The rear surface can be the surface of the shroud 3-104 facing the user's eyes when the HMD device is donned. In at least one example, opaque portions can be on the front surface of the shroud 3-104 opposite the rear surface. In at least one example, the opaque portion or portions of the shroud 3-104 can include perimeter portions visually hiding any components around an outside perimeter of the display screen of the display assembly 3-108. In this way, the opaque portions of the shroud hide any other components, including electronic components, structural components, and so forth, of the HMD device that would otherwise be visible through the transparent or semi-transparent cover 3-102 and/or shroud 3-104.

In at least one example, the shroud 3-104 can define one or more apertures transparent portions 3-120 through which sensors can send and receive signals. In one example, the portions 3-120 are apertures through which the sensors can extend or send and receive signals. In one example, the portions 3-120 are transparent portions, or portions more transparent than surrounding semi-transparent or opaque portions of the shroud, through which sensors can send and receive signals through the shroud and through the transparent cover 3-102. In one example, the sensors can include cameras, infrared (IR) sensors, LUX sensors, or any other visual or non-visual environmental sensors of the HMD device.

Any of the features, components, and/or parts, including the arrangements and configurations thereof shown in FIG. 1G can be included, cither alone or in any combination, in any of the other examples of devices, features, components, and parts described herein. Likewise, any of the features, components, and/or parts, including the arrangements and configurations thereof shown and described herein can be included, either alone or in any combination, in the example of the devices, features, components, and parts shown in FIG. 1G.

FIG. 1H illustrates an exploded view of an example of an HMD device 6-100.

The HMD device 6-100 can include a sensor array or system 6-102 including one or more sensors, cameras, projectors, and so forth mounted to one or more components of the HMD 6-100. In at least one example, the sensor system 6-102 can include a bracket 1-338 on which one or more sensors of the sensor system 6-102 can be fixed/secured.

FIG. 1I illustrates a portion of an HMD device 6-100 including a front transparent cover 6-104 and a sensor system 6-102. The sensor system 6-102 can include a number of different sensors, emitters, receivers, including cameras, IR sensors, projectors, and so forth. The transparent cover 6-104 is illustrated in front of the sensor system 6-102 to illustrate relative positions of the various sensors and emitters as well as the orientation of each sensor/emitter of the system 6-102. As referenced herein, “sideways,” “side,” “lateral,” “horizontal,” and other similar terms refer to orientations or directions as indicated by the X-axis shown in FIG. 1J. Terms such as “vertical,” “up,” “down,” and similar terms refer to orientations or directions as indicated by the Z-axis shown in FIG. 1J. Terms such as “frontward,” “rearward,” “forward,” backward,” and similar terms refer to orientations or directions as indicated by the Y-axis shown in FIG. 1J.

In at least one example, the transparent cover 6-104 can define a front, external surface of the HMD device 6-100 and the sensor system 6-102, including the various sensors and components thereof, can be disposed behind the cover 6-104 in the Y-axis/direction. The cover 6-104 can be transparent or semi-transparent to allow light to pass through the cover 6-104, both light detected by the sensor system 6-102 and light emitted thereby.

As noted elsewhere herein, the HMD device 6-100 can include one or more controllers including processors for electrically coupling the various sensors and emitters of the sensor system 6-102 with one or more mother boards, processing units, and other electronic devices such as display screens and the like. In addition, as will be shown in more detail below with reference to other figures, the various sensors, emitters, and other components of the sensor system 6-102 can be coupled to various structural frame members, brackets, and so forth of the HMD device 6-100 not shown in FIG. 1I. FIG. 1I shows the components of the sensor system 6-102 unattached and un-coupled electrically from other components for the sake of illustrative clarity.

In at least one example, the device can include one or more controllers having processors configured to execute instructions stored on memory components electrically coupled to the processors. The instructions can include, or cause the processor to execute, one or more algorithms for self-correcting angles and positions of the various cameras described herein overtime with use as the initial positions, angles, or orientations of the cameras get bumped or deformed due to unintended drop events or other events.

In at least one example, the sensor system 6-102 can include one or more scene cameras 6-106. The system 6-102 can include two scene cameras 6-102 disposed on either side of the nasal bridge or arch of the HMD device 6-100 such that each of the two cameras 6-106 correspond generally in position with left and right eyes of the user behind the cover 6-103. In at least one example, the scene cameras 6-106 are oriented generally forward in the Y-direction to capture images in front of the user during use of the HMD 6-100. In at least one example, the scene cameras are color cameras and provide images and content for MR video pass through to the display screens facing the user's eyes when using the HMD device 6-100. The scene cameras 6-106 can also be used for environment and object reconstruction.

In at least one example, the sensor system 6-102 can include a first depth sensor 6-108 pointed generally forward in the Y-direction. In at least one example, the first depth sensor 6-108 can be used for environment and object reconstruction as well as user hand and body tracking. In at least one example, the sensor system 6-102 can include a second depth sensor 6-110 disposed centrally along the width (e.g., along the X-axis) of the HMD device 6-100. For example, the second depth sensor 6-110 can be disposed above the central nasal bridge or accommodating features over the nose of the user when donning the HMD 6-100. In at least one example, the second depth sensor 6-110 can be used for environment and object reconstruction as well as hand and body tracking. In at least one example, the second depth sensor can include a light detection and ranging (LIDAR) sensor.

In at least one example, the sensor system 6-102 can include a depth projector 6-112 facing generally forward to project electromagnetic waves, for example in the form of a predetermined pattern of light dots, out into and within a field of view of the user and/or the scene cameras 6-106 or a field of view including and beyond the field of view of the user and/or scene cameras 6-106. In at least one example, the depth projector can project electromagnetic waves of light in the form of a dotted light pattern to be reflected off objects and back into the depth sensors noted above, including the depth sensors 6-108, 6-110. In at least one example, the depth projector 6-112 can be used for environment and object reconstruction as well as hand and body tracking.

In at least one example, the sensor system 6-102 can include downward facing cameras 6-114 with a field of view pointed generally downward relative to the HMD device 6-100 in the Z-axis. In at least one example, the downward cameras 6-114 can be disposed on left and right sides of the HMD device 6-100 as shown and used for hand and body tracking, headset tracking, and facial avatar detection and creation for display a user avatar on the forward facing display screen of the HMD device 6-100 described elsewhere herein. The downward cameras 6-114, for example, can be used to capture facial expressions and movements for the face of the user below the HMD device 6-100, including the checks, mouth, and chin.

In at least one example, the sensor system 6-102 can include jaw cameras 6-116. In at least one example, the jaw cameras 6-116 can be disposed on left and right sides of the HMD device 6-100 as shown and used for hand and body tracking, headset tracking, and facial avatar detection and creation for display a user avatar on the forward facing display screen of the HMD device 6-100 described elsewhere herein. The jaw cameras 6-116, for example, can be used to capture facial expressions and movements for the face of the user below the HMD device 6-100, including the user's jaw, cheeks, mouth, and chin. for hand and body tracking, headset tracking, and facial avatar

In at least one example, the sensor system 6-102 can include side cameras 6-118. The side cameras 6-118 can be oriented to capture side views left and right in the X-axis or direction relative to the HMD device 6-100. In at least one example, the side cameras 6-118 can be used for hand and body tracking, headset tracking, and facial avatar detection and re-creation.

In at least one example, the sensor system 6-102 can include a plurality of eye tracking and gaze tracking sensors for determining an identity, status, and gaze direction of a user's eyes during and/or before use. In at least one example, the eye/gaze tracking sensors can include nasal eye cameras 6-120 disposed on either side of the user's nose and adjacent the user's nose when donning the HMD device 6-100. The eye/gaze sensors can also include bottom eye cameras 6-122 disposed below respective user eyes for capturing images of the eyes for facial avatar detection and creation, gaze tracking, and iris identification functions.

In at least one example, the sensor system 6-102 can include infrared illuminators 6-124 pointed outward from the HMD device 6-100 to illuminate the external environment and any object therein with IR light for IR detection with one or more IR sensors of the sensor system 6-102. In at least one example, the sensor system 6-102 can include a flicker sensor 6-126 and an ambient light sensor 6-128. In at least one example, the flicker sensor 6-126 can detect overhead light refresh rates to avoid display flicker. In one example, the infrared illuminators 6-124 can include light emitting diodes and can be used especially for low light environments for illuminating user hands and other objects in low light for detection by infrared sensors of the sensor system 6-102.

In at least one example, multiple sensors, including the scene cameras 6-106, the downward cameras 6-114, the jaw cameras 6-116, the side cameras 6-118, the depth projector 6-112, and the depth sensors 6-108, 6-110 can be used in combination with an electrically coupled controller to combine depth data with camera data for hand tracking and for size determination for better hand tracking and object recognition and tracking functions of the HMD device 6-100. In at least one example, the downward cameras 6-114, jaw cameras 6-116, and side cameras 6-118 described above and shown in FIG. 1I can be wide angle cameras operable in the visible and infrared spectrums. In at least one example, these cameras 6-114, 6-116, 6-118 can operate only in black and white light detection to simplify image processing and gain sensitivity.

Any of the features, components, and/or parts, including the arrangements and configurations thereof shown in FIG. 1I can be included, either alone or in any combination, in any of the other examples of devices, features, components, and parts shown in FIGS. 1J-1L and described herein. Likewise, any of the features, components, and/or parts, including the arrangements and configurations thereof shown and described with reference to FIGS. 1J-1L can be included, either alone or in any combination, in the example of the devices, features, components, and parts shown in FIG. 1I.

FIG. 1J illustrates a lower perspective view of an example of an HMD 6-200 including a cover or shroud 6-204 secured to a frame 6-230. In at least one example, the sensors 6-203 of the sensor system 6-202 can be disposed around a perimeter of the HDM 6-200 such that the sensors 6-203 are outwardly disposed around a perimeter of a display region or area 6-232 so as not to obstruct a view of the displayed light. In at least one example, the sensors can be disposed behind the shroud 6-204 and aligned with transparent portions of the shroud allowing sensors and projectors to allow light back and forth through the shroud 6-204. In at least one example, opaque ink or other opaque material or films/layers can be disposed on the shroud 6-204 around the display area 6-232 to hide components of the HMD 6-200 outside the display area 6-232 other than the transparent portions defined by the opaque portions, through which the sensors and projectors send and receive light and electromagnetic signals during operation. In at least one example, the shroud 6-204 allows light to pass therethrough from the display (e.g., within the display region 6-232) but not radially outward from the display region around the perimeter of the display and shroud 6-204.

In some embodiments, the shroud 6-204 includes a transparent portion 6-205 and an opaque portion 6-207, as described above and elsewhere herein. In at least one example, the opaque portion 6-207 of the shroud 6-204 can define one or more transparent regions 6-209 through which the sensors 6-203 of the sensor system 6-202 can send and receive signals. In the illustrated example, the sensors 6-203 of the sensor system 6-202 sending and receiving signals through the shroud 6-204, or more specifically through the transparent regions 6-209 of the (or defined by) the opaque portion 6-207 of the shroud 6-204 can include the same or similar sensors as those shown in the example of FIG. 1I, for example depth sensors 6-108 and 6-110, depth projector 6-112, first and second scene cameras 6-106, first and second downward cameras 6-114, first and second side cameras 6-118, and first and second infrared illuminators 6-124. These sensors are also shown in the examples of FIGS. 1K and 1L. Other sensors, sensor types, number of sensors, and relative positions thereof can be included in one or more other examples of HMDs.

Any of the features, components, and/or parts, including the arrangements and configurations thereof shown in FIG. 1J can be included, either alone or in any combination, in any of the other examples of devices, features, components, and parts shown in FIGS. 1I and 1K-1L and described herein. Likewise, any of the features, components, and/or parts, including the arrangements and configurations thereof shown and described with reference to FIGS. 1I and 1K-1L can be included, cither alone or in any combination, in the example of the devices, features, components, and parts shown in FIG. 1J.

FIG. 1K illustrates a front view of a portion of an example of an HMD device 6-300 including a display 6-334, brackets 6-336, 6-338, and frame or housing 6-330. The example shown in FIG. 1K does not include a front cover or shroud in order to illustrate the brackets 6-336, 6-338. For example, the shroud 6-204 shown in FIG. 1J includes the opaque portion 6-207 that would visually cover/block a view of anything outside (e.g., radially/peripherally outside) the display/display region 6-334, including the sensors 6-303 and bracket 6-338.

In at least one example, the various sensors of the sensor system 6-302 are coupled to the brackets 6-336, 6-338. In at least one example, the scene cameras 6-306 include tight tolerances of angles relative to one another. For example, the tolerance of mounting angles between the two scene cameras 6-306 can be 0.5 degrees or less, for example 0.3 degrees or less. In order to achieve and maintain such a tight tolerance, in one example, the scene cameras 6-306 can be mounted to the bracket 6-338 and not the shroud. The bracket can include cantilevered arms on which the scene cameras 6-306 and other sensors of the sensor system 6-302 can be mounted to remain un-deformed in position and orientation in the case of a drop event by a user resulting in any deformation of the other bracket 6-226, housing 6-330, and/or shroud.

Any of the features, components, and/or parts, including the arrangements and configurations thereof shown in FIG. 1K can be included, either alone or in any combination, in any of the other examples of devices, features, components, and parts shown in FIGS. 1I-1J and 1L and described herein. Likewise, any of the features, components, and/or parts, including the arrangements and configurations thereof shown and described with reference to FIGS. 1I-1J and 1L can be included, either alone or in any combination, in the example of the devices, features, components, and parts shown in FIG. 1K.

FIG. 1L illustrates a bottom view of an example of an HMD 6-400 including a front display/cover assembly 6-404 and a sensor system 6-402. The sensor system 6-402 can be similar to other sensor systems described above and elsewhere herein, including in reference to FIGS. 1I-1K. In at least one example, the jaw cameras 6-416 can be facing downward to capture images of the user's lower facial features. In one example, the jaw cameras 6-416 can be coupled directly to the frame or housing 6-430 or one or more internal brackets directly coupled to the frame or housing 6-430 shown. The frame or housing 6-430 can include one or more apertures/openings 6-415 through which the jaw cameras 6-416 can send and receive signals.

Any of the features, components, and/or parts, including the arrangements and configurations thereof shown in FIG. 1L can be included, either alone or in any combination, in any of the other examples of devices, features, components, and parts shown in FIGS. 1I-1K and described herein. Likewise, any of the features, components, and/or parts, including the arrangements and configurations thereof shown and described with reference to FIGS. 1I-1K can be included, either alone or in any combination, in the example of the devices, features, components, and parts shown in FIG. 1L.

FIG. 1M illustrates a rear perspective view of an inter-pupillary distance (IPD) adjustment system 11.1.1-102 including first and second optical modules 11.1.1-104a-b slidably engaging/coupled to respective guide-rods 11.1.1-108a-b and motors 11.1.1-110a-b of left and right adjustment subsystems 11.1.1-106a-b. The IPD adjustment system 11.1.1-102 can be coupled to a bracket 11.1.1-112 and include a button 11.1.1-114 in electrical communication with the motors 11.1.1-110a-b. In at least one example, the button 11.1.1-114 can electrically communicate with the first and second motors 11.1.1-110a-b via a processor or other circuitry components to cause the first and second motors 11.1.1-110a-b to activate and cause the first and second optical modules 11.1.1-104a-b, respectively, to change position relative to one another.

In at least one example, the first and second optical modules 11.1.1-104a-b can include respective display screens configured to project light toward the user's eyes when donning the HMD 11.1.1-100. In at least one example, the user can manipulate (e.g., depress and/or rotate) the button 11.1.1-114 to activate a positional adjustment of the optical modules 11.1.1-104a-b to match the inter-pupillary distance of the user's eyes. The optical modules 11.1.1-104a-b can also include one or more cameras or other sensors/sensor systems for imaging and measuring the IPD of the user such that the optical modules 11.1.1-104a-b can be adjusted to match the IPD.

In one example, the user can manipulate the button 11.1.1-114 to cause an automatic positional adjustment of the first and second optical modules 11.1.1-104a-b. In one example, the user can manipulate the button 11.1.1-114 to cause a manual adjustment such that the optical modules 11.1.1-104a-b move further or closer away, for example when the user rotates the button 11.1.1-114 one way or the other, until the user visually matches her/his own IPD. In one example, the manual adjustment is electronically communicated via one or more circuits and power for the movements of the optical modules 11.1.1-104a-b via the motors 11.1.1-110a-b is provided by an electrical power source. In one example, the adjustment and movement of the optical modules 11.1.1-104a-b via a manipulation of the button 11.1.1-114 is mechanically actuated via the movement of the button 11.1.1-114.

Any of the features, components, and/or parts, including the arrangements and configurations thereof shown in FIG. 1M can be included, cither alone or in any combination, in any of the other examples of devices, features, components, and parts shown in any other figures shown and described herein. Likewise, any of the features, components, and/or parts, including the arrangements and configurations thereof shown and described with reference to any other figure shown and described herein, either alone or in any combination, in the example of the devices, features, components, and parts shown in FIG. 1M.

FIG. 1N illustrates a front perspective view of a portion of an HMD 11.1.2-100, including an outer structural frame 11.1.2-102 and an inner or intermediate structural frame 11.1.2-104 defining first and second apertures 11.1.2-106a, 11.1.2-106b. The apertures 11.1.2-106a-b are shown in dotted lines in FIG. 1N because a view of the apertures 11.1.2-106a-b can be blocked by one or more other components of the HMD 11.1.2-100 coupled to the inner frame 11.1.2-104 and/or the outer frame 11.1.2-102, as shown. In at least one example, the HMD 11.1.2-100 can include a first mounting bracket 11.1.2-108 coupled to the inner frame 11.1.2-104. In at least one example, the mounting bracket 11.1.2-108 is coupled to the inner frame 11.1.2-104 between the first and second apertures 11.1.2-106a-b.

The mounting bracket 11.1.2-108 can include a middle or central portion 11.1.2-109 coupled to the inner frame 11.1.2-104. In some embodiments, the middle or central portion 11.1.2-109 may not be the geometric middle or center of the bracket 11.1.2-108. Rather, the middle/central portion 11.1.2-109 can be disposed between first and second cantilevered extension arms extending away from the middle portion 11.1.2-109. In at least one example, the mounting bracket 108 includes a first cantilever arm 11.1.2-112 and a second cantilever arm 11.1.2-114 extending away from the middle portion 11.1.2-109 of the mount bracket 11.1.2-108 coupled to the inner frame 11.1.2-104.

As shown in FIG. 1N, the outer frame 11.1.2-102 can define a curved geometry on a lower side thereof to accommodate a user's nose when the user dons the HMD 11.1.2-100. The curved geometry can be referred to as a nose bridge 11.1.2-111 and be centrally located on a lower side of the HMD 11.1.2-100 as shown. In at least one example, the mounting bracket 11.1.2-108 can be connected to the inner frame 11.1.2-104 between the apertures 11.1.2-106a-b such that the cantilevered arms 11.1.2-112, 11.1.2-114 extend downward and laterally outward away from the middle portion 11.1.2-109 to compliment the nose bridge 11.1.2-111 geometry of the outer frame 11.1.2-102. In this way, the mounting bracket 11.1.2-108 is configured to accommodate the user's nose as noted above. The nose bridge 11.1.2-111 geometry accommodates the nose in that the nose bridge 11.1.2-111 provides a curvature that curves with, above, over, and around the user's nose for comfort and fit.

The first cantilever arm 11.1.2-112 can extend away from the middle portion 11.1.2-109 of the mounting bracket 11.1.2-108 in a first direction and the second cantilever arm 11.1.2-114 can extend away from the middle portion 11.1.2-109 of the mounting bracket 11.1.2-10 in a second direction opposite the first direction. The first and second cantilever arms 11.1.2-112, 11.1.2-114 are referred to as “cantilevered” or “cantilever” arms because each arm 11.1.2-112, 11.1.2-114, includes a distal free end 11.1.2-116, 11.1.2-118, respectively, which are free of affixation from the inner and outer frames 11.1.2-102, 11.1.2-104. In this way, the arms 11.1.2-112, 11.1.2-114 are cantilevered from the middle portion 11.1.2-109, which can be connected to the inner frame 11.1.2-104, with distal ends 11.1.2-102, 11.1.2-104 unattached.

In at least one example, the HMD 11.1.2-100 can include one or more components coupled to the mounting bracket 11.1.2-108. In one example, the components include a plurality of sensors 11.1.2-110a-f. Each sensor of the plurality of sensors 11.1.2-110a-f can include various types of sensors, including cameras, IR sensors, and so forth. In some embodiments, one or more of the sensors 11.1.2-110a-f can be used for object recognition in three-dimensional space such that it is important to maintain a precise relative position of two or more of the plurality of sensors 11.1.2-110a-f. The cantilevered nature of the mounting bracket 11.1.2-108 can protect the sensors 11.1.2-110a-f from damage and altered positioning in the case of accidental drops by the user. Because the sensors 11.1.2-110a-f are cantilevered on the arms 11.1.2-112, 11.1.2-114 of the mounting bracket 11.1.2-108, stresses and deformations of the inner and/or outer frames 11.1.2-104, 11.1.2-102 are not transferred to the cantilevered arms 11.1.2-112, 11.1.2-114 and thus do not affect the relative positioning of the sensors 11.1.2-110a-f coupled/mounted to the mounting bracket 11.1.2-108.

Any of the features, components, and/or parts, including the arrangements and configurations thereof shown in FIG. 1N can be included, either alone or in any combination, in any of the other examples of devices, features, components, and described herein. Likewise, any of the features, components, and/or parts, including the arrangements and configurations thereof shown and described herein can be included, cither alone or in any combination, in the example of the devices, features, components, and parts shown in FIG. 1N.

FIG. 10 illustrates an example of an optical module 11.3.2-100 for use in an electronic device such as an HMD, including HDM devices described herein. As shown in one or more other examples described herein, the optical module 11.3.2-100 can be one of two optical modules within an HMD, with each optical module aligned to project light toward a user's eye. In this way, a first optical module can project light via a display screen toward a user's first eye and a second optical module of the same device can project light via another display screen toward the user's second eye.

In at least one example, the optical module 11.3.2-100 can include an optical frame or housing 11.3.2-102, which can also be referred to as a barrel or optical module barrel. The optical module 11.3.2-100 can also include a display 11.3.2-104, including a display screen or multiple display screens, coupled to the housing 11.3.2-102. The display 11.3.2-104 can be coupled to the housing 11.3.2-102 such that the display 11.3.2-104 is configured to project light toward the eye of a user when the HMD of which the display module 11.3.2-100 is a part is donned during use. In at least one example, the housing 11.3.2-102 can surround the display 11.3.2-104 and provide connection features for coupling other components of optical modules described herein.

In one example, the optical module 11.3.2-100 can include one or more cameras 11.3.2-106 coupled to the housing 11.3.2-102. The camera 11.3.2-106 can be positioned relative to the display 11.3.2-104 and housing 11.3.2-102 such that the camera 11.3.2-106 is configured to capture one or more images of the user's eye during use. In at least one example, the optical module 11.3.2-100 can also include a light strip 11.3.2-108 surrounding the display 11.3.2-104. In one example, the light strip 11.3.2-108 is disposed between the display 11.3.2-104 and the camera 11.3.2-106. The light strip 11.3.2-108 can include a plurality of lights 11.3.2-110. The plurality of lights can include one or more light emitting diodes (LEDs) or other lights configured to project light toward the user's eye when the HMD is donned. The individual lights 11.3.2-110 of the light strip 11.3.2-108 can be spaced about the strip 11.3.2-108 and thus spaced about the display 11.3.2-104 uniformly or non-uniformly at various locations on the strip 11.3.2-108 and around the display 11.3.2-104.

In at least one example, the housing 11.3.2-102 defines a viewing opening 11.3.2-101 through which the user can view the display 11.3.2-104 when the HMD device is donned. In at least one example, the LEDs are configured and arranged to emit light through the viewing opening 11.3.2-101 and onto the user's eye. In one example, the camera 11.3.2-106 is configured to capture one or more images of the user's eye through the viewing opening 11.3.2-101.

As noted above, each of the components and features of the optical module 11.3.2-100 shown in FIG. 10 can be replicated in another (e.g., second) optical module disposed with the HMD to interact (e.g., project light and capture images) of another eye of the user.

Any of the features, components, and/or parts, including the arrangements and configurations thereof shown in FIG. 10 can be included, either alone or in any combination, in any of the other examples of devices, features, components, and parts shown in FIG. 1P or otherwise described herein. Likewise, any of the features, components, and/or parts, including the arrangements and configurations thereof shown and described with reference to FIG. 1P or otherwise described herein can be included, either alone or in any combination, in the example of the devices, features, components, and parts shown in FIG. 10.

FIG. 1P illustrates a cross-sectional view of an example of an optical module 11.3.2-200 including a housing 11.3.2-202, display assembly 11.3.2-204 coupled to the housing 11.3.2-202, and a lens 11.3.2-216 coupled to the housing 11.3.2-202. In at least one example, the housing 11.3.2-202 defines a first aperture or channel 11.3.2-212 and a second aperture or channel 11.3.2-214. The channels 11.3.2-212, 11.3.2-214 can be configured to slidably engage respective rails or guide rods of an HMD device to allow the optical module 11.3.2-200 to adjust in position relative to the user's eyes for match the user's interpapillary distance (IPD). The housing 11.3.2-202 can slidably engage the guide rods to secure the optical module 11.3.2-200 in place within the HMD.

In at least one example, the optical module 11.3.2-200 can also include a lens 11.3.2-216 coupled to the housing 11.3.2-202 and disposed between the display assembly 11.3.2-204 and the user's eyes when the HMD is donned. The lens 11.3.2-216 can be configured to direct light from the display assembly 11.3.2-204 to the user's eye. In at least one example, the lens 11.3.2-216 can be a part of a lens assembly including a corrective lens removably attached to the optical module 11.3.2-200. In at least one example, the lens 11.3.2-216 is disposed over the light strip 11.3.2-208 and the one or more eye-tracking cameras 11.3.2-206 such that the camera 11.3.2-206 is configured to capture images of the user's eye through the lens 11.3.2-216 and the light strip 11.3.2-208 includes lights configured to project light through the lens 11.3.2-216 to the users' eye during use.

Any of the features, components, and/or parts, including the arrangements and configurations thereof shown in FIG. 1P can be included, either alone or in any combination, in any of the other examples of devices, features, components, and parts and described herein. Likewise, any of the features, components, and/or parts, including the arrangements and configurations thereof shown and described herein can be included, either alone or in any combination, in the example of the devices, features, components, and parts shown in FIG. 1P.

FIG. 2 is a block diagram of an example of the controller 110 in accordance with some embodiments. While certain specific features are illustrated, those skilled in the art will appreciate from the present disclosure that various other features have not been illustrated for the sake of brevity, and so as not to obscure more pertinent aspects of the embodiments disclosed herein. To that end, as a non-limiting example, in some embodiments, the controller 110 includes one or more processing units or processors 202 (e.g., microprocessors, application-specific integrated-circuits (ASICs), field-programmable gate arrays (FPGAs), graphics processing units (GPUs), central processing units (CPUs), processing cores, and/or the like), one or more input/output (I/O) devices 206, one or more communication interfaces 208 (e.g., universal serial bus (USB), FIREWIRE, THUNDERBOLT, IEEE 802.3x, IEEE 802.11x, IEEE 802.16x, global system for mobile communications (GSM), code division multiple access (CDMA), time division multiple access (TDMA), global positioning system (GPS), infrared (IR), BLUETOOTH, ZIGBEE, and/or the like type interface), one or more programming (e.g., I/O) interfaces 210, a memory 220, and one or more communication buses 204 for interconnecting these and various other components.

In some embodiments, the one or more communication buses 204 include circuitry that interconnects and controls communications between system components. In some embodiments, the one or more I/O devices 206 include at least one of a keyboard, a mouse, a touchpad, a joystick, one or more microphones, one or more speakers, one or more image sensors, one or more displays, and/or the like.

The memory 220 includes high-speed random-access memory, such as dynamic random-access memory (DRAM), static random-access memory (SRAM), double-data-rate random-access memory (DDR RAM), or other random-access solid-state memory devices. In some embodiments, the memory 220 includes non-volatile memory, such as one or more magnetic disk storage devices, optical disk storage devices, flash memory devices, or other non-volatile solid-state storage devices. The memory 220 optionally includes one or more storage devices remotely located from the one or more processing units 202. The memory 220 comprises a non-transitory computer readable storage medium. In some embodiments, the memory 220 or the non-transitory computer readable storage medium of the memory 220 stores the following programs, modules and data structures, or a subset thereof including an optional operating system 230 and a XR experience module 240.

The operating system 230 includes instructions for handling various basic system services and for performing hardware dependent tasks. In some embodiments, the XR experience module 240 is configured to manage and coordinate one or more XR experiences for one or more users (e.g., a single XR experience for one or more users, or multiple XR experiences for respective groups of one or more users). To that end, in various embodiments, the XR experience module 240 includes a data obtaining unit 241, a tracking unit 242, a coordination unit 246, and a data transmitting unit 248.

In some embodiments, the data obtaining unit 241 is configured to obtain data (e.g., presentation data, interaction data, sensor data, location data, etc.) from at least the display generation component 120 of FIG. 1A, and optionally one or more of the input devices 125, output devices 155, sensors 190, and/or peripheral devices 195. To that end, in various embodiments, the data obtaining unit 241 includes instructions and/or logic therefor, and heuristics and metadata therefor.

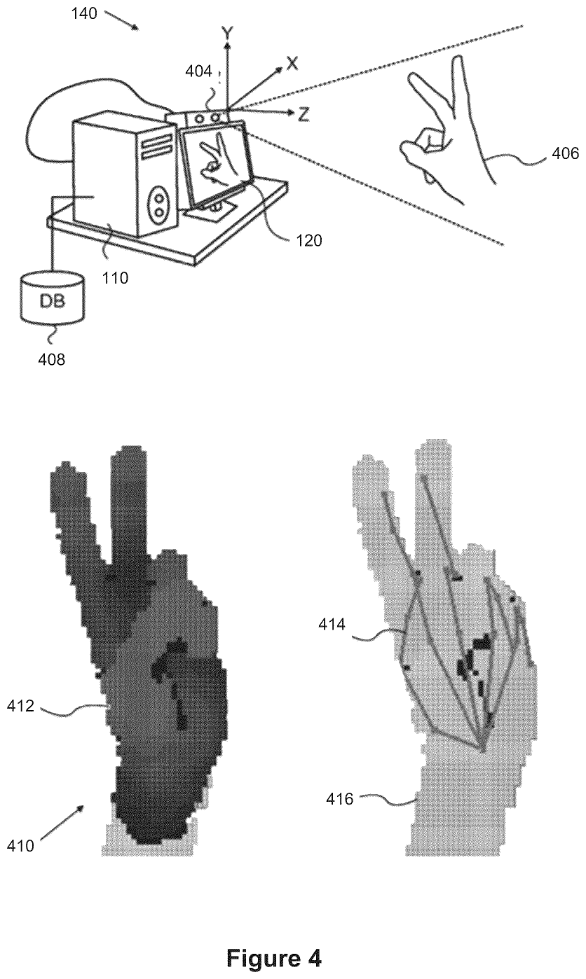

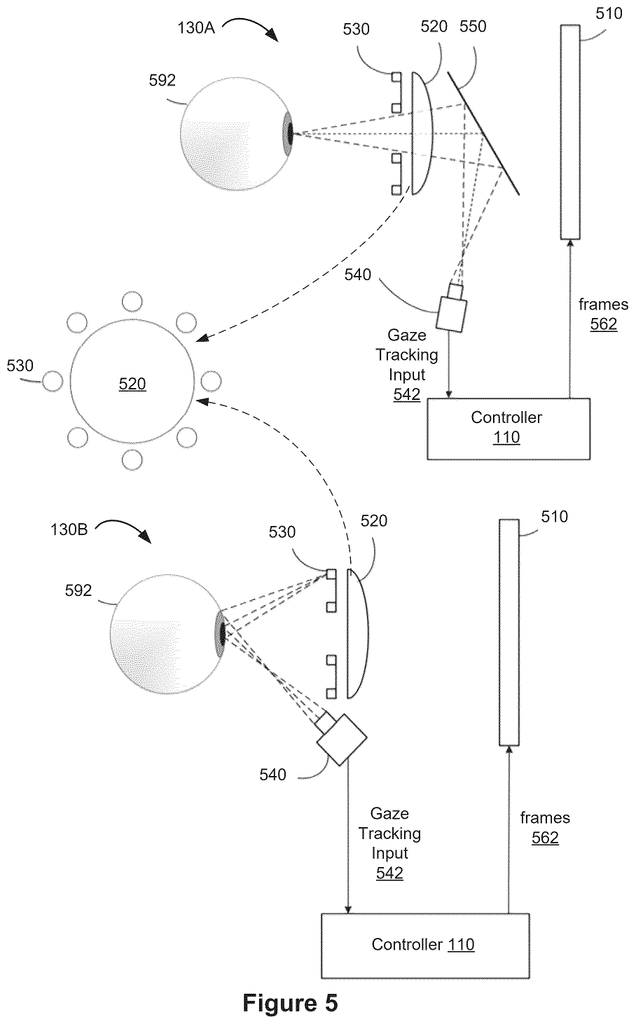

In some embodiments, the tracking unit 242 is configured to map the scene 105 and to track the position/location of at least the display generation component 120 with respect to the scene 105 of FIG. 1A, and optionally, to one or more of the input devices 125, output devices 155, sensors 190, and/or peripheral devices 195. To that end, in various embodiments, the tracking unit 242 includes instructions and/or logic therefor, and heuristics and metadata therefor. In some embodiments, the tracking unit 242 includes hand tracking unit 244 and/or eye tracking unit 243. In some embodiments, the hand tracking unit 244 is configured to track the position/location of one or more portions of the user's hands, and/or motions of one or more portions of the user's hands with respect to the scene 105 of FIG. 1A, relative to the display generation component 120, and/or relative to a coordinate system defined relative to the user's hand. The hand tracking unit 244 is described in greater detail below with respect to FIG. 4. In some embodiments, the eye tracking unit 243 is configured to track the position and movement of the user's gaze (or more broadly, the user's eyes, face, or head) with respect to the scene 105 (e.g., with respect to the physical environment and/or to the user (e.g., the user's hand)) or with respect to the XR content displayed via the display generation component 120. The eye tracking unit 243 is described in greater detail below with respect to FIG. 5.

In some embodiments, the coordination unit 246 is configured to manage and coordinate the XR experience presented to the user by the display generation component 120, and optionally, by one or more of the output devices 155 and/or peripheral devices 195. To that end, in various embodiments, the coordination unit 246 includes instructions and/or logic therefor, and heuristics and metadata therefor.

In some embodiments, the data transmitting unit 248 is configured to transmit data (e.g., presentation data, location data, etc.) to at least the display generation component 120, and optionally, to one or more of the input devices 125, output devices 155, sensors 190, and/or peripheral devices 195. To that end, in various embodiments, the data transmitting unit 248 includes instructions and/or logic therefor, and heuristics and metadata therefor.

Although the data obtaining unit 241, the tracking unit 242 (e.g., including the eye tracking unit 243 and the hand tracking unit 244), the coordination unit 246, and the data transmitting unit 248 are shown as residing on a single device (e.g., the controller 110), it should be understood that in other embodiments, any combination of the data obtaining unit 241, the tracking unit 242 (e.g., including the eye tracking unit 243 and the hand tracking unit 244), the coordination unit 246, and the data transmitting unit 248 may be located in separate computing devices.

Moreover, FIG. 2 is intended more as functional description of the various features that may be present in a particular implementation as opposed to a structural schematic of the embodiments described herein. As recognized by those of ordinary skill in the art, items shown separately could be combined and some items could be separated. For example, some functional modules shown separately in FIG. 2 could be implemented in a single module and the various functions of single functional blocks could be implemented by one or more functional blocks in various embodiments. The actual number of modules and the division of particular functions and how features are allocated among them will vary from one implementation to another and, in some embodiments, depends in part on the particular combination of hardware, software, and/or firmware chosen for a particular implementation.

FIG. 3A is a block diagram of an example of the display generation component 120 in accordance with some embodiments. While certain specific features are illustrated, those skilled in the art will appreciate from the present disclosure that various other features have not been illustrated for the sake of brevity, and so as not to obscure more pertinent aspects of the embodiments disclosed herein. To that end, as a non-limiting example, in some embodiments the display generation component 120 (e.g., HMD) includes one or more processing units 302 (e.g., microprocessors, ASICs, FPGAs, GPUs, CPUs, processing cores, and/or the like), one or more input/output (I/O) devices and sensors 306, one or more communication interfaces 308 (e.g., USB, FIREWIRE, THUNDERBOLT, IEEE 802.3x, IEEE 802.11x, IEEE 802.16x, GSM, CDMA, TDMA, GPS, IR, BLUETOOTH, ZIGBEE, and/or the like type interface), one or more programming (e.g., I/O) interfaces 310, one or more XR displays 312, one or more optional interior- and/or exterior-facing image sensors 314, a memory 320, and one or more communication buses 304 for interconnecting these and various other components.

In some embodiments, the one or more communication buses 304 include circuitry that interconnects and controls communications between system components. In some embodiments, the one or more I/O devices and sensors 306 include at least one of an inertial measurement unit (IMU), an accelerometer, a gyroscope, a thermometer, one or more physiological sensors (e.g., blood pressure monitor, heart rate monitor, blood oxygen sensor, blood glucose sensor, etc.), one or more microphones, one or more speakers, a haptics engine, one or more depth sensors (e.g., a structured light, a time-of-flight, or the like), and/or the like.

In some embodiments, the one or more XR displays 312 are configured to provide the XR experience to the user. In some embodiments, the one or more XR displays 312 correspond to holographic, digital light processing (DLP), liquid-crystal display (LCD), liquid-crystal on silicon (LCoS), organic light-emitting field-effect transitory (OLET), organic light-emitting diode (OLED), surface-conduction electron-emitter display (SED), field-emission display (FED), quantum-dot light-emitting diode (QD-LED), micro-electro-mechanical system (MEMS), and/or the like display types. In some embodiments, the one or more XR displays 312 correspond to diffractive, reflective, polarized, holographic, etc. waveguide displays. For example, the display generation component 120 (e.g., HMD) includes a single XR display. In another example, the display generation component 120 includes a XR display for each eye of the user. In some embodiments, the one or more XR displays 312 are capable of presenting MR and VR content. In some embodiments, the one or more XR displays 312 are capable of presenting MR or VR content.

In some embodiments, the one or more image sensors 314 are configured to obtain image data that corresponds to at least a portion of the face of the user that includes the eyes of the user (and may be referred to as an eye-tracking camera). In some embodiments, the one or more image sensors 314 are configured to obtain image data that corresponds to at least a portion of the user's hand(s) and optionally arm(s) of the user (and may be referred to as a hand-tracking camera). In some embodiments, the one or more image sensors 314 are configured to be forward-facing so as to obtain image data that corresponds to the scene as would be viewed by the user if the display generation component 120 (e.g., HMD) was not present (and may be referred to as a scene camera). The one or more optional image sensors 314 can include one or more red-green-blue (RGB) cameras (e.g., with a complimentary metal-oxide-semiconductor (CMOS) image sensor or a charge-coupled device (CCD) image sensor), one or more infrared (IR) cameras, one or more event-based cameras, and/or the like.

The memory 320 includes high-speed random-access memory, such as DRAM, SRAM, DDR RAM, or other random-access solid-state memory devices. In some embodiments, the memory 320 includes non-volatile memory, such as one or more magnetic disk storage devices, optical disk storage devices, flash memory devices, or other non-volatile solid-state storage devices. The memory 320 optionally includes one or more storage devices remotely located from the one or more processing units 302. The memory 320 comprises a non-transitory computer readable storage medium. In some embodiments, the memory 320 or the non-transitory computer readable storage medium of the memory 320 stores the following programs, modules and data structures, or a subset thereof including an optional operating system 330 and a XR presentation module 340.

The operating system 330 includes instructions for handling various basic system services and for performing hardware dependent tasks. In some embodiments, the XR presentation module 340 is configured to present XR content to the user via the one or more XR displays 312. To that end, in various embodiments, the XR presentation module 340 includes a data obtaining unit 342, a XR presenting unit 344, a XR map generating unit 346, and a data transmitting unit 348.

In some embodiments, the data obtaining unit 342 is configured to obtain data (e.g., presentation data, interaction data, sensor data, location data, etc.) from at least the controller 110 of FIG. 1A. To that end, in various embodiments, the data obtaining unit 342 includes instructions and/or logic therefor, and heuristics and metadata therefor.

In some embodiments, the XR presenting unit 344 is configured to present XR content via the one or more XR displays 312. To that end, in various embodiments, the XR presenting unit 344 includes instructions and/or logic therefor, and heuristics and metadata therefor.

In some embodiments, the XR map generating unit 346 is configured to generate a XR map (e.g., a 3D map of the mixed reality scene or a map of the physical environment into which computer-generated objects can be placed to generate the extended reality) based on media content data. To that end, in various embodiments, the XR map generating unit 346 includes instructions and/or logic therefor, and heuristics and metadata therefor.

In some embodiments, the data transmitting unit 348 is configured to transmit data (e.g., presentation data, location data, etc.) to at least the controller 110, and optionally one or more of the input devices 125, output devices 155, sensors 190, and/or peripheral devices 195. To that end, in various embodiments, the data transmitting unit 348 includes instructions and/or logic therefor, and heuristics and metadata therefor.

Although the data obtaining unit 342, the XR presenting unit 344, the XR map generating unit 346, and the data transmitting unit 348 are shown as residing on a single device (e.g., the display generation component 120 of FIG. 1A), it should be understood that in other embodiments, any combination of the data obtaining unit 342, the XR presenting unit 344, the XR map generating unit 346, and the data transmitting unit 348 may be located in separate computing devices.

Moreover, FIG. 3A is intended more as a functional description of the various features that could be present in a particular implementation as opposed to a structural schematic of the embodiments described herein. As recognized by those of ordinary skill in the art, items shown separately could be combined and some items could be separated. For example, some functional modules shown separately in FIG. 3A could be implemented in a single module and the various functions of single functional blocks could be implemented by one or more functional blocks in various embodiments. The actual number of modules and the division of particular functions and how features are allocated among them will vary from one implementation to another and, in some embodiments, depends in part on the particular combination of hardware, software, and/or firmware chosen for a particular implementation.

Implementations within the scope of the present disclosure can be partially or entirely realized using a tangible computer-readable storage medium (or multiple tangible computer-readable storage media of one or more types) encoding one or more computer-readable instructions. It should be recognized that computer-readable instructions can be organized in any format, including applications, widgets, processes, software, and/or components.

Implementations within the scope of the present disclosure include a computer-readable storage medium that encodes instructions organized as an application (e.g., application 3160) that, when executed by one or more processing units, control an electronic device (e.g., device 3150) to perform the method of FIG. 3B, the method of FIG. 3C, and/or one or more other processes and/or methods described herein.

It should be recognized that application 3160 (shown in FIG. 3D) can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application. In some embodiments, application 3160 is an application that is pre-installed on device 3150 at purchase (e.g., a first party application). In some embodiments, application 3160 is an application that is provided to device 3150 via an operating system update file (e.g., a first party application or a second party application). In some embodiments, application 3160 is an application that is provided via an application store. In some embodiments, the application store can be an application store that is pre-installed on device 3150 at purchase (e.g., a first party application store). In some embodiments, the application store is a third-party application store (e.g., an application store that is provided by another application store, downloaded via a network, and/or read from a storage device).

Referring to FIG. 3B and FIG. 3F, application 3160 obtains information (e.g., 3010). In some embodiments, at 3010, information is obtained from at least one hardware component of device 3150. In some embodiments, at 3010, information is obtained from at least one software module of device 3150. In some embodiments, at 3010, information is obtained from at least one hardware component external to the device 3150 (e.g., a peripheral device, an accessory device, and/or a server). In some embodiments, the information obtained at 3010 includes positional information, time information, notification information, user information, environment information, electronic device state information, weather information, media information, historical information, event information, hardware information, and/or motion information. In some embodiments, in response to and/or after obtaining the information at 3010, application 3160 provides the information to a system (e.g., 3020).

In some embodiments, the system (e.g., 3110 shown in FIG. 3E) is an operating system hosted on device 3150. In some embodiments, the system (e.g., 3110 shown in FIG. 3E) is an external device (e.g., a server, a peripheral device, an accessory, and/or a personal computing device) that includes an operating system.

Referring to FIG. 3C and FIG. 3G, application 3160 obtains information (e.g., 3030). In some embodiments, the information obtained at 3030 includes positional information, time information, notification information, user information, environment information electronic device state information, weather information, media information, historical information, event information, hardware information and/or motion information. In response to and/or after obtaining the information at 3030, application 3160 performs an operation with the information (e.g., 3040). In some embodiments, the operation performed at 3040 includes: providing a notification based on the information, sending a message based on the information, displaying the information, controlling a user interface of a fitness application based on the information, controlling a user interface of a health application based on the information, controlling a focus mode based on the information, setting a reminder based on the information, adding a calendar entry based on the information, and/or calling an API of system 3110 based on the information.

In some embodiments, one or more steps of the method of FIG. 3B and/or the method of FIG. 3C is performed in response to a trigger. In some embodiments, the trigger includes detection of an event, a notification received from system 3110, a user input, and/or a response to a call to an API provided by system 3110.

In some embodiments, the instructions of application 3160, when executed, control device 3150 to perform the method of FIG. 3B and/or the method of FIG. 3C by calling an application programming interface (API) (e.g., API 3190) provided by system 3110. In some embodiments, application 3160 performs at least a portion of the method of FIG. 3B and/or the method of FIG. 3C without calling API 3190.

In some embodiments, one or more steps of the method of FIG. 3B and/or the method of FIG. 3C includes calling an API (e.g., API 3190) using one or more parameters defined by the API. In some embodiments, the one or more parameters include a constant, a key, a data structure, an object, an object class, a variable, a data type, a pointer, an array, a list or a pointer to a function or method, and/or another way to reference a data or other item to be passed via the API.

Referring to FIG. 3D, device 3150 is illustrated. In some embodiments, device 3150 is a personal computing device, a smart phone, a smart watch, a fitness tracker, a head mounted display (HMD) device, a media device, a communal device, a speaker, a television, and/or a tablet. As illustrated in FIG. 3D, device 3150 includes application 3160 and an operating system (e.g., system 3110 shown in FIG. 3E). Application 3160 includes application implementation module 3170 and API-calling module 3180. System 3110 includes API 3190 and implementation module 3100. It should be recognized that device 3150, application 3160, and/or system 3110 can include more, fewer, and/or different components than illustrated in FIGS. 3D and 31E.

In some embodiments, application implementation module 3170 includes a set of one or more instructions corresponding to one or more operations performed by application 3160. For example, when application 3160 is a messaging application, application implementation module 3170 can include operations to receive and send messages. In some embodiments, application implementation module 3170 communicates with API-calling module to communicate with system 3110 via API 3190 (shown in FIG. 3E).

In some embodiments, API 3190 is a software module (e.g., a collection of computer-readable instructions) that provides an interface that allows a different module (e.g., API-calling module 3180) to access and/or use one or more functions, methods, procedures, data structures, classes, and/or other services provided by implementation module 3100 of system 3110. For example, API-calling module 3180 can access a feature of implementation module 3100 through one or more API calls or invocations (e.g., embodied by a function or a method call) exposed by API 3190 (e.g., a software and/or hardware module that can receive API calls, respond to API calls, and/or send API calls) and can pass data and/or control information using one or more parameters via the API calls or invocations. In some embodiments, API 3190 allows application 3160 to use a service provided by a Software Development Kit (SDK) library. In some embodiments, application 3160 incorporates a call to a function or method provided by the SDK library and provided by API 3190 or uses data types or objects defined in the SDK library and provided by API 3190. In some embodiments, API-calling module 3180 makes an API call via API 3190 to access and use a feature of implementation module 3100 that is specified by API 3190. In such embodiments, implementation module 3100 can return a value via API 3190 to API-calling module 3180 in response to the API call. The value can report to application 3160 the capabilities or state of a hardware component of device 3150, including those related to aspects such as input capabilities and state, output capabilities and state, processing capability, power state, storage capacity and state, and/or communications capability. In some embodiments, API 3190 is implemented in part by firmware, microcode, or other low level logic that executes in part on the hardware component.

In some embodiments, API 3190 allows a developer of API-calling module 3180 (which can be a third-party developer) to leverage a feature provided by implementation module 3100. In such embodiments, there can be one or more API-calling modules (e.g., including API-calling module 3180) that communicate with implementation module 3100. In some embodiments, API 3190 allows multiple API-calling modules written in different programming languages to communicate with implementation module 3100 (e.g., API 3190 can include features for translating calls and returns between implementation module 3100 and API-calling module 3180) while API 3190 is implemented in terms of a specific programming language. In some embodiments, API-calling module 3180 calls APIs from different providers such as a set of APIs from an OS provider, another set of APIs from a plug-in provider, and/or another set of APIs from another provider (e.g., the provider of a software library) or creator of the another set of APIs.

Examples of API 3190 can include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an near field communication (NFC) API, a ultrawideband (UWB) API, a fitness API, a smart home API, contact transfer API, photos API, camera API, and/or image processing API. In some embodiments the sensor API is an API for accessing data associated with a sensor of device 3150. For example, the sensor API can provide access to raw sensor data. For another example, the sensor API can provide data derived (and/or generated) from the raw sensor data. In some embodiments, the sensor data includes temperature data, image data, video data, audio data, heart rate data, IMU (inertial measurement unit) data, lidar data, location data, GPS data, and/or camera data. In some embodiments, the sensor includes one or more of an accelerometer, temperature sensor, infrared sensor, optical sensor, heartrate sensor, barometer, gyroscope, proximity sensor, temperature sensor and/or biometric sensor.

In some embodiments, implementation module 3100 is a system (e.g., operating system, server system) software module (e.g., a collection of computer-readable instructions) that is constructed to perform an operation in response to receiving an API call via API 3190. In some embodiments, implementation module 3100 is constructed to provide an API response (via API 3190) as a result of processing an API call. By way of example, implementation module 3100 and API-calling module 3180 can each be any one of an operating system, a library, a device driver, an API, an application program, or other module. It should be understood that implementation module 3100 and API-calling module 3180 can be the same or different type of module from each other. In some embodiments, implementation module 3100 is embodied at least in part in firmware, microcode, or hardware logic.

In some embodiments, implementation module 3100 returns a value through API 3190 in response to an API call from API-calling module 3180. While API 3190 defines the syntax and result of an API call (e.g., how to invoke the API call and what the API call does), API 3190 might not reveal how implementation module 3100 accomplishes the function specified by the API call. Various API calls are transferred via the one or more application programming interfaces between API-calling module 3180 and implementation module 3100. Transferring the API calls can include issuing, initiating, invoking, calling, receiving, returning, and/or responding to the function calls or messages. In other words, transferring can describe actions by either of API-calling module 3180 or implementation module 3100. In some embodiments, a function call or other invocation of API 3190 sends and/or receives one or more parameters through a parameter list or other structure.

In some embodiments, implementation module 3100 provides more than one API, each providing a different view of or with different aspects of functionality implemented by implementation module 3100. For example, one API of implementation module 3100 can provide a first set of functions and can be exposed to third party developers, and another API of implementation module 3100 can be hidden (e.g., not exposed) and provide a subset of the first set of functions and also provide another set of functions, such as testing or debugging functions which are not in the first set of functions. In some embodiments, implementation module 3100 calls one or more other components via an underlying API and thus is both an API-calling module and an implementation module. It should be recognized that implementation module 3100 can include additional functions, methods, classes, data structures, and/or other features that are not specified through API 3190 and are not available to API-calling module 3180. It should also be recognized that API-calling module 3180 can be on the same system as implementation module 3100 or can be located remotely and access implementation module 3100 using API 3190 over a network. In some embodiments, implementation module 3100, API 3190, and/or API-calling module 3180 is stored in a machine-readable medium, which includes any mechanism for storing information in a form readable by a machine (e.g., a computer or other data processing system). For example, a machine-readable medium can include magnetic disks, optical disks, random access memory; read only memory, and/or flash memory devices.

An application programming interface (API) is an interface between a first software process and a second software process that specifies a format for communication between the first software process and the second software process. Limited APIs (e.g., private APIs or partner APIs) are APIs that are accessible to a limited set of software processes (e.g., only software processes within an operating system or only software processes that are approved to access the limited APIs). Public APIs that are accessible to a wider set of software processes. Some APIs enable software processes to communicate about or set a state of one or more input devices (e.g., one or more touch sensors, proximity sensors, visual sensors, motion/orientation sensors, pressure sensors, intensity sensors, sound sensors, wireless proximity sensors, biometric sensors, buttons, switches, rotatable elements, and/or external controllers). Some APIs enable software processes to communicate about and/or set a state of one or more output generation components (e.g., one or more audio output generation components, one or more display generation components, and/or one or more tactile output generation components). Some APIs enable particular capabilities (e.g., scrolling, handwriting, text entry, image editing, and/or image creation) to be accessed, performed, and/or used by a software process (e.g., generating outputs for use by a software process based on input from the software process). Some APIs enable content from a software process to be inserted into a template and displayed in a user interface that has a layout and/or behaviors that are specified by the template.

Many software platforms include a set of frameworks that provides the core objects and core behaviors that a software developer needs to build software applications that can be used on the software platform. Software developers use these objects to display content onscreen, to interact with that content, and to manage interactions with the software platform. Software applications rely on the set of frameworks for their basic behavior, and the set of frameworks provides many ways for the software developer to customize the behavior of the application to match the specific needs of the software application. Many of these core objects and core behaviors are accessed via an API. An API will typically specify a format for communication between software processes, including specifying and grouping available variables, functions, and protocols. An API call (sometimes referred to as an API request) will typically be sent from a sending software process to a receiving software process as a way to accomplish one or more of the following: the sending software process requesting information from the receiving software process (e.g., for the sending software process to take action on), the sending software process providing information to the receiving software process (e.g., for the receiving software process to take action on), the sending software process requesting action by the receiving software process, or the sending software process providing information to the receiving software process about action taken by the sending software process. Interaction with a device (e.g., using a user interface) will in some circumstances include the transfer and/or receipt of one or more API calls (e.g., multiple API calls) between multiple different software processes (e.g., different portions of an operating system, an application and an operating system, or different applications) via one or more APIs (e.g., via multiple different APIs). For example when an input is detected the direct sensor data is frequently processed into one or more input events that are provided (e.g., via an API) to a receiving software process that makes some determination based on the input events, and then sends (e.g., via an API) information to a software process to perform an operation (e.g., change a device state and/or user interface) based on the determination. While a determination and an operation performed in response could be made by the same software process, alternatively the determination could be made in a first software process and relayed (e.g., via an API) to a second software process, that is different from the first software process, that causes the operation to be performed by the second software process. Alternatively, the second software process could relay instructions (e.g., via an API) to a third software process that is different from the first software process and/or the second software process to perform the operation. It should be understood that some or all user interactions with a computer system could involve one or more API calls within a step of interacting with the computer system (e.g., between different software components of the computer system or between a software component of the computer system and a software component of one or more remote computer systems). It should be understood that some or all user interactions with a computer system could involve one or more API calls between steps of interacting with the computer system (e.g., between different software components of the computer system or between a software component of the computer system and a software component of one or more remote computer systems).

In some embodiments, the application can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application.

In some embodiments, the application is an application that is pre-installed on the first computer system at purchase (e.g., a first party application). In some embodiments, the application is an application that is provided to the first computer system via an operating system update file (e.g., a first party application). In some embodiments, the application is an application that is provided via an application store. In some embodiments, the application store is pre-installed on the first computer system at purchase (e.g., a first party application store) and allows download of one or more applications. In some embodiments, the application store is a third party application store (e.g., an application store that is provided by another device, downloaded via a network, and/or read from a storage device). In some embodiments, the application is a third party application (e.g., an app that is provided by an application store, downloaded via a network, and/or read from a storage device). In some embodiments, the application controls the first computer system to perform methods 800 and/or 900 (FIGS. 8 and/or 9) by calling an application programming interface (API) provided by the system process using one or more parameters.

In some embodiments, exemplary APIs provided by the system process include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, contact transfer API, a photos API, a camera API, and/or an image processing API.

In some embodiments, at least one API is a software module (e.g., a collection of computer-readable instructions) that provides an interface that allows a different module (e.g., API-calling module) to access and use one or more functions, methods, procedures, data structures, classes, and/or other services provided by an implementation module of the system process. The API can define one or more parameters that are passed between the API-calling module and the implementation module. In some embodiments, API 3190 defines a first API call that can be provided by API-calling module 3180. The implementation module is a system software module (e.g., a collection of computer-readable instructions) that is constructed to perform an operation in response to receiving an API call via the API. In some embodiments, the implementation module is constructed to provide an API response (via the API) as a result of processing an API call. In some embodiments, the implementation module is included in the device (e.g., 3150) that runs the application. In some embodiments, the implementation module is included in an electronic device that is separate from the device that runs the application.

FIG. 4 is a schematic, pictorial illustration of an example embodiment of the hand tracking device 140. In some embodiments, hand tracking device 140 (FIG. 1A) is controlled by hand tracking unit 244 (FIG. 2) to track the position/location of one or more portions of the user's hands, and/or motions of one or more portions of the user's hands with respect to the scene 105 of FIG. 1A (e.g., with respect to a portion of the physical environment surrounding the user, with respect to the display generation component 120, or with respect to a portion of the user (e.g., the user's face, eyes, or head), and/or relative to a coordinate system defined relative to the user's hand. In some embodiments, the hand tracking device 140 is part of the display generation component 120 (e.g., embedded in or attached to a head-mounted device). In some embodiments, the hand tracking device 140 is separate from the display generation component 120 (e.g., located in separate housings or attached to separate physical support structures).

In some embodiments, the hand tracking device 140 includes image sensors 404 (e.g., one or more IR cameras, 3D cameras, depth cameras, and/or color cameras, etc.) that capture three-dimensional scene information that includes at least a hand 406 of a human user. The image sensors 404 capture the hand images with sufficient resolution to enable the fingers and their respective positions to be distinguished. The image sensors 404 typically capture images of other parts of the user's body, as well, or possibly all of the body, and may have either zoom capabilities or a dedicated sensor with enhanced magnification to capture images of the hand with the desired resolution. In some embodiments, the image sensors 404 also capture 2D color video images of the hand 406 and other elements of the scene. In some embodiments, the image sensors 404 are used in conjunction with other image sensors to capture the physical environment of the scene 105, or serve as the image sensors that capture the physical environments of the scene 105. In some embodiments, the image sensors 404 are positioned relative to the user or the user's environment in a way that a field of view of the image sensors or a portion thereof is used to define an interaction space in which hand movement captured by the image sensors are treated as inputs to the controller 110.

In some embodiments, the image sensors 404 output a sequence of frames containing 3D map data (and possibly color image data, as well) to the controller 110, which extracts high-level information from the map data. This high-level information is typically provided via an Application Program Interface (API) to an application running on the controller, which drives the display generation component 120 accordingly. For example, the user may interact with software running on the controller 110 by moving his hand 406 and changing his hand posture.

In some embodiments, the image sensors 404 project a pattern of spots onto a scene containing the hand 406 and capture an image of the projected pattern. In some embodiments, the controller 110 computes the 3D coordinates of points in the scene (including points on the surface of the user's hand) by triangulation, based on transverse shifts of the spots in the pattern. This approach is advantageous in that it does not require the user to hold or wear any sort of beacon, sensor, or other marker. It gives the depth coordinates of points in the scene relative to a predetermined reference plane, at a certain distance from the image sensors 404. In the present disclosure, the image sensors 404 are assumed to define an orthogonal set of x, y, z axes, so that depth coordinates of points in the scene correspond to z components measured by the image sensors. Alternatively, the image sensors 404 (e.g., a hand tracking device) may use other methods of 3D mapping, such as stereoscopic imaging or time-of-flight measurements, based on single or multiple cameras or other types of sensors.

In some embodiments, the hand tracking device 140 captures and processes a temporal sequence of depth maps containing the user's hand, while the user moves his hand (e.g., whole hand or one or more fingers). Software running on a processor in the image sensors 404 and/or the controller 110 processes the 3D map data to extract patch descriptors of the hand in these depth maps. The software matches these descriptors to patch descriptors stored in a database 408, based on a prior learning process, in order to estimate the pose of the hand in each frame. The pose typically includes 3D locations of the user's hand joints and fingertips.

The software may also analyze the trajectory of the hands and/or fingers over multiple frames in the sequence in order to identify gestures. The pose estimation functions described herein may be interleaved with motion tracking functions, so that patch-based pose estimation is performed only once in every two (or more) frames, while tracking is used to find changes in the pose that occur over the remaining frames. The pose, motion, and gesture information are provided via the above-mentioned API to an application program running on the controller 110. This program may, for example, move and modify images presented on the display generation component 120, or perform other functions, in response to the pose and/or gesture information.

In some embodiments, a gesture includes an air gesture. An air gesture is a gesture that is detected without the user touching (or independently of) an input element that is part of a device (e.g., computer system 101, one or more input device 125, and/or hand tracking device 140) and is based on detected motion of a portion (e.g., the head, one or more arms, one or more hands, one or more fingers, and/or one or more legs) of the user's body through the air including motion of the user's body relative to an absolute reference (e.g., an angle of the user's arm relative to the ground or a distance of the user's hand relative to the ground), relative to another portion of the user's body (e.g., movement of a hand of the user relative to a shoulder of the user, movement of one hand of the user relative to another hand of the user, and/or movement of a finger of the user relative to another finger or portion of a hand of the user), and/or absolute motion of a portion of the user's body (e.g., a tap gesture that includes movement of a hand in a predetermined pose by a predetermined amount and/or speed, or a shake gesture that includes a predetermined speed or amount of rotation of a portion of the user's body).

In some embodiments, input gestures used in the various examples and embodiments described herein include air gestures performed by movement of the user's finger(s) relative to other finger(s) or part(s) of the user's hand) for interacting with an XR environment (e.g., a virtual or mixed-reality environment), in accordance with some embodiments. In some embodiments, an air gesture is a gesture that is detected without the user touching an input element that is part of the device (or independently of an input element that is a part of the device) and is based on detected motion of a portion of the user's body through the air including motion of the user's body relative to an absolute reference (e.g., an angle of the user's arm relative to the ground or a distance of the user's hand relative to the ground), relative to another portion of the user's body (e.g., movement of a hand of the user relative to a shoulder of the user, movement of one hand of the user relative to another hand of the user, and/or movement of a finger of the user relative to another finger or portion of a hand of the user), and/or absolute motion of a portion of the user's body (e.g., a tap gesture that includes movement of a hand in a predetermined pose by a predetermined amount and/or speed, or a shake gesture that includes a predetermined speed or amount of rotation of a portion of the user's body).

In some embodiments in which the input gesture is an air gesture (e.g., in the absence of physical contact with an input device that provides the computer system with information about which user interface element is the target of the user input, such as contact with a user interface element displayed on a touchscreen, or contact with a mouse or trackpad to move a cursor to the user interface element), the gesture takes into account the user's attention (e.g., gaze) to determine the target of the user input (e.g., for direct inputs, as described below). Thus, in implementations involving air gestures, the input gesture is, for example, detected attention (e.g., gaze) toward the user interface element in combination (e.g., concurrent) with movement of a user's finger(s) and/or hands to perform a pinch and/or tap input, as described in more detail below.

In some embodiments, input gestures that are directed to a user interface object are performed directly or indirectly with reference to a user interface object. For example, a user input is performed directly on the user interface object in accordance with performing the input gesture with the user's hand at a position that corresponds to the position of the user interface object in the three-dimensional environment (e.g., as determined based on a current viewpoint of the user). In some embodiments, the input gesture is performed indirectly on the user interface object in accordance with the user performing the input gesture while a position of the user's hand is not at the position that corresponds to the position of the user interface object in the three-dimensional environment while detecting the user's attention (e.g., gaze) on the user interface object. For example, for direct input gesture, the user is enabled to direct the user's input to the user interface object by initiating the gesture at, or near, a position corresponding to the displayed position of the user interface object (e.g., within 0.5 cm, 1 cm, 5 cm, or a distance between 0-5 cm, as measured from an outer edge of the option or a center portion of the option). For an indirect input gesture, the user is enabled to direct the user's input to the user interface object by paying attention to the user interface object (e.g., by gazing at the user interface object) and, while paying attention to the option, the user initiates the input gesture (e.g., at any position that is detectable by the computer system) (e.g., at a position that does not correspond to the displayed position of the user interface object).

In some embodiments, input gestures (e.g., air gestures) used in the various examples and embodiments described herein include pinch inputs and tap inputs, for interacting with a virtual or mixed-reality environment, in accordance with some embodiments. For example, the pinch inputs and tap inputs described below are performed as air gestures.

In some embodiments, a pinch input is part of an air gesture that includes one or more of: a pinch gesture, a long pinch gesture, a pinch and drag gesture, or a double pinch gesture. For example, a pinch gesture that is an air gesture includes movement of two or more fingers of a hand to make contact with one another, that is, optionally, followed by an immediate (e.g., within 0-1 seconds) break in contact from each other. A long pinch gesture that is an air gesture includes movement of two or more fingers of a hand to make contact with one another for at least a threshold amount of time (e.g., at least 1 second), before detecting a break in contact with one another. For example, a long pinch gesture includes the user holding a pinch gesture (e.g., with the two or more fingers making contact), and the long pinch gesture continues until a break in contact between the two or more fingers is detected. In some embodiments, a double pinch gesture that is an air gesture comprises two (e.g., or more) pinch inputs (e.g., performed by the same hand) detected in immediate (e.g., within a predefined time period) succession of each other. For example, the user performs a first pinch input (e.g., a pinch input or a long pinch input), releases the first pinch input (e.g., breaks contact between the two or more fingers), and performs a second pinch input within a predefined time period (e.g., within 1 second or within 2 seconds) after releasing the first pinch input.

In some embodiments, a pinch and drag gesture that is an air gesture (e.g., an air drag gesture or an air swipe gesture) includes a pinch gesture (e.g., a pinch gesture or a long pinch gesture) performed in conjunction with (e.g., followed by) a drag input that changes a position of the user's hand from a first position (e.g., a start position of the drag) to a second position (e.g., an end position of the drag). In some embodiments, the user maintains the pinch gesture while performing the drag input, and releases the pinch gesture (e.g., opens their two or more fingers) to end the drag gesture (e.g., at the second position). In some embodiments, the pinch input and the drag input are performed by the same hand (e.g., the user pinches two or more fingers to make contact with one another and moves the same hand to the second position in the air with the drag gesture). In some embodiments, the pinch input is performed by a first hand of the user and the drag input is performed by the second hand of the user (e.g., the user's second hand moves from the first position to the second position in the air while the user continues the pinch input with the user's first hand. In some embodiments, an input gesture that is an air gesture includes inputs (e.g., pinch and/or tap inputs) performed using both of the user's two hands. For example, the input gesture includes two (e.g., or more) pinch inputs performed in conjunction with (e.g., concurrently with, or within a predefined time period of) each other. For example, a first pinch gesture performed using a first hand of the user (e.g., a pinch input, a long pinch input, or a pinch and drag input), and, in conjunction with performing the pinch input using the first hand, performing a second pinch input using the other hand (e.g., the second hand of the user's two hands).

In some embodiments, a tap input (e.g., directed to a user interface element) performed as an air gesture includes movement of a user's finger(s) toward the user interface element, movement of the user's hand toward the user interface element optionally with the user's finger(s) extended toward the user interface element, a downward motion of a user's finger (e.g., mimicking a mouse click motion or a tap on a touchscreen), or other predefined movement of the user's hand. In some embodiments a tap input that is performed as an air gesture is detected based on movement characteristics of the finger or hand performing the tap gesture movement of a finger or hand away from the viewpoint of the user and/or toward an object that is the target of the tap input followed by an end of the movement. In some embodiments the end of the movement is detected based on a change in movement characteristics of the finger or hand performing the tap gesture (e.g., an end of movement away from the viewpoint of the user and/or toward the object that is the target of the tap input, a reversal of direction of movement of the finger or hand, and/or a reversal of a direction of acceleration of movement of the finger or hand).

In some embodiments, attention of a user is determined to be directed to a portion of the three-dimensional environment based on detection of gaze directed to the portion of the three-dimensional environment (optionally, without requiring other conditions). In some embodiments, attention of a user is determined to be directed to a portion of the three-dimensional environment based on detection of gaze directed to the portion of the three-dimensional environment with one or more additional conditions such as requiring that gaze is directed to the portion of the three-dimensional environment for at least a threshold duration (e.g., a dwell duration) and/or requiring that the gaze is directed to the portion of the three-dimensional environment while the viewpoint of the user is within a distance threshold from the portion of the three-dimensional environment in order for the device to determine that attention of the user is directed to the portion of the three-dimensional environment, where if one of the additional conditions is not met, the device determines that attention is not directed to the portion of the three-dimensional environment toward which gaze is directed (e.g., until the one or more additional conditions are met).

In some embodiments, the detection of a ready state configuration of a user or a portion of a user is detected by the computer system. Detection of a ready state configuration of a hand is used by a computer system as an indication that the user is likely preparing to interact with the computer system using one or more air gesture inputs performed by the hand (e.g., a pinch, tap, pinch and drag, double pinch, long pinch, or other air gesture described herein). For example, the ready state of the hand is determined based on whether the hand has a predetermined hand shape (e.g., a pre-pinch shape with a thumb and one or more fingers extended and spaced apart ready to make a pinch or grab gesture or a pre-tap with one or more fingers extended and palm facing away from the user), based on whether the hand is in a predetermined position relative to a viewpoint of the user (e.g., below the user's head and above the user's waist and extended out from the body by at least 15, 20, 25, 30, or 50 cm), and/or based on whether the hand has moved in a particular manner (e.g., moved toward a region in front of the user above the user's waist and below the user's head or moved away from the user's body or leg). In some embodiments, the ready state is used to determine whether interactive elements of the user interface respond to attention (e.g., gaze) inputs.

In scenarios where inputs are described with reference to air gestures, it should be understood that similar gestures could be detected using a hardware input device that is attached to or held by one or more hands of a user, where the position of the hardware input device in space can be tracked using optical tracking, one or more accelerometers, one or more gyroscopes, one or more magnetometers, and/or one or more inertial measurement units and the position and/or movement of the hardware input device is used in place of the position and/or movement of the one or more hands in the corresponding air gesture(s). In scenarios where inputs are described with reference to air gestures, it should be understood that similar gestures could be detected using a hardware input device that is attached to or held by one or more hands of a user. User inputs can be detected with controls contained in the hardware input device such as one or more touch-sensitive input elements, one or more pressure-sensitive input elements, one or more buttons, one or more knobs, one or more dials, one or more joysticks, one or more hand or finger coverings that can detect a position or change in position of portions of a hand and/or fingers relative to each other, relative to the user's body, and/or relative to a physical environment of the user, and/or other hardware input device controls, where the user inputs with the controls contained in the hardware input device are used in place of hand and/or finger gestures such as air taps or air pinches in the corresponding air gesture(s). For example, a selection input that is described as being performed with an air tap or air pinch input could be alternatively detected with a button press, a tap on a touch-sensitive surface, a press on a pressure-sensitive surface, or other hardware input. As another example, a movement input that is described as being performed with an air pinch and drag (e.g., an air drag gesture or an air swipe gesture) could be alternatively detected based on an interaction with the hardware input control such as a button press and hold, a touch on a touch-sensitive surface, a press on a pressure-sensitive surface, or other hardware input that is followed by movement of the hardware input device (e.g., along with the hand with which the hardware input device is associated) through space. Similarly, a two-handed input that includes movement of the hands relative to each other could be performed with one air gesture and one hardware input device in the hand that is not performing the air gesture, two hardware input devices held in different hands, or two air gestures performed by different hands using various combinations of air gestures and/or the inputs detected by one or more hardware input devices that are described above.

In some embodiments, the software may be downloaded to the controller 110 in electronic form, over a network, for example, or it may alternatively be provided on tangible, non-transitory media, such as optical, magnetic, or electronic memory media. In some embodiments, the database 408 is likewise stored in a memory associated with the controller 110. Alternatively or additionally, some or all of the described functions of the computer may be implemented in dedicated hardware, such as a custom or semi-custom integrated circuit or a programmable digital signal processor (DSP). Although the controller 110 is shown in FIG. 4, by way of example, as a separate unit from the image sensors 404, some or all of the processing functions of the controller may be performed by a suitable microprocessor and software or by dedicated circuitry within the housing of the image sensors 404 (e.g., a hand tracking device) or otherwise associated with the image sensors 404. In some embodiments, at least some of these processing functions may be carried out by a suitable processor that is integrated with the display generation component 120 (e.g., in a television set, a handheld device, or head-mounted device, for example) or with any other suitable computerized device, such as a game console or media player. The sensing functions of image sensors 404 may likewise be integrated into the computer or other computerized apparatus that is to be controlled by the sensor output.

FIG. 4 further includes a schematic representation of a depth map 410 captured by the image sensors 404, in accordance with some embodiments. The depth map, as explained above, comprises a matrix of pixels having respective depth values. The pixels 412 corresponding to the hand 406 have been segmented out from the background and the wrist in this map. The brightness of each pixel within the depth map 410 corresponds inversely to its depth value, i.e., the measured z distance from the image sensors 404, with the shade of gray growing darker with increasing depth. The controller 110 processes these depth values in order to identify and segment a component of the image (i.e., a group of neighboring pixels) having characteristics of a human hand. These characteristics, may include, for example, overall size, shape and motion from frame to frame of the sequence of depth maps.

FIG. 4 also schematically illustrates a hand skeleton 414 that controller 110 ultimately extracts from the depth map 410 of the hand 406, in accordance with some embodiments. In FIG. 4, the hand skeleton 414 is superimposed on a hand background 416 that has been segmented from the original depth map. In some embodiments, key feature points of the hand (e.g., points corresponding to knuckles, fingertips, center of the palm, end of the hand connecting to wrist, etc.) and optionally on the wrist or arm connected to the hand are identified and located on the hand skeleton 414. In some embodiments, location and movements of these key feature points over multiple image frames are used by the controller 110 to determine the hand gestures performed by the hand or the current state of the hand, in accordance with some embodiments.

FIG. 5 illustrates an example embodiment of the eye tracking device 130 (FIG. 1A). In some embodiments, the eye tracking device 130 is controlled by the eye tracking unit 243 (FIG. 2) to track the position and movement of the user's gaze with respect to the scene 105 or with respect to the XR content displayed via the display generation component 120. In some embodiments, the eye tracking device 130 is integrated with the display generation component 120. For example, in some embodiments, when the display generation component 120 is a head-mounted device such as headset, helmet, goggles, or glasses, or a handheld device placed in a wearable frame, the head-mounted device includes both a component that generates the XR content for viewing by the user and a component for tracking the gaze of the user relative to the XR content. In some embodiments, the eye tracking device 130 is separate from the display generation component 120. For example, when display generation component is a handheld device or a XR chamber, the eye tracking device 130 is optionally a separate device from the handheld device or XR chamber. In some embodiments, the eye tracking device 130 is a head-mounted device or part of a head-mounted device. In some embodiments, the head-mounted eye-tracking device 130 is optionally used in conjunction with a display generation component that is also head-mounted, or a display generation component that is not head-mounted. In some embodiments, the eye tracking device 130 is not a head-mounted device, and is optionally used in conjunction with a head-mounted display generation component. In some embodiments, the eye tracking device 130 is not a head-mounted device, and is optionally part of a non-head-mounted display generation component.

In some embodiments, the display generation component 120 uses a display mechanism (e.g., left and right near-eye display panels) for displaying frames including left and right images in front of a user's eyes to thus provide 3D virtual views to the user. For example, a head-mounted display generation component may include left and right optical lenses (referred to herein as eye lenses) located between the display and the user's eyes. In some embodiments, the display generation component may include or be coupled to one or more external video cameras that capture video of the user's environment for display. In some embodiments, a head-mounted display generation component may have a transparent or semi-transparent display through which a user may view the physical environment directly and display virtual objects on the transparent or semi-transparent display. In some embodiments, display generation component projects virtual objects into the physical environment. The virtual objects may be projected, for example, on a physical surface or as a holograph, so that an individual, using the system, observes the virtual objects superimposed over the physical environment. In such cases, separate display panels and image frames for the left and right eyes may not be necessary.

As shown in FIG. 5, in some embodiments, eye tracking device 130 (e.g., a gaze tracking device) includes at least one eye tracking camera (e.g., infrared (IR) or near-IR (NIR) cameras), and illumination sources (e.g., IR or NIR light sources such as an array or ring of LEDs) that emit light (e.g., IR or NIR light) towards the user's eyes. The eye tracking cameras may be pointed towards the user's eyes to receive reflected IR or NIR light from the light sources directly from the eyes, or alternatively may be pointed towards “hot” mirrors located between the user's eyes and the display panels that reflect IR or NIR light from the eyes to the eye tracking cameras while allowing visible light to pass. The eye tracking device 130 optionally captures images of the user's eyes (e.g., as a video stream captured at 60-120 frames per second (fps)), analyze the images to generate gaze tracking information, and communicate the gaze tracking information to the controller 110. In some embodiments, two eyes of the user are separately tracked by respective eye tracking cameras and illumination sources. In some embodiments, only one eye of the user is tracked by a respective eye tracking camera and illumination sources.

In some embodiments, the eye tracking device 130 is calibrated using a device-specific calibration process to determine parameters of the eye tracking device for the specific operating environment 100, for example the 3D geometric relationship and parameters of the LEDs, cameras, hot mirrors (if present), eye lenses, and display screen. The device-specific calibration process may be performed at the factory or another facility prior to delivery of the AR/VR equipment to the end user. The device-specific calibration process may be an automated calibration process or a manual calibration process. A user-specific calibration process may include an estimation of a specific user's eye parameters, for example the pupil location, fovea location, optical axis, visual axis, eye spacing, etc. Once the device-specific and user-specific parameters are determined for the eye tracking device 130, images captured by the eye tracking cameras can be processed using a glint-assisted method to determine the current visual axis and point of gaze of the user with respect to the display, in accordance with some embodiments.

As shown in FIG. 5, the eye tracking device 130 (e.g., 130A or 130B) includes one or more eye lenses 520, and a gaze tracking system that includes at least one eye tracking camera 540 (e.g., infrared (IR) or near-IR (NIR) cameras) positioned on a side of the user's face for which eye tracking is performed, and an illumination source 530 (e.g., IR or NIR light sources such as an array or ring of NIR light-emitting diodes (LEDs)) that emit light (e.g., IR or NIR light) towards the user's eyes or eyes 592. The eye tracking cameras 540 may be pointed towards mirrors 550 located between the user's eyes or eyes 592 and a display 510 (e.g., a left or right display panel of a head-mounted display, or a display of a handheld device, a projector, etc.) that reflect IR or NIR light from the eye or eyes 592 while allowing visible light to pass (e.g., as shown in the top portion of FIG. 5), or alternatively may be pointed towards the user's eye or eyes 592 to receive reflected IR or NIR light from the eye or eyes 592 (e.g., as shown in the bottom portion of FIG. 5).

In some embodiments, the controller 110 renders AR or VR frames 562 (e.g., left and right frames for left and right display panels) and provides the frames 562 to the display 510. The controller 110 uses gaze tracking input 542 from the eye tracking cameras 540 for various purposes, for example in processing the frames 562 for display. The controller 110 optionally estimates the user's point of gaze on the display 510 based on the gaze tracking input 542 obtained from the eye tracking cameras 540 using the glint-assisted methods or other suitable methods. The point of gaze estimated from the gaze tracking input 542 is optionally used to determine the direction in which the user is currently looking.

The following describes several possible use cases for the user's current gaze direction, and is not intended to be limiting. As an example use case, the controller 110 may render virtual content differently based on the determined direction of the user's gaze. For example, the controller 110 may generate virtual content at a higher resolution in a foveal region determined from the user's current gaze direction than in peripheral regions. As another example, the controller may position or move virtual content in the view based at least in part on the user's current gaze direction. As another example, the controller may display particular virtual content in the view based at least in part on the user's current gaze direction. As another example use case in AR applications, the controller 110 may direct external cameras for capturing the physical environments of the XR experience to focus in the determined direction. The autofocus mechanism of the external cameras may then focus on an object or surface in the environment that the user is currently looking at on the display 510. As another example use case, the eye lenses 520 may be focusable lenses, and the gaze tracking information is used by the controller to adjust the focus of the eye lenses 520 so that the virtual object that the user is currently looking at has the proper vergence to match the convergence of the user's eyes 592. The controller 110 may leverage the gaze tracking information to direct the eye lenses 520 to Adjust focus so that close objects that the user is looking at appear at the right distance.

In some embodiments, the eye tracking device is part of a head-mounted device that includes a display (e.g., display 510), two eye lenses (e.g., eye lens(es) 520), eye tracking cameras (e.g., eye tracking cameras 540), and light sources (e.g., illumination sources 530 (e.g., IR or NIR LEDs), mounted in a wearable housing. The light sources emit light (e.g., IR or NIR light) towards the user's eye(s) 592. In some embodiments, the light sources may be arranged in rings or circles around each of the lenses as shown in FIG. 5. In some embodiments, eight illumination sources 530 (e.g., LEDs) are arranged around each lens 520 as an example. However, more or fewer illumination sources 530 may be used, and other arrangements and locations of illumination sources 530 may be used.

In some embodiments, the display 510 emits light in the visible light range and does not emit light in the IR or NIR range, and thus does not introduce noise in the gaze tracking system. Note that the location and angle of eye tracking cameras 540 are given by way of example, and is not intended to be limiting. In some embodiments, a single eye tracking camera 540 is located on each side of the user's face. In some embodiments, two or more NIR cameras may be used on each side of the user's face as eye tracking cameras 540. In some embodiments, a camera 540 with a wider field of view (FOV) and a camera 540 with a narrower FOV may be used on each side of the user's face. In some embodiments, a camera 540 that operates at one wavelength (e.g., 850 nm) and a camera 540 that operates at a different wavelength (e.g., 940 nm) may be used on each side of the user's face.

Embodiments of the gaze tracking system as illustrated in FIG. 5 may, for example, be used in computer-generated reality, virtual reality, and/or mixed reality applications to provide computer-generated reality, virtual reality, augmented reality, and/or augmented virtuality experiences to the user.

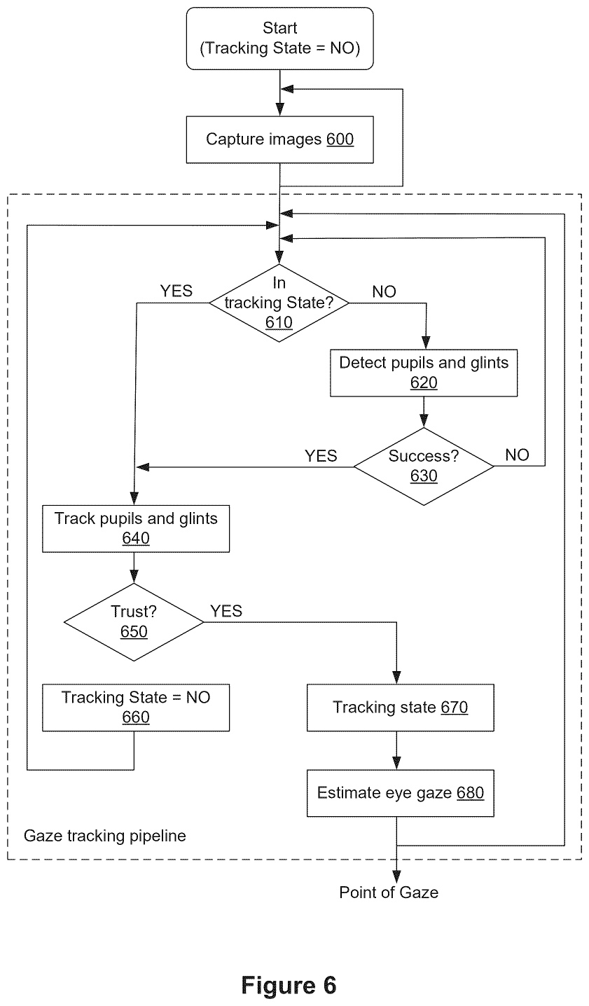

FIG. 6 illustrates a glint-assisted gaze tracking pipeline, in accordance with some embodiments. In some embodiments, the gaze tracking pipeline is implemented by a glint-assisted gaze tracking system (e.g., eye tracking device 130 as illustrated in FIGS. 1A and 5). The glint-assisted gaze tracking system may maintain a tracking state. Initially, the tracking state is off or “NO.” When in the tracking state, the glint-assisted gaze tracking system uses prior information from the previous frame when analyzing the current frame to track the pupil contour and glints in the current frame. When not in the tracking state, the glint-assisted gaze tracking system attempts to detect the pupil and glints in the current frame and, if successful, initializes the tracking state to “YES” and continues with the next frame in the tracking state.

As shown in FIG. 6, the gaze tracking cameras may capture left and right images of the user's left and right eyes. The captured images are then input to a gaze tracking pipeline for processing beginning at 610. As indicated by the arrow returning to element 600, the gaze tracking system may continue to capture images of the user's eyes, for example at a rate of 60 to 120 frames per second. In some embodiments, each set of captured images may be input to the pipeline for processing. However, in some embodiments or under some conditions, not all captured frames are processed by the pipeline.

At 610, for the current captured images, if the tracking state is YES, then the method proceeds to element 640. At 610, if the tracking state is NO, then as indicated at 620 the images are analyzed to detect the user's pupils and glints in the images. At 630, if the pupils and glints are successfully detected, then the method proceeds to element 640. Otherwise, the method returns to element 610 to process next images of the user's eyes.

At 640, if proceeding from element 610, the current frames are analyzed to track the pupils and glints based in part on prior information from the previous frames. At 640, if proceeding from element 630, the tracking state is initialized based on the detected pupils and glints in the current frames. Results of processing at element 640 are checked to verify that the results of tracking or detection can be trusted. For example, results may be checked to determine if the pupil and a sufficient number of glints to perform gaze estimation are successfully tracked or detected in the current frames. At 650, if the results cannot be trusted, then the tracking state is set to NO at element 660, and the method returns to element 610 to process next images of the user's eyes. At 650, if the results are trusted, then the method proceeds to element 670. At 670, the tracking state is set to YES (if not already YES), and the pupil and glint information is passed to element 680 to estimate the user's point of gaze.

FIG. 6 is intended to serve as one example of eye tracking technology that may be used in a particular implementation. As recognized by those of ordinary skill in the art, other eye tracking technologies that currently exist or are developed in the future may be used in place of or in combination with the glint-assisted eye tracking technology describe herein in the computer system 101 for providing XR experiences to users, in accordance with various embodiments.

In some embodiments, the captured portions of real world environment 602 are used to provide a XR experience to the user, for example, a mixed reality environment in which one or more virtual objects are superimposed over representations of real world environment 602.

Thus, the description herein describes some embodiments of three-dimensional environments (e.g., XR environments) that include representations of real world objects and representations of virtual objects. For example, a three-dimensional environment optionally includes a representation of a table that exists in the physical environment, which is captured and displayed in the three-dimensional environment (e.g., actively via cameras and displays of a computer system, or passively via a transparent or translucent display of the computer system). As described previously, the three-dimensional environment is optionally a mixed reality system in which the three-dimensional environment is based on the physical environment that is captured by one or more sensors of the computer system and displayed via a display generation component. As a mixed reality system, the computer system is optionally able to selectively display portions and/or objects of the physical environment such that the respective portions and/or objects of the physical environment appear as if they exist in the three-dimensional environment displayed by the computer system. Similarly, the computer system is optionally able to display virtual objects in the three-dimensional environment to appear as if the virtual objects exist in the real world (e.g., physical environment) by placing the virtual objects at respective locations in the three-dimensional environment that have corresponding locations in the real world. For example, the computer system optionally displays a vase such that it appears as if a real vase is placed on top of a table in the physical environment. In some embodiments, a respective location in the three-dimensional environment has a corresponding location in the physical environment. Thus, when the computer system is described as displaying a virtual object at a respective location with respect to a physical object (e.g., such as a location at or near the hand of the user, or at or near a physical table), the computer system displays the virtual object at a particular location in the three-dimensional environment such that it appears as if the virtual object is at or near the physical object in the physical world (e.g., the virtual object is displayed at a location in the three-dimensional environment that corresponds to a location in the physical environment at which the virtual object would be displayed if it were a real object at that particular location).

In some embodiments, real world objects that exist in the physical environment that are displayed in the three-dimensional environment (e.g., and/or visible via the display generation component) can interact with virtual objects that exist only in the three-dimensional environment. For example, a three-dimensional environment can include a table and a vase placed on top of the table, with the table being a view of (or a representation of) a physical table in the physical environment, and the vase being a virtual object.

In a three-dimensional environment (e.g., a real environment, a virtual environment, or an environment that includes a mix of real and virtual objects), objects are sometimes referred to as having a depth or simulated depth, or objects are referred to as being visible, displayed, or placed at different depths. In this context, depth refers to a dimension other than height or width. In some embodiments, depth is defined relative to a fixed set of coordinates (e.g., where a room or an object has a height, depth, and width defined relative to the fixed set of coordinates). In some embodiments, depth is defined relative to a location or viewpoint of a user, in which case, the depth dimension varies based on the location of the user and/or the location and angle of the viewpoint of the user. In some embodiments where depth is defined relative to a location of a user that is positioned relative to a surface of an environment (e.g., a floor of an environment, or a surface of the ground), objects that are further away from the user along a line that extends parallel to the surface are considered to have a greater depth in the environment, and/or the depth of an object is measured along an axis that extends outward from a location of the user and is parallel to the surface of the environment (e.g., depth is defined in a cylindrical or substantially cylindrical coordinate system with the position of the user at the center of the cylinder that extends from a head of the user toward feet of the user). In some embodiments where depth is defined relative to viewpoint of a user (e.g., a direction relative to a point in space that determines which portion of an environment that is visible via a head mounted device or other display), objects that are further away from the viewpoint of the user along a line that extends parallel to the direction of the viewpoint of the user are considered to have a greater depth in the environment, and/or the depth of an object is measured along an axis that extends outward from a line that extends from the viewpoint of the user and is parallel to the direction of the viewpoint of the user (e.g., depth is defined in a spherical or substantially spherical coordinate system with the origin of the viewpoint at the center of the sphere that extends outwardly from a head of the user). In some embodiments, depth is defined relative to a user interface container (e.g., a window or application in which application and/or system content is displayed) where the user interface container has a height and/or width, and depth is a dimension that is orthogonal to the height and/or width of the user interface container. In some embodiments, in circumstances where depth is defined relative to a user interface container, the height and or width of the container are typically orthogonal or substantially orthogonal to a line that extends from a location based on the user (e.g., a viewpoint of the user or a location of the user) to the user interface container (e.g., the center of the user interface container, or another characteristic point of the user interface container) when the container is placed in the three-dimensional environment or is initially displayed (e.g., so that the depth dimension for the container extends outward away from the user or the viewpoint of the user). In some embodiments, in situations where depth is defined relative to a user interface container, depth of an object relative to the user interface container refers to a position of the object along the depth dimension for the user interface container. In some embodiments, multiple different containers can have different depth dimensions (e.g., different depth dimensions that extend away from the user or the viewpoint of the user in different directions and/or from different starting points). In some embodiments, when depth is defined relative to a user interface container, the direction of the depth dimension remains constant for the user interface container as the location of the user interface container, the user and/or the viewpoint of the user changes (e.g., or when multiple different viewers are viewing the same container in the three-dimensional environment such as during an in-person collaboration session and/or when multiple participants are in a real-time communication session with shared virtual content including the container). In some embodiments, for curved containers (e.g., including a container with a curved surface or curved content region), the depth dimension optionally extends into a surface of the curved container. In some situations, z-separation (e.g., separation of two objects in a depth dimension), z-height (e.g., distance of one object from another in a depth dimension), z-position (e.g., position of one object in a depth dimension), z-depth (e.g., position of one object in a depth dimension), or simulated z dimension (e.g., depth used as a dimension of an object, dimension of an environment, a direction in space, and/or a direction in simulated space) are used to refer to the concept of depth as described above.

In some embodiments, a user is optionally able to interact with virtual objects in the three-dimensional environment using one or more hands as if the virtual objects were real objects in the physical environment. For example, as described above, one or more sensors of the computer system optionally capture one or more of the hands of the user and display representations of the hands of the user in the three-dimensional environment (e.g., in a manner similar to displaying a real world object in three-dimensional environment described above), or in some embodiments, the hands of the user are visible via the display generation component via the ability to see the physical environment through the user interface due to the transparency/translucency of a portion of the display generation component that is displaying the user interface or due to projection of the user interface onto a transparent/translucent surface or projection of the user interface onto the user's eye or into a field of view of the user's eye. Thus, in some embodiments, the hands of the user are displayed at a respective location in the three-dimensional environment and are treated as if they were objects in the three-dimensional environment that are able to interact with the virtual objects in the three-dimensional environment as if they were physical objects in the physical environment. In some embodiments, the computer system is able to update display of the representations of the user's hands in the three-dimensional environment in conjunction with the movement of the user's hands in the physical environment.

In some of the embodiments described below, the computer system is optionally able to determine the “effective” distance between physical objects in the physical world and virtual objects in the three-dimensional environment, for example, for the purpose of determining whether a physical object is directly interacting with a virtual object (e.g., whether a hand is touching, grabbing, holding, etc. a virtual object or within a threshold distance of a virtual object). For example, a hand directly interacting with a virtual object optionally includes one or more of a finger of a hand pressing a virtual button, a hand of a user grabbing a virtual vase, two fingers of a hand of the user coming together and pinching/holding a user interface of an application, and any of the other types of interactions described here. For example, the computer system optionally determines the distance between the hands of the user and virtual objects when determining whether the user is interacting with virtual objects and/or how the user is interacting with virtual objects. In some embodiments, the computer system determines the distance between the hands of the user and a virtual object by determining the distance between the location of the hands in the three-dimensional environment and the location of the virtual object of interest in the three-dimensional environment. For example, the one or more hands of the user are located at a particular position in the physical world, which the computer system optionally captures and displays at a particular corresponding position in the three-dimensional environment (e.g., the position in the three-dimensional environment at which the hands would be displayed if the hands were virtual, rather than physical, hands). The position of the hands in the three-dimensional environment is optionally compared with the position of the virtual object of interest in the three-dimensional environment to determine the distance between the one or more hands of the user and the virtual object. In some embodiments, the computer system optionally determines a distance between a physical object and a virtual object by comparing positions in the physical world (e.g., as opposed to comparing positions in the three-dimensional environment). For example, when determining the distance between one or more hands of the user and a virtual object, the computer system optionally determines the corresponding location in the physical world of the virtual object (e.g., the position at which the virtual object would be located in the physical world if it were a physical object rather than a virtual object), and then determines the distance between the corresponding physical position and the one of more hands of the user. In some embodiments, the same techniques are optionally used to determine the distance between any physical object and any virtual object. Thus, as described herein, when determining whether a physical object is in contact with a virtual object or whether a physical object is within a threshold distance of a virtual object, the computer system optionally performs any of the techniques described above to map the location of the physical object to the three-dimensional environment and/or map the location of the virtual object to the physical environment.

In some embodiments, the same or similar technique is used to determine where and what the gaze of the user is directed to and/or where and at what a physical stylus held by a user is pointed. For example, if the gaze of the user is directed to a particular position in the physical environment, the computer system optionally determines the corresponding position in the three-dimensional environment (e.g., the virtual position of the gaze), and if a virtual object is located at that corresponding virtual position, the computer system optionally determines that the gaze of the user is directed to that virtual object. Similarly, the computer system is optionally able to determine, based on the orientation of a physical stylus, to where in the physical environment the stylus is pointing. In some embodiments, based on this determination, the computer system determines the corresponding virtual position in the three-dimensional environment that corresponds to the location in the physical environment to which the stylus is pointing, and optionally determines that the stylus is pointing at the corresponding virtual position in the three-dimensional environment.

Similarly, the embodiments described herein may refer to the location of the user (e.g., the user of the computer system) and/or the location of the computer system in the three-dimensional environment. In some embodiments, the user of the computer system is holding, wearing, or otherwise located at or near the computer system. Thus, in some embodiments, the location of the computer system is used as a proxy for the location of the user. In some embodiments, the location of the computer system and/or user in the physical environment corresponds to a respective location in the three-dimensional environment. For example, the location of the computer system would be the location in the physical environment (and its corresponding location in the three-dimensional environment) from which, if a user were to stand at that location facing a respective portion of the physical environment that is visible via the display generation component, the user would see the objects in the physical environment in the same positions, orientations, and/or sizes as they are displayed by or visible via the display generation component of the computer system in the three-dimensional environment (e.g., in absolute terms and/or relative to each other). Similarly, if the virtual objects displayed in the three-dimensional environment were physical objects in the physical environment (e.g., placed at the same locations in the physical environment as they are in the three-dimensional environment, and having the same sizes and orientations in the physical environment as in the three-dimensional environment), the location of the computer system and/or user is the position from which the user would see the virtual objects in the physical environment in the same positions, orientations, and/or sizes as they are displayed by the display generation component of the computer system in the three-dimensional environment (e.g., in absolute terms and/or relative to each other and the real world objects).

In the present disclosure, various input methods are described with respect to interactions with a computer system. When an example is provided using one input device or input method and another example is provided using another input device or input method, it is to be understood that each example may be compatible with and optionally utilizes the input device or input method described with respect to another example. Similarly, various output methods are described with respect to interactions with a computer system. When an example is provided using one output device or output method and another example is provided using another output device or output method, it is to be understood that each example may be compatible with and optionally utilizes the output device or output method described with respect to another example. Similarly, various methods are described with respect to interactions with a virtual environment or a mixed reality environment through a computer system. When an example is provided using interactions with a virtual environment and another example is provided using mixed reality environment, it is to be understood that each example may be compatible with and optionally utilizes the methods described with respect to another example. As such, the present disclosure discloses embodiments that are combinations of the features of multiple examples, without exhaustively listing all features of an embodiment in the description of each example embodiment.

### User Interfaces and Associated Processes

Attention is now directed towards embodiments of user interfaces (“UI”) and associated processes that may be implemented on a computer system, such as portable multifunction device or a head-mounted device, with a display generation component, one or more input devices, and (optionally) one or more cameras.

FIGS. 7A-7V illustrate examples of a computer system facilitating interaction with virtual objects associated with virtual workspaces in a three-dimensional environment in accordance with some embodiments.

FIG. 7A illustrates a computer system 101 (e.g., an electronic device) displaying, via a display generation component (e.g., display generation component 120 of FIGS. 1 and 3), a three-dimensional environment 700 from a viewpoint of a user 702 in top-down view 705 of the three-dimensional environment 700 (e.g., facing the back wall of the physical environment in which computer system 101 is located).

In some embodiments, computer system 101 includes a display generation component 120. In FIG. 7A, the computer system 101 includes one or more internal image sensors 114a oriented towards the face of the user 702 (e.g., eye tracking cameras 540 described with reference to FIG. 5). In some embodiments, internal image sensors 114a are used for eye tracking (e.g., detecting a gaze of the user). Internal image sensors 114a are optionally arranged on the left and right portions of display generation component 120 to enable eye tracking of the user's left and right eyes. Computer system 101 also includes external image sensors 114b and 114c facing outwards from the user to detect and/or capture the physical environment and/or movements of the user's hands.

As shown in FIG. 7A, computer system 101 captures one or more images of the physical environment around computer system 101 (e.g., operating environment 100), including one or more objects in the physical environment around computer system 101. In some embodiments, computer system 101 displays representations of the physical environment in three-dimensional environment 700. For example, three-dimensional environment 700 includes a representation of a desk 704, which is optionally a representation of a physical desk in the physical environment.

As discussed in more detail below, in FIG. 7A, display generation component 120 is illustrated as displaying content in the three-dimensional environment 700. In some embodiments, the content is displayed by a single display (e.g., display 510 of FIG. 5) included in display generation component 120. In some embodiments, display generation component 120 includes two or more displays (e.g., left and right display panels for the left and right eyes of the user, respectively, as described with reference to FIG. 5) having displayed outputs that are merged (e.g., by the user's brain) to create the view of the content shown in FIGS. 7A-7V.

Display generation component 120 has a field of view (e.g., a field of view captured by external image sensors 114b and 114c and/or visible to the user via display generation component 120) that corresponds to the content shown in FIG. 7A. Because computer system 101 is optionally a head-mounted device, the field of view of display generation component 120 is optionally the same as or similar to the field of view of the user (e.g., indicated in the top-down view 705 in FIG. 7A).

As discussed herein, one or more air pinch gestures performed by a user (e.g., with hand 703) are detected by one or more input devices of computer system 101 and interpreted as one or more user inputs directed to content displayed by computer system 101. Additionally or alternatively, in some embodiments, the one or more user inputs interpreted by computer system 101 as being directed to content displayed by computer system 101 are detected via one or more hardware input devices (e.g., controllers) rather than via the one or more input devices that are configured to detect air gestures, such as the one or more air pinch gestures, performed by the user. Such depiction is intended to be exemplary rather than limiting; the user optionally provides user inputs using different air gestures and/or using other forms of input.

As mentioned above, the computer system 101 is configured to display content in the three-dimensional environment 700 using the display generation component 120. In FIG. 7A, three-dimensional environment 700 includes virtual objects 708 and 710. In some embodiments, the virtual objects 708 and 710 are user interfaces of applications containing content (e.g., a plurality of selectable options), three-dimensional objects (e.g., virtual clocks, virtual balls, virtual cars, etc.) or any other element displayed by computer system 101 that is not included in the physical environment of display generation component 120. For example, in FIG. 7A, the virtual object 708 is a user interface of a document-editing application containing editable content, such as editable text and/or images. As another example, in FIG. 7A, the virtual object 710 is a user interface of a presentation application containing presentation content, such as one or more slides and/or pages of text, images, video, hyperlinks, and/or audio content, associated with a presentation (e.g., a slideshow). It should be understood that the content discussed above is exemplary and that, in some embodiments, additional and/or alternative content and/or user interfaces are provided in the three-dimensional environment 700, such as the content described below with reference to methods 800, 1000 and/or 1200. In some embodiments, as described in more detail below, the virtual objects 708 and 710 are associated with a respective virtual workspace that is currently open/launched in the three-dimensional environment 700.

In some embodiments, as shown in FIG. 7A, the virtual objects 708 and 710 are displayed with movement elements 711a and 711b (e.g., grabber bars) in the three-dimensional environment 700. In some embodiments, the movement elements 711a and 711b are selectable to initiate movement of the corresponding virtual object within the three-dimensional environment 700 relative to the viewpoint of the user 702. For example, the movement element 711a that is associated with the virtual object 708 is selectable to initiate movement of the virtual object 708, and the movement element 711b that is associated with the virtual object 710 is selectable to initiate movement of the virtual object 710, within the three-dimensional environment 700.

In some embodiments, virtual objects are displayed in three-dimensional environment 700 at respective sizes relative to the viewpoint of user 702 (e.g., prior to receiving input interacting with the virtual objects, which will be described later, in three-dimensional environment 700). In some embodiments, virtual objects are displayed in three-dimensional environment 700 at respective locations relative to the viewpoint of user 702 (e.g., prior to receiving input interacting with the virtual objects, which will be described later, in three-dimensional environment 700). In some embodiments, virtual objects are displayed in three-dimensional environment 700 with respective orientations relative to the viewpoint of user 702 (e.g., prior to receiving input interacting with the virtual objects, which will be described later, in three-dimensional environment 700). It should be understood that the sizes, locations, and/or orientations of the virtual objects in FIGS. 7A-7V are merely exemplary and that other sizes are possible.

In some embodiments, the computer system 101 is configured to display content associated with a plurality of virtual workspaces in the three-dimensional environment 700, including facilitating interactions with the content of a respective virtual workspace when the respective virtual workspace is open/active in the three-dimensional environment 700. As mentioned above, the virtual objects 708 and 710 are optionally associated with a respective virtual workspace that is currently open in the three-dimensional environment 700. In some embodiments, while the virtual objects 708 and 710 are associated with the respective virtual workspace, a status of the content of the virtual objects 708 and 710 is preserved between instances of display of the respective virtual workspace in the three-dimensional environment 700. For example, the computer system 101 preserves the particular content of the user interfaces of the virtual objects 708 and 710 between instances of the display of the respective virtual workspace in the three-dimensional environment 700. Similarly, in some embodiments, as described in more detail below, the computer system 101 preserves a three-dimensional spatial arrangement of the virtual objects 708 and 710 relative to the viewpoint of the user 702 in the three-dimensional environment 700. For example, while the virtual objects 708 and 710 are associated with the respective virtual workspace, locations of the virtual objects 708 and 710, orientations of the virtual objects 708 and 710, and/or sizes of the virtual objects 708 and 710 relative to the viewpoint of the user 702 are preserved between instances of the display of the respective virtual workspace in the three-dimensional environment 700. Additional details regarding virtual workspaces are provided below with references to methods 800, 1000, and/or 1200.

In FIG. 7A, the computer system 101 detects an input corresponding to a request to close the respective virtual workspace that is currently open in the three-dimensional environment 700. For example, as shown in FIG. 7A, the computer system 101 detects a multi-press of hardware button or hardware element 740 of the computer system 101 provided by hand 703 of the user 702. In some embodiments, as illustrated in FIG. 7A, the multi-press of the hardware button 740 corresponds to a double press of the hardware button 740.

In some embodiments, as shown in FIG. 7B, in response to detecting the multi-press of the hardware button 740, the computer system 101 closes the respective virtual workspace in the three-dimensional environment 700. For example, as shown in FIG. 7B, the computer system 101 ceases display of the virtual objects 708 and 710 in the three-dimensional environment 700. In some embodiments, when the computer system 101 closes the respective virtual workspace in the three-dimensional environment 700, the computer system 101 displays virtual workspace selection user interface 720 in the three-dimensional environment 700. In some embodiments, the computer system 101 closes the respective virtual workspace using an animation. For example, as described in more detail with reference to method 800, the computer system 101 displays an animation of the virtual objects 708 and 710 gradually minimizing in size and/or ceasing to be displayed in the three-dimensional environment 700. In some embodiments, as shown in FIG. 7B, the virtual workspaces selection user interface 720 includes a plurality of representations (e.g., virtual bubbles or orbs) of a plurality of virtual workspaces that are able to be displayed (e.g., opened/launched) in the three-dimensional environment 700. For example, as shown in FIG. 7B, the virtual workspaces selection user interface 720 includes a first representation 722a of a first virtual workspace (e.g., a Home virtual workspace), a second representation 722b of a second virtual workspace (e.g., a Work virtual workspace), which optionally corresponds to the respective virtual workspace described above with reference to FIG. 7A, and a third representation 722c of a third virtual workspace (e.g., a Travel virtual workspace). In some embodiments, as shown in FIG. 7B, the plurality of representations of the plurality of virtual workspaces in the virtual workspaces selection user interface 720 includes representations of the content associated with the plurality of virtual workspaces. For example, in FIG. 7B, the first representation 722a includes representations 724-I and 726-I corresponding to user interfaces that are associated with the first virtual workspace, the second representation 722b includes representations 708-I and 710-I corresponding to the user interfaces associated with the second virtual workspace (e.g., virtual objects 708 and 710 in FIG. 7A above), and the third representation 722c includes representations 721-1, 723-1, 725-I, and 750-I corresponding to content associated with the third virtual workspace. In some embodiments, the representations of the content associated with the plurality of virtual workspaces correspond to miniature representations of the content associated with the plurality of virtual workspaces. For example, the representations 724-I and 726-I in the first representation 722a correspond to miniature representations of the virtual objects (e.g., virtual windows including user interfaces) that are associated with the first virtual workspace. Additionally, in some embodiments, the representations of the content associated with the plurality of virtual workspaces include a spatial arrangement that is based on the three-dimensional spatial arrangement of the content associated with the plurality of virtual workspaces. For example, as shown in FIG. 7B, the representations 724-I and 726-I in the first representation have a first three-dimensional spatial arrangement relative to the viewpoint of the user 702 that is based on and/or that corresponds to the three-dimensional spatial arrangement of the virtual objects that are associated with the first virtual workspace. In some embodiments, the representations of the content associated with the plurality of virtual workspaces correspond to icons representing the applications of the content associated with the plurality of virtual workspaces. For example, the representations 708-I and 710-I in the second representation 722b correspond to icons of the applications associated with the virtual objects 708 and 710 of FIG. 7A that are associated with the second virtual workspace.

Additionally, in some embodiments, a respective virtual workspace of the plurality of virtual workspaces is configured to be shared with one or more users (e.g., different from the user 702), such that the content of the respective virtual workspace is accessible to the one or more users (e.g., via respective computer systems associated with the one or more users). In some embodiments, a representation of a virtual workspace that is shared with one or more users includes one or more visual indications of the one or more users who have access to the virtual workspace. For example, in FIG. 7B, the third virtual workspace (e.g., Travel virtual workspace) is shared with users John and Jeremy. Accordingly, in some embodiments, as shown in FIG. 7B, the third representation 722c includes visual indications 714a and 714b indicating that the users John and Jeremy have access to the third virtual workspace. In some embodiments, the visual indications of the one or more users who have access to a respective virtual workspace include an indication of a status of interaction with the content of the respective virtual workspace. For example, as shown in FIG. 7B, the third representation 722c is displayed with active status indicator 716 (e.g., a checkmark) that indicates that the user John is currently active in the third virtual workspace (e.g., is currently interacting with the content of the third virtual workspace). In some embodiments, the indication that the user John is currently active in the third virtual workspace is further provided via the representation 725-I of the third representation 722c. For example, in FIG. 7B, the representation 725-I corresponds to a visual representation (e.g., an avatar) of John. Additional details regarding the virtual workspaces selection user interface 720 and the plurality of representations of the plurality of virtual workspaces are provided below with reference to methods 800, 1000, and/or 1200.

In FIG. 7B, while displaying the virtual workspaces selection user interface 720, the computer system 101 detects an input corresponding to a request to display (e.g., open/launch) the first virtual workspace in the three-dimensional environment 700. For example, as shown in FIG. 7B, the computer system 101 detects an air pinch gesture performed by the hand 703 of the user 702, optionally while attention of the user 702 (e.g., including gaze 712) is directed to the first representation 722a in the three-dimensional environment 700.

In some embodiments, as shown in FIG. 7C, in response to detecting the selection of the first representation 722a, the computer system 101 launches the first virtual workspace, which includes displaying the content associated with the first virtual workspace in the three-dimensional environment 700. For example, as shown in FIG. 7C, the computer system 101 displays virtual objects 724 and 726 in the three-dimensional environment 700, which optionally correspond to the representations 724-I and 726-I, respectively, included in the first representation 722a in FIG. 7B. In some embodiments, as shown in FIG. 7C, the virtual object 724 is a user interface of a document-viewing application containing content, such as text. Additionally, in FIG. 7C, the virtual object 726 is a user interface of an image-viewing application containing image-based content, such as images, photographs, video, sketches, and/or cartoons. In some embodiments, as similarly described above, the virtual objects 724 and 726 are displayed with movement elements 713a and 713b (e.g., grabber bars), respectively, that are selectable to initiate movement of the corresponding virtual object in the three-dimensional environment 700.

In FIG. 7C, while displaying the virtual objects 724 and 726, the computer system 101 detects an input corresponding to a request to move the virtual object 724 in the three-dimensional environment 700 relative to the viewpoint of the user 702. For example, as shown in FIG. 7C, the computer system 101 detects an air pinch and drag gesture provided by the hand 703 of the user 702, optionally while the attention of the user 702 (e.g., including the gaze 712) is directed to the movement element 713a associated with the virtual object 724 in the three-dimensional environment 700. In some embodiments, as indicated in FIG. 7C, the movement of the hand 703 corresponds to movement of the virtual object 724 diagonally leftward relative to the viewpoint of the user 702 and further from the viewpoint of the user 702.

In some embodiments, as shown in FIG. 7D, in response to detecting the input provided by the hand 703, the computer system 101 moves the virtual object 724 in the three-dimensional environment 700 relative to the viewpoint of the user 702 in accordance with the movement of the hand 703. For example, as shown in FIG. 7D, the computer system 101 moves the virtual object 724 leftward and upward (e.g., vertically) in the three-dimensional environment 700 relative to the viewpoint of the user 702. Additionally, as illustrated in the top-down view 705 in FIG. 7D, the computer system 101 moves the virtual object 724 farther from the viewpoint of the user 702 in the three-dimensional environment 700 in accordance with the movement of the hand 703. In some embodiments, the movement of the virtual object 724 in the three-dimensional environment 700 in FIG. 7D corresponds to an event that causes the three-dimensional spatial arrangement of the virtual objects 724 and 726 to be updated in the first virtual workspace relative to the viewpoint of the user 702. For example, as indicated in the top-down view 705 in FIG. 7D, the movement of the virtual object 724 causes the virtual objects 724 and 726 to be located farther apart in the first virtual workspace relative to the viewpoint of the user 702 and causes the virtual object 724 to be located farther from the viewpoint of the user 702 than the virtual object 726 in the first virtual workspace as compared to FIG. 7C.

In FIG. 7D, the computer system 101 detects a sequence of inputs corresponding to a request to display additional content (e.g., open an additional application) in the three-dimensional environment 700. For example, as shown in FIG. 7D, the computer system 101 detects a press (e.g., a single press, as opposed to a multi-press) of the hardware button 740 provided by hand 703a of the user 702. In some embodiments, in response to detecting the press of the hardware button 740, the computer system 101 displays home user interface 730 in the three-dimensional environment 700 (e.g., as opposed to the virtual workspaces selection user interface 720). In some embodiments, the home user interface 730 corresponds to a home user interface of the computer system 101 that includes a plurality of selectable icons associated with respective applications configured to be run on the computer system 101. In FIG. 7D, after displaying the home user interface 730, the computer system 101 detects an input provided by the hand 703 corresponding to a selection of a first icon 731a of the plurality of icons of the home user interface 730 in the three-dimensional environment 700. For example, as shown in FIG. 7D, the computer system 101 detects an air pinch gesture performed by the hand 703b, optionally while the attention (e.g., including gaze 712) is directed to the first icon 731a in the three-dimensional environment 700.

In some embodiments, the first icon 731a is associated with a first application that is configured to be run on the computer system 101. Particularly, in some embodiments, the first icon 731a is associated with a music player application corresponding to and/or including music-based content that is able to be output by the computer system 101. In some embodiments, as shown in FIG. 7E, in response to detecting the selection of the first icon 731a, the computer system 101 displays virtual object 728 corresponding to the music player application in the three-dimensional environment 700.

In some embodiments, when the virtual object 728 is displayed in the three-dimensional environment 700, the virtual object 728 becomes associated with the first virtual workspace along with the virtual objects 724 and 726. For example, as similarly discussed above, the computer system 101 preserves a three-dimensional spatial arrangement of the virtual objects 724-728 relative to the viewpoint of the user 702 and/or preserves a display status of the content of the virtual objects 724-728 in the first virtual workspace between instances of display of the first virtual workspace in the three-dimensional environment 700. In some embodiments, as shown in the top-down view 705 in FIG. 7E, in the three-dimensional spatial arrangement of the virtual objects 724-728, the virtual object 728 is displayed closer to the viewpoint of the user 702 than the virtual objects 724 and 726.

In FIG. 7E, the computer system 101 detects an input corresponding to a request to close the first virtual workspace that is currently open in the three-dimensional environment 700. For example, as shown in FIG. 7E, the computer system 101 detects a multi-press (e.g., a double press) of hardware button 740 of the computer system 101 provided by hand 703 of the user 702.

In some embodiments, as shown in FIG. 7F, in response to detecting the multi-press of the hardware button 740, the computer system 101 closes the first virtual workspace in the three-dimensional environment 700. For example, as shown in FIG. 7F, the computer system 101 ceases display of the virtual objects 724-728 in the three-dimensional environment 700. In some embodiments, as similarly discussed above, when the computer system 101 closes the first virtual workspace in the three-dimensional environment 700, the computer system 101 displays the virtual workspaces selection user interface 720 in the three-dimensional environment 700, as shown in FIG. 7F. In some embodiments, as shown in FIG. 7F, when the virtual workspaces selection user interface 720 is displayed in the three-dimensional environment 700, the first representation 722a of the first virtual workspace is updated to reflect the interactions discussed above with reference to FIGS. 7C-7E. For example, as shown in FIG. 7F, the representation 724-I in the first representation 722a is updated based on the movement of the virtual object 724 within the first virtual workspace relative to the viewpoint of the user 702 (e.g., the representation 724-I is located farther from the representation 726-I and is farther from the viewpoint of the user 702). Additionally, as shown in FIG. 7F, the first representation 722a of the first virtual workspace is updated to include representation 728-I corresponding to the virtual object 728 discussed above (e.g., which was not displayed in the first virtual workspace when the virtual workspace selection user interface was last displayed in FIG. 7B).

In some embodiments, the virtual workspace selection user interface 720 is configured to be scrollable (e.g., horizontally scrollable) in the three-dimensional environment 700 to reveal (e.g., display) one or more additional representations of virtual workspaces of the plurality of virtual workspaces. For example, in FIG. 7F, the computer system 101 detects an input provided by the hand 703 of the user 702 corresponding to a request to scroll the virtual workspace selection user interface 720 leftward in the three-dimensional environment 700 relative to the viewpoint of the user 702. In some embodiments, the input corresponds to an air pinch and drag gesture performed by the hand 703, optionally while the attention (e.g., including the gaze 712) is directed to the virtual workspace selection user interface 720.

In some embodiments, as shown in FIG. 7G, in response to detecting the input provided by the hand 703, the computer system 101 scrolls the virtual workspace selection user interface 720 in the three-dimensional environment 700. For example, as shown in FIG. 7G, the computer system 101 scrolls the virtual workspace selection user interface 720 leftward relative to the viewpoint of the user 702, which causes a fourth representation 722d of a fourth virtual workspace (e.g., Meditation virtual workspace) to be displayed in the three-dimensional environment 700. In some embodiments, as shown in FIG. 7G, the fourth representation 722d includes representation 729-1 corresponding to the content that is associated with the fourth virtual workspace, such as a meditation application that is open in the fourth virtual workspace. Additionally, in some embodiments, as shown in FIG. 7G and as similarly discussed above, the fourth virtual workspace is shared with user Tyler who is currently active in the fourth virtual workspace. Accordingly, as shown in FIG. 7G, the fourth representation 722d is displayed with visual indication 714c and active status indicator 716 that indicate that user Tyler is currently active in the fourth virtual workspace, as further indicated by the inclusion of representation 727-I (e.g., corresponding to an avatar of Tyler).

Additionally, in some embodiments, as shown in FIG. 7G, when the virtual workspace selection user interface 720 is scrolled in the three-dimensional environment 700, the computer system 101 displays selectable option 735 in the virtual workspace selection user interface 720. In some embodiments, the selectable option 735 is selectable to initiate a process to create a new virtual workspace at the computer system 101, as described in more detail later.

In FIG. 7G, while displaying the virtual workspaces selection user interface 720, the computer system 101 detects an input corresponding to a request to display (e.g., open/launch) the third virtual workspace in the three-dimensional environment 700. For example, as shown in FIG. 7G, the computer system 101 detects an air pinch gesture performed by the hand 703 of the user 702, optionally while attention of the user 702 (e.g., including gaze 712) is directed to the third representation 722c in the three-dimensional environment 700.

In some embodiments, as shown in FIG. 7H, in response to detecting the selection of the third representation 722c, the computer system 101 launches the third virtual workspace, which includes displaying the content associated with the third virtual workspace in the three-dimensional environment 700. For example, as shown in FIG. 7H, the computer system 101 displays virtual objects 721 and 723 in the three-dimensional environment 700, which optionally correspond to the representations 721-I and 723-I, respectively, included in the third representation 722c in FIG. 7I. In some embodiments, as shown in FIG. 7H, the virtual object 721 is a user interface of a music player application, such as the music player application described above with reference to FIG. 7E. Additionally, in FIG. 7H, the virtual object 723 is a three-dimensional model, such as a three-dimensional virtual campfire. In some embodiments, as similarly described above, the virtual objects 721 and 723 are displayed with movement elements 715a and 715b (e.g., grabber bars), respectively, that are selectable to initiate movement of the corresponding virtual object in the three-dimensional environment 700. In some embodiments, as previously discussed above, because a user (e.g., John) is currently active in the third virtual workspace, the computer system 101 displays visual representation 725 (e.g., an avatar) of the user who is currently active in the third virtual workspace.

In some embodiments, a respective virtual workspace includes a virtual environment within which the content associated with the respective virtual workspace is displayed in the three-dimensional environment 700. For example, as shown in FIG. 7H, when the third virtual workspace is displayed in the three-dimensional environment 700, the computer system displays virtual environment 750 (e.g., a virtual mountains environment) within which the virtual objects 721 and 723 and the visual representation 725 are displayed in the three-dimensional environment 700. Additional details regarding the display of virtual environments within virtual workspaces are provided below with reference to method 800.

In FIG. 7H, the computer system 101 detects an input corresponding to a request to move the virtual object 721 in the three-dimensional environment 700 relative to the viewpoint of the user 702. For example, as shown in FIG. 7H, the computer system 101 detects an air pinch and drag gesture provided by the hand 703 of the user 702, optionally while the attention of the user 702 (e.g., including the gaze 712) is directed to the movement element 715a associated with the virtual object 721 in the three-dimensional environment 700. In some embodiments, as indicated in FIG. 7H, the movement of the hand 703 corresponds to movement of the virtual object 721 leftward relative to the viewpoint of the user 702.

In some embodiments, as shown in FIG. 7I, in response to detecting the input provided by the hand 703, the computer system 101 moves the virtual object 721 in the three-dimensional environment 700 relative to the viewpoint of the user 702 in accordance with the movement of the hand 703. For example, as shown in FIG. 7I, the computer system 101 moves the virtual object 721 leftward in the three-dimensional environment 700 relative to the viewpoint of the user 702. Additionally, as illustrated in the top-down view 705 in FIG. 7I, the computer system 101 moves the virtual object 721 farther from the viewpoint of the user 702 in the three-dimensional environment 700 in accordance with the movement of the hand 703. In some embodiments, the movement of the virtual object 724 in the three-dimensional environment 700 in FIG. 7I corresponds to an event that causes the three-dimensional spatial arrangement of the virtual objects 721 and 723 to be updated in the third virtual workspace relative to the viewpoint of the user 702. For example, as indicated in the top-down view 705 in FIG. 7I, the movement of the virtual object 721 causes the virtual objects 721 and 723 to be located farther apart in the third virtual workspace relative to the viewpoint of the user 702 and causes the virtual object 721 to be located farther from the viewpoint of the user 702 than the virtual object 723 in the third virtual workspace as compared to FIG. 7H.

In FIG. 7I, the computer system 101 detects an input corresponding to a request to close the third virtual workspace that is currently open in the three-dimensional environment 700. For example, as shown in FIG. 7I, the computer system 101 detects a multi-press (e.g., a double press) of hardware button 740 of the computer system 101 provided by hand 703 of the user 702.

In some embodiments, as shown in FIG. 7J, in response to detecting the multi-press of the hardware button 740, the computer system 101 closes the third virtual workspace in the three-dimensional environment 700. For example, as shown in FIG. 7J, the computer system 101 ceases display of the virtual objects 721 and 723, the visual representation 725, and the virtual environment 750 in the three-dimensional environment 700 and displays the virtual workspaces selection user interface 720 in the three-dimensional environment 700. In some embodiments, as shown in FIG. 7J, when the virtual workspaces selection user interface 720 is displayed in the three-dimensional environment 700, the third representation 722c of the third virtual workspace is updated to reflect the interactions discussed above with reference to FIGS. 7H-71. For example, as shown in FIG. 7J, the representation 721-I in the third representation 722c is updated based on the movement of the virtual object 721 within the third virtual workspace relative to the viewpoint of the user 702 (e.g., the representation 721-I is located farther from the representation 723-I and is farther from the viewpoint of the user 702).

In FIG. 7J, the computer system 101 detects an input provided by the hand 703 of the user 702 corresponding to a request to scroll the virtual workspaces selection user interface 720 rightward in the three-dimensional environment 700 relative to the viewpoint of the user 702. In some embodiments, the input corresponds to an air pinch and drag gesture performed by the hand 703, optionally while the attention (e.g., including the gaze 712) is directed to the virtual workspaces selection user interface 720.

In some embodiments, as shown in FIG. 7K, in response to detecting the input provided by the hand 703, the computer system 101 scrolls the virtual workspaces selection user interface 720 in the three-dimensional environment 700. For example, as shown in FIG. 7K, the computer system 101 scrolls the virtual workspaces selection user interface 720 rightward relative to the viewpoint of the user 702, which causes the first representation 722a of the first virtual workspace and the second representation 722b of the second virtual workspace to be redisplayed in the three-dimensional environment 700. In FIG. 7K, after scrolling the virtual workspaces selection user interface 720, the computer system 101 detects a selection of the first representation 722a provided by the hand 703 (e.g., via an air pinch gesture while the gaze 712 is directed to the first representation 722a in the three-dimensional environment 700).

In some embodiments, as shown in FIG. 7L, in response to detecting the selection of the first representation 722a, the computer system 101 redisplays the first virtual workspace in the three-dimensional environment 700. For example, as shown in FIG. 7L, the computer system redisplays the virtual objects 724-726 in the three-dimensional environment 700. In some embodiments, as illustrated in FIG. 7L, when the virtual objects 724-728 are redisplayed in the three-dimensional environment 700, the three-dimensional spatial arrangement of the virtual objects 724-728 is preserved since the last instance of display of the first virtual workspace in the three-dimensional environment 700. For example, the positions, orientations, and/or sizes of the virtual objects 724-726 are maintained relative to the viewpoint of the user 702 since the last instance of the display of the first virtual workspace in FIG. 7E. Additionally, in some embodiments, the status of the content of the virtual objects 724-726 is preserved since the last instance of display of the first virtual workspace in the three-dimensional environment 700. Particularly, in FIG. 7L, the three-dimensional spatial arrangement of the virtual objects 724-728 and the state of the content of the virtual objects 724-728 are preserved/maintained because user input (e.g., provided by the user 702 or other users who have access to the first virtual workspace) have not interacted with the virtual objects 724-728 in such a way that causes the three-dimensional spatial arrangement or the content of the virtual objects 724-728 to change since the first virtual workspace was last displayed in the three-dimensional environment 700.

In some embodiments, interactions with content associated with an application within one virtual workspace do not affect the state of the content associated with the same application in a different virtual workspace. For example, the movement of the virtual object 721 within the third virtual workspace described previously above with reference to FIG. 7I does not cause the virtual object 728 to be moved within the first virtual workspace as indicated in FIG. 7L, despite the virtual objects 721 and 728 being associated with the same application (e.g., the music player application).

In FIG. 7M, the computer system 101 detects an input corresponding to a request to redisplay the virtual workspaces selection user interface in the three-dimensional environment 700. For example, as shown in FIG. 7M and as similarly discussed above, the computer system 101 detects a multi-press of the hardware button 740 provided by the hand 703 of the user 702.

In some embodiments, as similarly discussed above, in response to detecting the multi-press of the hardware button 740, as shown in FIG. 7N, the computer system 101 displays the virtual workspaces selection user interface 720 in the three-dimensional environment 700. In some embodiments, the plurality of representations of the plurality of virtual workspaces is displayed as world locked objects in the three-dimensional environment 700. For example, as indicated by the dashed arrow in the top-down view 705 in FIG. 7N, the computer system 101 detects movement of the viewpoint of the user 702 relative to the three-dimensional environment 700. As an example, the computer system 101 detects (e.g., via one or more motion sensors of the computer system 101) the user 702 walk to a side of the desk 704 in the physical environment, which causes the computer system 101 to also be moved within the physical environment, thereby changing the viewpoint of the user 702.

In some embodiments, as shown in FIG. 7O, when the viewpoint of the user 702 changes, the view of the three-dimensional environment 700 is updated based on the updated viewpoint of the user 702. For example, as shown in FIG. 7O, because the viewpoint of the user 702 is positioned at a corner of the desk 704 in the physical environment, the view of the representation of the desk 704 is visually updated to be from the side/corner of the desk 704 in the three-dimensional environment 700. Additionally, in some embodiments, because the plurality of representations of the plurality of virtual objects in the virtual workspaces selection user interface 720 is displayed as world locked objects in the three-dimensional environment 700, the view of the plurality of representations is updated based on the updated viewpoint of the user 702. For example, as shown in FIG. 7O, the computer system 101 updates the view of the first representation 722a, the second representation 722b, and the third representation 722c based on the updated viewpoint of the user 702, which includes providing updated views of the representations of the content associated with the first virtual workspace, the second virtual workspace, and the third virtual workspace, respectively.

In FIG. 7O, the computer system 101 detects further movement of the viewpoint of the user 702. For example, as shown by the dashed arrow in the top-down view 705 in FIG. 7O, the computer system 101 detects movement of the user 702 in the physical environment to be repositioned in front of the desk 704 in the physical environment, which causes the computer system 101 to also be moved within the physical environment, thereby changing the viewpoint of the user 702, as similarly discussed above.

In some embodiments, as shown in FIG. 7P, as similarly discussed above, in response to detecting the movement of the viewpoint of the user 702, the computer system 101 updates the view of the three-dimensional environment 700 based on the updated viewpoint of the user 702. For example, as shown in FIG. 7P, because the viewpoint of the user 702 is repositioned in front of the desk 704 in the physical environment, the view of the representation of the desk 704 and the virtual workspaces selection user interface 720 are visually updated to be from the front of the desk 704 in the three-dimensional environment 700. Additionally, as indicated in FIG. 7P, the computer system 101 determines that the user Tyler is no longer currently active in the fourth virtual workspace. Accordingly, in some embodiments, as shown in FIG. 7P, the visual indication 714c is no longer displayed with the active status indicator 716 and the fourth representation 722d of the fourth virtual workspace no longer includes the representation 727-I (e.g., corresponding to a visual representation of the user Tyler).

In FIG. 7P, while displaying the virtual workspaces selection user interface 720 in the three-dimensional environment 700, the computer system 101 detects a selection of the selectable option 735. For example, as shown in FIG. 7P, the computer system 101 detects an air pinch gesture performed by the hand 703 of the user 702, optionally while the attention (e.g., including the gaze 712) is directed to the selectable option 735 in the three-dimensional environment 700.

In some embodiments, as shown in FIG. 7Q, in response to detecting the selection of the selectable option 735, the computer system 101 initiates a process to create a new virtual workspace, as similarly discussed above. In some embodiments, as shown in FIG. 7Q, initiating the process to create a new virtual workspace includes ceasing display of the virtual workspaces selection user interface 720 and displaying the home user interface 730 including the plurality of icons associated with applications discussed previously above. In some embodiments, the display of the home user interface 730 in response to detecting the selection of the selectable option 735 enables the user 702 to easily select and/or open applications from which content will be associated with the new virtual workspace. For example, in FIG. 7Q, the computer system 101 detects a sequence of inputs corresponding to a request to display content from multiple applications in the three-dimensional environment 700. In some embodiments, as shown in FIG. 7Q, the computer system 101 detects a first input corresponding to a selection of second icon 731b in the home user interface 730, such as via an air pinch gesture provided by the hand 703 while the attention (e.g., including the gaze 712) is directed to the second icon 731b, and a second input corresponding to a selection of third icon 731c in the home user interface 730, such as via an air pinch gesture provided by the hand 703 while the attention (e.g., including the gaze 712) is directed to the third icon 731c. In some embodiments, the first input and the second input are detected sequentially.

In some embodiments, as shown in FIG. 7R, in response to detecting the sequence of inputs discussed above, the computer system 101 displays content from applications associated with the second icon 731b and the third icon 731c. For example, the second icon 731b is associated with a messaging application (e.g., a text-messaging application) and the third icon 731c is associated with an email application. Accordingly, in FIG. 7R, in response to detecting the selection of the second icon 731b, the computer system 101 optionally displays virtual object 734 that is or includes a mail user interface (e.g., including a plurality of indications of emails), and in response to detecting the selection of the third icon 731c, the computer system 101 optionally displays virtual object 736 that is or includes a messaging user interface (e.g., including a text messaging thread with user John). Thus, as similarly discussed herein, the display of the virtual objects 734 and 736 in the three-dimensional environment 700 causes the content of the virtual objects 734 and 736 to become associated with the new virtual workspace. In some embodiments, as similarly described above, the virtual objects 734 and 736 are displayed with movement elements 717a and 717b, respectively, that are selectable to initiate movement of the corresponding virtual object in the three-dimensional environment 700.

In FIG. 7R, after displaying the virtual objects 734 and 736 in the three-dimensional environment 700, the computer system 101 detects an input corresponding to a request to redisplay the home user interface 730. For example, as shown in FIG. 7R, the computer system 101 detects a press (e.g., a single press, as opposed to a multi-press) of the hardware button 740 of the computer system 101.

In some embodiments, as shown in FIG. 7S, in response to detecting the press of the hardware button 740, the computer system 101 redisplays the home user interface 730 in the three-dimensional environment 700. In some embodiments, the home user interface 730 includes tabs that are selectable to display alternative user interfaces of the home user interface 730. For example, in FIG. 7S, tab 730-1 is currently selected (e.g., by default) when the home user interface 730 is displayed in the three-dimensional environment 700, which causes the home user interface to include the plurality of icons associated with applications of the computer system 101 discussed above. As shown in FIG. 7S, in some embodiments, the home user interface 730 includes tab 730-2 that is associated with virtual environments that are able to be displayed in the three-dimensional environment 700.

In FIG. 7S, while displaying the home user interface 730, the computer system 101 detects a selection of the tab 730-2. For example, as shown in FIG. 7S, the computer system 101 detects an air pinch gesture performed by the hand 703 while the attention (e.g., including the gaze 712) of the user 702 is directed to the tab 730-2 in the home user interface 730.

In some embodiments, as shown in FIG. 7T, in response to detecting the selection of the tab 730-2, the computer system 101 updates the home user interface 730 from including the plurality of icons associated with applications on the computer system 101 to a plurality of icons associated with virtual environments that are able to be displayed in the three-dimensional environment 700. In some embodiments, the plurality of icons is selectable to display a corresponding virtual environment, such as a beach environment, a desert environment, a mountain environment, or a desert environment, in the three-dimensional environment 700.

In FIG. 7T, the computer system 101 detects a selection of icon 733 that is associated with a beach virtual environment. For example, as shown in FIG. 7T, the computer system 101 detects an air pinch gesture provided by the hand 703 while the attention (e.g., including the gaze 712) of the user 702 is directed to the icon 733 in the three-dimensional environment 700.

In some embodiments, as shown in FIG. 7U, in response to detecting the selection of the icon 733, the computer system 101 displays virtual environment 752 in the three-dimensional environment 700. In some embodiments, as mentioned above, the virtual environment 752 corresponds to a virtual beach environment, as shown in FIG. 7U. Additionally, in some embodiments, when the virtual environment 752 is displayed in the three-dimensional environment 700, the virtual objects 734 and 736 are displayed within the virtual environment 752 from the viewpoint of the user 702. In some embodiments, as similarly described above, when the computer system 101 displays the virtual environment 752 in the three-dimensional environment 700, the computer system 101 associates the virtual environment 752 with the new virtual workspace.

In FIG. 7U, after displaying the virtual environment 752 in the three-dimensional environment 700, the computer system 101 detects an input corresponding to a request to redisplay the virtual workspaces selection user interface in the three-dimensional environment 700. For example, as shown in FIG. 7U, the computer system 101 detects a multi-press of the hardware button 740 provided by the hand 703 of the user 702.

In some embodiments, as shown in FIG. 7V, in response to detecting the multi-press of the hardware button 740, the computer system 101 closes the new virtual workspace and redisplays the virtual workspaces selection user interface 720 in the three-dimensional environment 700. For example, as shown in FIG. 7V and as similarly discussed above, the computer system 101 ceases display of the virtual objects 734 and 736 and the virtual environment 752 in the three-dimensional environment 700 and redisplays the virtual workspaces selection user interface 720. In some embodiments, as shown in FIG. 7V, when the virtual workspaces selection user interface 720 is redisplayed in the three-dimensional environment 700, the computer system 101 generates and displays a fifth representation 722e of a fifth virtual workspace corresponding to the new virtual workspace discussed above (e.g., titled Communication by the user 702). In some embodiments, as shown in FIG. 7V, the fifth representation 722e includes representations of the content associated with the fifth virtual workspace discussed above. For example, as similarly described herein, the fifth representation 722e includes representations 734-I and 736-I corresponding to the virtual objects 734 and 736, respectively, described above and representation 752-I corresponding to the virtual environment 752 described above. Additionally, as similarly described herein, as shown in FIG. 7V, the representations 734-I and 736-I have a three-dimensional spatial arrangement within the fifth representation 722e that is based on the three-dimensional spatial arrangement of the virtual objects 734 and 736 in the fifth virtual workspace. For example, a size, orientation, and/or position of the representations 734-I and 736-I are based on a size, orientation, and/or position of the virtual objects 734 and 736 within the fifth virtual workspace relative to the viewpoint of the user 702.

FIG. 8 is a flowchart illustrating an exemplary method 800 of facilitating interaction with virtual objects associated with virtual workspaces in a three-dimensional environment in accordance with some embodiments. In some embodiments, the method 800 is performed at a computer system (e.g., computer system 101 in FIG. 1 such as a tablet, smartphone, wearable computer, or head mounted device) including a display generation component (e.g., display generation component 120 in FIGS. 1, 3, and 4) (e.g., a heads-up display, a display, a touchscreen, and/or a projector) and one or more cameras (e.g., a camera (e.g., color sensors, infrared sensors, and other depth-sensing cameras) that points downward at a user's hand or a camera that points forward from the user's head). In some embodiments, the method 800 is governed by instructions that are stored in a non-transitory computer-readable storage medium and that are executed by one or more processors of a computer system, such as the one or more processors 202 of computer system 101 (e.g., control unit 110 in FIG. 1A). Some operations in method 800 are, optionally, combined and/or the order of some operations is, optionally, changed.

In some embodiments, method 800 is performed at a computer system (e.g., computer system 101 in FIG. 7A) in communication with one or more display generation components (e.g., display 120) and one or more input devices (e.g., image sensors 114a-114c). For example, the computer system is or includes a mobile device (e.g., a tablet, a smartphone, a media player, or a wearable device), or a computer. In some embodiments, the one or more display generation components include a display integrated with the electronic device (optionally a touch screen display), external display such as a monitor, projector, television, or a hardware component (optionally integrated or external) for projecting a user interface or causing a user interface to be visible to one or more users. In some embodiments, the one or more input devices include an electronic device or component capable of receiving a user input (e.g., capturing a user input or detecting a user input) and transmitting information associated with the user input to the electronic device. Examples of input devices include a touch screen, mouse (e.g., external), trackpad (optionally integrated or external), touchpad (optionally integrated or external), remote control device (e.g., external), another mobile device (e.g., separate from the electronic device), a handheld device (e.g., external), a controller (e.g., external), a camera, a depth sensor, an eye tracking device, and/or a motion sensor (e.g., a hand tracking device, or a hand motion sensor). In some embodiments, the computer system is in communication with a hand tracking device (e.g., one or more cameras, depth sensors, proximity sensors, touch sensors (e.g., a touch screen, trackpad). In some embodiments, the hand tracking device is a wearable device, such as a smart glove. In some embodiments, the hand tracking device is a handheld input device, such as a remote control or stylus.

In some embodiments, while displaying, via the one or more display generation components, a first group of objects (e.g., a first group of one or more virtual objects) in a three-dimensional environment, wherein the first group of objects has one or more first visual characteristics, including a first spatial arrangement (e.g., first positions and/or first orientations that are, optionally, distributed in the three-dimensional environment so that they cannot be contained in a single plane (e.g., distributed in a non-planar manner)), such as the spatial arrangement of virtual objects 708 and 710 in three-dimensional environment 700 in FIG. 7A, wherein the first spatial arrangement is a three-dimensional arrangement of the first group of objects in the three-dimensional environment, the computer system detects (802), via the one or more input devices, a first input corresponding to a request to display one or more graphical user interface objects, such as a multi-press of hardware element 740 provided by hand 703 in FIG. 7A. For example, the three-dimensional environment is generated, displayed, or otherwise caused to be viewable by the computer system (e.g., an extended reality (XR) environment such as a virtual reality (VR) environment, a mixed reality (MR) environment, or an augmented reality (AR) environment). In some embodiments, a physical environment surrounding the display generation component is visible through a transparent portion of the display generation component (e.g., true or real passthrough). For example, a representation of the physical environment is displayed in the three-dimensional environment via the display generation component (e.g., virtual or video passthrough). In some embodiments, the first group of objects is generated by the computer system and/or is or includes content (e.g., user interfaces), such as one or more of a window of a web browsing application displaying content (e.g., text, images, or video), a window displaying a photograph or video clip, a media player window for controlling playback of content items on the computer system, a contact card in a contacts application displaying contact information (e.g., phone number email address, and/or birthday) and a virtual boardgame of a gaming application. In some embodiments, the first group of objects is associated with a virtual workspace within the three-dimensional environment. For example, the virtual workspace is accessible by a user of the computer system. In some embodiments, the virtual workspace is specifically associated with (e.g., anchored to) the physical environment surrounding the display generation component. For example, the virtual workspace is assigned to the physical environment and is configured to be displayed in the three-dimensional environment while the computer system is located in the physical environment. In some embodiments, the virtual workspace is associated with a particular object (e.g., physical object) in the physical environment, such as a table, desk, wall, shelf, and/or other object located in the physical environment. In some embodiments, the virtual workspace becomes associated with the physical environment via user input detected at the computer system. For example, the virtual workspace is assigned to the current physical environment of the user/computer system (e.g., and/or a particular object in the physical environment) when the computer system detects input corresponding to a request to create a virtual workspace (e.g., the computer system associates the virtual workspace with the current location of the computer system). As another example, the virtual workspace is associated with a particular physical environment in response to detecting user input manually selecting/designating the physical environment (e.g., via one or more settings and/or options associated with the virtual workspace). In some embodiments, a plurality of virtual workspaces is associated with a same physical environment, such as the physical environment discussed above. In some embodiments, a virtual workspace is configured to contain/house content, such as the first group of objects discussed above. For example, after a respective virtual workspace has been created, as described in more detail below, the computer system detects one or more inputs for displaying one or more objects in the three-dimensional environment (e.g., selection of a respective icon associated with an application corresponding to a respective object of the first group of objects). In some embodiments, as discussed herein below, the virtual workspace includes the first group of objects that are arranged in the first spatial arrangement irrespective of the particular physical (or virtual) environment in which the virtual workspace is launched. In some embodiments, once one or more objects are displayed in the three-dimensional environment while a virtual workspace is open/active, the one or more objects become associated with the virtual workspace. In some embodiments, the one or more objects become associated with the virtual workspace once the computer system detects input corresponding to interaction with content of the one or more objects. For example, a virtual object becomes associated with a virtual workspace after the computer system detects input moving the virtual object, selecting and/or otherwise interacting with an option or toggle within the virtual object, rotating the virtual object, and/or entering content into the virtual object, such as text or an image. Accordingly, in some embodiments, the first group of objects is associated with a first virtual workspace in the three-dimensional environment. In some embodiments, displaying/launching a respective virtual workspace in the three-dimensional environment causes the computer system to display the content that is associated with the respective virtual workspace in the three-dimensional environment. For example, the first group of objects discussed above is displayed in the three-dimensional environment in response to detecting an input corresponding to a request to launch the first virtual workspace. In some embodiments, a respective virtual workspace is able to be selected for display from a list of virtual workspaces, such as from the one or more graphical user interface objects described below. In some embodiments, the virtual workspaces are associated with a respective application running on the computer system, as described in more detail below.

In some embodiments, while the first group of objects is displayed in the three-dimensional environment, the first group of objects has one or more first visual characteristics, including a first spatial arrangement in the three-dimensional environment. In some embodiments, the one or more first visual characteristics include one or more first locations of the first group of objects relative to the viewpoint of the user, one or more first orientations of the first group of objects relative to the viewpoint of the user, one or more first brightness levels of the first group of objects, one or more first translucency levels of the first group of objects, one or more first colors of the first group of objects, and/or one or more first sizes of the first group of objects. In some embodiments, while the first group of objects is displayed in the first spatial arrangement in the three-dimensional environment, a first object of the first group of objects is displayed at a first location relative to the viewpoint of the user and a second object, different from the first object, of the first group of objects is displayed at a second location, different from the first location, relative to the viewpoint of the user. Additionally, in some embodiments, the first location of the first object is a first distance from the second location of the second object in the three-dimensional environment from the viewpoint of the user. In some embodiments, the first group of objects has the one or more first visual characteristics while the first virtual workspace discussed above is open/active in the three-dimensional environment. In some embodiments, the one or more first visual characteristics are based on and/or determined by user input directed to the first group of objects in the three-dimensional environment. For example, the first group of objects has the first spatial arrangement in the three-dimensional environment due to user input positioning (e.g., moving) one or more objects of the first group of objects to one or more first locations and/or one or more first orientations relative to the viewpoint of the user in the three-dimensional environment.

In some embodiments, the first input corresponding to the request to display the one or more graphical user interface objects includes interaction with a hardware control (e.g., physical button or dial) of the computer system for requesting the display of the one or more graphical user interface objects, such as a press, click, and/or rotation of the hardware control. In some embodiments, the interaction with the hardware control includes a double press or click (e.g., two sequential selections of the hardware control), a triple press or click, or other particular interaction and/or manipulation of the hardware control. In some embodiments, the first input corresponding to the request to display the one or more graphical user interface objects includes interaction with a virtual button displayed in the three-dimensional environment for requesting the display of the one or more graphical user interface objects. For example, the computer system detects an air pinch gesture performed by a hand of the user of the computer system-such as the thumb and index finger of the hand of the user starting more than a threshold distance (e.g., 0.1, 0.2, 0.5, 1, 2, or 5 cm) apart and coming together and touching at the tips—while attention (e.g., including gaze) of the user is directed toward the virtual button in the three-dimensional environment.

In some embodiments, in response to detecting the first input (804), the computer system displays (806), via the display generation component, a user interface including a plurality of graphical user interface objects in the three-dimensional environment, such as displaying virtual workspaces selection user interface 720 as shown in FIG. 7B. For example, as described in more detail below, the computer system displays a virtual workspaces selection user interface in the three-dimensional environment. In some embodiments, the one or more graphical user interface objects correspond to representations of virtual workspaces that are able to be opened/launched in the three-dimensional environment (e.g., in response to the computer system detecting a selection of a respective representation of a respective virtual workspace). In some embodiments, the one or more graphical user interface objects are displayed as a scrollable list in the user interface, such as a horizontally or vertically scrollable list of icons. In some embodiments, the one or more graphical user interface objects include a name, title, or other identifier of the corresponding virtual workspace (e.g., a label denoting a Home virtual workspace or a Work virtual workspace). In some embodiments, the one or more graphical user interface objects include a graphical user interface object that is selectable to add and/or create a new virtual workspace (optionally associated with the current location of the computer system).

In some embodiments, while displaying the user interface that includes the plurality of graphical user interface objects, the computer system detects (808), via the one or more input devices, a second input that includes selection of a respective graphical user interface object of the one or more graphical user interface objects, such as selection of first representation 722a provided by the hand 703 as shown in FIG. 7B. For example, the computer system detects an air gesture directed to the respective graphical user interface object in the three-dimensional environment. In some embodiments, detecting the second input includes detecting an air pinch gesture or an air tap gesture performed by a hand of the user, optionally while the attention of the user is directed toward the respective graphical user interface object in the three-dimensional environment. In some embodiments, detecting the second input includes detecting selection of a physical button of an input device (e.g., hardware controller) in communication with the computer system provided by a hand of the user (e.g., a button press by a finger on the physical button). In some embodiments, detecting the second input includes detecting a gaze and dwell directed toward the respective graphical user interface object in the three-dimensional environment, such as detecting the gaze of the user directed toward the respective graphical user interface object for at least a threshold amount of time (e.g., 0.25, 0.5, 1, 1.5, 2, 3, 4, 5, or 10 seconds).

In some embodiments, in response to detecting the second input (810), in accordance with a determination that the second input includes selection of a first graphical user interface object that represents the first group of objects (e.g., corresponding to a representation of the first virtual workspace discussed above), such as a selection of second representation 722b representing the virtual objects 708 and 710 in FIG. 7B, the computer system redisplays (812), via the one or more display generation components, the first group of objects with the one or more first visual characteristics, including the first spatial arrangement, in the three-dimensional environment, such as displaying the virtual objects 708 and 710 with the spatial arrangement shown in FIG. 7A. For example, the computer system adjusts one or more locations of the first group of objects relative to the viewpoint of the user, one or more orientations of the first group of objects relative to the viewpoint of the user, one or more brightness levels of the first group of objects, one or more translucency levels of the first group of objects, one or more colors of the first group of objects, and/or one or more sizes of the first group of objects to correspond to the one or more first visual characteristics. In some embodiments, redisplaying the first group of objects with the one or more first visual characteristics includes redisplaying the first group of objects in the three-dimensional environment. Additionally, when the first group of objects is redisplayed in the three-dimensional environment, the first group of objects is optionally displayed at one or more first locations and/or with one or more first orientations relative to the viewpoint of the user that correspond to the previous one or more locations and/or previous one or more orientations (e.g., prior to detecting the first input). In some embodiments, when the computer system redisplays the first group of objects with the one or more first visual characteristics in the three-dimensional environment, the computer system ceases display of the user interface including the one or more graphical user interface objects in the three-dimensional environment. In some embodiments, the computer system redisplays the first group of objects with the one or more first visual characteristics because the second input corresponds to a request to relaunch/reopen the first visual space discussed above. For example, as mentioned above, the first graphical user interface object corresponds to a representation of the first virtual workspace, and the selection of the representation of the first virtual workspace corresponds to a request to display content associated with the first virtual workspace. As described previously above, the first group of objects is optionally associated with the first virtual workspace, which causes the computer system to display the content associated with the first virtual workspace in response to detecting the second input, which includes redisplaying the first group of objects in the first spatial arrangement.

In some embodiments, in accordance with a determination that the second input includes selection of a second graphical user interface object that represents a second group of objects (e.g., corresponding to a representation of a second virtual workspace, different from the first virtual workspace), different from the first graphical user interface object, such as the selection of the first representation 722a as shown in FIG. 7B, the computer system displays (814) the second group of objects (optionally different from the first group of objects) in the three-dimensional environment, wherein the second group of objects has one or more second visual characteristics different from the one or more first visual characteristics, including a second spatial arrangement (e.g., second positions and/or second orientations that are, optionally, distributed in the three-dimensional environment so that they cannot be contained in a single plane (e.g., distributed in a non-planar manner)), wherein the second spatial arrangement is a three-dimensional arrangement of the second group of objects in the three-dimensional environment that is different from the first spatial arrangement in the three-dimensional environment, such as the display of virtual objects 724 and 726 in FIG. 7C that have a spatial arrangement that is different from the spatial arrangement of the virtual objects 708 and 710 in FIG. 7A. For example, the computer system launches/opens a second virtual workspace in the three-dimensional environment, which includes displaying the second group of objects in the three-dimensional environment. In some embodiments, the second group of objects have one or more characteristics of the first group of objects (e.g., the second group of objects corresponds to a second group of virtual object, including content). In some embodiments, the second group of objects includes one or more objects of the first group of objects (e.g., and vice versa). In some embodiments, the second group of objects is displayed with one or more third visual characteristics (optionally different from the one or more first visual characteristics and/or the one or more second visual characteristics), including one or more third locations of the second group of objects relative to the viewpoint of the user, one or more third orientations of the second group of objects relative to the viewpoint of the user, one or more third brightness levels of the second group of objects, one or more third translucency levels of the second group of objects, one or more third colors of the second group of objects, and/or one or more third sizes of the second group of objects. In some embodiments, the second group of objects is displayed in the second spatial arrangement while the second virtual workspace is open/active in the three-dimensional environment. In some embodiments, the second spatial arrangement is based on and/or determined by prior user input directed to the second group of objects in the three-dimensional environment (e.g., a prior instance of the display of the second virtual workspace stored by (e.g., in memory) and/or otherwise known/accessible to the computer system). For example, the second group of objects has the second spatial arrangement in the three-dimensional environment due to user input positioning (e.g., moving) one or more objects of the second group of objects to one or more second locations and/or one or more second orientations relative to the viewpoint of the user in the three-dimensional environment when the second virtual workspace was last open/active at the computer system (and optionally in the three-dimensional environment discussed above). Providing a virtual workspace that preserves one or more visual characteristics of the display of content in a three-dimensional environment relative to a viewpoint of a user enables particular content items and the spatial arrangement of the content items to be automatically updated and preserved due to their association with the virtual workspace, which reduces a number of inputs that would be needed to reopen the content items and/or restore the content items to their previous spatial arrangement in the three-dimensional environment relative to the viewpoint of the user, thereby improving user-device interaction and preserving computing resources.

In some embodiments, in response to detecting the first input, the computer system updates display, via the display generation component of the first group of objects to have one or more second visual characteristics (e.g., size, transparency, position, brightness, and/or another visual characteristic), different from the one or more first visual characteristics, such as minimizing the virtual objects 708 and 710 from FIG. 7A to FIG. 7B to be displayed as representations 708-1 and 710-I within the second representation 722b. In some embodiments, updating display of the first group of objects to have the one or more second visual characteristics includes adjusting one or more locations of the first group of objects relative to the viewpoint of the user, one or more orientations of the first group of objects relative to the viewpoint of the user, one or more brightness levels of the first group of objects, one or more translucency levels of the first group of objects, one or more colors of the first group of objects, and/or one or more sizes of the first group of objects. In some embodiments, updating display of the first group of objects to have the one or more second visual characteristics includes ceasing display of the first group of objects in the three-dimensional environment. In some embodiments, updating display of the first group of objects to have the one or more second visual characteristics includes clearing the first group of objects from a field of view of the user in the three-dimensional environment. For example, the computer system increases a translucency of the first group of objects such that the first group of objects appear to no longer be visible in the field of view of the user, moves the first group of objects out of the field of view of the user (e.g., to one or more second locations outside of the field of view in the three-dimensional environment), decreases a size of the first group of objects in the three-dimensional environment, and/or decreases a brightness of the first group of objects in the three-dimensional environment.

In some embodiments, in response to detecting the second input, in accordance with a determination that the second input includes selection of a third graphical user interface object (e.g., corresponding to a representation of a new virtual workspace, different from the first virtual workspace and the second virtual workspace discussed above) that is selectable to initiate a process to arrange one or more respective objects in a respective spatial arrangement in the three-dimensional environment, different from the first graphical user interface object and the second graphical user interface object (e.g., the third graphical user interface object is selectable to create a third virtual workspace that is different from the first virtual workspace and the second virtual workspace, and that is currently not in existence when the second input is detected), such as selectable option 735 in FIG. 7P, the computer system ceases display of the user interface including the plurality of graphical user interface objects, such as ceasing display of the virtual workspaces selection user interface 720 as shown in FIG. 7Q. For example, the computer system minimizes, closes, and/or otherwise ceases display of the virtual workspaces selection user interface in the three-dimensional environment.

In some embodiments, the computer system forgoes display of the first group of objects with the one or more first visual characteristics in the three-dimensional environment, such as forgoing display of the virtual objects 708 and 710 of FIG. 7A as shown in FIG. 7Q. For example, the computer system creates and/or generates a new virtual workspace (e.g., a third virtual workspace) without displaying content (e.g., the first group of objects) from the first virtual workspace described previously above. In some embodiments, as similarly discussed above, creating the new virtual workspace includes associating the new virtual workspace with the current location of the user (e.g., the current location of the computer system). For example, the new virtual workspace is anchored to and/or persists in the current room, building, or other geolocation of the user. In some embodiments, as discussed in more detail below, the computer system displays one or more user interface objects (e.g., different from the first group of objects) that are selectable to add content to the new virtual workspace in the three-dimensional environment. Creating a virtual workspace that preserves one or more visual characteristics of the display of content in a three-dimensional environment relative to a viewpoint of a user in response to detecting a selection of a respective graphical user interface object in a virtual workspaces selection user interface reduces a number of inputs needed to create a new virtual workspace, thereby improving user-device interaction and preserving computing resources.

In some embodiments, in response to detecting the second input, in accordance with the determination that the second input includes selection of the third graphical user interface object (e.g., the representation of a new virtual workspace, different from the first virtual workspace and the second virtual workspace discussed above), such as the selectable option 735 in FIG. 7P, the computer system displays, via the one or more display generation components, one or more system user interface objects in the three-dimensional environment, such as display of home user interface 730 as shown in FIG. 7Q, wherein the one or more system user interface objects have a respective spatial arrangement in the three-dimensional environment (e.g., determined automatically by the computer system, optionally without user input and/or designation), wherein the respective spatial arrangement is a three-dimensional arrangement of the one or more system user interface objects in the three-dimensional environment, such as the spatial arrangement of the selectable icons of the home user interface 730 in FIG. 7Q. For example, when the computer system creates a new virtual workspace in response to detecting the selection of the third graphical user interface object, the computer system displays one or more system user interface objects at one or more default locations in the three-dimensional environment relative to the viewpoint of the user. In some embodiments, the one or more system user interface objects are different from the first group or objects and/or the second group of objects discussed previously above. In some embodiments, the one or more system user interface objects are not associated with the new virtual workspace as content belonging to (e.g., being preserved within) the new virtual workspace. For example, the one or more system user interface objects include and/or correspond to one or more icons associated with respective applications that are selectable to add respective content, such as user interfaces, images, files, documents, and/or video associated with the respective applications, to the new virtual workspace. As an example, while displaying the one or more system user interface objects, if the computer system detects an input corresponding to a selection of a first system user interface object of the one or more system user interface objects (e.g., via an air pinch gesture provided by a hand of the user), the computer system launches a first application associated with the first system user interface object, which optionally includes displaying a first user interface corresponding to the first application in the three-dimensional environment. In some embodiments, the display of the first user interface associates the first user interface (e.g., and the content of the first user interface) with the new virtual workspace in the three-dimensional environment, as similarly discussed above with reference to the first group of objects. In some embodiments, the one or more system user interface objects include an option for selecting and/or designating (e.g., via text-entry input) a name or title of the new virtual workspace. Displaying system user interface objects having a default spatial arrangement in a three-dimensional environment relative to a viewpoint of a user when creating a virtual workspace that preserves one or more visual characteristics of the display of content reduces a number of inputs needed to add content to the new virtual workspace and/or facilitates user input for associating content with the virtual workspace based on the default spatial arrangement, thereby improving user-device interaction and preserving computing resources.

In some embodiments, the first group of objects is associated with a first virtual workspace (e.g., the first virtual workspace discussed above), and the first graphical user interface object corresponds to a representation of the first virtual workspace, such as the first representation 722a in FIG. 7B corresponding to a representation of a first virtual workspace that includes the virtual objects 724 and 726. For example, as discussed above, the virtual workspaces selection user interface includes a representation of the first virtual workspace. In some embodiments, the representation of the first virtual workspace is selectable to display the first virtual workspace, including the content of the first virtual workspace (e.g., the first group of objects), in the first spatial arrangement discussed above. In some embodiments, as discussed in more detail below, the first graphical user interface includes one or more visual indications of the content included in the first virtual workspace (e.g., visual representations, such as icons or images, of the first group of objects associated with the first virtual workspace). Additionally, in some embodiments, the first graphical user interface object includes and/or is displayed with an indication of a name or title of the first virtual workspace (e.g., a user-defined and/or a user-selected name or title for the first virtual workspace).

In some embodiments, the second group of objects is associated with a second virtual workspace (e.g., the second virtual workspace discussed above), and the second graphical user interface object corresponds to a representation of the second virtual workspace, such as the second representation 722b in FIG. 7B corresponding to a representation of a second virtual workspace that includes the virtual objects 708 and 710. For example, as discussed above, the virtual workspaces selection user interface includes a representation of the second virtual workspace. In some embodiments, the representation of the second virtual workspace is selectable to display the second virtual workspace, including the content of the first virtual workspace (e.g., the first group of objects), in the second spatial arrangement discussed above. In some embodiments, as discussed in more detail below, the second graphical user interface includes one or more visual indications of the content included in the second virtual workspace (e.g., visual representations, such as icons or images, of the second group of objects associated with the second virtual workspace). In some embodiments, a visual appearance of the second graphical user interface object is different from a visual appearance of the first graphical user interface object. Displaying a virtual workspaces selection user interface that includes a plurality of representations of a plurality of virtual workspaces in a three-dimensional environment reduces a number of inputs needed to launch a respective virtual workspace in the three-dimensional environment and/or facilitates user discovery of the current virtual workspaces created and/or able to be displayed in the three-dimensional environment, thereby improving user-device interaction.

In some embodiments, while displaying the user interface including the plurality of graphical user interface objects in the three-dimensional environment (e.g., before detecting the second input discussed above), the computer system detects, via the one or more input devices, a third input corresponding to a request to scroll through the plurality of graphical user interface objects, such as the input provided by hand 703 as shown in FIG. 7F. For example, the computer system detects an air pinch and drag gesture directed to the plurality of user interface objects in the virtual workspaces selection user interface. In some embodiments, the computer system detects an air pinch gesture performed by a hand of the user, optionally while the attention (e.g., including gaze) of the user is directed to a respective graphical user interface object of the plurality of graphical user interface objects. In some embodiments, after detecting the air pinch gesture performed by the hand, the computer system detects movement of the hand in space relative to the viewpoint of the user (e.g., while maintaining the pinch hand shape). In some embodiments, the computer system detects the hand of the user move with a respective magnitude (e.g., of speed and/or distance) and/or in a respective direction relative to the viewpoint of the user. In some embodiments, the third input includes selection of an option that is selectable to scroll through the plurality of graphical user interface objects (e.g., by a default and/or system-determined amount (e.g., distance) and/or number of graphical user interface objects). For example, the computer system detects an air pinch gesture directed to a scroll button or carrot displayed within the virtual workspaces selection user interface (e.g., at opposite ends of the row of the plurality of graphical user interface objects) in the three-dimensional environment.

In some embodiments, in response to detecting the third input, the computer system scrolls the plurality of graphical user interface object in the user interface, including updating display, via the display generation component, of the user interface to include a third graphical user interface object (e.g., a graphical user interface object that was previously not displayed and/or non-visible in the user interface) corresponding to a representation of a third virtual workspace (e.g., different from the first virtual workspace and the second virtual workspace discussed above), such as scrolling the virtual workspaces selection user interface 720 in FIG. 7G to reveal fourth representation 722d of a fourth virtual workspace. For example, the computer system scrolls the plurality of graphical user interface objects within the virtual workspaces selection user interface in accordance with the third input discussed above. In some embodiments, computer system scrolls the plurality of graphical user interface objects in a respective direction and/or with a respective magnitude based on the movement of the hand of the user discussed above. For example, if the computer system detects the hand of the user move in a first direction in space relative to the viewpoint of the user, the computer system scrolls the plurality of graphical user interface objects in a first respective direction that is based on the first direction. In some embodiments, if the computer system detects the hand of the user move in a second direction, opposite the first direction, in space relative to the viewpoint of the user, the computer system scrolls the plurality of graphical user interface objects in a second respective direction, different from the first respective direction, that is based on the second direction. Similarly, in some embodiments, if the computer system detects the hand of the user move with a first magnitude (e.g., of speed and/or distance) in space relative to the viewpoint of the user, the computer system scrolls the plurality of graphical user interface objects with a first respective magnitude that is based on the first magnitude. In some embodiments, if the computer system detects the hand of the user move with a second magnitude (e.g., of speed and/or distance), greater than the first magnitude, in space relative to the viewpoint of the user, the computer system scrolls the plurality of graphical user interface objects with a second respective magnitude, greater than the first respective magnitude, that is based on the second magnitude. Scrolling through a plurality of representations of a plurality of virtual workspaces within a virtual workspaces selection user interface that is displayed in a three-dimensional environment in response to detecting a scrolling input directed to the plurality of representations of the plurality of virtual workspaces reduces a number of inputs or simplifies the input needed to navigate to and/or display a respective representation of a respective virtual workspace in the three-dimensional environment and/or facilitates user discovery of the current virtual workspaces able to be displayed in the three-dimensional environment, thereby improving user-device interaction.

In some embodiments, the representation of the first virtual workspace is a first three-dimensional representation, and the representation of the second virtual workspace is a second three-dimensional representation, such as the three-dimensionality of the first representation 722a and the second representation 722b in the virtual workspaces selection user interface 720 in FIG. 7B. For example, the computer system displays the representations of the first virtual workspace and the second virtual workspace as three-dimensional objects in the three-dimensional environment, such as three-dimensional icons, bubbles, orbs, and/or models. Accordingly, in some embodiments, a portion of the first three-dimensional representation and/or the second three-dimensional representation that is closest to the viewpoint of the user and/or that is visible from the current viewpoint of the user is configured to change based on changes in the location of the viewpoint of the user in the three-dimensional environment. In some embodiments, a visual appearance of the first three-dimensional representation is different from a visual appearance of the second three-dimensional representation based on the specific content included in the first virtual workspace and the second virtual workspace, respectively, as discussed in more detail below. For example, the first three-dimensional representation and the second three-dimensional representation are displayed at a same size (e.g., at a same volume) within the virtual workspaces selection user interface, but the particular content included within the first three-dimensional representation is different from that of the second three-dimensional representation in the three-dimensional environment. Displaying a virtual workspaces selection user interface that includes a plurality of three-dimensional representations of a plurality of virtual workspaces in a three-dimensional environment reduces a number of inputs or simplifies the input needed to launch a respective virtual workspace in the three-dimensional environment and/or facilitates user discovery of the current virtual workspaces created and/or able to be displayed in the three-dimensional environment, thereby improving user-device interaction.

In some embodiments, the first graphical user interface object includes a first plurality of representations corresponding to the first group of objects, such as the first representation 722a including representations 724-I and 726-I corresponding to the virtual objects 724 and 726, respectively, in FIG. 7B, and the second graphical user interface object includes a second plurality of representations corresponding to the second group of objects, such as the second representation 722b including representations 708-1 and 710-I corresponding to the virtual objects 708 and 710, respectively, in FIG. 7B. For example, the first graphical user interface object and the second graphical user interface object include individual representations of the respective content included in and/or associated with the first virtual workspace and the second virtual workspace. In some embodiments, the first plurality of representations and the second plurality of representations are three-dimensional representations within the first graphical user interface object and the second graphical user interface object, respectively. For example, the first plurality of representations corresponds to miniature versions of the first group of objects having a same or similar visual appearance (e.g., shape, color, brightness, and/or dimensionality) of the first group of objects. Similarly, in some embodiments, the second plurality of representations corresponds to miniature versions of the second group of objects having a same or similar visual appearance (e.g., shape, color, brightness, and/or dimensionality) of the second group of objects. In some embodiments, the first plurality of representations and the second plurality of representations are two-dimensional representations within the first graphical user interface object and the second graphical user interface object, respectively. For example, the first plurality of representations corresponds to images and/or icons representing the first group of objects, such as an image or icon of respective applications associated with the first group of objects. Similarly, in some embodiments, the second plurality of representations corresponds to images and/or icons representing the second group of objects, such as an image or icon of respective applications associated with the second group of objects. In some embodiments, the first plurality of representations is different from the second plurality of representations. For example, the first plurality of representations is different from the second plurality of representations in visual appearance (e.g., due to different types of applications being open and/or launched within the first virtual workspace and the second virtual workspace) and/or in number (e.g., due to a different number of applications being open and/or launched within the first virtual workspace and the second virtual workspace). Displaying a virtual workspaces selection user interface that includes a plurality of representations of a plurality of virtual workspaces that includes visual indications of the content associated with the plurality of virtual workspaces reduces a number of inputs or simplifies the input needed to launch a respective virtual workspace in the three-dimensional environment and/or facilitates user discovery of the current virtual workspaces created and/or able to be displayed in the three-dimensional environment, thereby improving user-device interaction.

In some embodiments, in accordance with a determination that the first virtual workspace is accessible to one or more first participants (e.g., one or more first users different from the user of the computer system), the first graphical user interface object is displayed with a visual indication of the one or more first participants, such as third representation 722c including representation 725-I corresponding to a participant who has access to the third virtual workspace associated with the third representation 722c in FIG. 7B. In some embodiments, the one or more first participants have access to the first virtual workspace because the first virtual workspace has been shared with the one or more first participants (e.g., shared by the user of the computer system and/or by another user of the one or more first participants). In some embodiments, the one or more first participants have access to the first group of objects within the first virtual workspace. For example, the one or more first participants are able to view and/or interact with the first group of objects (e.g., move, resize, and/or cease display of the first group of objects) and/or the content of the first group of objects (e.g., interact with the user interfaces of the first group of objects). In some embodiments, the one or more first participants have access to one or more objects in the first group of objects without having access to others of the first group of objects. For example, a first object in the first group of objects is shared with all participants in the first virtual workspace (e.g., the one or more first participants and the user of the computer system) but a second object in the first group of objects is private to the user of the computer system (e.g., and is thus not visible to and/or interactive to the one or more first participants). In some embodiments, the visual indication of the one or more first participants includes and/or corresponds to a list of names (or other identifiers) associated with the one or more first participants. For example, the first graphical user interface object is displayed with a list of names and/or corresponding images (e.g., contact photo, avatar, cartoon, name, initials, or other representation) of the one or more first participants. In some embodiments, the visual indication of the one or more first participants includes a visual representation of the one or more first participants. For example, the first graphical user interface object includes miniature (e.g., three-dimensional or two-dimensional) representations of the one or more first participants who have access to the first virtual workspace.

In some embodiments, in accordance with a determination that the second virtual workspace is accessible to one or more second participants (e.g., one or more second users different from the user of the computer system), the second graphical user interface object is displayed with the visual indication of the one or more second participants, such as the fourth representation 722d including representation 727-I corresponding to a participant who has access to the fourth virtual workspace associated with the fourth representation 722d in FIG. 7G. In some embodiments, the one or more first participants are different from the one or more second participants. In some embodiments, one or more respective participants are shared between (e.g., belongs to both) the one or more first participants and the one or more second participants. In some embodiments, the visual indication of the one or more second participants has one or more characteristics of the visual indication of the one or more first participants. Displaying a virtual workspaces selection user interface that includes a plurality of representations of a plurality of virtual workspaces that includes visual indications of participants, in addition to the user of the computer system, who have access to the plurality of virtual workspaces reduces a number of inputs or simplifies the input needed to launch a respective virtual workspace in the three-dimensional environment and/or facilitates user discovery of which participants have access to which virtual workspaces in the three-dimensional environment, thereby improving user-device interaction.

In some embodiments, displaying the visual indication of the one or more first participants includes, in accordance with a determination that a first participant of the one or more first participants is currently interacting with the first virtual workspace, displaying a visual indication of the first participant with a first visual appearance, such as display of status indicator 716 with visual indicator 714a indicating that the participant “John” is currently active in the third virtual workspace associated with the third representation 722c in FIG. 7B. For example, if the first participant is currently active (e.g., is viewing and/or interacting with the first group of objects in the first virtual workspace via their respective computer system), the computer system displays the representation of the first participant with the first visual appearance with the first graphical user interface object. In some embodiments, displaying the visual indication of the first participant with the first visual appearance includes displaying a (e.g., three-dimensional) representation of the first participant, such as a virtual avatar of the first participant, within the first graphical user interface object in the virtual workspaces selection user interface in the three-dimensional environment. In some embodiments, displaying the visual indication of the first participant with the first visual appearance includes displaying the representation of the first participant within the first graphical user interface object with a first visual appearance, such as a first level of brightness, transparency, coloration, saturation, and/or size. In some embodiments, displaying the visual indication of the first participant with the first visual appearance includes displaying an indication (e.g., label or other visual indicator) of the first participant being active in the first virtual workspace. For example, the computer system displays an “active” label or a green checkmark or dot next to and/or with (e.g., overlaid on) the indication of the name of the first participant that is displayed with the first graphical user interface object in the virtual workspaces selection user interface.

In some embodiments, in accordance with a determination that the first participant of the one or more first participants is not currently interacting with the first virtual workspace, displaying the visual indication of the first participant with a second visual appearance, different from the first visual appearance, such as forgoing display of status indicator 716 with visual indicator 714b indicating that the participant “Jeremy” is not currently active in the third virtual workspace associated with the third representation 722c in FIG. 7B. For example, if the first participant is currently inactive (e.g., is not currently viewing and/or interacting with the first group of objects in the first virtual workspace via their respective computer system), the computer system displays the representation of the first participant with the second visual appearance with the first graphical user interface object. In some embodiments, displaying the visual indication of the first participant with the second visual appearance includes displaying the representation of the first participant within the first graphical user interface object with a second visual appearance, such as a second level of brightness, transparency, coloration, saturation, and/or size, different from the first level of brightness, transparency, coloration, saturation, and/or size discussed above. In some embodiments, displaying the visual indication of the first participant with the second visual appearance includes displaying an indication (e.g., label or other visual indicator) of the first participant being inactive in the first virtual workspace. For example, the computer system displays an “inactive” or “away” label or a grey or yellow checkmark or dot next to and/or with (e.g., overlaid on) the indication of the name of the first participant that is displayed with the first graphical user interface object in the virtual workspaces selection user interface. In some embodiments, displaying the visual indication of the one or more second participants includes, in accordance with a determination that a second participant of the one or more second participants is currently interacting with the second virtual workspace, displaying a visual indication of the second participant with the first visual appearance. In some embodiments, in accordance with a determination that the second participant of the one or more second participants is not currently interacting with the second virtual workspace, the computer system displays the visual indication of the second participant with the second visual appearance. Displaying a virtual workspaces selection user interface that includes a plurality of representations of a plurality of virtual workspaces that includes visual indications of active and inactive participants, in addition to the user of the computer system, who have access to the plurality of virtual workspaces reduces a number of inputs or simplifies the input needed to launch a respective virtual workspace in the three-dimensional environment and/or facilitates user discovery of which active and/or inactive participants have access to which virtual workspaces in the three-dimensional environment, thereby improving user-device interaction.

In some embodiments, displaying the visual indication of the first participant with the first visual appearance includes displaying the visual indication within the first graphical user interface object, such as display of representation 725-I within the third representation 722c as shown in FIG. 7B. For example, as similarly discussed above, if the first participant is currently active in the first virtual workspace, the computer system displays a (e.g., three-dimensional) representation of the first participant, such as a virtual avatar of the first participant, within the first graphical user interface object in the virtual workspaces selection user interface in the three-dimensional environment.

In some embodiments, displaying the visual indication of the first participant with the second visual appearance includes displaying the visual indication outside of the first graphical user interface object, such as display of visual indicator 714b below the third representation 722c as shown in FIG. 7B. For example, as similarly discussed above, if the first participant is not currently active in the first virtual workspace, the computer system forgoes displaying a (e.g., three-dimensional) representation of the first participant within the first graphical user interface object in the virtual workspaces selection user interface in the three-dimensional environment. Rather, in some embodiments, the computer system displays an indication (e.g., text label or image) corresponding to the first participant below, above, or to a side of the first graphical user interface object in the virtual workspaces selection user interface. In some embodiments, the determination that the first participant is not currently active in the first virtual workspace is in accordance with (e.g., is based on) a determination that the first participant has been invited to access the first virtual workspace, without requiring that the first participant has actually accepted the invitation to access the first virtual workspace. Displaying a virtual workspaces selection user interface that includes a plurality of representations of a plurality of virtual workspaces that includes visual indications of active and inactive participants, in addition to the user of the computer system, who have access to the plurality of virtual workspaces reduces a number of inputs needed to launch a respective virtual workspace in the three-dimensional environment and/or facilitates user discovery of which active and/or inactive participants have access to which virtual workspaces in the three-dimensional environment, thereby improving user-device interaction.

In some embodiments, the plurality of graphical user interface objects corresponds to a plurality of virtual workspaces, including the first virtual workspace and the second virtual workspace. In some embodiments, one or more virtual workspaces of the plurality of virtual workspaces were created by the user of the computer system (e.g., prior to detecting the first input and/or the second input discussed above), such as the first virtual workspace associated with the first representation 722a being created by the user 702 in FIG. 7B. For example, the first virtual workspace, the second virtual workspace, and/or a third virtual workspace of the plurality of virtual workspaces are created by the user of the computer system. In some embodiments, the one or more virtual workspaces were created by the user of the computer system via the selection of the third graphical user interface object of the plurality of graphical user interface objects discussed above. For example, the computer system detects selection of the option for creating a new virtual workspace corresponding to the one or more virtual workspaces. Additionally, in some embodiments, the first group of objects included in the first virtual workspace and/or the second group of objects included in the second virtual workspace are included based on user input provided by the user of the computer system that causes the first group of objects to be associated with the first virtual workspace and/or the second group of objects to be associated with the second virtual workspace. For example, the computer system detects input provided by the user for launching respective applications associated with the first group of objects and/or the second group of objects while the first virtual workspace is open and/or while the second virtual workspace is open, respectively, in the three-dimensional environment. In some embodiments, the one or more virtual workspaces include a visual indication that the one or more virtual workspaces were created by the user of the computer system. For example, the computer system displays a label or other visual indication indicating that the user is the creator (e.g., owner) of the one or more virtual workspaces in the virtual workspaces selection user interface. Displaying a virtual workspaces selection user interface that includes a plurality of representations of a plurality of virtual workspaces that includes one or more virtual workspaces created by the user of the computer system in a three-dimensional environment reduces a number of inputs or simplifies the input needed to launch a respective virtual workspace in the three-dimensional environment and/or facilitates user discovery of the current virtual workspaces created and/or able to be displayed in the three-dimensional environment, thereby improving user-device interaction.

In some embodiments, the plurality of graphical user interface objects corresponds to a plurality of virtual workspaces, including the first virtual workspace and the second virtual workspace. In some embodiments, one or more virtual workspaces of the plurality of virtual workspaces were created by one or more respective participants, different from the user of the computer system, such as the third virtual workspace associated with the third representation 722c being created by a participant that is different from the user 702 in FIG. 7B. In some embodiments, one or more virtual workspaces of the plurality of virtual workspaces were created by one or more other participants, different from the user of the computer system, such as the one or more first participants and/or the one or more second participants discussed above. In some embodiments, though the one or more virtual workspaces were created by one or more other participants, the user of the computer system has access to the one or more virtual workspaces (e.g., because the one or more virtual workspaces have been shared with the user of the computer system). In some embodiments, the one or more virtual workspaces include a visual indication that the one or more virtual workspaces were created by the one or more respective participants. For example, the computer system displays a label or other visual indication indicating a name of the creator (e.g., owner) of the one or more virtual workspaces in the virtual workspaces selection user interface, such as the name(s) of the respective participant(s) who provided access to the user of the computer system to the one or more virtual workspaces. Displaying a virtual workspaces selection user interface that includes a plurality of representations of a plurality of virtual workspaces that includes one or more virtual workspaces created by one or more participants different from the user of the computer system in a three-dimensional environment reduces a number of inputs or simplifies the input needed to launch a respective virtual workspace in the three-dimensional environment and/or facilitates user discovery of the current virtual workspaces created and/or able to be displayed in the three-dimensional environment, thereby improving user-device interaction.

In some embodiments, the first group of objects includes a first object that is also included in the second group of objects, such as virtual object 728 in FIG. 7E and virtual object 721 in FIG. 7H. For example, as similarly described above with reference to the first group of objects and the second group of objects, the first object is or includes respective content, such as a first user interface or similar virtual object (e.g., virtual window) including one or more images, video, text, selectable options, text-entry regions, and/or other two-dimensional or three-dimensional content. In some embodiments, the first object is associated with a first application configured to be run on the computer system.

In some embodiments, a first representation of the first object has a first visual appearance in the first graphical user interface object (e.g., the representation of the first virtual workspace), such as the virtual object 728 being displayed at a first location relative to a viewpoint of the user 702 within the first virtual workspace as shown in FIG. 7E. In some embodiments, a second representation of the first object has a second visual appearance, different from the first visual appearance, in the second graphical user interface object (e.g., the representation of the second virtual workspace), such as virtual object 721 being displayed at a second location, different from the first location, relative to the viewpoint of the user 702 within the third virtual workspace as shown in FIG. 7H. For example, the first object is included in and/or is associated with both the first virtual workspace and the second virtual workspace, but is visually represented differently in the respective virtual workspaces. In some embodiments, the first object includes and/or is associated with (e.g., is displaying) first content in the first virtual workspace that causes the first object to have the first visual appearance in the first graphical user interface object, and the second object includes and/or is associated with second content, different from the first content, that causes the second object to have the second visual appearance in the second graphical user interface object. For example, the first object is displaying a first user interface and/or one or more first user interfaces in the first virtual workspace but is displaying a second user interface, different from the first user interface, and/or one or more second user interfaces, different from the one or more first user interfaces, in the second virtual workspace. In some embodiments, the first object is located at a first location relative to the viewpoint of the user in the first virtual workspace that causes the first object to have the first visual appearance in the first graphical user interface object, and is located at a second location, different from the first location, relative to the viewpoint of the user that causes the first object to have the second visual appearance in the second graphical user interface object. For example, the first location of the first object causes the first object to have a first apparent size relative to the viewpoint of the user and the second location of the first object causes the first object to have a second apparent size relative to the viewpoint of the user. Similarly, in some embodiments, the first object has a first orientation relative to the viewpoint of the user in the first virtual workspace that causes the first object to have the first visual appearance in the first graphical user interface object, and has a second orientation, different from the first orientation, relative to the viewpoint of the user in the second virtual workspace that causes the first object to have the second visual appearance in the second graphical user interface object. In some embodiments, as similarly discussed above, the first object has the first visual appearance in the first graphical user interface object due to user action (e.g., input provided by the user of the computer system and/or another participant who has access to the first virtual workspace) directed to the first object in the first virtual workspace, and the first object has the first visual appearance in the second graphical user interface object due to user action (e.g., input provided by the user of the computer system and/or another participant who has access to the second virtual workspace) directed to the first object in the second virtual workspace. Displaying a virtual workspaces selection user interface that includes a plurality of representations of a plurality of virtual workspaces, including representations of the content associated with the plurality of virtual workspaces, in a three-dimensional environment reduces a number of inputs or simplifies the input needed to launch a respective virtual workspace in the three-dimensional environment and/or facilitates user discovery of the current virtual workspaces created and/or able to be displayed in the three-dimensional environment, thereby improving user-device interaction.

In some embodiments, while displaying the first group of objects in the three-dimensional environment, wherein the first group of objects has the one or more first visual characteristics, including the first spatial arrangement (e.g., before detecting the second input described previously above), the computer system detects, via the one or more input devices, a third input directed to the first object of the first group of objects, such as input provided by hand 703 corresponding to a request to move the virtual object 721 as shown in FIG. 7H. For example, the computer system detects an input corresponding to a request to update a visual appearance of the first object in the first virtual workspace. In some embodiments, the third input corresponds to a request to change and/or update display of the content associated with (e.g., displayed within) the first object in the first virtual workspace. For example, the computer system detects selection (e.g., via an air pinch gesture provided by the hand of the user) of a selectable option or other user interface object displayed in the first object that is selectable to update and/or change the content of the user interface of the first object in the first virtual workspace. In some embodiments, the third input has one or more characteristics of the inputs described herein.

In some embodiments, in response to detecting the third input, the computer system updates display, via the one or more display generation components, of the first object in the three-dimensional environment in accordance with the third input, such that the first group of objects has one or more third visual characteristics, different from the one or more first visual characteristics (optionally including a third spatial arrangement, different from the first spatial arrangement), such as movement of the virtual object 721 in accordance with the movement of the hand 703 that causes the spatial arrangement of the virtual object 721, the visual representation 725, and the virtual object 723 to be changed in the third virtual workspace as shown in FIG. 7I. In some embodiments, the computer system changes and/or updates display of the content of the first object in the first virtual workspace in accordance with the selection input or other interaction performed by the hand of the user discussed above. For example, the computer system updates the user interface of the first object to include additional and/or alternative content, such as additional and/or alternative images, video, text, and the like, or updates the first object to include a second user interface, different from the user interface displayed in the first object when the third input is detected.

In some embodiments, while displaying the first group of objects in the three-dimensional environment, wherein the first group of objects has the one or more third visual characteristics, the computer system detects, via the one or more input devices, a fourth input corresponding to a request to display the one or more graphical user interface objects, such as a multi-press of the hardware element 740 provided by the hand 703 as shown in FIG. 7I. In some embodiments, the fourth input has one or more characteristics of the first input discussed above corresponding to the request to display the one or more graphical user interface objects (e.g., the virtual workspaces selection user interface). For example, the computer system detects interaction with a hardware button (e.g., physical control or dial) of the computer system for requesting the display of the one or more graphical user interface objects, such as a (optionally multi) press, click, and/or rotation of the hardware control.

In some embodiments, in response to detecting the fourth input, the computer system displays, via the one or more display generation components, the user interface including the plurality of graphical user interface objects in the three-dimensional environment, such as the display of the virtual workspaces selection user interface 720 as shown in FIG. 7J. For example, as similarly discussed above with reference to the first input, the computer system displays the virtual workspaces selection user interface in the three-dimensional environment. In some embodiments, as similarly discussed above, the computer system minimizes, reduces the size of, and/or otherwise ceases display of the first virtual workspace, including the first group of objects, in the three-dimensional environment when the user interface including the plurality of graphical user interface objects is displayed in the three-dimensional environment.

In some embodiments, the first representation of the first object has a third visual appearance, different from the first visual appearance, in the first graphical user interface object, such as the location of the representation 721-I corresponding to the virtual object 721 being updated within the third representation 722c based on the movement of the virtual object 721 in the third virtual workspace as shown in FIG. 7J. For example, as similarly discussed above, the plurality of graphical user interface objects includes and/or corresponds to (representations (e.g., icons representing the content and/or reduced scale representations of the content) of a plurality of virtual workspaces, including the first virtual workspace that is represented by the first graphical user interface object. Accordingly, as similarly discussed above, the first graphical user interface object optionally includes representations (e.g., icons representing the content and/or reduced scale representations of the content) of the content associated with (e.g., included in) the first virtual workspace, such as representations of the first group of objects, including the first object. In some embodiments, when the plurality of graphical user interface objects is displayed in the three-dimensional environment, the representation of the first object is updated from having the first visual appearance described previously above to having the third visual appearance that corresponds to and/or is based on the one or more third visual characteristics of the first group of objects. For example, the representation of the first object in the first graphical user interface object has an updated visual appearance based on the updated location, orientation, and/or content of the first object in the first virtual workspace discussed above in response to detecting the third input.

In some embodiments, the second representation of the first object has the second visual appearance in the second graphical user interface object, such as the representation 728-I corresponding to the virtual object 728 remaining displayed at the same location within the first representation 722a associated with the first virtual workspace despite the movement of the virtual object 721 within the third virtual workspace in FIG. 7K. For example, the computer system maintains display of the representation of the first object with the second visual appearance in the representation of the second virtual workspace that is included in the virtual workspaces selection user interface. Particularly, in some embodiments, because the first object is separately and individually associated with the first virtual workspace and the second virtual workspace, the interaction directed to the first object in the first virtual workspace that causes the visual appearance of the first object in the first virtual workspace to be updated relative to the viewpoint of the user does not affect the display of (e.g., the visual appearance of) the first object in the second virtual workspace. Similarly, in some embodiments, if the computer system detects interaction directed to the first object in the second virtual workspace (e.g., similar to the third input discussed above) that causes the visual appearance of the first object in the second virtual workspace to be updated relative to the viewpoint of the user, the computer system changes the visual appearance of the first object in the second virtual workspace without changing the visual appearance of the first object in the first virtual workspace. Updating display of a virtual workspaces selection user interface that includes a plurality of representations of a plurality of virtual workspaces based on interactions with the content associated with the plurality of virtual workspaces in a three-dimensional environment provides a visual indication of a current state of the content of the plurality of virtual workspaces, which aids the user in remembering the interactions with the content, and/or reduces a number of inputs or simplifies the input needed to launch a respective virtual workspace in the three-dimensional environment, thereby improving user-device interaction.

In some embodiments, displaying the first representation of the first object with the first visual appearance includes displaying the first representation at a first location in the first graphical user interface object (e.g., before detecting the second input described previously above), such as the location of the representation 728-I corresponding to the virtual object 728 within the first representation 722a in FIG. 7F, and displaying the second representation of the first object with the second visual appearance includes displaying the second representation at a second location in the second graphical user interface object (e.g., relative to the viewpoint of the user), such as the location of the representation 721-I corresponding to the virtual object 721 within the third representation 722c in FIG. 7G. In some embodiments, the first location is different from the second location relative to the viewpoint of the user.

In some embodiments, while displaying the first group of objects in the three-dimensional environment, wherein the first group of objects has the one or more first visual characteristics, including the first spatial arrangement, the computer system detects, via the one or more input devices, a third input corresponding to a request to move the first object of the first group of objects in the three-dimensional environment, such as input provided by hand 703 corresponding to a request to move the virtual object 721 as shown in FIG. 7H. In some embodiments, the third input corresponds to a request to move the first object, without moving other objects in the first group of objects, within the first virtual workspace relative to the viewpoint of the user. For example, the computer system detects an air pinch and drag gesture directed to the first object (e.g., directed to a movement element, such as a grabber bar or handlebar, displayed with the first object in the three-dimensional environment). In some embodiments, the computer system detects the hand of the user move with a respective magnitude (e.g., of speed and/or distance) and/or in a respective direction in space relative to the viewpoint of the user. In some embodiments, the third input corresponds to a request to rotate (e.g., change the orientation of) the first object within the first virtual workspace relative to the viewpoint of the user. For example, the computer system detects an air pinch gesture directed to the first object, followed by rotation of the hand(s) of the user corresponding to rotation of the first object in the three-dimensional environment relative to the viewpoint of the user.

In some embodiments, in response to detecting the third input, the computer system moves the first object in the three-dimensional environment in accordance with the third input, such that the first group of objects has one or more third visual characteristics, different from the one or more first visual characteristics, including a third spatial arrangement, different from the first spatial arrangement, such as movement of the virtual object 721 in accordance with the movement of the hand 703 that causes the spatial arrangement of the virtual object 721, the visual representation 725, and the virtual object 723 to be changed in the third virtual workspace as shown in FIG. 7I. For example, the computer system moves the first object in the three-dimensional environment relative to the viewpoint of the user in accordance with the movement of the hand discussed above, thereby causing the spatial arrangement of the first group of objects to be updated in the first virtual workspace relative to the viewpoint of the user. In some embodiments, the computer system moves the first object with a magnitude (e.g., of speed and/or distance) and/or in a direction in the three-dimensional environment based on the movement of the hand of the user. For example, if the computer system detects the hand of the user move with a first respective magnitude in space, the computer system moves the first object with a first magnitude in the three-dimensional environment that is based on (e.g., is equal to or is proportional to) the first respective magnitude. Similarly, in some embodiments, if the computer system detects the hand of the user move in a first respective direction in space relative to the viewpoint of the user, the computer system moves the first object in a first direction in the three-dimensional environment relative to the viewpoint of the user that is based on the first respective direction. In some embodiments, the computer system rotates the first object in the three-dimensional environment relative to the viewpoint of the user in accordance with the movement and/or rotation of the hand discussed above, thereby causing the orientation of the first object to be updated in the first virtual workspace relative to the viewpoint of the user.

In some embodiments, while displaying the first group of objects in the three-dimensional environment, wherein the first group of objects has the one or more third visual characteristics, the computer system detects, via the one or more input devices, a fourth input corresponding to a request to display the one or more graphical user interface objects, such as a multi-press of the hardware element 740 provided by the hand 703 as shown in FIG. 7I. In some embodiments, the fourth input has one or more characteristics of the first input discussed above corresponding to the request to display the one or more graphical user interface objects (e.g., the virtual workspaces selection user interface). For example, the computer system detects interaction with a hardware button (e.g., physical control or dial) of the computer system for requesting the display of the one or more graphical user interface objects, such as a (optionally multi) press, click, and/or rotation of the hardware control.

In some embodiments, in response to detecting the fourth input, the computer system displays, via the one or more display generation components, the user interface including the plurality of graphical user interface objects in the three-dimensional environment, such as the display of the virtual workspaces selection user interface 720 as shown in FIG. 7J. For example, as similarly discussed above with reference to the first input, the computer system displays the virtual workspaces selection user interface in the three-dimensional environment. In some embodiments, as similarly discussed above, the computer system minimizes, reduces the size of, and/or otherwise ceases display of the first virtual workspace, including the first group of objects, in the three-dimensional environment when the user interface including the plurality of graphical user interface objects is displayed in the three-dimensional environment.

In some embodiments, the first representation of the first object is displayed at a third location, different from the first location, in the first graphical user interface object, such as the location of the representation 721-I corresponding to the virtual object 721 being updated within the third representation 722c based on the movement of the virtual object 721 in the third virtual workspace as shown in FIG. 7J. For example, as similarly discussed above, the plurality of graphical user interface objects includes and/or corresponds to representations (e.g., icons representing the content and/or reduced scale representations of the content) of a plurality of virtual workspaces, including the first virtual workspace that is represented by the first graphical user interface object. Accordingly, as similarly discussed above, the first graphical user interface object optionally includes representations of the content (e.g., icons representing the content and/or reduced scale representations of the content) associated with (e.g., included in) the first virtual workspace, such as representations of the first group of objects, including the first object. In some embodiments, when the plurality of graphical user interface objects is displayed in the three-dimensional environment, the first graphical user interface object (e.g., the representation of the first virtual workspace) is updated to include the representation of the first object at an updated location that is based on the movement of the first object in the first virtual workspace relative to the viewpoint of the user in response to detecting the third input.

In some embodiments, the second representation of the first object is displayed at the second location in the second graphical user interface object, such as the representation 728-1 corresponding to the virtual object 728 remaining displayed at the same location within the first representation 722a associated with the first virtual workspace despite the movement of the virtual object 721 within the third virtual workspace in FIG. 7K. For example, the computer system maintains display of the representation of the first object at the second location in the representation of the second virtual workspace that is included in the virtual workspaces selection user interface. Particularly, in some embodiments, because the first object is separately and individually associated with the first virtual workspace and the second virtual workspace, the movement of the first object in the first virtual workspace that causes the first object to be displayed at an updated location in the first virtual workspace relative to the viewpoint of the user does not affect the display of (e.g., the location of) the first object in the second virtual workspace. Similarly, in some embodiments, if the computer system detects a movement input directed to the first object in the second virtual workspace (e.g., similar to the third input discussed above) that causes the location of the first object in the second virtual workspace to be updated relative to the viewpoint of the user, the computer system changes the location of the first object in the second virtual workspace without changing the location of the first object in the first virtual workspace. Updating display of a virtual workspaces selection user interface that includes a plurality of representations of a plurality of virtual workspaces based on interactions with the content associated with the plurality of virtual workspaces in a three-dimensional environment provides a visual indication of a current state of the content of the plurality of virtual workspaces, which aids the user in remembering the interactions with the content, and/or reduces a number of inputs or simplifies the input needed to launch a respective virtual workspace in the three-dimensional environment, thereby improving user-device interaction.

In some embodiments, while displaying the first group of objects in the three-dimensional environment (e.g., while the first virtual workspace is open in the three-dimensional environment), wherein the first group of objects has the one or more first visual characteristics, including the first spatial arrangement, the computer system detects, via the one or more input devices, a third input corresponding to a request to cease display of the first object of the first group of objects, such as similar to the input provided by the hand 703a/703b corresponding to a request to display a new virtual object as shown in FIG. 7D. For example, the computer system detects an input closing the application associated with the first object in the three-dimensional environment. In some embodiments, the third input includes a selection of a close option associated with (e.g., displayed with) the first object in the three-dimensional environment. For example, the computer system detects an air pinch gesture provided by the hand of the user, optionally while the attention (e.g., including gaze) of the user is directed to the close option in the three-dimensional environment. In some embodiments, the close option is displayed as a user interface element within the user interface of the first object, such as at a top of the user interface or within a menu or list of options displayed in the user interface.

In some embodiments, in response to detecting the third input, the computer system ceases display of the first object in the three-dimensional environment in accordance with the third input, such that the first group of objects has one or more third visual characteristics, different from the one or more first visual characteristics (optionally including a third spatial arrangement, different from the first spatial arrangement), such as similar to the display of the virtual object 728 as shown in FIG. 7E. For example, the computer system closes the application associated with the first object, thereby causing the first object to no longer be displayed in the three-dimensional environment. In some embodiments, ceasing display of the first object in the three-dimensional environment causes the first object to no longer be associated with (e.g., no longer included as content of) the first virtual workspace. In some embodiments, ceasing display of the first object causes the first group of objects to include one fewer object in the three-dimensional environment, which causes the spatial distribution of the first group of objects in the three-dimensional environment relative to the viewpoint of the user to change.

In some embodiments, while displaying the first group of objects in the three-dimensional environment, wherein the first group of objects has the one or more third visual characteristics, the computer system detects, via the one or more input devices, a fourth input corresponding to a request to display the one or more graphical user interface objects, such as the multi-press of the hardware element 740 provided by the hand 703 as shown in FIG. 7E. In some embodiments, the fourth input has one or more characteristics of the first input discussed above corresponding to the request to display the one or more graphical user interface objects (e.g., the virtual workspaces selection user interface). For example, the computer system detects interaction with a hardware button (e.g., physical control or dial) of the computer system for requesting the display of the one or more graphical user interface objects, such as a (optionally multi) press, click, and/or rotation of the hardware control.

In some embodiments, in response to detecting the fourth input, the computer system displays, via the one or more display generation components, the user interface including the plurality of graphical user interface objects in the three-dimensional environment, such as the display of the virtual workspaces selection user interface 720 as shown in FIG. 7F. For example, as similarly discussed above with reference to the first input, the computer system displays the virtual workspaces selection user interface in the three-dimensional environment. In some embodiments, as similarly discussed above, the computer system minimizes, reduces the size of, and/or otherwise ceases display of the first virtual workspace, including the first group of objects, in the three-dimensional environment when the user interface including the plurality of graphical user interface objects is displayed in the three-dimensional environment.

In some embodiments, the computer system displays the second representation of the first object with the second visual appearance in the second graphical user interface object, without displaying the first representation of the first object with the first visual appearance in the first graphical user interface object, such as updating display of the first representation 722a to include the representation 728-I corresponding to the virtual object 728, without updating display of the second representation 722b to include a representation corresponding to the virtual object 728 as shown in FIG. 7F. For example, as similarly discussed above, the plurality of graphical user interface objects includes and/or corresponds to representations (e.g., icons representing the content and/or reduced scale representations of the content) of a plurality of virtual workspaces, including the first virtual workspace that is represented by the first graphical user interface object. Accordingly, as similarly discussed above, the first graphical user interface object optionally includes representations of the content (e.g., icons representing the content and/or reduced scale representations of the content) associated with (e.g., included in) the first virtual workspace, such as representations of the first group of objects, including the first object. In some embodiments, because the first object is no longer displayed in the first virtual workspace as discussed above, the computer system removes the representation of the first object from the first graphical user interface object when the plurality of graphical user interface objects is displayed in the three-dimensional environment. Additionally, in some embodiments, because the first object is separately and individually associated with the first virtual workspace and the second virtual workspace, ceasing display of the first object in the first virtual workspace does not affect the display of the first object in the second virtual workspace. Accordingly, when the computer system displays the virtual workspaces selection user interface, the computer system optionally maintains display of the representation of the first object in the second graphical user interface in the three-dimensional environment. Similarly, in some embodiments, if the computer system detects an input corresponding to a request to cease display of the first object in the second virtual workspace (e.g., similar to the third input discussed above) that causes the first object to no longer be displayed in the second virtual workspace, the computer system ceases display of the first object in the second virtual workspace without ceasing display of the first object in the first virtual workspace. Updating display of a virtual workspaces selection user interface that includes a plurality of representations of a plurality of virtual workspaces based on interactions with the content associated with the plurality of virtual workspaces in a three-dimensional environment provides a visual indication of a current state of the content of the plurality of virtual workspaces, which aids the user in remembering the interactions with the content, and/or reduces a number of inputs or simplifies the input needed to launch a respective virtual workspace in the three-dimensional environment, thereby improving user-device interaction.

In some embodiments, the user interface including the plurality of graphical user interface objects is displayed as a world locked object (e.g., as defined herein) in the three-dimensional environment, such as the virtual workspaces selection user interface 720 being world locked in the three-dimensional environment 700 in FIG. 7B. In some embodiments, in addition to the plurality of graphical user interface objects being displayed world locked in the three-dimensional environment, the representations of the content within the graphical user interface objects, as similarly discussed above, are individually displayed as world locked in the three-dimensional environment. Displaying a virtual workspaces selection user interface that includes a plurality of representations of a plurality of virtual workspaces, including representations of the content associated with the plurality of virtual workspaces, world locked in a three-dimensional environment enables the user to easily and freely view the content of the plurality of virtual workspaces via the plurality of representations from different unique viewpoints in the three-dimensional environment, which facilitates user input for launching a respective virtual workspace of the plurality of virtual workspaces in the three-dimensional environment, thereby improving user-device interaction.

In some embodiments, the first graphical user interface object includes first content having a first visual appearance while a viewpoint of the user of the computer system is a first viewpoint, such as the visual appearance of the first representation 722a from the viewpoint of the user 702 as shown in FIG. 7N. For example, as similarly described with reference to the first object above, the first graphical user interface object corresponds to a representation of the first virtual workspace and includes individual representations of the content items (e.g., user interfaces) associated with (e.g., included in) the first virtual workspace. Accordingly, in some embodiments, the first visual appearance of the first content in the first graphical user interface object is based on and/or corresponds to a visual appearance of the first content in the first virtual workspace. For example, the first visual appearance of the first content in the first graphical user interface object is based on and/or corresponds to a location of the first content in the first virtual workspace relative to the viewpoint of the user, an orientation of the first content in the first virtual workspace relative to the viewpoint of the user, a size of the first content in the first virtual workspace relative to the viewpoint of the user, and/or the particular user interface(s) of the first content in the first virtual workspace.

In some embodiments, while displaying the user interface including the plurality of graphical user interface objects in the three-dimensional environment, including displaying the first content of the first graphical user interface object with the first visual appearance, the computer system detects, via the one or more input devices, movement of the viewpoint of the user from the first viewpoint to a second viewpoint, different from the first viewpoint, such as movement of the viewpoint of the user 702 as illustrated by the dashed arrow in top-down view 705 in FIG. 7N. For example, the computer system detects movement of the viewpoint of the user relative to the virtual workspaces selection user interface that is world locked in the three-dimensional environment. In some embodiments, the computer system detects movement of a head and/or a location of the user in the physical environment of the computer system, which cause the location of the viewpoint of the user to change relative to the three-dimensional environment. In some embodiments, the movement of the viewpoint of the user is detected via one or more external sensors in communication with the computer system and/or via one or more motion sensors in communication with the computer system, such as an inertial measurement unit and/or one or more cameras (e.g., utilizing visual inertial odometry).

In some embodiments, in response to detecting the movement of the viewpoint of the user, the computer system displays, via the one or more display generation components, the user interface including the plurality of graphical user interface objects from the second viewpoint of the user, including updating display of the first content of the first graphical user interface object to have a second visual appearance, different from the first visual appearance, such as updating display of the first representation 722a in the three-dimensional environment 700 to be based on the updated viewpoint of the user 702 as shown in FIG. 7O. In some embodiments, because the user interface including the plurality of graphical user interface objects is world locked in the three-dimensional environment, the movement of the viewpoint of the user does not cause the user interface to move in the three-dimensional environment with the movement of the viewpoint (e.g., as a head locked object would). Rather, in some embodiments, from the updated viewpoint of the user (e.g., the second viewpoint), additional and/or alternative views of the plurality of graphical user interface objects are provided in the three-dimensional environment. For example, from the first viewpoint of the user prior to detecting the movement of the viewpoint of the user, the portion(s) that cause the first graphical user interface object to have the first visual appearance correspond to a front portion or face of the first graphical user interface object. In some embodiments, from the second viewpoint of the user after detecting the movement of the viewpoint of the user, the portion(s) that cause the first graphical user interface object to have the second visual appearance correspond to a side portion or edge or a rear portion or edge of the first graphical user interface object. Additionally, in some embodiments, because additional and/or alternative views of the first graphical user interface object are provided from the second viewpoint of the user in the three-dimensional environment, additional and/or alternative content of the first graphical user interface object are provided from the second viewpoint of the user. For example, as similarly discussed above, because the first graphical user interface object includes representations of the content (e.g., icons representing the content and/or reduced scale representations of the content) associated with (e.g., included in) the first virtual workspace, the movement of the viewpoint of the user causes additional and/or alternative portions of the representations of the content to be visible in the first graphical user interface object relative to the second viewpoint of the user. Displaying a virtual workspaces selection user interface that includes a plurality of representations of a plurality of virtual workspaces, including representations of the content associated with the plurality of virtual workspaces, world locked in a three-dimensional environment enables the user to easily and freely view the content of the plurality of virtual workspaces via the plurality of representations from different unique viewpoints in the three-dimensional environment, which facilitates user input for launching a respective virtual workspace of the plurality of virtual workspaces in the three-dimensional environment, thereby improving user-device interaction.

In some embodiments, the first group of objects is accessible to one or more first participants other than (e.g., in addition to) the user of the computer system, such as participant “John” as described with reference to FIG. 7B. For example, the first virtual workspace is shared with the one or more first participants, such that the one or more first participants are able to view and/or interact with, such as move, rotate, and/or update the display of, the content of the first virtual workspace, as similarly discussed above.

In some embodiments, while displaying the second group of objects (e.g., with the one or more second visual characteristics described above) in the three-dimensional environment in accordance with the determination that the second input includes selection of the second graphical user interface object in response to detecting the second input, the computer system detects, via the one or more input devices, a third input corresponding to a request to display the one or more graphical user interface objects, such as a multi-press of the hardware element 740 provided by the hand 703 as shown in FIG. 7A. In some embodiments, the third input has one or more characteristics of the first input discussed above corresponding to the request to display the one or more graphical user interface objects (e.g., the virtual workspaces selection user interface). For example, the computer system detects interaction with a hardware button (e.g., physical control or dial) of the computer system for requesting the display of the one or more graphical user interface objects, such as a (optionally multi) press, click, and/or rotation of the hardware control.

In some embodiments, in response to detecting the third input, the computer system displays, via the one or more display generation components, the user interface including the plurality of graphical user interface objects in the three-dimensional environment, such as displaying the virtual workspaces selection user interface 720 in the three-dimensional environment 700 as shown in FIG. 7B. For example, as similarly discussed above with reference to the first input, the computer system displays the virtual workspaces selection user interface in the three-dimensional environment. In some embodiments, as similarly discussed above, the computer system minimizes, reduces the size of, and/or otherwise ceases display of the second virtual workspace, including the second group of objects, in the three-dimensional environment when the user interface including the plurality of graphical user interface objects is displayed in the three-dimensional environment.

In some embodiments, while displaying the user interface including the plurality of graphical user interface objects in the three-dimensional environment, the computer system detects, via the one or more input devices, a fourth input including selection of the first graphical user interface object that represents the first group of objects, such as selection of the third representation 722c corresponding to the third virtual workspace provided by the hand 703 in FIG. 7G. For example, the computer system detects an input corresponding to a request to display the first virtual workspace in the three-dimensional environment. In some embodiments, the computer system detects an air pinch gesture provided by the hand of the user, optionally while the attention (e.g., including gaze) of the user is directed to the first graphical user interface object in the three-dimensional environment. In some embodiments, the fourth input has one or more characteristics of the second input discussed above that includes selection of a respective graphical user interface object of the one or more graphical user interface objects.

In some embodiments, in response to detecting the fourth input, the computer system displays, via the one or more display generation components, the first group of objects in the three-dimensional environment, such as display of virtual objects 721 and 723 and visual representation 725 as shown in FIG. 7H. For example, the computer system redisplays the first virtual workspace that includes the first group of objects in the three-dimensional environment. In some embodiments, as similarly described above, when the computer system displays the first group of objects in the three-dimensional environment, the computer system ceases display of the plurality of graphical user interface objects in the three-dimensional environment.

In some embodiments, in accordance with a determination that one or more visual characteristics of the first group of objects has been updated based on prior user activity of a respective participant of the one or more first participants, the first group of objects has one or more third visual characteristics, including a third spatial arrangement in the three-dimensional environment, wherein the third spatial arrangement is a three-dimensional arrangement of the first group of objects in the three-dimensional environment, such as the updated spatial arrangement of the virtual objects 721 and 723 and the visual representation 725 in the three-dimensional environment 700 being caused by prior user activity of the participant “John” in FIG. 7I. For example, one or more visual characteristics, including a spatial arrangement (e.g., position, orientation and/or size of objects), of the first group of objects is updated in the three-dimensional environment relative to the viewpoint of the user compared to when the first group of objects was last displayed in the three-dimensional environment, such as prior to detecting the first input above. In some embodiments, displaying the first group of objects with the one or more third visual characteristics includes displaying the first group of objects at one or more updated locations (e.g., relative to the locations of the one or more first visual characteristics), with one or more updated orientations (e.g., relative to the orientations of the one or more first visual characteristics), at one or more updated sizes (e.g., relative to the sizes of the one or more first visual characteristics), and/or with updated content, such as updated user interfaces (e.g., relative to the content of the one or more first visual characteristics). In some embodiments, the third spatial arrangement of the first group of objects is different from the first spatial arrangement described above. In some embodiments, the prior user activity of the respective participant is detected by a respective computer system associated with (e.g., used by) the respective participant. For example, the respective computer system detects input provided by the respective participant for moving one or more of the first group of objects in the first virtual workspace, rotating one or more of the first group of objects in the first virtual workspace, resizing one or more of the first group of objects in the first virtual workspace, and/or updating and/or changing display of the content (e.g., user interfaces) of one or more of the first group of objects in the first virtual workspace, which causes the one or more visual characteristics of the first group of objects to change (e.g., to the one or more third visual characteristics). Accordingly, in some embodiments, when the computer system redisplays the first group of objects in the three-dimensional environment in response to detecting the fourth input above, the display of the first group of objects reflects the interactions provided by the respective participant directed to one or more of the first group of objects in the first virtual workspace. In some embodiments, in accordance with a determination that one or more visual characteristics of the first group of objects has not been updated based on prior user activity of a respective participant of the one or more first participants, the first group of objects is maintained with the one or more first visual characteristics described previously above. Providing a shared virtual workspace that preserves one or more visual characteristics of the display of content in a three-dimensional environment relative to a viewpoint of a user enables particular content items and interactions of the content items by other users who have access to the shared virtual workspace to be automatically updated and preserved due to their association with the shared virtual workspace, which reduces a number of inputs that would be needed to reopen the content items and/or restore the content items to their previous spatial arrangement in the three-dimensional environment relative to the viewpoint of the user, thereby improving user-device interaction and collaboration between participants and preserving computing resources.

In some embodiments, while displaying the second group of objects (e.g., with the one or more second visual characteristics described above) in the three-dimensional environment in accordance with the determination that the second input includes selection of the second graphical user interface object in response to detecting the second input, the computer system detects, via the one or more input devices, a third input corresponding to a request to update a spatial arrangement of the second group of objects in the three-dimensional environment, such as the input provided by the hand 703 corresponding to a request to move the virtual object 724 in the three-dimensional environment 700 in FIG. 7C. In some embodiments, the third input corresponds to a request to move a respective object in the second group of objects within the second virtual workspace relative to the viewpoint of the user. For example, the computer system detects an air pinch and drag gesture directed to the respective object (e.g., directed to a movement element, such as a grabber bar or handlebar, displayed with the respective object in the three-dimensional environment). In some embodiments, the computer system detects the hand of the user move with a respective magnitude (e.g., of speed and/or distance) and/or in a respective direction in space relative to the viewpoint of the user. In some embodiments, the third input corresponds to a request to rotate (e.g., change the orientation of) the respective object within the second virtual workspace relative to the viewpoint of the user. For example, the computer system detects an air pinch gesture directed to the respective object, followed by rotation of the hand(s) of the user corresponding to rotation of the respective object in the three-dimensional environment relative to the viewpoint of the user.

In some embodiments, in response to detecting the third input, the computer system updates display of the second group of objects to have one or more third visual characteristics, different from the one or more second visual characteristics, including a third spatial arrangement in the three-dimensional environment based on the third input, wherein the third spatial arrangement is a three-dimensional spatial arrangement of the second group of objects in the three-dimensional environment, such as moving the virtual object 724 in the three-dimensional environment 700 in accordance with the movement of the hand 703, which causes the spatial arrangement of the virtual objects 724 and 726 to be updated in the three-dimensional environment 700 as shown in FIG. 7D. For example, the computer system moves the respective object of the second group of objects discussed above in the three-dimensional environment relative to the viewpoint of the user in accordance with the movement of the hand discussed above, thereby causing the spatial arrangement of the second group of objects to be updated in the second virtual workspace relative to the viewpoint of the user. In some embodiments, the computer system moves the respective object with a magnitude (e.g., of speed and/or distance) and/or in a direction in the three-dimensional environment based on the movement of the hand of the user. For example, if the computer system detects the hand of the user move with a first respective magnitude in space, the computer system moves the respective object with a first magnitude in the three-dimensional environment that is based on (e.g., is equal to or is proportional to) the first respective magnitude. Similarly, in some embodiments, if the computer system detects the hand of the user move in a first respective direction in space relative to the viewpoint of the user, the computer system moves the respective object in a first direction in the three-dimensional environment relative to the viewpoint of the user that is based on the first respective direction. In some embodiments, the computer system rotates the respective object in the three-dimensional environment relative to the viewpoint of the user in accordance with the movement and/or rotation of the hand discussed above, thereby causing the orientation of the respective object to be updated in the first virtual workspace relative to the viewpoint of the user. In some embodiments, the third spatial arrangement of the second group of objects is different from the second spatial arrangement described above.

In some embodiments, while displaying the second group of objects in the three-dimensional environment, wherein the second group of objects has the one or more third visual characteristics, the computer system detects, via the one or more input devices, a fourth input corresponding to a request to display the one or more graphical user interface objects, such as a multi-press of the hardware element 740 provided by the hand 703 as shown in FIG. 7E. In some embodiments, the fourth input has one or more characteristics of the first input discussed above corresponding to the request to display the one or more graphical user interface objects (e.g., the virtual workspaces selection user interface). For example, the computer system detects interaction with a hardware control (e.g., physical button or dial) of the computer system for requesting the display of the one or more graphical user interface objects, such as a (optionally multi) press, click, and/or rotation of the hardware control.

In some embodiments, in response to detecting the fourth input, the computer system displays, via the one or more display generation components, the user interface including the plurality of graphical user interface objects in the three-dimensional environment, such as display of the virtual workspaces selection user interface 720 in the three-dimensional environment 700 as shown in FIG. 7F. For example, as similarly discussed above with reference to the first input, the computer system displays the virtual workspaces selection user interface in the three-dimensional environment. In some embodiments, as similarly discussed above, the computer system minimizes, reduces the size of, and/or otherwise ceases display of the second virtual workspace, including the second group of objects, in the three-dimensional environment when the user interface including the plurality of graphical user interface objects is displayed in the three-dimensional environment.

In some embodiments, while displaying the user interface including the plurality of graphical user interface objects in the three-dimensional environment, the computer system detects, via the one or more input devices, a fifth input including selection of the second graphical user interface object that represents the second group of objects, such as the selection of the first representation 722a corresponding to the first virtual workspace provided by the hand 703 in FIG. 7K. For example, the computer system detects an input corresponding to a request to display the second virtual workspace in the three-dimensional environment. In some embodiments, the computer system detects an air pinch gesture provided by the hand of the user, optionally while the attention (e.g., including gaze) of the user is directed to the second graphical user interface object in the three-dimensional environment. In some embodiments, the fourth input has one or more characteristics of the second input discussed above that includes selection of a respective graphical user interface object of the one or more graphical user interface objects.

In some embodiments, in response to detecting the fifth input, the computer system displays (e.g., redisplays), via the one or more display generation components, the second group of objects in the three-dimensional environment, wherein the second group of objects has the one or more third visual characteristics, including the third spatial arrangement in the three-dimensional environment, such as display of the virtual objects 721 and 726 having the same spatial arrangement as in FIG. 7E in the three-dimensional environment 700 as shown in FIG. 7L. In some embodiments, as described above, one or more visual characteristics, including a spatial arrangement, of the second group of objects is updated in the three-dimensional environment relative to the viewpoint of the user in response to detecting the third input above. Accordingly, in some embodiments, when the second group of objects is redisplayed in the three-dimensional environment in response to detecting the fifth input above, the second group of objects has the one or more third visual characteristics that are based on the third input discussed above. For example, the second group of objects is displayed at the one or more updated locations in the three-dimensional environment relative to the viewpoint of the user, with the one or more updated orientations in the three-dimensional environment relative to the viewpoint of the user, and/or at the one or more updated sizes relative to the viewpoint of the user in the three-dimensional environment. Accordingly, in some embodiments, when the computer system redisplays the first group of objects in the three-dimensional environment in response to detecting the fourth input above, the display of the first group of objects reflects the interactions provided by the respective participant directed to one or more of the first group of objects in the first virtual workspace. Providing a virtual workspace that preserves one or more visual characteristics of the display of content in a three-dimensional environment relative to a viewpoint of a user enables particular content items and interactions of the content items by the user to be automatically updated and preserved due to their association with the virtual workspace, which reduces a number of inputs that would be needed to reopen the content items and/or restore the content items to their previous spatial arrangement in the three-dimensional environment relative to the viewpoint of the user, thereby improving user-device interaction and collaboration between participants and preserving computing resources.

In some embodiments, the first input includes interaction with a hardware input element (e.g., hardware element 740 in FIG. 7A) of the computer system (e.g., as similarly discussed above). For example, the computer system detects a selection of a hardware control (e.g., a physical button or dial) of the computer system discussed above for requesting the display of the user interface including the plurality of graphical user interface objects in the three-dimensional environment, such as a press, click, and/or rotation of the hardware control. In some embodiments, the interaction with the hardware input element includes a multiple selection of the hardware input element of the computer system. For example, the computer system detects a press of the hardware input element 2, 3, 4, or 5 times provided by the hand of the user. Displaying a virtual workspaces selection user interface that includes a plurality of representations of a plurality of virtual workspaces, including representations of the content associated with the plurality of virtual workspaces, in a three-dimensional environment in response to detecting interaction with a hardware input element of the computer system reduces a number of inputs or simplifies the input needed to launch a respective virtual workspace in the three-dimensional environment and/or facilitates user discovery of the current virtual workspaces created and/or able to be displayed in the three-dimensional environment, thereby improving user-device interaction.

In some embodiments, the second input includes an air pinch gesture (e.g., provided by the hand of the user of the computer system as described with reference to the second input above), such as the air pinch gesture provided by the hand 703 as shown in FIG. 7B. In some embodiments, the computer system detects the attention (e.g., including gaze) of the user directed to the respective graphical user interface object when the air pinch gesture is detected, as similarly discussed above. Displaying a virtual workspace that preserves one or more visual characteristics of the display of content in a three-dimensional environment relative to a viewpoint of a user in response to detecting an air pinch gesture directed to a representation of the virtual workspace reduces a number of inputs needed to reopen the content items in their previous spatial arrangement associated with the virtual workspace in the three-dimensional environment relative to the viewpoint of the user, thereby improving user-device interaction and preserving computing resources.

In some embodiments, while displaying the first group of objects with the one or more first visual characteristics in the three-dimensional environment prior to detecting the first input, the first group of objects is displayed in a virtual environment, such as display of virtual objects 721 and 723 and visual representation 725 in virtual environment 750 as shown in FIG. 7H. For example, the first virtual workspace is associated with (e.g., includes) a virtual environment in which the content items of the first virtual workspace are displayed. In some embodiments, the virtual environment includes a scene that at least partially veils at least a part of the three-dimensional environment (and/or the physical environment surrounding the one or more display generation components) such that it appears as if the user were located in the scene (e.g., and optionally no longer located in the three-dimensional environment). In some embodiments, the virtual environment is an atmospheric transformation that modifies one or more visual characteristics of the three-dimensional environment such that it appears as if the three-dimensional environment is located at a different time, place, and/or condition (e.g., morning lighting instead of afternoon lighting, sunny instead of overcast, and/or evening instead of morning). In some embodiments, the first group of objects is displayed within the virtual environment, such that a portion of the virtual environment is displayed in the background of and/or behind the first group of objects relative to the viewpoint of the user in the three-dimensional environment.

In some embodiments, displaying the user interface that includes the plurality of graphical user interface objects in the three-dimensional environment in response to detecting the first input includes displaying a representation of the virtual environment in the first graphical user interface object that represents the first group of objects, such as display of representation 750-I corresponding to the virtual environment 750 within the third representation 722c in the virtual workspaces selection user interface 720 as shown in FIG. 7J. For example, as similarly discussed above, because the first graphical user interface object includes representations of the content of the first virtual workspace, the first graphical user interface object includes a representation of the virtual environment in which the first group of objects is located. In some embodiments, the representation of the virtual environment includes representations (e.g., icons representing the content and/or reduced scale representations of the content) of the virtual features and/or characteristics of the virtual environment. For example, if the virtual environment is an outdoor scene that includes mountains, a field, and clouds, the representation of the virtual environment includes representations of the mountains, field, and clouds, and these representations are included in the first graphical user interface object. Additionally, a spatial arrangement of the first group of objects relative to the virtual environment is preserved and/or represented via their respective representations in the first graphical user interface. For example, the representations of the first group of objects in the first graphical user interface object have locations, orientations, and/or sizes relative to the representation of the virtual environment that are based on and/or correspond to the locations, orientations, and/or sizes of the first group of objects within and/or relative to the virtual environment in the first virtual workspace. In some embodiments, because the virtual environment is associated with the first virtual workspace, the computer system displays the virtual environment in the three-dimensional environment when (e.g., each time that) the first virtual workspace is launched/opened in the three-dimensional environment (e.g., in response to detecting a selection of the first graphical user interface as discussed above) until the virtual environment is no longer associated with the first virtual workspace (e.g., the virtual workspace is closed while the first virtual workspace is open). In some embodiments, in accordance with a determination that the second virtual workspace is associated with a second virtual environment, the second graphical user interface object that represents the second group of objects includes a representation of the second virtual environment. Displaying a virtual workspaces selection user interface that includes a plurality of representations of a plurality of virtual workspaces, including representations of the content and/or virtual environments, associated with the plurality of virtual workspaces, in a three-dimensional environment reduces a number of inputs or simplifies the input needed to launch a respective virtual workspace in the three-dimensional environment and/or facilitates user discovery of the current virtual workspaces created and/or able to be displayed in the three-dimensional environment, thereby improving user-device interaction.

In some embodiments, while displaying the first group of objects with the one or more first visual characteristics in the three-dimensional environment prior to detecting the first input, the first group of objects is displayed in a virtual environment that has a first level of immersion, such as display of virtual objects 721 and 723 and visual representation 725 in virtual environment 750 that is displayed at full immersion as shown in FIG. 7H. In some embodiments, the virtual environment has one or more characteristics of the virtual environments discussed above. In some embodiments, a level of immersion includes an associated degree to which the virtual environment displayed by the computer system obscures background content (e.g., the three-dimensional environment including portions of the physical environment) around/behind the virtual environment, optionally including the number of items of background content displayed and the visual characteristics (e.g., colors, contrast, and/or opacity) with which the background content is displayed, and/or the angular range of the content displayed via the one or more display generation components (e.g., 60 degrees of content displayed at low immersion, 120 degrees of content displayed at medium immersion, and/or 180 degrees of content displayed at high immersion), and/or the proportion of the field of view displayed via the one or more display generation components consumed by the virtual environment (e.g., 33% of the field of view consumed by the virtual environment at low immersion, 66% of the field of view consumed by the virtual environment at medium immersion, and/or 100% of the field of view consumed by the virtual environment at high immersion). In some embodiments, at a first (e.g., high) level of immersion, the background, virtual and/or real objects are displayed in an obscured manner. For example, a respective virtual environment with a high level of immersion is displayed without concurrently displaying the background content (e.g., in a full screen or fully immersive mode). In some embodiments, at a second (e.g., low) level of immersion, the background, virtual and/or real objects are displayed in an obscured manner (e.g., dimmed, blurred, and/or removed from display). For example, a virtual environment with a low level of immersion is optionally displayed concurrently with the background content, which is optionally displayed with full brightness, color, and/or translucency. As another example, a virtual environment displayed with a medium level of immersion is optionally displayed concurrently with darkened, blurred, or otherwise de-emphasized background content. In some embodiments, the visual characteristics of the background objects vary among the background objects. For example, at a particular immersion level, one or more first background objects are visually de-emphasized (e.g., dimmed, blurred, and/or displayed with increased transparency) more than one or more second background objects, and one or more third background objects cease to be displayed.

In some embodiments, displaying the user interface that includes the plurality of graphical user interface objects in the three-dimensional environment in response to detecting the first input includes displaying a representation of the virtual environment at the first level of immersion in the first graphical user interface object that represents the first group of objects, such as display of representation 750-I corresponding to the virtual environment 750 at full immersion within the third representation 722c in the virtual workspaces selection user interface 720 as shown in FIG. 7J. For example, as similarly discussed above, because the first graphical user interface object includes representations of the content of the first virtual workspace, the first graphical user interface object includes a representation of the virtual environment in which the first group of objects is located, as similarly described above. In some embodiments, the level of immersion of the representation of the virtual environment is determined based on and/or relative to a size (e.g., volume and/or surface area) of the first graphical user interface object in the three-dimensional environment. For example, if the first level of immersion corresponds to high (e.g., 90%, full or 100%) immersion, the representation of the virtual environment occupies a whole of the size of the first graphical user interface object in the three-dimensional environment. As another example, if the first level of immersion corresponds to medium (e.g., 40%, 50%) immersion, the representation of the virtual environment occupies half of the size of the first graphical user interface object in the three-dimensional environment. In some embodiments, because the virtual environment is associated with the first virtual workspace, the computer system displays the virtual environment in the three-dimensional environment at the first level of immersion when (e.g., one or more times or each time that) the first virtual workspace is launched/opened in the three-dimensional environment (e.g., in response to detecting a selection of the first graphical user interface as discussed above) until the virtual environment is no longer associated with the first virtual workspace (e.g., the virtual workspace is closed while the first virtual workspace is open). In some embodiments, if, while the first virtual workspace is open in the three-dimensional environment, the computer system detects an input corresponding to a request to change the level of immersion of the virtual environment (e.g., such as via a rotation of a hardware input element of the computer system, such as the hardware input element that is selectable to display the virtual workspaces selection user interface as discussed above), and the computer system changes (e.g., increases or decreases) the level of immersion of the virtual environment (e.g., to an updated level of immersion) in the first virtual workspace, the representation of the virtual environment is updated to have the updated level of immersion in the first graphical user interface object. In some embodiments, in accordance with a determination that the second virtual workspace is associated with a second virtual environment that is displayed at a second level of immersion, the second graphical user interface object that represents the second group of objects includes a representation of the second virtual environment having the second level of immersion. Displaying a virtual workspaces selection user interface that includes a plurality of representations of a plurality of virtual workspaces, including representations of the content and/or virtual environments and their associated levels of immersion, associated with the plurality of virtual workspaces, in a three-dimensional environment reduces a number of inputs or simplifies the input needed to launch a respective virtual workspace in the three-dimensional environment and/or facilitates user discovery of the current virtual workspaces created and/or able to be displayed in the three-dimensional environment, thereby improving user-device interaction.

In some embodiments, updating display of the first group of objects to have the one or more second visual characteristics in response to detecting the first input includes (e.g., gradually) changing a size of the first group of objects relative to a respective location in the three-dimensional environment, such as decreasing a size of the virtual objects 708 and 710 relative to a location of the second representation 722b in the three-dimensional environment 700 when displaying the virtual workspaces selection user interface 720 from FIG. 7A to FIG. 7B. For example, the computer system transitions from displaying the first group of object in the three-dimensional environment to displaying the virtual workspaces selection user interface by resizing the first group of objects relative to a central point in the field of view of the user from the viewpoint of the user in the three-dimensional environment. In some embodiments, changing the size of the first group of objects relative to the respective location in the three-dimensional environment includes decreasing the size of the first group of objects relative to the respective location, such as minimizing the first group of objects to a location within the virtual workspaces selection user interface relative to the respective location in the three-dimensional environment. In some embodiments, when the first group of objects is resized relative to the respective location in the three-dimensional environment, the computer system displays an animated transition of the first group of objects being reduced in size relative to the respective location and being displayed within (e.g., inside of or encapsulated by) the first graphical user interface object in the user interface in the three-dimensional environment. Reducing a size of a first group of objects associated with a first virtual workspace when transitioning to displaying a virtual workspaces selection user interface that includes a plurality of representations of a plurality of virtual workspaces, including a representation of the first virtual workspace, in a three-dimensional environment helps reduce eye strain or other user discomfort associated with updating display of the three-dimensional environment, thereby improving user-device interaction.

It should be understood that the particular order in which the operations in method 800 have been described is merely exemplary and is not intended to indicate that the described order is the only order in which the operations could be performed. One of ordinary skill in the art would recognize various ways to reorder the operations described herein. In some embodiments, aspects/operations of method 800 may be interchanged, substituted, and/or added between these methods. For example, various object manipulation techniques and/or object movement techniques of method 800 is optionally interchanged, substituted, and/or added between these methods. For brevity, these details are not repeated here.

FIGS. 9A-9J illustrate examples of a computer system facilitating multi-user collaboration with content associated with a virtual workspace in a three-dimensional environment in accordance with some embodiments.

FIG. 9A illustrates a first computer system 101a (e.g., an electronic device) is displaying, via a display generation component (e.g., display generation component 120 of FIGS. 1 and 3), a three-dimensional environment 900a from a viewpoint of a first user 902 in top-down view 915 of the three-dimensional environment 900a (e.g., facing the back wall of the physical environment in which first computer system 101a is located).

In some embodiments, first computer system 101a includes a display generation component 120a. In FIG. 9A, the first computer system 101a includes one or more internal image sensors 114a-i oriented towards the face of the first user 902 (e.g., eye tracking cameras 540 described with reference to FIG. 5). In some embodiments, internal image sensors 114a-i are used for eye tracking (e.g., detecting a gaze of the first user). Internal image sensors 114a-i are optionally arranged on the left and right portions of display generation component 120a to enable eye tracking of the user's left and right eyes. First computer system 101a also includes external image sensors 114b-i and 114c-i facing outwards from the first user to detect and/or capture the physical environment and/or movements of the user's hands.

As shown in FIG. 9A, first computer system 101a captures one or more images of the physical environment around first computer system 101a (e.g., operating environment 100), including one or more objects in the physical environment around first computer system 101a. In some embodiments, first computer system 101a displays representations of the physical environment in three-dimensional environment 900a. For example, three-dimensional environment 900a includes a representation of a desk 906, which is optionally a representation of a physical desk in the physical environment, and a representation of a lamp 909, which is optionally a representation of a physical lamp in the physical environment, as illustrated in the top-down view 915 in FIG. 9A.

As discussed in more detail below, in FIG. 9A, display generation component 120a is configured to display content in the three-dimensional environment 900a. In some embodiments, the content is displayed by a single display (e.g., display 510 of FIG. 5) included in display generation component 120a. In some embodiments, display generation component 120a includes two or more displays (e.g., left and right display panels for the left and right eyes of the user, respectively, as described with reference to FIG. 5) having displayed outputs that are merged (e.g., by the user's brain) to create the view of the content shown in FIGS. 9A-9J.

Display generation component 120a has a field of view (e.g., a field of view captured by external image sensors 114b-i and 114c-i and/or visible to the user via display generation component 120a) that corresponds to the content shown in FIG. 9A. Because first computer system 101a is optionally a head-mounted device, the field of view of display generation component 120a is optionally the same as or similar to the field of view of the user (e.g., indicated in the top-down view 915 in FIG. 9A).

As discussed herein, one or more air pinch gestures performed by a user are detected by one or more input devices of first computer system 101a and interpreted as one or more user inputs directed to content displayed by first computer system 101a. Additionally or alternatively, in some embodiments, the one or more user inputs interpreted by first computer system 101a as being directed to content displayed by first computer system 101a are detected via one or more hardware input devices (e.g., controllers) rather than via the one or more input devices that are configured to detect air gestures, such as the one or more air pinch gestures, performed by the user. Such depiction is intended to be exemplary rather than limiting; the user optionally provides user inputs using different air gestures and/or using other forms of input.

In some embodiments, as discussed herein below, the first computer system 101a facilitates multi-user (e.g., multi-participant) collaboration with content (e.g., virtual content, including virtual objects, user interface, models, and/or shapes) that is associated with a respective virtual workspace. For example, as illustrated in top-down view 905 in FIG. 9A, a second user 908 of a second computer system 101b (e.g., an electronic device) is located in a different (e.g., a separate) physical environment that includes table 904. In some embodiments, as described below, the first user 902 and the second user 908 are configured to individually and collaboratively interact with content that is associated with a respective virtual workspace via their respective computer systems. Additional details regarding virtual workspaces and multi-participant collaboration within virtual workspaces are provided below with reference to methods 800, 1000, and/or 1200.

In FIG. 9A, the first computer system 101a detects an input corresponding to a request to display a virtual workspaces selection user interface via which to launch a respective virtual workspace in the three-dimensional environment 900a. For example, as shown in FIG. 9A, the first computer system 101a detects a multi-press of hardware button or hardware element 940 of the first computer system 101a provided by hand 903 of the first user 902. In some embodiments, as illustrated in FIG. 9A, the multi-press of the hardware button 940 corresponds to a double press of the hardware button 940. In some embodiments, the hardware button 940 has one or more characteristics of hardware button 740 in FIGS. 7A-7V above.

In some embodiments, as shown in FIG. 9B, in response to detecting the multi-press of the hardware button 940, the first computer system 101a displays virtual workspace selection user interface 920 in the three-dimensional environment 900. In some embodiments, the virtual workspace selection user interface 920 has one or more characteristics of the virtual workspaces selection user interface 720 in FIGS. 7A-7V above. In some embodiments, as shown in FIG. 9B, the virtual workspaces selection user interface 920 includes a plurality of representations (e.g., virtual bubbles or orbs) of a plurality of virtual workspaces that is able to be displayed (e.g., opened and/or launched) in the three-dimensional environment 900a. For example, as shown in FIG. 9B, the virtual workspaces selection user interface 920 includes a first representation 922a of a first virtual workspace (e.g., a Home virtual workspace), a second representation 922b of a second virtual workspace (e.g., a Work virtual workspace), and a third representation 922c of a third virtual workspace (e.g., a Travel virtual workspace). In some embodiments, as shown in FIG. 9B, the plurality of representations of the plurality of virtual workspaces in the virtual workspaces selection user interface 920 includes representations of the content associated with the plurality of virtual workspaces. Additional details regarding the representations of the content associated with the plurality of virtual workspaces are provided with reference to method 800.

Additionally, in some embodiments, a respective virtual workspace of the plurality of virtual workspaces is configured to be shared with one or more users (e.g., different from the first user 902), such that the content of the respective virtual workspace is accessible to the one or more users (e.g., via respective computer systems associated with the one or more users). In some embodiments, a representation of a virtual workspace that is shared with one or more users includes one or more visual indications of the one or more users who have access to the virtual workspace. For example, in FIG. 9B, the second virtual workspace (e.g., Work virtual workspace) is shared with user Jill. Accordingly, in some embodiments, as shown in FIG. 9B, the second representation 922b includes visual indication 916 indicating that the user Jill has access to the second virtual workspace. In some embodiments, the visual indications of the one or more users who have access to a respective virtual workspace include an indication of a status of interaction with the content of the respective virtual workspace. For example, as shown in FIG. 9B, the visual indication 916 of the second representation 922b is displayed with an active status indicator (e.g., a checkmark) that indicates that the user Jill is currently active in the second virtual workspace (e.g., is currently interacting with the content of the second virtual workspace). In some embodiments, the user Jill corresponds to the second user 908 illustrated in the top-down view 905 in FIG. 9B. Additional detail regarding the virtual workspaces selection user interface 920 are provided with reference to methods 800, 1000, and/or 1200.

In FIG. 9B, while displaying the virtual workspaces selection user interface 920, the first computer system 101a detects an input corresponding to a request to display (e.g., open/launch) the second virtual workspace in the three-dimensional environment 900a. For example, as shown in FIG. 9B, the first computer system 101a detects an air pinch gesture performed by the hand 903 of the first user 902, optionally while attention of the first user 902 (e.g., including gaze 912) is directed to the second representation 922b in the three-dimensional environment 900a.

In some embodiments, as shown in FIG. 9C, in response to detecting the selection of the second representation 922b, the first computer system 101a launches the second virtual workspace, which includes displaying the content associated with the second virtual workspace in the three-dimensional environment 900a. For example, as shown in FIG. 9C, the first computer system 101a displays virtual objects 924 and 926 in the three-dimensional environment 900a, which optionally correspond to the representations included in the second representation 922b in FIG. 9B. In some embodiments, as shown in FIG. 9C, the virtual object 924 is a user interface of a document-viewing application containing content, such as text. Additionally, in FIG. 9C, the virtual object 926 is a user interface of a media-playback application that is configured to display (e.g., play back) media content, such as a movie, television show episode, short film, and/or other video-based content. For example, as shown in FIG. 9C, the virtual object 926 includes selectable option 933 (e.g., a play button) that is selectable to initiate playback of a respective media item in the virtual object 936. It should be understood that the content discussed above is exemplary and that, in some embodiments, additional and/or alternative content and/or user interfaces are provided in the three-dimensional environment 900a, such as the content described below with reference to methods 800, 1000 and/or 1200. In some embodiments, the virtual objects 924 and 926 correspond to shared virtual objects in the second virtual workspace. For example, as shown in FIG. 9C, the virtual object 924 is displayed with pill 925 (e.g., a selectable user interface element) indicating that the virtual object 924 is shared in the second virtual workspace, and the virtual object 926 is displayed with pill 927 indicating that the virtual object 926 is shared in the second virtual workspace. In some embodiments, while the virtual objects 924 and 926 are shared in the second virtual workspace, the content of the virtual objects 924 and 926 is accessible to the users who have access to the second virtual workspace. For example, in FIG. 9C, the user interfaces of the virtual objects 924 and 926 are viewable by and/or are interactive to the first user 902, the second user 908, and the third user (e.g., User C, who is currently not active in the second virtual workspace). Additional details regarding shared content in virtual workspaces are provided below with reference to method 1000.

In some embodiments, as shown in FIG. 9C, the virtual objects 924 and 926 are displayed with movement elements 913a and 913b (e.g., grabber bars) in the three-dimensional environment 900a. In some embodiments, the movement elements 913a and 913b are selectable to initiate movement of the corresponding virtual object within the three-dimensional environment 900a relative to the viewpoint of the first user 902. For example, the movement element 913a that is associated with the virtual object 924 is selectable to initiate movement of the virtual object 924, and the movement element 913b that is associated with the virtual object 926 is selectable to initiate movement of the virtual object 926, within the three-dimensional environment 900a.

In some embodiments, as shown in FIG. 9C, when the second virtual workspace is launched in the three-dimensional environment 900a, the first computer system 101 displays visual representation 914 (e.g., a virtual avatar) of the second user 908 in the three-dimensional environment 900a. For example, as mentioned above, because the user Jill (e.g., corresponding to the second user 908) is currently active in the second virtual workspace, but is not physically located in the same physical environment as the first user 902, as illustrated in the top-down views 905 and 915, the first computer system 101a displays the visual representation 914 of the second user 908 in the three-dimensional environment 900a indicating that the second user 908 is currently active (e.g., viewing and/or interacting with the content of the virtual objects 924 and/or 926).

In some embodiments, virtual objects 924 and 926 are displayed in three-dimensional environment 900a at respective sizes, with respective orientations, and/or at respective locations relative to the viewpoint of the first user 902 based on prior user action directed to the virtual objects 924 and 926 within the second virtual workspace (e.g., prior to the display of the second virtual workspace in FIG. 9C in response to detecting the selection of the second representation 922b in FIG. 9B). For example, the virtual object 924 and/or the virtual object 926 have been interacted with (e.g., resized, rotated, and/or moved) within the second virtual workspace prior to the current instance of display of the second virtual workspace in the three-dimensional environment 900a. In some embodiments, the prior user activity (e.g., prior user interaction directed to the virtual objects 924 and/or 926) is provided by the first user 902, the second user 908, and/or a different user (e.g., a third participant who has access to the second virtual workspace but is not currently active in the second virtual workspace). It should be understood that the sizes, locations, and/or orientations of the virtual objects in FIGS. 9A-9J are merely exemplary and that other sizes, locations, and/or orientations are possible. Additionally, in some embodiments, the display of the content of the virtual objects 924 and 926 (e.g., a state and/or visual appearance of the user interfaces of the virtual objects 924 and 926) in the three-dimensional environment 900a is based on prior user action directed to the virtual objects 924 and 926 within the second virtual workspace (e.g., prior to the display of the second virtual workspace in FIG. 9C in response to detecting the selection of the second representation 922b in FIG. 9B). For example, the user interfaces of the virtual object 924 and/or the virtual object 926 have been interacted with (e.g., updated, scrolled, selected, and/or removed) within the second virtual workspace prior to the current instance of display of the second virtual workspace in the three-dimensional environment 900a.

In some embodiments, a summary of the prior user activity (e.g., a summary of the changes to the virtual objects 924 and/or 926 and/or a summary of the changes to the content of the virtual objects 924 and/or 926) is provided in the three-dimensional environment 900a when the second virtual workspace is launched in the three-dimensional environment 900a. For example, as shown in FIG. 9C, the first computer system 101a displays summary user interface 911 in the three-dimensional environment 900a that includes a summary of the prior user activity since the last instance of display of the second virtual workspace in the three-dimensional environment 900a. In some embodiments, as shown in FIG. 9C, the summary user interface 911 includes a list or other visual indication of the changes made to the content associated with the second virtual workspace since the last instance of display of the second virtual workspace in the three-dimensional environment 900a. For example, as shown in FIG. 9C, the summary user interface 911 includes first indication 912a that User B (e.g., the second user 908, corresponding to user Jill) has updated the content of a particular virtual object (e.g., “document 1” in the virtual object 924). Additionally, for example, in FIG. 9C, the summary user interface 911 includes second indication 912b that User C (e.g., a third user who is not currently active in the second virtual workspace) has closed a particular application (e.g., caused a virtual object corresponding to “application C” to no longer be displayed in the second virtual workspace). In some embodiments, as shown in FIG. 9C, the first indication 912a and the second indication 912b include time indications corresponding to the corresponding change/action in the second virtual workspace (e.g., time stamps for the corresponding actions).

Additionally, in some embodiments, a chat thread is provided to the first user 902 in the three-dimensional environment 900a when the second virtual workspace is opened in the three-dimensional environment 900a. For example, as shown in FIG. 9C, the first computer system 101a displays chat user interface 917 in the three-dimensional environment 900a that includes one or more messages from one or more users who have access to the second virtual workspace and/or who have interacted with or are currently interacting with the content of the second virtual workspace. In some embodiments, as shown in FIG. 9C, the chat user interface 917 includes a first message 918a from a first user (e.g., User C, who is currently not active in the second virtual workspace as similarly discussed above) and a second message 918b from a second user (e.g., User B, optionally corresponding to the second user 908 as similarly discussed above). In some embodiments, the first message 918a and the second message 918b are private to the first user 902 in the second virtual workspace (e.g., the messages are viewable only by the first user 902 in the chat user interface 917 because the messages were transmitted directly to the first user 902). In some embodiments, the first message 918a and the second message 918b are public in the second virtual workspace (e.g., the messages are viewable by users who have access to the second virtual workspace). In some embodiments, the first message 918a and the second message 918b were transmitted to the first user 902 prior to the second virtual workspace being opened in the three-dimensional environment 900a (e.g., prior to the first computer system 101a detecting the selection of the second representation 922b in FIG. 9B). In some embodiments, the first message 918a and the second message 918b were transmitted to the first user 902 after launching the second virtual workspace in the three-dimensional environment 900a.

In FIG. 9D, the first computer system 101a detects a sequence of inputs corresponding to a request to display additional content (e.g., open an additional application) in the three-dimensional environment 900a. For example, as shown in FIG. 9D, the first computer system 101a detects a press (e.g., a single press, as opposed to a multi-press) of the hardware button 940 provided by hand 903a of the first user 902. In some embodiments, in response to detecting the press of the hardware button 940, the first computer system 101a displays home user interface 930 in the three-dimensional environment 900 (e.g., as opposed to the virtual workspaces selection user interface 920). In some embodiments, the home user interface 930 corresponds to a home user interface of the first computer system 101a that includes a plurality of selectable icons associated with respective applications configured to be run on the first computer system 101a. In FIG. 9D, after displaying the home user interface 930, the first computer system 101a detects an input provided by hand 903b corresponding to a selection of a first icon 931 of the plurality of icons of the home user interface 930 in the three-dimensional environment 900a. For example, as shown in FIG. 9D, the first computer system 101a detects an air pinch gesture performed by the hand 903b, optionally while the attention (e.g., including gaze 912) is directed to the first icon 931 in the three-dimensional environment 900a.

In some embodiments, the first icon 931 is associated with a first application that is configured to be run on the first computer system 101a. Particularly, in some embodiments, the first icon 931 is associated with a music player application corresponding to and/or including music-based content that is able to be output by the first computer system 101a. In some embodiments, as shown in FIG. 9E, in response to detecting the selection of the first icon 931, the first computer system 101a displays virtual object 928 corresponding to the music player application in the three-dimensional environment 900a.

In some embodiments, when the virtual object 928 is displayed in the three-dimensional environment 900a, the virtual object 928 becomes associated with the second virtual workspace along with the virtual objects 924 and 926. For example, as similarly discussed above with reference to method 800, the first computer system 101a preserves a three-dimensional spatial arrangement of the virtual objects 924-928 relative to the viewpoint of the first user 902 and/or preserves a display status of the content of the virtual objects 924-928 in the second virtual workspace between instances of display of the second virtual workspace in the three-dimensional environment 900a. In some embodiments, as similarly discussed above, the virtual object 928 is displayed with movement element 913c (e.g., a grabber bar) that is selectable to initiate movement of the virtual object 928 in the three-dimensional environment 900a relative to the viewpoint of the first user 902.

In some embodiments, as shown in FIG. 9E, when the virtual object 928 is displayed in the three-dimensional environment 900a, the virtual object 928 is (e.g., initially, optionally by default) displayed as a private object to the first user 902 within the second virtual workspace. For example, as shown in FIG. 9E, the virtual object 928 is displayed with pill 929 indicating that the content of the virtual object 928 is private to the first user 902 (e.g., is visible by and/or interactive only to the first user 902). Accordingly, in some embodiments, as shown in FIG. 9E, the user interface of the virtual object 928 is hidden from (e.g., is not visible to) the second user 908 at the second computer system 101b, as described below.

In some embodiments, as shown in FIG. 9E, the second computer system 101b is displaying, via a display generation component (e.g., display generation component 120 of FIGS. 1 and 3), a three-dimensional environment 900b from a viewpoint of the second user 908 of the three-dimensional environment 900b (e.g., facing the back wall of the physical environment in which second computer system 101b is located).

In some embodiments, as similarly discussed above, second computer system 101b includes a display generation component 120b. In FIG. 9E, the second computer system 101b includes one or more internal image sensors 114a-ii oriented towards the face of the second user 908 (e.g., eye tracking cameras 540 described with reference to FIG. 5). In some embodiments, internal image sensors 114a-ii are used for eye tracking (e.g., detecting a gaze of the second user). Internal image sensors 114a-ii are optionally arranged on the left and right portions of display generation component 120b to enable eye tracking of the user's left and right eyes. Second computer system 101b also includes external image sensors 114b-ii and 114c-ii facing outwards from the second user to detect and/or capture the physical environment and/or movements of the user's hands.

As shown in FIG. 9E, second computer system 101b captures one or more images of the physical environment around second computer system 101b (e.g., operating environment 100), including one or more objects in the physical environment around second computer system 101b. In some embodiments, first computer system 101a displays representations of the physical environment in three-dimensional environment 900a. For example, three-dimensional environment 900b includes a representation of a table 904, which is optionally a representation of a physical table in the physical environment.

As illustrated in FIG. 9E and as similarly discussed above, display generation component 120b is configured to display content in the three-dimensional environment 900b. In some embodiments, the content is displayed by a single display (e.g., display 510 of FIG. 5) included in display generation component 120b. In some embodiments, display generation component 120b includes two or more displays (e.g., left and right display panels for the left and right eyes of the user, respectively, as described with reference to FIG. 5) having displayed outputs that are merged (e.g., by the user's brain) to create the view of the content shown in FIGS. 9A-9J.

Display generation component 120b has a field of view (e.g., a field of view captured by external image sensors 114b-i and 114c-i and/or visible to the user via display generation component 120b) that corresponds to the content shown in FIG. 9E. Because second computer system 101b is optionally a head-mounted device, the field of view of display generation component 120b is optionally the same as or similar to the field of view of the second user.

As discussed herein, one or more air pinch gestures performed by a user are detected by one or more input devices of second computer system 101b and interpreted as one or more user inputs directed to content displayed by second computer system 101b. Additionally or alternatively, in some embodiments, the one or more user inputs interpreted by second computer system 101b as being directed to content displayed by second computer system 101b are detected via one or more hardware input devices (e.g., controllers) rather than via the one or more input devices that are configured to detect air gestures, such as the one or more air pinch gestures, performed by the user. Such depiction is intended to be exemplary rather than limiting; the user optionally provides user inputs using different air gestures and/or using other forms of input.

As shown in FIG. 9E, because the virtual objects 924 and 926 are shared in the second virtual workspace, as discussed above, the second computer system 101b displays the virtual objects 924 and 926 in the three-dimensional environment 900b from the viewpoint of the second user 908 of the second computer system 101b. As illustrated in FIG. 9E, the viewpoint of the second user 908 corresponds to (e.g., matches) the orientation of the visual representation 914 that is displayed in the three-dimensional environment 900a by the first computer system 101a. Additionally, as shown in FIG. 9E, the three-dimensional environment 900b includes visual representation 934 (e.g., a virtual avatar) of the first user 902 because, from the perspective of the second user 908, the first user 902 is active in the second virtual workspace in the three-dimensional environment 900b. In some embodiments, as shown in FIG. 9E, because the virtual object 928 is private to the first user 902 in the second virtual workspace, the content (e.g., the user interface) of the virtual object 928 is not visible to the second user 908 in the three-dimensional environment 900b. In some embodiments, as shown in FIG. 9E, though the content of the virtual object 928 is not visible to the second user 908 in the three-dimensional environment 900b, a visual indication of the virtual object 928 (e.g., a preview or hint) is provided in the three-dimensional environment 900b that provides the second user 908 with an indication of a location and/or orientation of the virtual object 928 within the second virtual workspace relative to the virtual objects 924 and 926, without enabling the second user 908 to view the content of the virtual object 928, in the three-dimensional environment 900b.

In FIG. 9E, the first computer system 101a detects an input corresponding to share the virtual object 928 in the second virtual workspace. For example, as shown in FIG. 9E, the first computer system 101a detects a selection of the pill 929 displayed with the virtual object 928 in the three-dimensional environment 900a, such as via an air pinch gesture provided by the hand 903 of the first user 902 optionally while the attention (e.g., including the gaze 912) of the first user 902 is directed to the pill 929.

In some embodiments, as shown in FIG. 9F, in response to detecting the selection of the pill 929, the first computer system 101a displays share user interface 935 with the virtual object 928 in the three-dimensional environment 900a. For example, as shown in FIG. 9F, the first computer system 101a displays the share user interface 935 overlaid on a portion of the virtual object 928 in the three-dimensional environment 900a from the viewpoint of the first user 902. In some embodiments, as shown in FIG. 9F, the share user interface 935 includes one or more options for designating one or more participants in the second virtual workspace with whom to share the content of the virtual object 928. For example, as shown in FIG. 9F, the share user interface 935 includes a first option 936a that is selectable to designate User B (e.g., the second user 908) as the recipient of the access to the content of the virtual object 928, a second option 936b that is selectable to designate User C (e.g., who is not currently active in the second virtual workspace, as discussed above) as the recipient of the access to the content of the virtual object 928, and a third option 936c that is selectable to designate all users who have access to the second virtual workspace as the recipients of the access to the content of the virtual object 928 (e.g., which includes the second user 908 and the third user).

In FIG. 9F, the first computer system 101a detects a selection of the third option 936c in the share user interface 935. For example, as shown in FIG. 9F, the first computer system 101a detects an air pinch gesture performed by the hand 903 of the first user 902, optionally while the attention (e.g., including the gaze 912) of the first user 902 is directed to the third option 936c in the three-dimensional environment 900a.

In some embodiments, as shown in FIG. 9G, in response to detecting the selection of the third option 936c, the first computer system 101a shares the content of the virtual object 928 with the second user 908 and the third user in the second virtual workspace. For example, as shown in FIG. 9G, when the virtual object 928 is shared in the second virtual workspace, the content (e.g., the user interface) of the virtual object 928 becomes available to (e.g., visible by and/or interactive to) the second user and the third user in the second virtual workspace. Accordingly, as shown in FIG. 9G, the second computer system 101b updates display of the virtual object 928 in the three-dimensional environment 900b to include the content of (e.g., the user interface of) the virtual object 928 and the pill 929 indicating that the virtual object 928 has been shared in the second virtual workspace.

In FIG. 9G, after the virtual object 928 has been shared with the second user 908, the second computer system 101b detects an input corresponding to a request to move the virtual object 928 in the three-dimensional environment 900b. For example, as shown in FIG. 9G, the second computer system 101b detects an air pinch and drag gesture performed by hand 907 of the second user 908, optionally while attention (e.g., including gaze 932) of the second user 908 is directed to the movement element 913c of the virtual object 928 in the three-dimensional environment 900b. In some embodiments, as indicated in FIG. 9G, the movement of the hand 907 corresponds to movement of the virtual object 928 rightward relative to the viewpoint of the second user 908.

In some embodiments, as shown in FIG. 9H, in response to detecting the input provided by the hand 907, the second computer system 101b moves the virtual object 928 in the three-dimensional environment 900b relative to the viewpoint of the second user 908 in accordance with the movement of the hand 907. For example, as shown in FIG. 9H, the second computer system 101b moves the virtual object 928 rightward in the three-dimensional environment 900b relative to the viewpoint of the second user 908. In some embodiments, the movement of the virtual object 928, which is a shared virtual object, in the three-dimensional environment 900b in FIG. 9H corresponds to an event that causes the three-dimensional spatial arrangement of the virtual objects 924-928 to be updated in the second virtual workspace relative to the viewpoint of the second user 908. Accordingly, as shown in FIG. 9H, the first computer system 101a optionally updates display of the virtual object 928 in the three-dimensional environment 900a to be located to the right of the virtual object 926 relative to the viewpoint of the first user 902 in accordance with the movement of the virtual object 928 in the three-dimensional environment 900b.

In FIG. 9H, the first computer system 101a detects a selection of the option 933 in the virtual object 926 in the three-dimensional environment 900a. For example, as shown in FIG. 9H, the first computer system 101a detects an air pinch gesture performed by the hand 903 of the first user 902, optionally while the attention (e.g., including the gaze 912) of the first user 902 is directed to the option 933 in the three-dimensional environment 900a. As previously discussed above, in some embodiments, the option 933 is selectable to initiate playback of media content in the virtual object 926.

In some embodiments, as shown in FIG. 9I, in response to detecting the selection of the option 933, the first computer system 101a activates the option 933, which causes playback of a respective media item (e.g., video-based content) in the virtual object 926. For example, as shown in FIG. 9H, the first computer system 101a updates display of the user interface of the virtual object 926 to include playback of a media item and scrubber bar 937 (e.g., which is configured to control a playback position within the media item). In some embodiments, the selection of the option 933 of the virtual object 926, which is a shared virtual object, in the three-dimensional environment 900a that causes playback of the media item to be initiated in the virtual object 926 in FIG. 9I corresponds to an event that causes a state and/or visual appearance of the content (e.g., the user interface) of the virtual object 926 to be updated in the second virtual workspace. Accordingly, as shown in FIG. 9I, the second computer system 101b optionally updates display of the user interface of the virtual object 926 in the three-dimensional environment 900b to include the playback of the media item (e.g., and the display of the scrubber bar 937) in accordance with the selection of the option 933 of the virtual object 928 in the three-dimensional environment 900a.

From FIG. 9I to FIG. 9J, the second computer system 101b detects disassociation of the second computer system 101b from the second user 908. For example, as illustrated in the top-down view 905 in FIG. 9J, the second user 908 is no longer wearing the second computer system 101b, such that the second computer system 101b is no longer in use by the second user 908. Additionally or alternatively, in some embodiments, the second computer system 101b enters a power off state or a sleep state.

In some embodiments, the disassociation of the second computer system 101b from the second user 908 corresponds to an event that causes the second user 908 to no longer be active in the second virtual workspace. For example, in FIG. 9J, the first computer system 101a detects an indication that the second user 908 is no longer viewing and/or interacting with the content of the second virtual workspace. In some embodiments, the event that causes the second user 908 to no longer be active in the second virtual workspace alternatively corresponds to the second computer system 101b closing the second virtual workspace in the three-dimensional environment 900b, which optionally includes displaying the virtual workspaces selection user interface 920 described previously above. In some embodiments, as shown in FIG. 9J, in response to detecting the indication that the second user 908 is no longer active in the second virtual workspace, the first computer system 101a ceases display of the visual representation 914 of the second user 908 in the three-dimensional environment 900a. Additionally, in some embodiments, as shown in FIG. 9J, the action of the second user 908 leaving and/or closing the second virtual workspace at the second computer system 101b does not affect the display of the virtual objects 924-928 in the three-dimensional environment 900a at the first computer system 101a. For example, as shown in FIG. 9J, the first computer system 101a maintains display of the virtual objects 924-928 and the content (e.g., the user interfaces) of the virtual objects 924-928 in the three-dimensional environment 900a when the visual representation 914 ceases to be displayed.

FIG. 10 is a flowchart illustrating an exemplary method 1000 of facilitating multi-user collaboration with content associated with a virtual workspace in a three-dimensional environment in accordance with some embodiments. In some embodiments, the method 1000 is performed at a computer system (e.g., computer system 101 in FIG. 1 such as a tablet, smartphone, wearable computer, or head mounted device) including a display generation component (e.g., display generation component 120 in FIGS. 1, 3, and 4) (e.g., a heads-up display, a display, a touchscreen, and/or a projector) and one or more cameras (e.g., a camera (e.g., color sensors, infrared sensors, and other depth-sensing cameras) that points downward at a user's hand or a camera that points forward from the user's head). In some embodiments, the method 1000 is governed by instructions that are stored in a non-transitory computer-readable storage medium and that are executed by one or more processors of a computer system, such as the one or more processors 202 of computer system 101 (e.g., control unit 110 in FIG. 1A). Some operations in method 1000 are, optionally, combined and/or the order of some operations is, optionally, changed.

In some embodiments, method 1000 is performed at a first computer system (e.g., first computer system 101a in FIG. 9A) in communication with one or more display generation components (e.g., display 120a) and one or more input devices (e.g., image sensors 114a-i through 114c-i). For example, the first computer system is or includes an electronic device, such as a mobile device (e.g., a tablet, a smartphone, a media player, or a wearable device), or a computer. In some embodiments, the first computer system has one or more characteristics of the computer systems in methods 800 and/or 1200. In some embodiments, the one or more display generation components have one or more characteristics of the one or more display generation components in methods 800 and/or 1200. In some embodiments, the one or more input devices have one or more characteristics of the one or more input devices in methods 800 and/or 1200.

In some embodiments, while an environment (e.g., a three-dimensional environment or a two-dimensional environment) is visible via the one or more display generation components, such as three-dimensional environment 900a in FIG. 8A, the first computer system detects (1002), via the one or more input devices, a first input corresponding to a request to display a first group of objects, such as a multi-press of hardware element 940 provided by hand 903 of first user 902 in FIG. 9A, followed by selection of second representation 922b corresponding to a second virtual workspace provided by the hand 903 as shown in FIG. 9B, wherein the request is received from a user of the first computer system who is a first participant in shared management of the first group of objects with one or more other participants, including a second participant different from the first participant, such as second user 908 in FIG. 9A, wherein the second participant is a user of a second computer system, different from the first computer system. In some embodiments, the environment is an extended reality (XR) environment, such as a virtual reality (VR) environment, a mixed reality (MR) environment, or an augmented reality (AR) environment. In some embodiments, the three-dimensional environment has one or more characteristics of the environment(s) in methods 800 and/or 1200. In some embodiments, the first group of objects corresponds to a first group of virtual objects displayed by the first computer system. In some embodiments, the first input corresponding to the request to display the first group of objects corresponds to a request to display a respective virtual workspace in the environment. For example, the first group of objects is associated with a first virtual workspace. In some embodiments, the first virtual workspace has one or more characteristics of the virtual workspace(s) in methods 800 and/or 1200. In some embodiments, the first virtual workspace corresponds to a virtual workspace that is shared with (e.g., viewable by and/or interactive to) one or more participants (e.g., users), including at least the first participant and the second participant who is the user of the second computer system, which causes shared content associated with the first virtual workspace (optionally, all shared content associated with the first virtual workspace) to be shared with the one or more participants (e.g., users). For example, the first virtual workspace is shared with the second participant who is the user of the second computer system discussed above, such that the first group of objects that is associated with the first virtual workspace is also shared with the second participant. In some embodiments, the first group of objects has one or more characteristics of the objects in methods 800 and/or 1200. In some embodiments, the first input includes and/or corresponds to interaction with one or more graphical user interface objects displayed in the three-dimensional environment. For example, as discussed with reference to method 800, the first computer system is displaying a virtual workspaces selection user interface that includes one or more representations of one or more virtual workspaces in the three-dimensional environment. In some embodiments, the first input includes a selection (e.g., via an air gesture) directed to a respective representation of the one or more representations of the one or more virtual workspaces in the virtual workspaces selection user interface. In some embodiments, the first input has one or more characteristics of the input(s) described in methods 800 and/or 1200.

In some embodiments, when the first input is detected, the first participant who is the user of the first computer system is not engaged in communication with the second participant who is the user of the second computer system. For example, the first participant is not engaged in a telephone call, a video conference, and/or other form of real-time communication with the second participant via the first computer system and the second computer system when the first input discussed above is detected. Additionally, in some embodiments, when the first input is detected, the second participant who is the user of the second computer system is not in close proximity to the first participant who is the user of the first computer system. For example, when the first input is detected, the second participant who is the user of the second computer system is more than a threshold distance (e.g., 0.1, 0.5, 0.75, 1, 2, 3, 5, 10, 12, 15, 20, 25, 30, or 50 m) of the first participant who is the user of the first computer system and/or is not located in a same physical environment of the first computer system. For example, the second participant is in a different room or space than the first participant. In some embodiments, when the first input is detected, the second participant is outside of a field of view of the first user in the environment (e.g., and/or vice versa). Alternatively, in some embodiments, when the first input is detected, the first participant who is the user of the first computer system is engaged in real-time communication with the second participant who is the user of the second computer system. In some embodiments, the second participant is proximate to the first participant and/or is located in a same or nearby room or space as the first participant. Additionally, in some embodiments, when the first input is detected, the second participant is within the field of view of the first participant in the environment.

In some embodiments, in response to detecting the first input, the first computer system displays (1004), via the one or more display generation components, the first group of objects in a first spatial arrangement, such as display of virtual objects 924 and 926 and visual representation 914 with a first spatial arrangement in the three-dimensional environment 900a as shown in FIG. 9C. In some embodiments, the first spatial arrangement is a three-dimensional arrangement of the first group of objects in the three-dimensional environment. For example, the first group of objects is, optionally, distributed in the three-dimensional environment so that the objects cannot be contained in a single plane (e.g., distributed in a non-planar manner).

In some embodiments, the first computer system displays (1006) a first object (e.g., of the first group of objects) associated with a first application (e.g., running on the first computer system) at a first location in the environment relative to a viewpoint of the first participant, wherein the first location in the first spatial arrangement is determined based on prior user activity of the first participant at the first computer system (e.g., during a last instance of the display of the first object associated with the first application), such as the virtual object 924 being displayed at a first location in the three-dimensional environment 900a based on prior user activity of the first user 902. For example, in response to detecting the first input, the first computer system opens/launches the shared virtual workspace, which includes displaying the first group of objects that are associated with the shared virtual workspace. In some embodiments, the first object associated with the first application is a shared object within the shared virtual workspace in the three-dimensional environment. For example, as similarly discussed above, the first object is viewable by and/or interactive to the first user and the one or more other users with which the shared virtual workspace is shared, including the second user of the second computer system. In some embodiments, a shared object of the first group of objects is able to be repositioned (e.g., moved) within the three-dimensional environment relative to the viewpoint of the first user by the first user and the second user (e.g., and/or other users with whom the object and/or the shared virtual workspace is shared). In some embodiments, a shared object of the first group of objects is able to be reoriented (e.g., rotated) within the three-dimensional environment relative to the viewpoint of the first user by the first user and the second user (e.g., and/or other users with whom the object and/or the shared virtual workspace is shared). In some embodiments, a shared object of the first group of objects is able to be resized (e.g., scaled) within the three-dimensional environment relative to the viewpoint of the first user by the first user and the second user (e.g., and/or other users with whom the object and/or the shared virtual workspace is shared). In some embodiments, content of the shared object (e.g., a user interface displayed within and/or with the shared object, such as in a window of the shared object) is able to be interacted with and/or updated, such as in response to input directed to selectable options/toggles within the user interface, by the first user and the second user (e.g., and/or other users with whom the object and/or the shared virtual workspace is shared). In some embodiments, the first object associated with the first application is a private object within the shared virtual workspace in the three-dimensional environment. For example, the first object is viewable by and/or interactive, such as the interactions discussed above, to only the owner of the first object, such as the first user of the first computer system, optionally without being viewable by and/or interactive to other users with whom the first object is not shared, such as the second user of the second computer system, optionally irrespective of whether the first virtual workspace is shared with one or more other users, as discussed in more detail below. In some embodiments, when the first object is displayed in the environment in response to detecting the first input, the first object is displayed at the first location relative to the viewpoint of the first user in the environment, as mentioned above. In some embodiments, the prior user activity that causes the first object to be displayed at the first location corresponds to and/or includes movement input provided by the first user and detected by the first computer system during a last instance of the display of the first object. For example, when the first object was last displayed (e.g., when the shared virtual workspace was last open), the first object was positioned and/or otherwise caused to be displayed at the first location relative to the viewpoint of the first user in response to the first computer system (or another computer system associated with (e.g., owned and/or operated by) the first user) detecting an input provided by the first user, such as an air pinch and drag gesture directed to the first object or selection via an air pinch gesture of an application icon associated with the first application, that causes the first object to be displayed at the first location relative to the viewpoint of the first user. In some embodiments, as similarly described in method 800, interactions with objects and/or content in a respective virtual workspace is preserved/maintained (e.g., such that a state of the objects and/or content, including the positions, orientations, sizes, and/or visual appearances of the objects and/or content, within the respective virtual workspace is saved, such as in a memory or cloud storage of the first computer system). Accordingly, in some embodiments, when the first computer system displays the first object in the environment in response to detecting the first input, the first object is displayed at a location in the environment (e.g., the first location) according to the input previously provided by the first user during the last instance of the display of the first object causing the positioning and/or display of the first object at the location relative to the viewpoint of the first user.

In some embodiments, the first computer system displays (1008) a second object (e.g., of the first group of objects), different from the first object, associated with a second application (e.g., running on the first computer system), different from the first application, at a second location, different from the first location, in the environment relative to the viewpoint of the first participant, wherein the second location in the first spatial arrangement is determined based on prior user activity of the second participant at the second computer system (e.g., during a last instance of the display of the first object associated with the first application), such as the virtual object 926 being displayed at a second location in the three-dimensional environment 900a based on prior user activity of the second user 908. For example, in response to detecting the first input, the first computer system opens/launches the shared virtual workspace, which includes displaying the second object that is associated with the shared virtual workspace. In some embodiments, the second object associated with the first application is a shared object within the shared virtual workspace in the three-dimensional environment. For example, as similarly discussed above, the second object is viewable by and/or interactive to the first participant and the one or more other participants (e.g., users) with which the shared virtual workspace is shared, including the second participant who is the user of the second computer system. In some embodiments, when the second object is displayed concurrently with the first object in the environment in response to detecting the first input, the second object is displayed at the second location relative to the viewpoint of the first participant in the environment, as mentioned above. In some embodiments, the prior user activity that causes the second object to be displayed at the second location corresponds to and/or includes movement input provided by the second user (and not the first participant) and detected by the second computer system during a last instance of the display of the second object. For example, when the second object was last displayed (e.g., when the shared virtual workspace was last open), the second object was positioned and/or otherwise caused to be displayed at the second location relative to the viewpoint of the first participant (which is optionally a different location relative to a viewpoint of the second participant at the second computer system) in response to the second computer system (or another computer system associated with (e.g., owned and/or operated by) the second participant) detecting an input provided by the second participant, such as an air pinch and drag gesture directed to the second object or selection via an air pinch gesture of an application icon associated with the second application, that causes the second object to be displayed at the second location relative to the viewpoint of the first participant. Accordingly, in some embodiments, when the first computer system displays the second object within the shared virtual workspace in the environment in response to detecting the first input, the second object is displayed at a location in the environment (e.g., the second location) according to the input previously provided by the second participant during the last instance of the display of the second object causing the positioning and/or display of the second object at the location relative to the viewpoint of the first participant. Providing a shared virtual workspace that preserves one or more visual characteristics of the display of content in a three-dimensional environment relative to a viewpoint of a user enables particular content items and interactions of the content items by other users who have access to the shared virtual workspace to be automatically updated and preserved due to their association with the shared virtual workspace, which reduces a number of inputs that would be needed to reopen the content items and/or restore the content items to their previous spatial arrangement in the three-dimensional environment relative to the viewpoint of the user, thereby improving user-device interaction and collaboration between participants and preserving computing resources.

In some embodiments, in accordance with a determination that a respective participant of the one or more other participants that are in shared management of the first group of objects with the first participant (e.g., the user of the first computer system) is currently active in the environment (e.g., currently active in the first virtual workspace), such as the second user 908 being active in the second virtual workspace in FIG. 9C, the environment includes a representation of the respective participant, such as the visual representation 914 of the second user 908 in FIG. 9C. In some embodiments, the respective participant has access to the first virtual workspace because the first virtual workspace has been shared with the respective participant (e.g., shared by the user of the first computer system and/or by another user of the one or more first participants), as similarly discussed above. In some embodiments, the respective participant has access to the first group of objects within the first virtual workspace. For example, the respective participant is able to view and/or interact with the first group of objects (e.g., move, resize, and/or cease display of the first group of objects) and/or the content of the first group of objects (e.g., interact with the user interfaces of the first group of objects). In some embodiments, the determination that the respective participant is currently active in the environment is based on a determination that the respective participant is viewing and/or interacting with the content of the first group of objects (e.g., via a respective computer system associated with the respective participant). In some embodiments, the representation of the respective participant includes (e.g., is displayed with) an indication of a name (or other identifier) associated with the respective participant. For example, the representation of the respective participant is displayed with and/or corresponds to an indication of a name and/or corresponding image (e.g., contact photo, avatar, cartoon, or other representation) of the respective participant. In some embodiments, the representation of the respective participant includes and/or corresponds to a visual representation of the respective participant. For example, the first graphical user interface object includes a miniature (e.g., three-dimensional or two-dimensional) representation of the respective participant who has access to the first virtual workspace and/or is currently active in the first virtual workspace. In some embodiments, the visual representation of the respective participant corresponds to a virtual avatar. For example, the virtual avatar corresponds to the respective participant (e.g., having one more visual characteristics corresponding to one or more physical characteristics of the respective participant, such as the user's height, posture, skin color, eye color, hair color, relative physical dimensions, facial features and/or position within the three-dimensional environment). In some embodiments, the computer system displays the visual representation of the respective participant with a visual appearance having a degree of visual prominence relative to the three-dimensional environment. The degree of visual prominence optionally corresponds to a form of the representation of the respective participant (e.g., an avatar having a human-like form and/or appearance or an abstracted avatar including less human-like form (e.g., corresponding to a generic two-dimensional or three-dimensional object, such as a virtual coin or a virtual sphere)). For example, the degree of visual prominence optionally includes and/or corresponds to a simulated blurring effect, a level of opacity, a simulated lighting effect, a saturation, and/or a brightness of a portion or all of the avatar. Providing a shared virtual workspace that includes representations of participants who are active within the shared virtual workspace facilitates discovery of which participants are currently active in the shared virtual workspace, which facilitates user input for interacting with the participants and/or particular content items within the shared virtual workspace, thereby improving user-device interaction and collaboration between participants and preserving computing resources.

In some embodiments, in accordance with a determination that the one or more other participants that are in shared management of the first group of objects with the first participant are not currently active in the environment (e.g., is not currently active in the first virtual workspace), the environment does not include a representation of a respective participant of the one or more participants, such as the first representation 922a corresponding to the first virtual workspace not including a representation of a respective participant. For example, the three-dimensional environment does not include a virtual three-dimensional or two-dimensional representation of the respective participant. In some embodiments, the three-dimensional environment optionally does not include any representations of any of the one or more other participants that are in shared management of the first group of objects because none of the one or more other participants are currently active in the three-dimensional environment. Providing a shared virtual workspace that includes representations of participants who are active within the shared virtual workspace facilitates discovery of which participants are currently active in the shared virtual workspace, which facilitates user input for interacting with the participants and/or particular content items within the shared virtual workspace, thereby improving user-device interaction and collaboration between participants and preserving computing resources.

In some embodiments, in accordance with a determination that a plurality of participants (e.g., including the respective participant discussed above) of the one or more other participants that are in shared management of the first group of objects with the first participant is currently active in the environment (e.g., currently active in the first virtual workspace), the environment includes a plurality of representations of the plurality of participants, such as the three-dimensional environment 900a including a plurality of visual representations similar to the visual representation 914 as shown in FIG. 9C. For example, the three-dimensional environment includes a plurality of virtual avatars representing the plurality of participants and/or a plurality of two-dimensional representations of the plurality of participants who are currently active in the first virtual workspace. Providing a shared virtual workspace that includes representations of participants who are active within the shared virtual workspace facilitates discovery of which participants are currently active in the shared virtual workspace, which facilitates user input for interacting with the participants and/or particular content items within the shared virtual workspace, thereby improving user-device interaction and collaboration between participants and preserving computing resources.

In some embodiments, while the representation of the respective participant in visible in the environment in accordance with the determination that the respective participant of the one or more other participants that are in shared management of the first group of objects with the first participant is currently active in the environment, the first computer system detects, via the one or more input devices, a second input corresponding to interaction with the representation of the respective participant in the environment, such as a speech-based input directed to the visual representation 914 in FIG. 9C. In some embodiments, the second input corresponding to interaction with the representation of the respective participant includes detecting voice-based input provided by the first participant (e.g., the user of the first computer system). For example, the first computer system detects, via one or more microphones in communication with the first computer system, speech or other voice-based input provided by the first participant that is directed to the respective participant (e.g., the first participant is having a conversation with the respective participant similar to a phone or video call). In some embodiments, the second input corresponding to interaction with the representation of the respective participant includes detecting a selection of the respective participant in the environment. For example, the first computer system detects an air pinch gesture provided by a hand of the first participant, optionally while attention (e.g., including gaze) of the first participant is directed toward the representation of the respective participant in the three-dimensional environment. In some embodiments, the second input corresponding to interaction with the representation of the respective participant includes detecting movement of the viewpoint of the first participant relative to the representation of the respective participant in the environment. For example, the first computer system detects, via one or more motion sensors in communication with the first computer system, the first participant walk toward or away from the representation of the respective participant in the three-dimensional environment, which causes the viewpoint of the first participant to be moved toward or away from the representation of the respective participant in the three-dimensional environment.

In some embodiments, in response to detecting the second input, the first computer system transmits data corresponding to the interaction that is received by a respective computer system associated with the respective participant, such as transmitting data corresponding to the speech-based input to second computer system 101b associated with the second user 908. For example, the first computer system transmits data corresponding to the voice-based data detected via the one or more microphones to the respective computer system, such as data corresponding to the speech input provided by the first participant discussed above. In some embodiments, the computer system transmits data corresponding to the selection of the representation of the respective participant to the respective computer system. In some embodiments, the computer system transmits data corresponding to the movement of the viewpoint of the first participant relative to the representation of the respective participant in the three-dimensional environment. In some embodiments, the transmission of the data corresponding to the interaction that is received by the respective computer system causes the respective computer system to perform a corresponding operation, such as output audio corresponding to the speech input provided by the first participant, update the display data corresponding to the respective representation that is transmitted to the first computer system, and/or update display of a representation of the first participant that is displayed in a respective three-dimensional environment at the respective computer system. Providing a shared virtual workspace that includes representations of participants who are active within the shared virtual workspace facilitates discovery of which participants are currently active in the shared virtual workspace, which facilitates user input for interacting with the participants and/or particular content items within the shared virtual workspace, thereby improving user-device interaction and collaboration between participants and preserving computing resources.

In some embodiments, a respective participant of the one or more other participants that are in shared management of the first group of objects with the first participant is currently active in the environment (e.g., as similarly discussed above with reference to the respective participant being active in the first virtual workspace), such as the second user 908 being active in the second virtual workspace in FIG. 9C. In some embodiments, while displaying the first group of objects in the first spatial arrangement in the environment in response to detecting the first input (e.g., and while displaying a representation of the respective participant in the environment as similarly discussed above), the first computer system detects an indication of input corresponding to a request to move one or more objects of the first group of objects performed by the respective participant, wherein the input is detected by a respective computer system associated with the respective participant, such as the second computer system 101b detecting input provided by hand 907 of the second user 908 corresponding to a request to move virtual object 928 as shown in FIG. 9G. For example, the first computer system receives data including one or more instructions and/or commands corresponding to user input detected by the respective computer system that is associated with the respective participant. In some embodiments, the indication of the input corresponding to the request to move one or more objects of the first group of objects performed by the respective participant corresponds to movement of a first object of the first group of objects with a respective magnitude (e.g., of speed and/or distance) and/or in a respective direction relative to a viewpoint of the respective participant.

In some embodiments, in response to detecting the indication, the first computer system displays, via the display generation component, the first group of objects in a second spatial arrangement, different from the first spatial arrangement, that is based on the input directed to the one or more objects of the first group of objects performed by the respective participant, such as the first computer system 101a moving the virtual object 928 in the three-dimensional environment 900a based on the input detected by the second computer system 101b as shown in FIG. 9H. For example, the first computer system moves the one or more objects of the first group of objects in accordance with the data provided by the respective computer system associated with the respective participant. In some embodiments, the computer system moves the one or more objects with a magnitude (e.g., of speed and/or distance) and in a direction relative to the viewpoint of the first participant in the three-dimensional environment that are based on and/or correspond to the respective magnitude and/or the respective direction of the movement of the one or more objects detected by the respective computer system. In some embodiments, the movement of the one or more objects of the first group of objects in the three-dimensional environment causes the spatial arrangement of the first group of objects to change relative to the viewpoint of the first participant due to updated location(s) of the one or more objects of the first group of objects in the three-dimensional environment. Accordingly, as outlined above, in some embodiments, input provided by another participant (e.g., different from the first participant) that causes the spatial arrangement of the first group of objects to change in the first virtual workspace causes (e.g., in real time) the change in the spatial arrangement of the first group of objects to be updated at the first computer system (e.g., because the first participant is currently active in the first virtual workspace). Providing a shared virtual workspace that preserves one or more visual characteristics of the display of content in a three-dimensional environment relative to a viewpoint of a user enables particular content items and interactions of the content items by other users who have access to the shared virtual workspace to be automatically updated and preserved due to their association with the shared virtual workspace, which reduces a number of inputs that would be needed to reopen the content items and/or restore the content items to their previous spatial arrangement in the three-dimensional environment relative to the viewpoint of the user, thereby improving user-device interaction and collaboration between participants and preserving computing resources.

In some embodiments, a respective participant of the one or more other participants that are in shared management of the first group of objects with the first participant is currently active in the environment (e.g., as similarly discussed above with reference to the respective participant being active in the first virtual workspace), such as the second user 908 being active in the second virtual workspace in FIG. 9C. In some embodiments, while displaying the first group of objects in the first spatial arrangement in the environment in response to detecting the first input, the first computer system detects an indication of input corresponding to a request to change a visual appearance of one or more objects of the first group of objects performed by the respective participant, wherein the input is detected by a respective computer system associated with the respective participant, such as a selection of option 933 in virtual object 926 provided by the hand 903 as shown in FIG. 9H. For example, the first computer system receives data including one or more instructions and/or commands corresponding to user input detected by the respective computer system that is associated with the respective participant. In some embodiments, the indication of the input corresponding to the request to change a visual appearance of one or more objects of the first group of objects performed by the respective participant corresponds to a request to change the content included and/or displayed in the one or more objects of the first group of objects. For example, the indication of the input corresponds to an indication of a request to update display of or change display of a user interface included in a first object of the first group of objects in the first virtual workspace (e.g., from a first user interface to a second user interface).

In some embodiments, in response to detecting the indication, the first computer system updates display, via the one or more display generation components, of the one or more objects of the first group of objects to have one or more respective visual characteristics that are based on the input directed to the one or more objects of the first group of objects performed by the respective participant, such as initiating playback of a content item in accordance with the selection of the option 933 in the virtual object 926 as shown in FIG. 9I. For example, the first computer system updates display of the one or more objects of the first group of objects to include additional and/or alternative content according to the data provided by the respective computer system. In some embodiments, the first computer system updates display of the current user interface of the first object in the first group of objects to include additional or alternative images, video, text, and/or selectable user interface elements. In some embodiments, the first computer system changes the current user interface of the first object from a first user interface to a second user interface, different from the first user interface. In some embodiments, updating display of the one or more objects of the first group of objects in the first virtual workspace to include additional and/or alternative content according to the data provided by the respective computer system causes the first group of objects to have the one or more respective visual characteristics (e.g., based on the brightness, color, size, and/or other visual characteristics of the content included in the first group of objects). Accordingly, as outlined above, in some embodiments, input provided by another participant (e.g., different from the first participant) that causes the spatial arrangement of the first group of objects to change in the first virtual workspace causes (e.g., in real time) the change in the spatial arrangement of the first group of objects to be updated at the first computer system (e.g., because the first participant is currently active in the first virtual workspace). Providing a shared virtual workspace that preserves one or more visual characteristics of the display of content in a three-dimensional environment relative to a viewpoint of a user enables particular content items and interactions of the content items by other users who have access to the shared virtual workspace to be automatically updated and preserved due to their association with the shared virtual workspace, which reduces a number of inputs that would be needed to reopen the content items and/or restore the content items to their previous spatial arrangement in the three-dimensional environment relative to the viewpoint of the user, thereby improving user-device interaction and collaboration between participants and preserving computing resources.

In some embodiments, the prior user activity of the second participant at the second computer system that determines the second location in the first spatial arrangement occurs prior to detecting the first input, such as prior to detecting the selection of the second representation 922b in FIG. 9B. For example, the prior user activity of the second participant at the second computer system occurs while the first participant is not currently active in the first virtual workspace as similarly discussed above. In some embodiments, the prior user activity of the second participant at the second computer system occurs while the first group of objects are not displayed in the three-dimensional environment (e.g., before the first virtual workspace is displayed in the three-dimensional environment). Accordingly, in some embodiments, the update to the spatial arrangement of the first group of objects that is caused by the prior user activity of the second participant at the second computer system is discovered by the first participant when the first group of objects is displayed in the environment (e.g., when the first participant opens the first virtual workspace in the three-dimensional environment at the first computer system). Providing a shared virtual workspace that preserves one or more visual characteristics of the display of content in a three-dimensional environment relative to a viewpoint of a user enables particular content items and interactions of the content items by other users who have access to the shared virtual workspace while the user is not viewing the shared virtual workspace to be automatically updated and preserved due to their association with the shared virtual workspace, which reduces a number of inputs that would be needed to reopen the content items and/or restore the content items to their previous spatial arrangement in the three-dimensional environment relative to the viewpoint of the user, thereby improving user-device interaction and collaboration between participants and preserving computing resources.

In some embodiments, the environment is a three-dimensional environment that includes one or more objects, including the first group of objects, that are virtual and in which at least a portion of a physical environment of the user is visible (e.g., the three-dimensional environment is an augmented reality environment, as similarly described above), such as lamp 909 and desk 906 being visible in the three-dimensional environment 900a as shown in FIG. 9A. Providing a shared virtual workspace that preserves one or more visual characteristics of the display of content in an augmented reality environment relative to a viewpoint of a user enables particular content items and interactions of the content items by other users who have access to the shared virtual workspace to be automatically updated and preserved due to their association with the shared virtual workspace, which reduces a number of inputs that would be needed to reopen the content items and/or restore the content items to their previous spatial arrangement in the augmented reality environment relative to the viewpoint of the user, thereby improving user-device interaction and collaboration between participants and preserving computing resources.

In some embodiments, prior to detecting the first input, the first group of objects was last interacted with in a first three-dimensional environment (e.g., a first three-dimensional environment that includes a representation of at least a portion of a first physical environment in which the display generation component was operating) and wherein the first group of objects had one or more first visual properties in the first three-dimensional environment (e.g., relative to the viewpoint of the user of the first computer system), such as virtual objects 1108, 1110, and 1114 being last interacted with in three-dimensional environment 1100 that includes a first physical environment as indicated by top-down view 1115 in FIG. 11A. In some embodiments, the one or more first visual properties of the first group of objects include one or more first locations of the first group of objects relative to the viewpoint of the user, one or more first orientations of the first group of objects relative to the viewpoint of the user, one or more first brightness levels of the first group of objects, one or more first translucency levels of the first group of objects, one or more first colors of the first group of objects, and/or one or more first sizes of the first group of objects.

In some embodiments, in response to detecting the first input, in accordance with a determination that the three-dimensional environment corresponds to a second three-dimensional environment (e.g., a second three-dimensional environment that includes a representation of at least a portion of a second physical environment, different from the first physical environment, in which the display generation component is operating), different from the first three-dimensional environment, such as the three-dimensional environment 1100 that includes a second physical environment, different from the first physical environment, as indicated in top-down view 1105 in FIG. 11D, the first computer system displays, via the one or more display generation components, the first group of objects with one or more second visual properties, different from the one or more first visual properties, in the second three-dimensional environment based on one or more differences between a (e.g., physical) space available for displaying the first group of objects in the first three-dimensional environment and a (e.g., physical) space available for displaying the first group of objects in the second three-dimensional environment (e.g., one or more differences in size and/or shape of the space available for displaying the first group of objects in the first environment and a size and/or shape of the space available for displaying the first group of objects in the second environment), such as display of the virtual objects 1108, 1110, and 1114 with an updated spatial arrangement that is based on the second physical environment in the three-dimensional environment 1100 as shown in FIG. 11E. For example, when the first input is detected, the first computer system (e.g., and thus the user of the first computer system) is located in a second physical environment that is different from the first physical environment (e.g., corresponding to the first environment discussed above). In some embodiments, when the first virtual workspace that includes the first group of objects is displayed/opened while the second physical environment is visible in the three-dimensional environment (e.g., while the first participant and/or the first computer system are located in the second physical environment), the first computer system (e.g., automatically) updates the one or more visual properties of the first group of objects to accommodate the space in the second environment (e.g., one or more physical properties of the second physical environment). For example, the second physical environment has a particular room/space layout, size, occupancy, lighting, and/or shape that is different from the first physical environment, and thus optionally visually and/or spatially conflicts with the one or more first visual properties of the first group of objects relative to the viewpoint of the first participant. In some embodiments, displaying the first group of objects with the one or more second visual properties in the second three-dimensional environment based on one or more differences between a space available or displaying the first group of objects in the first three-dimensional environment and a space available for displaying the first group of objects in the second three-dimensional environment has one or more characteristics of the same in method 1200. In some embodiments, in response to detecting the first input, in accordance with a determination that the three-dimensional environment corresponds to the first three-dimensional environment (e.g., including a representation of at least a portion of the first physical environment in which the display generation component is operating), the first computer system displays the first group of objects with the one or more first visual properties in the first three-dimensional environment. In some embodiments, in accordance with a determination that the three-dimensional environment corresponds to a second three-dimensional environment (e.g., a second three-dimensional environment that includes a representation of at least a portion of a third physical environment, different from the first physical environment (and optionally the second physical environment), in which the display generation component is operating), different from the first three-dimensional environment (and optionally the second three-dimensional environment), the first computer system displays the first group of objects with one or more third visual properties, different from the one or more first visual properties (and optionally the one or more second visual properties), in the third three-dimensional environment based on one or more differences between a (e.g., physical) space available for displaying the first group of objects in the first three-dimensional environment and a (e.g., physical) space available for displaying the first group of objects in the third three-dimensional environment (e.g., one or more differences in size and/or shape of the space available for displaying the first group of objects in the first environment and a size and/or shape of the space available for displaying the first group of objects in the third environment). Updating one or more visual properties of a group of objects that is associated with a virtual workspace of a first physical environment when the virtual workspace is displayed in a second physical environment, different from the first physical environment, helps preserve one or more visual characteristics of the display of content of the group of objects while adapting the group of objects to physical characteristics of the second physical environment, which maintains visibility and/or interactivity of the content of the group of objects relative to a viewpoint of the user in the second physical environment, which also reduces a number of inputs that would be needed to reposition and/or reorient the group of objects relative to the viewpoint of the user, thereby improving user-device interaction and preserving computing resources.

In some embodiments, prior to detecting the first input, the environment includes one or more objects, different from the first group of objects, that are private to the first participant (e.g., virtual object 928 that is private to the first user 902 as indicated by pill 929 in FIG. 9E), such that content of the one or more objects is visible to the first participant without being visible to the second participant. For example, the one or more objects are viewable by and/or interactive to the first participant in the first virtual workspace, without being viewable by and/or interactive to other participants who have access to the first virtual workspace. Particularly, in some embodiments, the content of the one or more objects has not specifically been shared with the second participant though the second participant has access to the first virtual workspace. Accordingly, in some embodiments, within a shared virtual workspace, certain content items are able to be shared with one or more participants while other content items are able to remain private to the user of the first computer system. In some embodiments, the second participant is able to see a representation of the one or more objects that are private to the first participant in the first virtual workspace, without being able to see and/or interact with the content (e.g., the particular user interfaces) of the one or more objects that are private to the first participant in the first virtual workspace. Accordingly, in some embodiments, interactions provided by the first participant directed to the one or more objects that are private to the first participant are not viewable to the second participant in the first virtual workspace. In some embodiments, the one or more objects remain private to the first participant in the first virtual workspace until the one or more objects are shared with the second participant (e.g., and/or other participants) who have access to the first virtual workspace (e.g., in response to user input), as discussed in more detail below. Providing a shared virtual workspace that preserves one or more visual characteristics of the display of shared content and private content in a three-dimensional environment relative to a viewpoint of a user enables particular content items and interactions of the content items by other users who have access to the shared virtual workspace to be automatically updated and preserved due to their association with the shared virtual workspace while maintaining the privacy of the user with respect to the private content items in the shared virtual workspace, thereby improving user-device interaction and collaboration between participants and preserving computing resources.

In some embodiments, a respective object of the one or more objects (e.g., a respective private object) is displayed with a first option (e.g., pill 929 in FIG. 9E) that is selectable to share the respective object with the one or more participants (e.g., including the second participant) that are in shared management of the first group of objects with the first participant. In some embodiments, the first option is displayed within a menu or list of selectable options that are associated with the respective object, such as in a list of settings, display options, and/or privacy options associated with the respective object. In some embodiments, the first option is displayed overlaid on a portion of the respective object in the three-dimensional environment (e.g., such as within a user interface displayed by the respective object). In some embodiments, the first option is displayed adjacent to, above, or below the respective object in the three-dimensional environment relative to the viewpoint of the first participant. In some embodiments, others of the one or more objects that are private to the first participant are associated with a same or similar option as the first option that is selectable to share the one or more objects with the one or more participants in the first virtual workspace.

In some embodiments, while displaying the one or more objects, including the respective object, in the environment, the first computer system detects, via the one or more input devices, a second input directed to the first option, such as selection of the pill 929 provided by the hand 903 as shown in FIG. 9E. For example, the computer system detects an input corresponding to a request to share the respective object with the one or more participants, including the second participant, in the first virtual workspace. In some embodiments, the second input includes a selection of the first option that is associated with the respective object in the three-dimensional environment. For example, the first computer system detects an air pinch gesture performed by the hand of the first participant, optionally while the attention (e.g., including gaze) of the first participant is directed to the first option in the three-dimensional environment. In some embodiments, the second input is a set of inputs (e.g., includes a first selection input directed to the first option, followed by a second selection input designating the participants with which to share the respective object in the first virtual workspace).

In some embodiments, in response to detecting the second input, the first computer system shares the respective object with the one or more participants that are in shared management of the first group of objects with the first participant, such that content of the respective object is visible to the first participant and the second participant, such as sharing the content of the virtual object 928 with the second user 908 at the second computer system 101b as indicated in FIG. 9G. For example, the respective object becomes a shared object in the first virtual workspace. In some embodiments, when the respective object is shared with the one or more participants, the content of the respective object becomes viewable to and/or interactive to the one or more participants in the first virtual workspace. In some embodiments, the first computer system shared the respective object in response to detecting the second input without sharing others of the one or more objects that are private to the first participant in the first virtual workspace. Sharing a private content item with other users in a shared virtual workspace that preserves one or more visual characteristics of the display of shared content and private content in a three-dimensional environment relative to a viewpoint of a user in response to detecting a selection of a share option associated with the private content item reduces the number of inputs needed to share the private content item in the shared virtual workspace, thereby enabling the content item and interactions of the content item by other users to be automatically updated and preserved due to their association with the shared virtual workspace, thereby improving user-device interaction and collaboration between participants and preserving computing resources.

In some embodiments, while the one or more objects are private to the first participant, one or more visual indications of one or more locations of the one or more objects in the environment are visible to the second participant without revealing at least a portion (e.g., some or all) of the content associated with the corresponding one or more objects, such as the second computer system 101b displaying a visual indication of the virtual object 928 in three-dimensional environment 900b as shown in FIG. 9E. For example, as similarly discussed above, in the first virtual workspace, objects that are private to the first participant are represented visually to other participants who have access to the first virtual workspace without enabling the content of the private objects to be visible to and/or interactive to the other participants. In some embodiments, the one or more visual indications include and/or correspond to one or more faded representations and/or instances of the one or more objects in the first virtual workspace. For example, at the second computer system of the second participant, the one or more objects are visually represented by objects having a reduced brightness, increased transparency, reduced coloration, and/or decreased saturation, such that the locations of the one or more objects are visible to the second participant without the particular content of the one or more objects being visible to the second participant at the second computer system. In some embodiments, the one or more visual indications correspond to visual markers (e.g., virtual flags, pins, orbs, and/or labels) that provide a visual indication of the locations of the one or more objects in the environment without revealing the particular content of the one or more objects to the second participant. Displaying a visual indication of a private content item in a shared virtual workspace, without revealing the particular content of the private content item in the shared virtual workspace, maintains the privacy of the user with respect to the private content item in the shared virtual workspace and/or facilitates user discovery of the existence of private content items in the shared virtual workspace, which improves spatial awareness for the users in the shared virtual workspace, thereby improving user-device interaction and collaboration between participants.

In some embodiments, the first input includes a selection of a first graphical user interface object of a plurality of graphical user interface objects in the environment, wherein the first graphical user interface object represents the first group of objects, such as the second representation 922b corresponding to the second virtual workspace in the virtual workspaces selection user interface 920 in FIG. 9B. For example, the first input includes a selection of a representation of the first virtual workspace that is displayed in a virtual workspaces selection user interface in the three-dimensional environment. In some embodiments, the first graphical user interface object has one or more characteristics of the first graphical user interface object described in method 800. In some embodiments, the plurality of graphical user interface objects has one or more characteristics of the plurality of graphical user interface objects described in method 800.

In some embodiments, the plurality of graphical user interface objects includes a second graphical user interface object representing a second group of objects (e.g., the second graphical user interface object corresponds to a representation of a second virtual workspace), wherein the first participant is in shared management of the second group of objects with one or more second other participants, including a third participant different from the first participant and the second participant, and wherein the third participant is a user of a third computer system, different from the first computer system and the second computer system, such as third representation 922c corresponding to a third virtual workspace in the virtual workspaces selection user interface 920 as shown in FIG. 9C and as similarly shown in FIG. 7B. For example, the third participant has access to the second virtual workspace, such that the third participant is able to view and/or interact with the content of the second virtual workspace, as similarly described above with reference to the second participant who is in shared management of the first group of objects with the first participant. In some embodiments, the second graphical user interface object has one or more characteristics of the second graphical user interface object described in method 800. In some embodiments, the third participant is not in shared management of the first group of objects with the first participant (e.g., the third participant does not have access to the content of the first virtual workspace). Similarly, in some embodiments, the second participant is not in shared management of the second group of objects with the first participant (e.g., the second participant does not have access to the content of the second virtual workspace). Providing a shared virtual workspace that preserves one or more visual characteristics of the display of content in a three-dimensional environment relative to a viewpoint of a user enables particular content items and interactions of the content items by other users who have access to the shared virtual workspace to be automatically updated and preserved due to their association with the shared virtual workspace, which reduces a number of inputs that would be needed to reopen the content items and/or restore the content items to their previous spatial arrangement in the three-dimensional environment relative to the viewpoint of the user, thereby improving user-device interaction and collaboration between participants and preserving computing resources.

In some embodiments, the plurality of graphical user interface objects includes a third graphical user interface object representing a third group of objects (e.g., the third graphical user interface object represents a third virtual workspace), wherein the third group of objects is privately managed by the first participant (e.g., the first participant is not in shared management of the third group of objects with (e.g., optionally any) other participants), such as first representation 722a corresponding to a first virtual workspace in the virtual workspaces selection user interface 720 as shown in FIG. 7B. For example, the third virtual workspace, including the content of the third virtual workspace, is private to the first participant. In some embodiments, as similarly described with respect to the plurality of graphical user interface objects in method 800, the third graphical user interface object is selectable (e.g., via an air pinch gesture provided by a hand of the first participant) to launch/open the third virtual workspace in the environment (e.g., display the third group of objects in the environment). In some embodiments, because the third group of objects are privately managed by the first participant, the third group of objects has a spatial arrangement (e.g., a three-dimensional arrangement of the first group of objects in the three-dimensional environment) relative to the viewpoint of the first participant in the environment that is determined based on user activity of the first participant. For example, as similarly discussed above with reference to the first object, the third group of objects has a spatial arrangement in the three-dimensional environment that is based on input provided by the first participant (e.g., and not by other participants) directed to one or more objects in the third group of objects, such as movement and/or rotation input provided by the first participant directed to the one or more objects (e.g., via air pinch gestures provided by a hand of the first participant). In some embodiments, because the third group of objects is privately managed by the first participant, the content of the third group of objects and/or interactivity of the third group of objects are private to the first participant at the first computer system. For example, other participants who do not have access to the third virtual workspace and/or the third group of objects are unable to view and/or interact with the third group of objects and/or the content of the third group of objects at their respective computer systems. Additionally, in some embodiments, multiple virtual workspaces (e.g., including the third virtual workspace described above) are privately managed by the first participant at the first computer system. For example, a respective virtual workspace includes a fourth group of objects that is privately managed by the first participant (e.g., in addition to the third group of objects), such that the fourth group of objects has a spatial arrangement relative to the viewpoint of the first participant in the environment that is based on user activity of the first participant and/or the content of the fourth group of objects is private to the first participant, without being accessible to other participants at their respective computer systems. Providing shared virtual workspaces and private virtual workspaces that preserve one or more visual characteristics of the display of content in a three-dimensional environment relative to a viewpoint of a user enables particular content items and interactions of the content items by other users who have access to the shared virtual workspaces to be automatically updated and preserved due to their association with the shared virtual workspaces, while maintaining privacy with respect to the content items that are associated with the private virtual workspaces, thereby improving user-device interaction and collaboration between participants.

In some embodiments, in response to detecting the first input, the first computer system displays, via the one or more display generation components, a visual indication of the prior user activity of the second participant at the second computer system that causes the second object to be displayed at the second location in the environment relative to the viewpoint of the first participant, such as summary user interface 911 that includes indications 912a/912b of prior user activity in the second virtual workspace as shown in FIG. 9B. For example, when the first computer system displays the first group of objects in the first spatial arrangement in the environment in response to detecting the first input, the first computer system displays a visual record of changes and/or updates to the first group of objects (e.g., or generally the first virtual workspace), optionally since the last instance of the display of the first group of objects in the environment by the first computer system. In some embodiments, the visual indication includes and/or corresponds to a visual board, panel, or other user interface or window that displays and/or includes a written record of the prior user activity of the second participant (and/or other participants who have made changes to the first group of objects). For example, the visual indication includes an indication of the name of the second participant and the particular user action performed by the second participant, such as the input provided by the second participant for displaying the second object at the second location relative to the viewpoint of the first participant (e.g., the movement input directed to the second object and/or the input launching (e.g., initially displaying) the second object in the first virtual workspace). In some embodiments, the visual record of the changes and/or updates to the first group of objects is displayed for a predetermined amount of time (e.g., 10, 15, 30, 45, or 60 seconds, or 2, 3, 5, 10, 15, or 30 minutes) after the first group of objects is displayed in the environment. In some embodiments, the visual record of the changes and/or updates to the first group of objects is displayed for the duration that the first group of objects is displayed in the environment at the first computer system (e.g., for the duration that the first participant is active in the first virtual workspace). In some embodiments, the first computer system (e.g., continuously) updates the visual record of the changes and/or updates to the first group of objects as further changes to the first group of objects are detected. For example, if a respective object of the first group of objects is moved in the first virtual workspace (e.g., by the first participant, the second participant, or another participant), which causes the respective object to be moved relative to the viewpoint of the first participant and/or the spatial arrangement of the first group of objects to be updated relative to the viewpoint of the first participant in the three-dimensional environment, the first computer system updates the visual record to include a visual indication of the movement of the respective objects in the first virtual workspace. Displaying a visual record of interactions with content items that are associated with a shared virtual workspace performed by other users who have access to the shared virtual workspace facilitates user discovery of the current state of the content of the shared virtual workspace, thereby improving user-device interaction and collaboration between participants.

In some embodiments, the visual indication is included in a user interface in the environment, and wherein the user interface includes a plurality of visual indications (e.g., visual indications 912a/912b in FIG. 9B) of a plurality of prior user activities of the one or more other participants since a last instance of the display of the first group of objects in the environment by the first computer system (e.g., as discussed above with reference to the visual indication of the prior user activity of the second participant at the second computer system). Displaying a visual record of interactions with content items that are associated with a shared virtual workspace performed by other users who have access to the shared virtual workspace since the shared virtual workspace was last interacted with by the user facilitates user discovery of the current state of the content of the shared virtual workspace, thereby improving user-device interaction and collaboration between participants.

In some embodiments, while displaying the first group of objects in the environment, the first computer system displays, via the one or more display generation components, a user interface of a messaging thread (e.g., a message or chat board user interface) including the first participants and the one or more other participants, including the second participant, wherein the user interface of the messaging thread includes one or more messages, such as chat user interface 917 that includes messages 918a/918b in FIG. 9B. For example, while the first virtual workspace is open in the three-dimensional environment, the first computer system displays a messages user interface (e.g., a chat box or window) via which the participants who have access to the first virtual workspace are able to leave messages (e.g., text messages, image or video messages, voice messages, and the like) for each other. In some embodiments, the one or more messages include messages between specific participants. For example, a first message of the one or more messages is provided in a messaging thread between the first participant and the second participant, without including other participants of the one or more participants. In some embodiments, the one or more messages include messages that are viewable by all participants who have access to the first virtual workspace. For example, a second message of the one or more messages is provided in a global or group-wide messaging thread that includes all participants. In some embodiments, messages are able to be provided in the user interface of the messaging thread irrespective of whether participants are currently active in the first virtual workspace. For example, a message is able to be transmitted from the first participant to the second participant (or another participant) without requiring the second participant to be currently active in the first virtual workspace. In some embodiments, the message transmitted from the first participant to the second participant remains in an unread state at the second computer system until the second participant accesses the first virtual workspace and opens/reads the message transmitted by the first participant. In some embodiments, a respective message is provided to the user interface of the messaging thread in response to detecting respective input at a respective computer system. For example, while the messages user interface is displayed in the three-dimensional environment, the first computer system detects an input provided by the first participant corresponding to a request to transmit a message to one or more participants who have access to the first virtual workspace. In some embodiments, the input includes or corresponds to an air gesture provided by the first participant, such as an air pinch gesture or an air tap gesture directed to a selectable user interface element for initiating transcription of a message, such as a text-entry field or a dictation button. In some embodiments, the input includes speech input provided by the first participant, such as speech for transcribing a message or providing a voice recording to be entered into the user interface of the messaging thread. In some embodiments, the input includes interaction with a keyboard, such as a virtual keyboard displayed in the three-dimensional environment and associated with the user interface of the messaging thread or a physical keyboard in communication with the first computer system. For example, the first computer system detects selection of one or more keys of the virtual or physical keyboard for entering a message into the text-entry field of the messages user interface. In some embodiments, while displaying the respective message in the messages user interface, the first computer system detects a selection of a send button or “enter” key for transmitting the respective message to the one or more respective participants at their respective computer systems via the messages user interface. Displaying a message board user interface via which participants are able to communicate with each other within a shared virtual workspace that preserve one or more visual characteristics of the display of content in a three-dimensional environment relative to a viewpoint of a user reduces the number of inputs needed to transmit messages between participants who have access to the shared virtual workspace and/or facilitates user discovery of the current state of the content of the shared virtual workspace via the communication between the participants, thereby improving user-device interaction and collaboration between participants.

It should be understood that the particular order in which the operations in method 1000 have been described is merely exemplary and is not intended to indicate that the described order is the only order in which the operations could be performed.

FIGS. 11A-11P illustrate examples of a computer system facilitating display of content associated with a virtual workspace in a three-dimensional environment based on physical properties of a physical environment in accordance with some embodiments.

FIG. 11A illustrates a computer system 101 (e.g., an electronic device) displaying, via a display generation component (e.g., display generation component 120 of FIGS. 1 and 3), a three-dimensional environment 1100 from a viewpoint of a user 1102 in top-down view 1115 of the three-dimensional environment 1100 (e.g., facing the back wall of the physical environment in which computer system 101 is located).

In some embodiments, computer system 101 includes a display generation component 120. In FIG. 11A, the computer system 101 includes one or more internal image sensors 114a oriented towards the face of the user 1102 (e.g., eye tracking cameras 540 described with reference to FIG. 5). In some embodiments, internal image sensors 114a are used for eye tracking (e.g., detecting a gaze of the user). Internal image sensors 114a are optionally arranged on the left and right portions of display generation component 120 to enable eye tracking of the user's left and right eyes. Computer system 101 also includes external image sensors 114b and 114c facing outwards from the user to detect and/or capture the physical environment and/or movements of the user's hands.

As shown in FIG. 11A, computer system 101 captures one or more images of the physical environment around computer system 101 (e.g., operating environment 100), including one or more objects in the physical environment around computer system 101. In some embodiments, computer system 101 displays representations of the physical environment in three-dimensional environment 1100. For example, three-dimensional environment 1100 includes a representation of a desk 1106, which is optionally a representation of a physical desk in the physical environment, a representation of a lamp 1109, which is optionally a representation of a physical lamp in the physical environment, and a representation of paper 1107 including markings (e.g., hand-drawn and/or written markings, such as words, numbers, sketches, shapes, and/or special characters), which is optionally a representation of a physical paper in the physical environment.

As discussed in more detail below, in FIG. 11A, display generation component 120 is illustrated as displaying content in the three-dimensional environment 1100. In some embodiments, the content is displayed by a single display (e.g., display 510 of FIG. 5) included in display generation component 120. In some embodiments, display generation component 120 includes two or more displays (e.g., left and right display panels for the left and right eyes of the user, respectively, as described with reference to FIG. 5) having displayed outputs that are merged (e.g., by the user's brain) to create the view of the content shown in FIGS. 11A-11P.

Display generation component 120 has a field of view (e.g., a field of view captured by external image sensors 114b and 114c and/or visible to the user via display generation component 120) that corresponds to the content shown in FIG. 11A. Because computer system 101 is optionally a head-mounted device, the field of view of display generation component 120 is optionally the same as or similar to the field of view of the user (e.g., indicated in the top-down view 1115 in FIG. 11A).

As discussed herein, one or more air pinch gestures performed by a user (e.g., with hand 1103) are detected by one or more input devices of computer system 101 and interpreted as one or more user inputs directed to content displayed by computer system 101. Additionally or alternatively, in some embodiments, the one or more user inputs interpreted by computer system 101 as being directed to content displayed by computer system 101 are detected via one or more hardware input devices (e.g., controllers) rather than via the one or more input devices that are configured to detect air gestures, such as the one or more air pinch gestures, performed by the user. Such depiction is intended to be exemplary rather than limiting; the user optionally provides user inputs using different air gestures and/or using other forms of input.

As mentioned above, the computer system 101 is configured to display content in the three-dimensional environment 1100 using the display generation component 120. In FIG. 11A, three-dimensional environment 700 includes virtual objects 1108, 1110, and 1114. In some embodiments, the virtual objects 1108, 1110, and 1114 are user interfaces of applications containing content (e.g., a plurality of selectable options), three-dimensional objects (e.g., virtual clocks, virtual balls, virtual cars, etc.) or any other element displayed by computer system 101 that is not included in the physical environment of display generation component 120. For example, in FIG. 11A, the virtual object 1108 is a user interface of a mail application containing email content, such as email threads. Additionally, in some embodiments, the virtual object 1110 is a user interface of a document-editing application containing editable content, such as editable text and/or images. In some embodiments, the virtual object 1114 is a user interface of a drawing application containing one or more drawings, images, sketches, and/or shapes. It should be understood that the content discussed above is exemplary and that, in some embodiments, additional and/or alternative content and/or user interfaces are provided in the three-dimensional environment 1100, such as the content described below with reference to methods 800, 1000 and/or 1200. In some embodiments, as described in more detail below, the virtual objects 1108 and 1110 are associated with a respective virtual workspace that is currently open/launched in the three-dimensional environment 1100.

In some embodiments, as shown in FIG. 11A, the virtual objects 1108, 1110, and 1114 are displayed with movement elements 1111a, 1111b, and 1111c (e.g., grabber bars) in the three-dimensional environment 1100. In some embodiments, the movement elements 1111a, 1111b, and 1111c are selectable to initiate movement of the corresponding virtual object within the three-dimensional environment 1100 relative to the viewpoint of the user 1102. For example, the movement element 1111a that is associated with the virtual object 1108 is selectable to initiate movement of the virtual object 1108, the movement element 1111b that is associated with the virtual object 1110 is selectable to initiate movement of the virtual object 1110, and the movement element 1111c that is associated with the virtual object 1114 is selectable to initiate movement of the virtual object 1114, within the three-dimensional environment 1100.

In some embodiments, virtual objects 1108, 1110, and 1114 are displayed in three-dimensional environment 1100 at respective sizes, at respective locations, and/or with respective orientations relative to the viewpoint of user 1102 (e.g., prior to receiving further input interacting with the virtual objects, which will be described later, in three-dimensional environment 1100). In some embodiments, the respective sizes, the respective locations, and/or the respective orientations of the virtual objects 1108, 1110, and/or 1114 in FIG. 11A are determined based on prior user input directed to the virtual objects 1108, 1110, and/or 1114 (e.g., provided by the user 1102), such as input moving and/or placing the virtual objects, rotating the virtual objects, and/or resizing the virtual objects. Additionally, in some embodiments, as described below, the virtual objects 1108, 1110, and 1114 have a three-dimensional spatial arrangement in the three-dimensional environment 1100 relative to the physical environment of the computer system 101. It should be understood that the sizes, locations, and/or orientations of the virtual objects in FIGS. 11A-11P are merely exemplary and that other sizes are possible.

In some embodiments, as previously discussed herein, the computer system 101 is configured to display content associated with a plurality of virtual workspaces in the three-dimensional environment 1100, including facilitating interactions with the content of a respective virtual workspace when the respective virtual workspace is open/active in the three-dimensional environment 1100. As mentioned above, the virtual objects 1108, 1110, and 1114 are optionally associated with a respective virtual workspace that is currently open in the three-dimensional environment 1100. In some embodiments, as described in more detail in methods 800 and/or 1200, while the virtual objects 1108, 1110, and 1114 are associated with the respective virtual workspace, a status of the content of the virtual objects 1108, 1110, and 1114 is preserved between instances of display of the respective virtual workspace in the three-dimensional environment 1100. Similarly, in some embodiments, as described in more detail below, the computer system 101 preserves the three-dimensional spatial arrangement of the virtual objects 1108, 1110, and 1114 relative to the viewpoint of the user 1102 in the three-dimensional environment 1100. For example, while the virtual objects 1108, 1110, and 1114 are associated with the respective virtual workspace, locations of the virtual objects 1108, 1110, and 1114, orientations of the virtual objects 1108, 1110, and 1114, and/or sizes of the virtual objects 1108, 1110, and 1114 relative to the viewpoint of the user 1102 are preserved between instances of the display of the respective virtual workspace in the three-dimensional environment 1100. Additional details regarding virtual workspaces are provided below with references to methods 800, 1000, and/or 1200.

In some embodiments, as mentioned above, the virtual objects 1108, 1110, and 1114 have a particular three-dimensional spatial arrangement in the three-dimensional environment 1100 relative to the physical environment of the computer system 101. For example, as indicated in the top-down view 1115 in FIG. 11A, the user 1102 (e.g., and the computer system 101) is located in a first physical environment that includes the desk 1106, which is different from a second physical environment of top-down view 1105, as discussed in more detail below. In some embodiments, as shown in FIG. 11A, the virtual object 1114 is displayed atop (e.g., is anchored to) the surface of the desk 1106 in the first physical environment that is visible in the three-dimensional environment 1100. Similarly, in some embodiments, as shown in FIG. 11A, the virtual object 1108 is aligned to (e.g., is displayed in front of) the back wall of the first physical environment that is visible in the three-dimensional environment 1100, as shown in the top-down view 1115 in FIG. 11A.

In FIG. 11A, the computer system 101 detects an input corresponding to a request to close the respective virtual workspace that is currently open in the three-dimensional environment 1100. For example, as shown in FIG. 11A, the computer system 101 detects a multi-press of hardware button or hardware element 1140 of the computer system 101 provided by hand 1103 of the user 1102. In some embodiments, as illustrated in FIG. 11A, the multi-press of the hardware element 1140 corresponds to a double press of the hardware element 1140. In some embodiments, the hardware button 1140 has one or more characteristics of the hardware buttons 740 and/or 940 in FIGS. 7A-7V and/or 9A-9J above.

In some embodiments, as shown in FIG. 11B, in response to detecting the multi-press of the hardware element 1140, the computer system 101 closes the respective virtual workspace in the three-dimensional environment 1100. For example, as shown in FIG. 11B, the computer system 101 ceases display of the virtual objects 1108, 1110, and 1114 in the three-dimensional environment 1100. In some embodiments, when the computer system 101 closes the respective virtual workspace in the three-dimensional environment 1100, the computer system 101 displays virtual workspace selection user interface 1120 in the three-dimensional environment 1100. In some embodiments, as shown in FIG. 11B, the virtual workspaces selection user interface 1120 includes a plurality of representations (e.g., virtual bubbles or orbs) of a plurality of virtual workspaces that is able to be displayed (e.g., opened/launched) in the three-dimensional environment 1100. For example, as shown in FIG. 11B, the virtual workspaces selection user interface 1120 includes a first representation 1122a of a first virtual workspace (e.g., a Home virtual workspace), a second representation 1122b of a second virtual workspace (e.g., a Work virtual workspace), which optionally corresponds to the respective virtual workspace described above with reference to FIG. 11A, and a third representation 1122c of a third virtual workspace (e.g., a Travel virtual workspace). In some embodiments, as shown in FIG. 11B, the plurality of representations of the plurality of virtual workspaces in the virtual workspaces selection user interface 1120 includes representations of the content associated with the plurality of virtual workspaces. For example, in FIG. 11B, the second representation 1122b includes representations 1108-1, 1110-I, and 1114-I corresponding to the user interfaces associated with the second virtual workspace (e.g., virtual objects 1108, 1110, and 1114 in FIG. 11A above). In some embodiments, the representations of the content associated with the plurality of virtual workspaces have one or more characteristics of the representations of content associated with the plurality of virtual workspaces in the virtual workspaces selection user interface 720 in FIGS. 7A-7V above. Additionally, in some embodiments, the representations of the content associated with the plurality of virtual workspaces include a spatial arrangement that is based on the three-dimensional spatial arrangement of the content associated with the plurality of virtual workspaces. For example, as shown in FIG. 11B, the representations 1108-1, 1110-I, and 1114-I in the second representation 1122b have a first three-dimensional spatial arrangement relative to the viewpoint of the user 1102 that is based on and/or that corresponds to the three-dimensional spatial arrangement of the virtual objects 1108, 1110, and 1114 that are associated with the second virtual workspace above. Additional details regarding the virtual workspaces selection user interface 1120 and the plurality of representations of the plurality of virtual workspaces are provided with reference to methods 800, 1000, and/or 1200.

In FIG. 11B, the user 1102, and thus the computer system 101, travels from the first physical environment indicated in the top-down view 1115 to the second physical environment indicated in the top-down view 1105 as illustrated by the dashed arrow. For example, while the user 1102 is wearing (e.g., using) the computer system 101, the computer system 101 detects the user 1102 walk from the first physical environment (e.g., which corresponds to a first room) to the second physical environment (e.g., which corresponds to a second room, different from the first room, in a same building, house, or other location). Alternatively, in some embodiments, the computer system 101 detects disassociation of the computer system 101 from the user 1102, such as via the user 1102 removing the computer system 101, powering down the computer system 101, activating a sleep mode on the computer system 101, and/or otherwise ceasing use of the computer system 101, while the user 1102 is located in the first physical environment, and later detects reassociation of the computer system 101 with the user 1102, such as via the user 1102 redonning the computer system 101, powering on the computer system 101, waking up the computer system 101, and/or otherwise continuing user of the computer system 101, when the user 1102 is located in the second physical environment.

In some embodiments, as shown in FIG. 11C, after the user 1102 has traveled to the second physical environment, as indicated in the top-down view 1105, and while the computer system 101 is in use, the computer system 101 redisplays the three-dimensional environment 1100 from an updated viewpoint of the user 1102 in the second physical environment. For example, as shown in the top-down view 1105 in FIG. 11C, the user 1102 is facing a corner of the second physical environment when the computer system 101 redisplays the three-dimensional environment 1100. Accordingly, as shown in FIG. 11C, the three-dimensional environment 1100 includes a representation of the corner, ceiling, and floor of the second physical environment that is visible from the updated viewpoint of the user 1102.

In FIG. 11C, the computer system 101 detects an input corresponding to a request to redisplay the virtual workspaces selection user interface 1120 in the three-dimensional environment 1100. For example, as shown in FIG. 11C, the computer system 101 detects a multi-press (e.g., a double press) of the hardware element 1140 of the computer system 101 provided by the hand 1103, as similarly described herein.

In some embodiments, as shown in FIG. 11D, in response to detecting the multi-press of the hardware element 1140, the computer system 101 displays the virtual workspaces selection user interface 1120 in the three-dimensional environment 1100. In FIG. 11D, after displaying the virtual workspaces selection user interface 1120 in the three-dimensional environment 1100, the computer system 101 detects an input corresponding to a request to display the second virtual workspace in the three-dimensional environment 1100. For example, as shown in FIG. 11D, the computer system 101 detects an air pinch gesture provided by the hand 1103, optionally while the attention (e.g., including the gaze 1112) of the user 1102 is directed to the second representation 1122b in the three-dimensional environment 1100.

In some embodiments, as shown in FIG. 11E, in response to detecting the selection of the second representation 1122b, the computer system 101 displays the second virtual workspace in the three-dimensional environment 1100. For example, as shown in FIG. 11E, the computer system 101 displays the virtual objects 1108, 1110, and 1114 in the three-dimensional environment 1100.

In some embodiments, when the computer system 101 displays the second virtual workspace in the three-dimensional environment 1100, the computer system 101 updates one or more spatial properties of the virtual objects 1108, 1110, and 1114 to accommodate one or more physical properties of the second physical environment. For example, as illustrated via the top-down views 1105 and 1115, the second physical environment is different from the first physical environment. Particularly, in some embodiments, the second physical environment in the top-down view 1105 is smaller (e.g., in size and/or dimensionality) than the first physical environment in the top-down view 1115. Additionally, in some embodiments, as illustrated in the top-down view 1105, when the computer system 101 displays the second virtual workspace in the three-dimensional environment 1100, the physical space in front of the user 1102 in the second physical environment is smaller than the physical space in front of the user 1102 in the first physical environment in FIG. 11A (e.g., because the user 1102 is positioned facing the corner of the second physical environment as discussed above). Accordingly, in some embodiments, the computer system 101 changes a size of the virtual objects 1108, 1110, and 1114 in the three-dimensional environment 1100. For example, as shown in FIG. 11E, the computer system 101 decreases the sizes of the virtual objects 1108, 1110, and 1114 to accommodate the decreased size of the physical space in front of the user 1102. Additionally, in some embodiments, as shown in FIG. 11E, the computer system 101 updates a distance at which the virtual objects 1108, 1110, and 1114 are displayed relative to the viewpoint of the user 1102 in the three-dimensional environment 1100. For example, as illustrated in the top-down view 1105, the computer system 101 decreases the distances at which the virtual objects 1108, 1110, and 1114 are displayed relative to the viewpoint of the user 1102 to accommodate the decreased size of the physical pace in front of the user 1102. In some embodiments, as shown in FIG. 11E, the computer system 101 updates a spatial distribution of the virtual objects 1108, 1110, and 1114 in the three-dimensional environment 1100 relative to the viewpoint of the user 1102 based on the physical properties of the second physical environment. For example, as shown in FIG. 11E, the computer system 101 shifts the virtual objects 1108, 1110, and/or 1114 in the three-dimensional environment 1100, such that the virtual objects 1108, 1110, and/or 1114 appear closer together relative to the viewpoint of the user 1102 (e.g., and remain in the field of view of the user 1102). In some embodiments, when the computer system 101 updates the one or more spatial properties of the virtual objects 1108, 1110, and 1114 in the manner discussed above, the computer system 101 maintains the amount of the field of view of the user 1102 that is occupied by the virtual objects 1108, 1110, and 1114 between the display of the second virtual workspace in the first physical environment and the second physical environment. For example, the amount of the field of view of the user 1102 that is occupied by the virtual objects 1108, 1110, and 1114 in the three-dimensional environment in FIG. 11A is approximately the same as in FIG. 11E.

In some embodiments, when the computer system 101 displays the second virtual workspace in the three-dimensional environment 1100 that includes the second physical environment, the computer system 101 generates and displays virtual representations of significant physical properties of the first physical environment (e.g., physical properties satisfying one or more selection criteria). For example, as shown in FIG. 11E, the computer system 101 displays virtual surface 1121 corresponding to (e.g., having a same or similar size, visual appearance, shape, and/or surface texture as) the physical surface of the physical desk 1106 in the first physical environment. Similarly, as shown in FIG. 11E, the computer system 101 optionally displays virtual paper 1123 that includes virtual representations of the marks of the physical paper 1107 positioned on the desk 1106 in the first physical environment. In some embodiments, the desk 1106 satisfies the one or more selection criteria and is thus virtually represented when the second virtual workspace is displayed in the three-dimensional environment 1100 that that includes the second physical environment because the virtual object 1114 is anchored to the desk 1106 in the first physical environment (e.g., the top surface of the desk 1106 serves as a display anchor for the virtual object 1114). In some embodiments, the paper 1107 that includes the handwritten marks satisfies the one or more selection criteria and is thus virtually represented when the second virtual workspace is displayed in the three-dimensional environment 1100 that includes the second physical environment because the handwritten marks relate to and/or are associated with the content of one or more of the virtual objects 1108, 1110, and 1114. For example, the handwritten marks include notes and/or sketches that were provided by the user 1102 while the virtual objects 1108, 1110, and 1114 were displayed in the three-dimensional environment 1100 while the user 1102 was located in the first physical environment. It should be understood that, in some embodiments, the computer system 101 displays virtual representations of physical properties of the first physical environment that satisfy the one or more criteria in accordance with a determination that the second physical environment does not include the same or similar physical properties. Additional details regarding the display of virtual representations of physical properties satisfying the one or more selection criteria are provided below with reference to method 1200.

In FIG. 11E, the computer system 101 detects an input corresponding to a request to close the second virtual workspace that is currently open in the three-dimensional environment 1100. For example, as shown in FIG. 11E, the computer system 101 detects a multi-press (e.g., a double press) of hardware element 1140 of the computer system 101 provided by hand 1103 of the user 1102.

In some embodiments, as shown in FIG. 11F, in response to detecting the multi-press of the hardware element 1140, the computer system 101 closes the second virtual workspace in the three-dimensional environment 1100. For example, as shown in FIG. 11F, the computer system 101 ceases display of the virtual objects 1108, 1110, and 1114, including the virtual surface 1121 and the virtual paper 1123, in the three-dimensional environment 1100. In some embodiments, as similarly discussed above, when the computer system 101 closes the second virtual workspace in the three-dimensional environment 1100, the computer system 101 displays the virtual workspaces selection user interface 1120 in the three-dimensional environment 1100, as shown in FIG. 11F.

In FIG. 11F, the computer system 101 detects movement of the viewpoint of the user 1102 relative to the three-dimensional environment 1100. For example, as shown in the top-down view 1105, the computer system 101 detects the user 1102 walk toward table 1104 in the second physical environment, as indicated by the dashed arrow. In some embodiments, the movement of the user 1102 causes the computer system 101 to move in the second physical environment, which is detected via one or more motion sensors of the computer system 101, thereby updating the viewpoint of the user 1102.

In some embodiments, as shown in FIG. 11G, when the user 1102 moves in the second physical environment, as illustrated in the top-down view 1105, the computer system 101 updates display of the three-dimensional environment 1100 based on the updated viewpoint of the user 1102. For example, as shown in FIG. 11G, because the user 1102 is positioned in front of and facing toward the table 1104 in the second physical environment, the three-dimensional environment 1100 includes a representation of the table 1104 that is visible in the field of view of the user 1102 from the updated viewpoint of the user 1102.

In FIG. 11G, the computer system 101 detects an input corresponding to a request to redisplay the virtual workspaces selection user interface 1120 in the three-dimensional environment 1100 from the updated viewpoint of the user 1102. For example, as shown in FIG. 11G and as similarly discussed above, the computer system 101 detects a multi-press (e.g., a double-press) of the hardware element 1140 provided by the hand 1103 of the user 1102.

In some embodiments, as shown in FIG. 11H, the computer system 101 detects an input corresponding to a request to redisplay the second virtual workspace in the three-dimensional environment 1100 from the updated viewpoint of the user 1102. For example, as shown in FIG. 11H, the computer system 101 detects an air gesture performed by the hand 1103, optionally while the attention (e.g., including the gaze 1112) of the user 1102 is directed to the second representation 1122b of the virtual workspaces selection user interface 1120.

In some embodiments, as shown in FIG. 11I, in response to detecting the selection of the second representation 1122b, the computer system 101 redisplays the second virtual workspace in the three-dimensional environment 1100 from the updated viewpoint of the user 1102. For example, as shown in FIG. 11I, the computer system 101 displays the virtual objects 1108, 1110, and 1114 in the three-dimensional environment 1100. In some embodiments, as similarly discussed above, when the computer system 101 displays the second virtual workspace in the three-dimensional environment 1100, the computer system 101 updates one or more spatial properties of the virtual objects 1108, 1110, and/or 1114 based on one or more physical properties of the second physical environment. As illustrated in the top-down view 1105, when the computer system 101 redisplays the second virtual workspace in the three-dimensional environment 1100, the user 1102 is optionally positioned in front of the table 1104 in the second physical environment. In some embodiments, when the second virtual workspace is displayed in the three-dimensional environment 1100, the computer system 101 anchors the virtual object 1114 to the surface of the table 1104. Particularly, the computer system 101 optionally identifies the table 1104 as being an object that is similar to the desk 1106 of the first physical environment to which the virtual object 1114 is anchored, and therefore determines that the table 1104 will serve as a sufficient anchoring surface for the virtual object 1114 in the second physical environment. Similarly, as illustrated in the top-down view 1105, in some embodiments, when the second virtual workspace is displayed in the three-dimensional environment 1100, the computer system 101 aligns the virtual object 1108 to the wall behind the table 1104 in the three-dimensional environment 1100 from the viewpoint of the user 1102. Particularly, in some embodiments, the computer system 101 identifies the back wall as being a vertical surface that is similar to the wall of the first physical environment to which the virtual object 1108 is aligned, and therefore determines that the wall behind the table 1104 will serve as a sufficient alignment surface for the virtual object 1108 in the second physical environment.

In FIG. 11I, the computer system 101 detects an input corresponding to a request to move the virtual object 1108 in the three-dimensional environment 1100 relative to the viewpoint of the user 1102. For example, as shown in FIG. 11I, the computer system 101 detects an air pinch and drag gesture performed by the hand 1103, optionally while the attention (e.g., including the gaze 1112) of the user 1102 is directed to the movement element 1111a that is associated with the virtual object 1108. In some embodiments, as indicated in FIG. 11I, the air pinch and drag gesture includes movement of the hand 1103 leftward relative to the viewpoint of the user 1102.

In some embodiments, as shown in FIG. 11J, in response to detecting the input provided by the hand 1103, the computer system 101 moves the virtual object 1108 leftward in the three-dimensional environment 1100 relative to the viewpoint of the user 1102 in accordance with the movement of the hand 1103. In some embodiments, as similarly described with reference to method 800, the movement of the virtual object 1108 relative to the viewpoint of the user 1102 corresponds to an event that causes the three-dimensional spatial arrangement of the virtual objects 1108, 1110, and 1114 to be updated in the second virtual workspace. For example, as shown in FIG. 11J, a distance between the virtual object 1108 and the virtual object 1110 is increased as a result of the leftward movement of the virtual object 1108 in the three-dimensional environment 1100.

In FIG. 11J, the computer system 101 detects an input corresponding to a request to close the second virtual workspace that is currently open in the three-dimensional environment 1100. For example, as shown in FIG. 11J, the computer system 101 detects a multi-press (e.g., a double press) of hardware element 1140 of the computer system 101 provided by hand 1103 of the user 1102.

In some embodiments, as shown in FIG. 11K, in response to detecting the multi-press of the hardware element 1140, the computer system 101 closes the second virtual workspace in the three-dimensional environment 1100. For example, as shown in FIG. 11K, the computer system 101 ceases display of the virtual objects 1108, 1110, and 1114 in the three-dimensional environment 1100. In some embodiments, as similarly discussed above, when the computer system 101 closes the second virtual workspace in the three-dimensional environment 1100, the computer system 101 displays the virtual workspaces selection user interface 1120 in the three-dimensional environment 1100, as shown in FIG. 11K.

In some embodiments, as shown in FIG. 11K, when the virtual workspaces selection user interface 1120 is displayed in the three-dimensional environment 1100, the second representation 1122b of the second virtual workspace is updated to reflect the interaction discussed above with reference to FIGS. 11I-11J. For example, as shown in FIG. 11K, the representation 1108-1 in the second representation 1122b is updated based on the movement of the virtual object 1108 within the second virtual workspace relative to the viewpoint of the user 1102 (e.g., the representation 1108-1 is located farther from the representation 1110-I a).

In FIG. 11K, the user 1102, and thus the computer system 101, travels from the second physical environment indicated in the top-down view 1105 back to the first physical environment indicated in the top-down view 1115 as illustrated by the dashed arrow. For example, while the user 1102 is wearing (e.g., using) the computer system 101, the computer system 101 detects the user 1102 walk from the second physical environment (e.g., which corresponds to a first room) to the first physical environment (e.g., which corresponds to a second room, different from the first room, in a same building, house, or other location). Alternatively, in some embodiments, the computer system 101 detects disassociation of the computer system 101 from the user 1102, such as via the user 1102 removing the computer system 101, powering down the computer system 101, activating a sleep mode on the computer system 101, and/or otherwise ceasing use of the computer system 101, while the user 1102 is located in the second physical environment, and later detects reassociation of the computer system 101 with the user 1102, such as via the user 1102 redonning the computer system 101, powering on the computer system 101, waking up the computer system 101, and/or otherwise continuing user of the computer system 101, when the user 1102 is located in the first physical environment.

In some embodiments, as shown in FIG. 11L, after the user 1102 has traveled back to the first physical environment, as indicated in the top-down view 1115, and while the computer system 101 is in use, the computer system 101 redisplays the three-dimensional environment 1100 from an updated viewpoint of the user 1102 in the first physical environment. For example, as shown in the top-down view 1115 in FIG. 11L, the user 1102 is positioned in front of and facing the desk 1106 in the first physical environment when the computer system 101 redisplays the three-dimensional environment 1100. Accordingly, as shown in FIG. 11L, the three-dimensional environment 1100 includes the representation of the desk 1106 and the representation of the wall located behind the desk that are visible from the updated viewpoint of the user 1102.

In FIG. 11L, the computer system 101 detects an input corresponding to a request to redisplay the virtual workspaces selection user interface 1120 in the three-dimensional environment 1100. For example, as shown in FIG. 11L, the computer system 101 detects a multi-press (e.g., a double press) of the hardware element 1140 of the computer system 101 provided by the hand 1103, as similarly described herein.

In some embodiments, as shown in FIG. 11M, in response to detecting the multi-press of the hardware element 1140, the computer system 101 displays the virtual workspaces selection user interface 1120 in the three-dimensional environment 1100. In FIG. 11M, while displaying the virtual workspaces selection user interface 1120, the computer system 101 detects a selection of the second representation 1122b of the second virtual workspace. For example, as shown in FIG. 11M, while displaying the virtual workspaces selection user interface 1120, the computer system 101 detects an air pinch gesture performed by the hand 1103, optionally while the attention (e.g., including the gaze 1112) of the user 1102 is directed to the second representation 1122b in the three-dimensional environment 1100.

In some embodiments, as shown in FIG. 11N, in response to detecting the selection of the second representation 1122b, the computer system 101 displays the second virtual workspace in the three-dimensional environment 1100. For example, as shown in FIG. 11N, the computer system 101 displays the virtual objects 1108, 1110, and 1114 in the three-dimensional environment 1100. In some embodiments, as shown in FIG. 11N, when the virtual objects 1108, 1110, and 1114 are displayed in the three-dimensional environment 1100 that includes the first physical environment, the virtual objects 1108, 1110, and 1114 have the same updated three-dimensional spatial arrangement as in the second physical environment in FIG. 11J above. Additionally, in some embodiments, as shown in the top-down view 1115 in FIG. 11N, the virtual object 1114 is anchored to the surface of the desk 1106 (e.g., adjacent to the paper 1107) in the three-dimensional environment 1100 and the virtual object 1108 is aligned to the wall behind the desk 1106 from the viewpoint of the user 1102 (e.g., while maintaining the same relative position in the three-dimensional environment 1100 as in FIG. 11J), as similarly described above with reference to FIG. 11A.

In FIG. 11N, the computer system 101 detects an input corresponding to a request to close the second virtual workspace in the three-dimensional environment 1100. For example, as shown in FIG. 11N, the computer system 101 detects a multi-press (e.g., a double press) of the hardware element 1140 of the computer system 101 provided by the hand 1103.

In some embodiments, as shown in FIG. 11O, in response to detecting the multi-press of the hardware element 1140, the computer system 101 ceases display of the virtual objects 1108, 1110, and 1114 and displays the virtual workspaces selection user interface 1120 in the three-dimensional environment 1100. As shown in FIG. 11O, while displaying the virtual workspaces selection user interface 1120, the computer system 101 detects an input corresponding to a request to display the first virtual workspace in the three-dimensional environment 1100. For example, as shown in FIG. 11O, the computer system 101 detects an air pinch gesture performed by the hand 1103, optionally while the attention (e.g., including the gaze 1112) of the user 1102 is directed to the first representation 1122a of the first virtual workspace in the virtual workspaces selection user interface 1120.

In some embodiments, as shown in FIG. 11P, the computer system 101 displays the first virtual workspace in the three-dimensional environment 1100. For example, as shown in FIG. 11P, the computer system 101 displays virtual objects 1124, 1126, and 1128 in the three-dimensional environment 1100. In some embodiments, the virtual objects 1124, 1126, and 1128 include user interfaces from applications running on the computer system 101, as similarly discussed above. In some embodiments, as shown in FIG. 11P, the virtual objects 1124, 1126, and 1128 of the first virtual workspace have a respective three-dimensional spatial arrangement in the three-dimensional environment, as indicated in the top-down view 1115, relative to the viewpoint of the user 1102. In some embodiments, as illustrated in FIG. 11P, the three-dimensional spatial arrangement of the virtual objects 1124, 1126, and 1128 is different from the three-dimensional spatial arrangement of the virtual objects 1108, 1110, and 1114 of the second virtual workspace in the three-dimensional environment 1100 in FIG. 11N. Particularly, in some embodiments, the virtual objects 1124, 1126, and 1128 have a different three-dimensional spatial arrangement relative to the physical properties of the first physical environment (e.g., the desk 1106 and the back wall) in the three-dimensional environment 1100, as illustrated in the top-down view 1115 in FIG. 11N.

FIG. 12 is a flowchart illustrating an exemplary method 1200 of facilitating display of content associated with a virtual workspace in a three-dimensional environment based on physical properties of a physical environment in accordance with some embodiments. In some embodiments, the method 1200 is performed at a computer system (e.g., computer system 101 in FIG. 1 such as a tablet, smartphone, wearable computer, or head mounted device) including a display generation component (e.g., display generation component 120 in FIGS. 1, 3, and 4) (e.g., a heads-up display, a display, a touchscreen, and/or a projector) and one or more cameras (e.g., a camera (e.g., color sensors, infrared sensors, and other depth-sensing cameras) that points downward at a user's hand or a camera that points forward from the user's head). In some embodiments, the method 1200 is governed by instructions that are stored in a non-transitory computer-readable storage medium and that are executed by one or more processors of a computer system, such as the one or more processors 202 of computer system 101 (e.g., control unit 110 in FIG. 1A). Some operations in method 1200 are, optionally, combined and/or the order of some operations is, optionally, changed.

In some embodiments, method 1200 is performed at a computer system (e.g., computer system 101 in FIG. 11A) in communication with one or more display generation components (e.g., display 120) and one or more input devices (e.g., image sensors 114a-114c). For example, the computer system is or includes an electronic device, such as a mobile device (e.g., a tablet, a smartphone, a media player, or a wearable device), or a computer. In some embodiments, the computer system has one or more characteristics of the computer systems in methods 800 and/or 1000. In some embodiments, the one or more display generation components have one or more characteristics of the one or more display generation components in methods 800 and/or 1000. In some embodiments, the one or more input devices have one or more characteristics of the one or more input devices in methods 800 and/or 1000.

In some embodiments, while a respective environment (e.g., a three-dimensional environment that includes a representation of at least a portion of a physical environment in which the display generation component is operating) is visible via the display generation component, such as three-dimensional environment 1100 in FIG. 11A, the computer system detects (1202), via the one or more input devices, a first input corresponding to a request to display a first group of objects in the respective environment, such as selection of second representation 1122b corresponding to a second virtual workspace in virtual workspaces selection user interface 1120 provided by hand 1103 as shown in FIG. 11D, wherein, prior to detecting the first input, the first group of objects was last interacted with in a first environment (e.g., a first three-dimensional environment that includes a representation of at least a portion of a first physical environment in which the display generation component was operating) and wherein the first group of objects had one or more first visual properties in the first environment (e.g., relative to a viewpoint of a user of the computer system), such as the spatial arrangement of virtual objects 1108, 1110, and 1114 in the three-dimensional environment 1100 shown in FIG. 11A. In some embodiments, the respective environment is an extended reality (XR) environment, such as a virtual reality (VR) environment, a mixed reality (MR) environment, or an augmented reality (AR) environment. In some embodiments, the representation of the at least the portion of the physical environment corresponds to a passthrough representation of the at least the portion of the physical environment that is visible in the three-dimensional environment. For example, the at least the portion of the physical environment is visible in the three-dimensional environment via optical or virtual passthrough, as defined herein. In some embodiments, the representation of the at least the portion of the physical environment corresponds to a virtual representation of the at least the portion of the physical environment that is displayed in the three-dimensional environment. In some embodiments, the environment has one or more characteristics of the environment(s) in methods 800 and/or 1000. In some embodiments, the first group of objects corresponds to a first group of virtual objects displayed by the first computer system. In some embodiments, the first input corresponding to the request to display the first group of objects corresponds to a request to display a respective virtual workspace in the respective environment. For example, the first group of objects is associated with a first virtual workspace. In some embodiments, the first virtual workspace is associated with a particular physical environment, such as the first physical environment that is visible in the first three-dimensional environment discussed above. In some embodiments, the first virtual workspace has one or more characteristics of the virtual workspace(s) in methods 800 and/or 1000. In some embodiments, the first virtual workspace corresponds to a virtual workspace that is shared with (e.g., viewable by and/or interactive to) one or more users, including at least the first user, which causes all shared content associated with the first virtual workspace to be shared with the one or more users, as described with reference to method 1000. In some embodiments, the one or more first visual properties of the first group of objects include one or more first locations of the first group of objects relative to the viewpoint of the user, one or more first orientations of the first group of objects relative to the viewpoint of the user, one or more first brightness levels of the first group of objects, one or more first translucency levels of the first group of objects, one or more first colors of the first group of objects, and/or one or more first sizes of the first group of objects. In some embodiments, the first group of objects has one or more characteristics of the objects in methods 800 and/or 1000. In some embodiments, when the first object is displayed in the first environment, the first group of objects is displayed with the one or more first visual properties relative to the viewpoint of the user in the first environment based on prior user activity, such as prior user interaction of the first user or a second user (e.g., of a second computer system) with which the first group of objects is shared. For example, the prior user activity that causes the first group of objects to be displayed with the one or more first visual properties corresponds to and/or includes movement input provided by the first user (or a second user) and detected by the first computer system (or a second computer system) during a last instance of the display of the first group of objects. As an example, when the first group of objects was last displayed (e.g., when the (optionally shared) virtual workspace was last open) in the first three-dimensional environment, the first group of objects was positioned at one or more first locations, oriented with one or more first orientations, displayed with one or more first sizes, and/or caused to display respective content (e.g., user interfaces) relative to the viewpoint of the first user (or the second user) in response to the first computer system (or a second computer system) detecting an input provided by the first user (or the second user), such as an air pinch and drag gesture directed to one or more objects of the first group of objects or selection of respective options displayed within one or more objects of the first group of objects, that causes the first group of objects to be displayed with the one or more first visual properties discussed above. In some embodiments, as similarly described in method 800, interactions with objects and/or content in a respective virtual workspace is preserved/maintained (e.g., such that a state of the objects and/or content, including the positions, orientations, sizes, and/or visual appearances of the objects and/or content, within the respective virtual workspace is saved, such as in a memory or cloud storage of a respective computer system).

In some embodiments, the first input includes and/or corresponds to interaction with one or more graphical user interface objects displayed in the three-dimensional environment. For example, as discussed with reference to method 800, the computer system is displaying a virtual workspaces selection user interface that includes one or more representations of one or more virtual workspaces in the three-dimensional environment. In some embodiments, the first input includes a selection (e.g., via an air gesture) directed to a respective representation of the one or more representations of the one or more virtual workspaces in the virtual workspaces selection user interface. In some embodiments, the first input has one or more characteristics of the input(s) described in methods 800 and/or 1000.

In some embodiments, in response to detecting the first input (1204), in accordance with a determination that the respective environment corresponds to a second environment (e.g., a second three-dimensional environment that includes a representation of at least a portion of a second physical environment, different from the first physical environment, in which the display generation component is operating), different from the first environment, such as the computer system 101 being located in the second physical environment as illustrated in top-down view 1105 in FIG. 11D, the computer system displays (1206), via the one or more display generation components, the first group of objects with one or more second visual properties, different from the one or more first visual properties, in the second environment based on one or more differences between a (e.g., physical) space available for displaying the first group of objects in the first environment and a (e.g., physical) space available for displaying the first group of objects in the second environment (e.g., one or more differences in size and/or shape of the space available for displaying the first group of objects in the first environment and a size and/or shape of the space available for displaying the first group of objects in the second environment), such as displaying the virtual objects 1108, 1110, and 1114 with an updated spatial arrangement based on physical properties of the second physical environment in the three-dimensional environment 1100 as shown in FIG. 11E. For example, when the first input is detected, the computer system (e.g., and thus the user of the computer system) is located in a second physical environment that is different from the first physical environment (e.g., corresponding to the first environment discussed above). In some embodiments, the second environment corresponds to a different room or space than the first environment. In some embodiments, the second environment includes physical objects that are different from those of the first environment. In some embodiments, as mentioned above, the first virtual workspace with which the first group of objects is associated is anchored/tied to a particular physical environment, such as the first physical environment discussed above. Particularly, in some embodiments, in addition to the first group of objects having the one or more first visual properties that are based on prior user input, as discussed above, the first group of objects have a particular spatial arrangement relative to the first physical environment (e.g., in the space of the first environment), including physical objects within the first physical environment. For example, the first group of objects have been positioned by the user of the computer system to be located above and/or proximate to particular surfaces of the first physical environment, such as above and/or on tables/desks or in front of and/or on walls of the first physical environment relative to the viewpoint of the user. Accordingly, in some embodiments, when the first virtual workspace that includes the first group of objects is displayed/opened while the second physical environment is visible in the respective three-dimensional environment (e.g., while the user and/or the computer system are located in the second physical environment), the computer system updates the one or more visual properties of the first group of objects to accommodate the space in the second environment (e.g., one or more physical properties of the second physical environment). For example, the second physical environment has a particular room/space layout, size, occupancy, lighting, and/or shape that is different from the first physical environment, and thus optionally visually and/or spatially conflicts with the one or more first visual properties of the first group of objects relative to the viewpoint of the user. As an example, the spatial arrangement of the first group of objects while in the first physical environment is selected by the user such that one or more objects of the first group of objects are positioned at certain distances and/or with certain orientations relative to the viewpoint of the user and/or relative to the first physical environment. However, such a spatial arrangement of the first group of objects in the second physical environment, for example, causes one or more objects of the first group of objects to intersect with, overlap with, and/or otherwise spatially conflict with one or more portions of the second physical environment (e.g., the space of the second environment), such as physical objects, walls, ceilings, and/or other boundaries. Accordingly, in some embodiments, the computer system automatically updates the one or more visual properties of the first group of objects to have the one or more second visual properties in the second environment. In some embodiments, the one or more second visual properties of the first group of objects include one or more second locations of the first group of objects relative to the viewpoint of the user, one or more second orientations of the first group of objects relative to the viewpoint of the user, one or more second brightness levels of the first group of objects, one or more second translucency levels of the first group of objects, one or more second colors of the first group of objects, and/or one or more second sizes of the first group of objects, optionally different from those of the one or more first visual properties discussed above. In some embodiments, in accordance with a determination that the respective environment corresponds to the first environment, the computer system displays the first group of objects with the one or more first visual properties in the first environment. Updating one or more visual properties of a group of objects that is associated with a virtual workspace of a first physical environment when the virtual workspace is displayed in a second physical environment, different from the first physical environment, helps preserve one or more visual characteristics of the display of content of the group of objects while adapting the group of objects to physical characteristics of the second physical environment, which maintains visibility and/or interactivity of the content of the group of objects relative to a viewpoint of the user in the second physical environment, which also reduces a number of inputs that would be needed to reposition and/or reorient the group of objects relative to the viewpoint of the user, thereby improving user-device interaction and preserving computing resources.

In some embodiments, in response to detecting the first input, in accordance with a determination that the respective environment corresponds to the first environment, the computer system displays, via the one or more display generation components, the first group of objects (e.g., associated with the first virtual workspace) with the one or more first visual properties in the first environment, such as the spatial arrangement of the virtual objects 1108, 1110, and 1114 in the three-dimensional environment 1100 shown in FIG. 11A. For example, if the computer system (e.g., and the user of the computer system) is located in the same environment in which the first group of objects was last interacted with by the user when the first input is detected, the computer system redisplays the first group of objects in the first environment and maintains display of the first group of objects with the one or more first visual properties discussed above. Maintaining one or more visual properties of a group of objects that is associated with a virtual workspace of a first physical environment when the virtual workspace is redisplayed in the first physical environment helps automatically preserve one or more visual characteristics of the display of content of the group of objects, which reduces a number of inputs that would be needed to reposition and/or reorient the group of objects relative to the viewpoint of the user, thereby improving user-device interaction and preserving computing resources.

In some embodiments, the first environment (e.g., first physical environment) is associated with the user of the computer system, such as the first physical environment indicated in the top-down view 1115 being associated with the user 1102 in FIG. 11A. For example, the first environment is a physical environment belonging to, occupied by, and/or otherwise known to the user of the computer system. In some embodiments, the first environment includes a home of the user, and/or a room of the home of the user. In some embodiments, the first environment includes a workplace of the user, such as an office of the user. In some embodiments, the first environment includes a school of the user, such as a high school, college, university, or other education center. In some embodiments, as similarly described with reference to method 800, the first virtual workspace is specifically associated with (e.g., anchored to) the first environment because the first virtual workspace was first created while the user (e.g., and the computer system) was located in the first environment. In some embodiments, the association of the first environment with the user of the computer system is known and/or determined by the computer system based on application data accessible by the computer system. For example, the computer system determines that the first environment is or includes a home or workplace of the user based on data provided by a navigation application, contacts application, calendar application, and/or web-browsing application. In some embodiments, the association of the first environment with the user of the computer system is known and/or determined by the computer system based on one or more user settings configured by the user. Accordingly, in some embodiments, the second environment (e.g., the second physical environment) corresponds to an environment or space that is not associated with the user of the computer system. Updating one or more visual properties of a group of objects that is associated with a virtual workspace of a first physical environment associated with the user of the computer system when the virtual workspace is displayed in a second physical environment, different from the first physical environment, helps preserve one or more visual characteristics of the display of content of the group of objects while adapting the group of objects to physical characteristics of the second physical environment, which maintains visibility and/or interactivity of the content of the group of objects relative to a viewpoint of the user in the second physical environment, which also reduces a number of inputs that would be needed to reposition and/or reorient the group of objects relative to the viewpoint of the user, thereby improving user-device interaction and preserving computing resources.

In some embodiments, the first environment is associated with a second user, different from the user, of a second computer system, different from the computer system, such as the first physical environment indicated in the top-down view 1115 being associated with a user that is different from the user 1102 in FIG. 11A. For example, the first group of objects was last interacted with by the user of the computer system while the first group of objects was displayed in the first environment by the computer system, or the first group of objects was last interacted with by the second user of the second computer system while the first group of objects was displayed in the first environment by the second computer system. In some embodiments, the user of the computer system is in shared management of the first group of objects with the second user of the second computer system. For example, as similarly described with reference to method 1000, the second user has access to the first virtual workspace and is able to view and/or interact with the content of the first virtual workspace, including the first group of objects. In some embodiments, the first virtual workspace is therefore owned by (e.g., was first created by) the second user, and was optionally first created while the second user was located in the first environment. For example, the user of the computer system has access to the first virtual workspace because the second user provided access to the user of the computer system (e.g., the content of the first virtual workspace was shared with the user). In some embodiments, the second environment is a physical environment belonging to, occupied by, and/or otherwise known to the second user of the second computer system, as similarly described above with reference to the first environment being associated with the user of the computer system. In some embodiments, the association of the first environment with the second user of the second computer system is known and/or determined by the computer system based on application data accessible by the computer system. For example, the computer system determines that the first environment is or includes a home or workplace of the second user based on data provided by a navigation application, contacts application, calendar application, and/or web-browsing application. In some embodiments, the association of the first environment with the second user of the second computer system is known and/or determined by data provided to the computer system by the second computer system. Accordingly, in some embodiments, the second environment (e.g., the second physical environment) corresponds to an environment or space that is associated with the user of the computer system, as similarly discussed above. Updating one or more visual properties of a group of objects that is associated with a virtual workspace of a first physical environment associated with a respective user other than the user of the computer system when the virtual workspace is displayed in a second physical environment, different from the first physical environment, helps preserve one or more visual characteristics of the display of content of the group of objects while adapting the group of objects to physical characteristics of the second physical environment, which maintains visibility and/or interactivity of the content of the group of objects relative to a viewpoint of the user in the second physical environment, which also reduces a number of inputs that would be needed to reposition and/or reorient the group of objects relative to the viewpoint of the user, thereby improving user-device interaction and preserving computing resources.

In some embodiments, displaying the first group of objects with the one or more first visual properties in the first environment includes displaying the first group of objects with one or more first sizes in the first environment, such as the sizes of the virtual objects 1108, 1110, and 1114 indicated in the top-down view 1115 in FIG. 11A. In some embodiments, displaying the first group of objects with the one or more second visual properties in the second environment includes displaying the first group of objects with one or more second sizes, different from the one or more first sizes, in the second environment, such as the updated sizes of the virtual objects 1108, 1110, and 1114 indicated in the top-down view 1105 in FIG. 11E. For example, when the computer system changes the one or more visual properties of the first group of objects when the first group of objects is displayed in the second environment as discussed above, the computer system changes a size of the first group of objects in the second environment relative to the viewpoint of the user. In some embodiments, the computer system changes the size of the first group of objects based on one or more physical characteristics of the second environment. For example, as similarly described above, if the second environment is smaller than the first environment and/or includes a greater number of physical objects or physical objects that are larger in size than physical objects in the first environment, the computer system decreases the size of the first group of objects to accommodate the physical characteristics of the second environment. Similarly, if the second environment is larger than the first environment and/or includes a smaller number of physical objects or physical objects that are smaller in size than physical objects in the second environment, the computer system optionally increases the size of the first group of objects (e.g., such that the first group of objects occupies the same or similar amount or portion of the viewport of the user in the second environment). In some embodiments, the computer system changes the size of the first group of objects by a same amount (e.g., the first group of objects is increased or decreased in size by a same proportion). In some embodiments, the computer system changes the size of one or more objects of the first group of objects, without changing the size of others of the first group of objects (e.g., based on the on one or more differences between a (e.g., physical) space available for displaying the first group of objects in the first environment and a (e.g., physical) space available for displaying the first group of objects in the second environment). Updating sizes of a group of objects that is associated with a virtual workspace of a first physical environment when the virtual workspace is displayed in a second physical environment, different from the first physical environment, helps preserve one or more visual characteristics of the display of content of the group of objects while adapting the group of objects to physical characteristics of the second physical environment, which maintains visibility and/or interactivity of the content of the group of objects relative to a viewpoint of the user in the second physical environment, which also reduces a number of inputs that would be needed to reposition and/or reorient the group of objects relative to the viewpoint of the user, thereby improving user-device interaction and preserving computing resources.

In some embodiments, the space available for displaying the first group of objects in the first environment has a first size (e.g., a first amount of available space), such as the size of the first physical environment indicated in the top-down view 1115 in FIG. 11A. In some embodiments, the space available for displaying the first group of objects in the first environment is based on the size of the first environment. In some embodiments, the space available for displaying the first group of objects in the first environment is based on physical objects in the first environment. For example, the space available for displaying the first group of objects in the first environment is based on the sizes of the physical objects, the locations of the physical objects, and/or the orientations of the physical objects in the first environment relative to the viewpoint of the user. In some embodiments, the space available for displaying the first group of objects in the first environment corresponds to empty space (e.g., unoccupied regions and/or locations) in the first environment relative to the viewpoint of the user. In some embodiments, the space available for displaying the first group of objects in the first environment corresponds to a ratio of the portions of the first environment that are occupied by the physical objects in the first environment to the size of the first environment in the field of view of the user from the viewpoint of the user.

In some embodiments, the space available for displaying the first group of objects in the second environment has a second size (e.g., a second amount of available space), smaller than the first size, such as the smaller size of the second physical environment indicated in the top-down view 1105 in FIG. 11A. In some embodiments, the space available for displaying the first group of objects in the second environment is based on the size of the second environment. In some embodiments, the space available for displaying the first group of objects in the second environment is based on physical objects in the second environment. For example, the space available for displaying the first group of objects in the second environment is based on the sizes of the physical objects, the locations of the physical objects, and/or the orientations of the physical objects in the second environment relative to the viewpoint of the user. In some embodiments, the space available for displaying the first group of objects in the second environment corresponds to empty space (e.g., unoccupied regions and/or locations) in the second environment relative to the viewpoint of the user. In some embodiments, the space available for displaying the first group of objects in the second environment corresponds to a ratio of the portions of the second environment that are occupied by the physical objects in the second environment to the size of the second environment in the field of view of the user from the viewpoint of the user.

In some embodiments, while the first group of objects is displayed with the one or more first visual properties in the first environment (e.g., before detecting the first input), the first group of objects has a first spatial arrangement and occupies a first amount of a field of view of the user in the first environment, such as the spatial arrangement of the virtual objects 1108, 1110, and 1114 indicated in the top-down view 1115 and the amount of the field of view of the user 1102 that is occupied by the virtual objects 1108, 1110, and 1114 shown in FIG. 11A. For example, as similarly discussed above, the first group of objects is displayed in the first environment at one or more locations, at one or more sizes, and/or with one or more orientations relative to the viewpoint of the user. In some embodiments, the amount of the field of view of the user that the first group of objects occupies is based on a width of the first group of objects in the environment, such as an aspect ratio of the objects and/or a scale (e.g., including magnification) of the objects. In some embodiments, the field of view of the user in the environment corresponds to a physical range of human vision of the user (e.g., a field of view as determined by one or both eyes of the user). Accordingly, in some embodiments, the first group of objects occupying the first amount of the field of view of the user corresponds to the first group of objects occupying a first amount of the range of vision of the user in one or more dimensions. In some embodiments, the field of view of the user in the environment corresponds to an angular field of view of one or more cameras in communication with the display generation component for display generation components having virtual passthrough, while the field of view of the user in the environment corresponds to an angular field of view of the user through partially or fully transparent portions of the display generation component for display generation components having optical passthrough.

In some embodiments, displaying the first group of objects with the one or more second visual properties in the second environment includes: moving one or more objects in the first group of objects in the second environment to maintain the first spatial arrangement, such as moving the virtual objects 1108, 1110, and/or 1114 in the three-dimensional environment 1100 to maintain the spatial arrangement of the virtual objects 1108, 1110, and 1114 indicated in the top-down view 1105 in FIG. 11E; and reducing one or more sizes of the first group of objects to the one or more second sizes, such that the first group of objects occupies the first amount of the field of view of the user in the second environment, such as decreasing the size of the virtual objects 1108, 1110, and/or 1114 in the three-dimensional environment 1100 to maintain the amount of the field of view of the user 1102 that is occupied by the virtual objects 1108, 1110, and 1114 in the three-dimensional environment 1100 as shown in FIG. 11E. For example, because the second environment has the second size that is smaller than the first size of the first environment, the computer system moves and resizes the first group of objects in the second environment relative to the viewpoint of the user to maintain the same spatial arrangement of the first group of objects as in the first environment. In some embodiments, moving the one or more objects in the first group of objects in the second environment to maintain the first spatial arrangement includes moving the one or more objects closer together relative to the reduced space of the second environment. For example, the one or more objects in the first group of objects are moved closer together to maintain the first group of objects within bounds (e.g., edges or boundaries) of the second environment relative to the viewpoint of the user in the second environment. Additionally, in some embodiments, moving the one or more objects in the first group of objects in the second environment enables the spatial arrangement of the first group of objects to remain approximately the same as in the first environment by maintaining a spatial separation between objects in the first group of objects based on the reduced sizes (e.g., the one or more second sizes) of the first group of objects in the environment. Updating one or more visual properties of a group of objects that is associated with a virtual workspace of a first physical environment when the virtual workspace is displayed in a second physical environment, different from the first physical environment, helps preserve one or more visual characteristics of the display of content of the group of objects while adapting the group of objects to physical characteristics of the second physical environment, which maintains visibility and/or interactivity of the content of the group of objects relative to a viewpoint of the user in the second physical environment, which also reduces a number of inputs that would be needed to reposition and/or reorient the group of objects relative to the viewpoint of the user, thereby improving user-device interaction and preserving computing resources.

In some embodiments, displaying the first group of objects with the one or more second visual properties in the second environment includes moving one or more objects in the first group of objects in the second environment based on a first spatial arrangement of the first group of objects in the first environment, such as moving the virtual objects 1108, 1110, and/or 1114 in the three-dimensional environment 1100 as indicated in the top-down view 1105 in FIG. 11E based on the spatial arrangement of the virtual objects 1108, 1110, and 1114 in the three-dimensional environment 1100 that includes the first physical environment in FIG. 11A. For example, as similarly discussed above, the computer system moves the one or more objects in the first group of objects in the second environment to maintain the same or similar spatial arrangement of the first group of objects in the second environment as in the first environment relative to the viewpoint of the user. In some embodiments, moving the one or more objects in the first group of objects in the second environment based on the first spatial arrangement includes moving the one or more objects closer together in the second environment. In some embodiments, moving the one or more objects in the first group of objects in the second environment based on the first spatial arrangement includes moving the one or more objects farther apart in the second environment. In some embodiments, as similarly discussed above, the computer system moves the one or more objects in the first group of objects in the second environment based on the first spatial arrangement of the first group of objects due to the size of the first environment being different from the size of the second environment (e.g., the space available for displaying the first group of objects in the first environment is different from the space available for displaying the first group of objects in the second environment). In some embodiments, the computer system moves the one or more objects in the first group of objects in the second environment based on the physical objects in the first environment being different from the physical objects in the second environment (e.g., the physical objects having different locations, sizes, and/or orientations in the first environment from the physical objects in the second environment). Updating locations of a group of objects that is associated with a virtual workspace of a first physical environment when the virtual workspace is displayed in a second physical environment, different from the first physical environment, helps preserve one or more visual characteristics of the display of content of the group of objects while adapting the group of objects to physical characteristics of the second physical environment, which maintains visibility and/or interactivity of the content of the group of objects relative to a viewpoint of the user in the second physical environment, which also reduces a number of inputs that would be needed to reposition and/or reorient the group of objects relative to the viewpoint of the user, thereby improving user-device interaction and preserving computing resources.

In some embodiments, the one or more objects are moved in the second environment to remain within one or more boundaries of the space available for displaying the first group of objects in the second environment from the viewpoint of the user, such as moving the virtual objects 1108, 1110, and/or 1114 in the three-dimensional environment 1100 to remain within one or more boundaries of the second physical environment as indicated in the top-down view 1105 as shown in FIG. 11E. For example, the one or more boundaries of the space available for displaying the first group of objects in the second environment from the viewpoint of the user are based on and/or determine the size of the second environment from the viewpoint of the user. In some embodiments, the one or more boundaries of the space available for displaying the first group of objects include and/or correspond to physical boundaries of the second environment, such as physical walls, floors, and/or ceilings of the second environment, or physical surfaces of objects in the second environment, such as physical surfaces of tables, desks, chairs, cabinets, frames, computers, and/or other objects or devices. In some embodiments, the one or more objects in the first group of objects are moved closer together to remain within the one or more boundaries of the space available for displaying the first group of objects in the second environment. For example, the size of the first environment is greater than the size of the second environment, such that the space available for displaying the first group of objects in the second environment is smaller than the space available for displaying the first group of objects in the first environment. Updating locations of a group of objects that is associated with a virtual workspace of a first physical environment when the virtual workspace is displayed in a second physical environment, different from the first physical environment, helps preserve one or more visual characteristics of the display of content of the group of objects while adapting the group of objects to physical characteristics of the second physical environment, which maintains visibility and/or interactivity of the content of the group of objects relative to a viewpoint of the user in the second physical environment, which also reduces a number of inputs that would be needed to reposition and/or reorient the group of objects relative to the viewpoint of the user, thereby improving user-device interaction and preserving computing resources.

In some embodiments, the first spatial arrangement of the first group of objects in the first environment is based on (e.g., and/or corresponds to) one or more first locations of one or more first physical objects in the first environment, such as the virtual object 1114 being displayed based on a location of desk 1106 and/or the virtual object 1108 being displayed based on a location of the rear wall in the first physical environment in the three-dimensional environment 1100 as shown in FIG. 11A. For example, the first environment includes one or more physical objects such as tables, desks, chairs, cabinets, shelves, and/or electronic devices or computer systems, such as computers, televisions, laptops, tablets, clocks, or other mobile electronic devices. In some embodiments, the first group of objects is arranged in the first environment based on the one or more first physical objects. For example, the first group of objects has the first spatial arrangement that is based on the locations of the one or more first physical objects, the sizes of the one or more first physical objects, and/or the orientations of the one or more first physical objects in the first environment relative to the viewpoint of the user. Specifically, in some embodiments, the first group of objects is positioned in empty space adjacent to the one or more first physical objects in the first environment, in front of and/or overlaid on the one or more first physical objects in the first environment, and/or above and/or anchored to one or more surfaces of the one or more first physical objects in the first environment. In some embodiments, the first group of objects is displayed in the first environment based on the one or more first locations of the one or more first physical objects in the first environment based on user input provided by the user of the computer system, such as movement input directed to one or more objects in the first group of objects for positioning the first group of objects based on the one or more first locations of the one or more first physical objects. In some embodiments, the first group of objects is displayed in the first environment based on the one or more first locations of the one or more first physical objects in the first environment based on application data associated with the first group of objects, such as display data provided by applications associated with the first group of objects for anchoring one or more objects in the first group of objects to particular surfaces and/or physical objects in the first environment.

In some embodiments, the one or more objects are moved in the second environment to be based on one or more second locations of one or more second physical objects in the second environment, wherein the one or more second physical objects have one or more characteristics of the one or more first physical objects, such as moving the virtual objects 1108, 1110, and/or 1114 in the three-dimensional environment 1100 as indicated in the top-down view 1105 as shown in FIG. 11E to be based on locations of the walls of the second physical environment in the three-dimensional environment 1100. For example, the one or more second physical objects are similar to the one or more first physical objects. In some embodiments, the one or more second physical objects are similar to the one or more first physical objects in location, size, orientation, and/or visual appearance relative to the viewpoint of the user. For example, the one or more first physical objects include a desk having a flat surface and the one or more second physical objects include a table (optionally having a different size) having a flat surface. As another example, the one or more first physical objects include a wall that is a first distance from the viewpoint of the user in the first environment, and the one or more second physical objects include a cabinet that is a second distance, similar to the first distance, from the viewpoint of the user in the second environment. In some embodiments, when the first group of objects are displayed in the second environment, the computer system repositions the first group of objects to be based on the one or more second locations of the one or more second physical objects, such that the first group of objects is positioned in empty space adjacent to the one or more second physical objects in the second environment, in front of and/or overlaid on the one or more second physical objects in the second environment, and/or above and/or anchored to one or more surfaces of the one or more second physical objects in the second environment. Accordingly, as outlined above, in some embodiments, the computer system displays (e.g., moves) the first group of objects in the second environment relative to physical objects in the second environment that are similar to (e.g., share one or more characteristics with) physical objects in the first environment according to which the first group of objects is displayed in the first environment. Updating locations of a group of objects that is associated with a virtual workspace of a first physical environment when the virtual workspace is displayed in a second physical environment, different from the first physical environment, helps preserve one or more visual characteristics of the display of content of the group of objects while adapting the group of objects to physical objects of the second physical environment, which maintains visibility and/or interactivity of the content of the group of objects relative to a viewpoint of the user in the second physical environment, which also reduces a number of inputs that would be needed to reposition and/or reorient the group of objects relative to the viewpoint of the user, thereby improving user-device interaction and preserving computing resources.

In some embodiments, a respective object of the first group of objects is displayed at a first location of the one or more first locations corresponding to a first physical object in the first environment, such as the virtual object 1114 being displayed at a location of the desk 1106 in the first physical environment in the three-dimensional environment 1100 as shown in FIG. 11A. For example, the respective object is displayed at a location in the first environment that corresponds to a location of the first physical object relative to the viewpoint of the user, such as overlaid on, attached to, anchored to, and/or otherwise associated with the first physical object in the first environment. In some embodiments, as similarly described above, the respective object is displayed at the first location corresponding to the first physical object based on and/or in accordance with user input provided by the user of the computer system (e.g., movement input directed to the respective object) or application data associated with the respective object (e.g., provided by an application associated with the respective object).

In some embodiments, moving the one or more objects in the second environment to be based on the one or more second locations of the one or more second physical objects corresponding to a second physical object in the second environment includes displaying the respective object at a second location of the one or more second locations in the second environment, wherein the second location has one or more characteristics of the first location, such as displaying the virtual object 1114 at a location of table 1104 in the second physical environment in the three-dimensional environment 1100 as shown in FIG. 11I. For example, as similarly discussed above, the second physical object has one or more characteristics of (e.g., is similar to) the first physical object. In some embodiments, the second physical object is similar to the first physical object in size, location, orientation, and/or visual appearance, as similarly described above. Accordingly, in some embodiments, when the first group of objects is displayed in the second environment as discussed above, the computer system moves the respective object in the second environment relative to the viewpoint of the user to correspond to the location of the second physical object in the second environment. In some embodiments, because the second physical object is similar to the first physical object, the second location at which the respective object is displayed in the second environment is similar to the first location at which the respective object is displayed in the first environment. For example, the respective object is displayed at a distance from the viewpoint of the user in the second environment that is similar to the distance from the viewpoint of the user that the respective object is displayed in the first environment relative to the viewpoint of the user. Updating locations of a group of objects that is associated with a virtual workspace of a first physical environment when the virtual workspace is displayed in a second physical environment, different from the first physical environment, helps preserve one or more visual characteristics of the display of content of the group of objects while adapting the group of objects to physical objects of the second physical environment, which maintains visibility and/or interactivity of the content of the group of objects relative to a viewpoint of the user in the second physical environment, which also reduces a number of inputs that would be needed to reposition and/or reorient the group of objects relative to the viewpoint of the user, thereby improving user-device interaction and preserving computing resources.

In some embodiments, a respective object of the first group of objects is displayed at a first location that is associated with a first physical object in the first environment, such as displaying the virtual object 1108 at a location that is based on the rear wall of the first physical environment in the three-dimensional environment 1100 as shown in FIG. 11A. In some embodiments, the respective object is a world locked object (e.g., as defined herein) that maintains a position relative to the first physical object in the first environment. For example, the respective object is displayed at a location in the first environment that corresponds to a location of the first physical object relative to the viewpoint of the user, such as overlaid on, attached to, anchored to, and/or otherwise associated with the first physical object in the first environment. In some embodiments, because the computer system maintains the position of the respective object relative to the first physical object in the first environment, movement of the viewpoint of the user does not cause the respective object to be moved relative to the first physical object in the first environment. Similarly, in some embodiments, if the computer system detects that the first physical object is moved in the first environment (e.g., as a result of the user picking up and/or repositioning the first physical object in the first environment), the computer system moves the respective object with the first physical object to maintain the position of the respective object relative to the first physical object in the first environment. In some embodiments, as similarly described above, the respective object is displayed at the first location corresponding to the first physical object based on and/or in accordance with user input provided by the user of the computer system (e.g., movement input directed to the respective object) or application data associated with the respective object (e.g., provided by an application associated with the respective object).

In some embodiments, when the first group of objects is displayed in the second environment, the respective object is displayed at a second location that is not associated with a physical object in the second environment, such as displaying the virtual object 1108 at a location that is not based on a physical object in the second physical environment in the three-dimensional environment 1100 as shown in FIG. 11E. For example, the respective object is not displayed at a location in the second environment that corresponds to a location of a physical object in the second environment relative to the viewpoint of the user. In some embodiments, the respective object is a world locked object that does not maintain a position relative to a physical object in the second environment. In some embodiments, the respective object is displayed at the second location that is not associated with a physical object in the second environment because physical objects in the second environment do not have one or more characteristics of (e.g., are not similar to) the first physical object in the first environment. For example, none of the physical objects in the second environment is similar to the first physical object in size, location, orientation, and/or visual appearance. In some embodiments, the second environment does not include optionally any physical objects from the viewpoint of the user when the first group of objects is displayed in the second environment. Accordingly, in some embodiments, when the first group of objects is displayed in the second environment as discussed above, the computer system forgoes moving the respective object in the second environment relative to the viewpoint of the user to correspond to a location of a physical object in the second environment. In some embodiments, the second location at which the respective object is displayed in the second environment is the same as the first location at which the respective object is displayed in the first environment relative to the viewpoint of the user. For example, the respective object is displayed at a distance from the viewpoint of the user in the second environment that is equal to the distance from the viewpoint of the user that the respective object is displayed in the first environment relative to the viewpoint of the user. Updating locations of a group of objects that is associated with a virtual workspace of a first physical environment when the virtual workspace is displayed in a second physical environment, different from the first physical environment, helps preserve one or more visual characteristics of the display of content of the group of objects while adapting the group of objects to physical objects of the second physical environment, which maintains visibility and/or interactivity of the content of the group of objects relative to a viewpoint of the user in the second physical environment, which also reduces a number of inputs that would be needed to reposition and/or reorient the group of objects relative to the viewpoint of the user, thereby improving user-device interaction and preserving computing resources.

In some embodiments, in response to detecting the first input, in accordance with the determination that the respective environment corresponds to the second environment, the computer system displays, via the one or more display generation components, one or more visual indications of one or more physical properties of the first environment in the second environment, such as displaying virtual surface 1121 corresponding to the desk 1106 in the first physical environment in the three-dimensional environment 1100 in FIG. 11A as shown in FIG. 11E, wherein the one or more physical properties satisfy one or more selection criteria. For example, as described in more detail below, when the first group of objects is displayed in the second environment, the computer system displays important and/or significant physical characteristics of the first environment in the second environment. In some embodiments, the one or more visual indications correspond to representations of the one or more physical properties of the first environment that are displayed in the second environment. For example, the computer system generates and displays a virtual version of a physical object in the first environment that satisfies the one or more selection criteria discussed below. In some embodiments, in response to detecting the first input, in accordance with a determination that the respective environment corresponds to a third environment, different from the second environment, the computer system displays, via the one or more display generation components, one or more visual indications of one or more physical properties of the first environment in the third environment, wherein the one or more physical properties satisfy the one or more selection criteria. Displaying visual indications of important physical characteristics of a first physical environment in a second physical environment, different from the first physical environment, when a virtual workspace is displayed in the second physical environment helps preserve one or more visual characteristics of the display of content of a group of objects associated with the virtual workspace that is displayed based on the one or more physical characteristics of the first physical environment which maintains visibility and/or interactivity of the content of the group of objects relative to a viewpoint of the user in the second physical environment, which also reduces a number of inputs that would be needed to reposition and/or reorient the group of objects relative to the viewpoint of the user, thereby improving user-device interaction and preserving computing resources.

In some embodiments, the one or more visual indications of the one or more physical properties include one or more representations of one or more physical surfaces in the first environment, such as the virtual surface 1121 representing the surface of the desk 1106 in the first physical environment in FIG. 11E. For example, the one or more physical surfaces satisfy the one or more selection criteria discussed below. In some embodiments, the one or more physical surfaces in the first environment correspond to surfaces on which and/or with which the first group of objects is displayed in the first environment. Accordingly, in some embodiments, when the first group of objects is displayed in the second environment, the computer system displays the representations of the one or more physical surfaces in the second environment, such that the first group of objects visually appear to continue to be displayed at locations corresponding to the one or more physical surfaces in the first environment relative to the viewpoint of the user in the second environment. For example, if a first object is displayed in the first environment anchored to a physical surface of a desk in the first environment, when the first group of objects is displayed in the second environment, the first object in the first group of objects is displayed anchored to a representation of the physical surface of the desk in the second environment. Displaying representations of important physical surfaces of a first physical environment in a second physical environment, different from the first physical environment, when a virtual workspace is displayed in the second physical environment helps preserve one or more visual characteristics of the display of content of a group of objects associated with the virtual workspace that is displayed based on the one or more physical surfaces of the first physical environment which maintains visibility and/or interactivity of the content of the group of objects relative to a viewpoint of the user in the second physical environment, which also reduces a number of inputs that would be needed to reposition and/or reorient the group of objects relative to the viewpoint of the user, thereby improving user-device interaction and preserving computing resources.

In some embodiments, the one or more visual indications of the one or more physical properties include one or more representations of one or more physical objects in the first environment, such as the virtual surface 1121 representing the desk 1106 in the first physical environment in FIG. 11E. For example, the one or more physical objects satisfy the one or more selection criteria discussed below. In some embodiments, the one or more physical objects in the first environment correspond to objects on which and/or with which the first group of objects is displayed in the first environment. Accordingly, in some embodiments, when the first group of objects is displayed in the second environment, the computer system displays the representations of the one or more physical objects in the second environment, such that the first group of objects visually appear to continue to be displayed at locations corresponding to the one or more physical objects in the first environment relative to the viewpoint of the user in the second environment. For example, if a first object is displayed in the first environment anchored to a physical chair in the first environment, when the first group of objects is displayed in the second environment, the first object in the first group of objects is displayed anchored to a representation of the physical chair in the second environment. Displaying representations of important physical objects of a first physical environment in a second physical environment, different from the first physical environment, when a virtual workspace is displayed in the second physical environment helps preserve one or more visual characteristics of the display of content of a group of objects associated with the virtual workspace that is displayed based on the one or more physical objects of the first physical environment which maintains visibility and/or interactivity of the content of the group of objects relative to a viewpoint of the user in the second physical environment, which also reduces a number of inputs that would be needed to reposition and/or reorient the group of objects relative to the viewpoint of the user, thereby improving user-device interaction and preserving computing resources.

In some embodiments, satisfaction of the one or more selection criteria is in accordance with (e.g., based on) a determination that the one or more physical properties of the first environment correspond to one or more physical portions of the first environment with which one or more objects of the first group of objects are associated in the first environment, such as the virtual object 1114 being associated with the desk 1106 in the first physical environment in the three-dimensional environment 1100 in FIG. 11A. For example, the determination of the importance of the one or more physical properties of the first environment is in accordance with (e.g., is based on) a determination that the one or more physical properties of the first environment serve as anchor points for the first group of objects in the first environment. In some embodiments, the one or more physical portions of the first environment include one or more physical objects in the first environment on which and/or with which the one or more objects of the first group of objects are displayed in the first environment. In some embodiments, the one or more physical portions of the first environment include one or more physical surfaces in the first environment on which and/or with which the one or more objects of the first group of objects are displayed in the first environment. Accordingly, in some embodiments, if a first object in the first group of objects is displayed in the first environment anchored to a first physical object (e.g., anchored to a surface of a desk or table), thereby causing the first physical object to satisfy the one or more selection criteria, when the first group of objects is displayed in the second environment, the computer system displays the first object in the second environment as anchored to a representation of the first physical object in the second environment (e.g., because the second environment does not include the first physical object or a physical object that is similar to the first physical object). In some embodiments, the representation of the first physical object is displayed at a location in the second environment that is based on (e.g., is similar to) and/or that corresponds to the location of the first physical in the first environment relative to the viewpoint of the user. Displaying representations of important physical objects of a first physical environment in a second physical environment, different from the first physical environment, when a virtual workspace is displayed in the second physical environment helps preserve one or more visual characteristics of the display of content of a group of objects associated with the virtual workspace that is displayed based on the one or more physical objects of the first physical environment which maintains visibility and/or interactivity of the content of the group of objects relative to a viewpoint of the user in the second physical environment, which also reduces a number of inputs that would be needed to reposition and/or reorient the group of objects relative to the viewpoint of the user, thereby improving user-device interaction and preserving computing resources.

In some embodiments, satisfaction of the one or more selection criteria is in accordance with (e.g., based on) a determination that the one or more physical properties of the first environment correspond to one or more drawing surfaces on which one or more users, including the user of the computer system, have provided one or more handwritten marks (e.g., handwritten text, drawings, sketches, notes, and the like) in the first environment (e.g., while the first group of objects are displayed in the first environment), such as physical paper 1107 that includes handwritten marks in FIG. 11A. For example, the determination of the importance of the one or more physical properties of the first environment is in accordance with (e.g., is based on) a determination that the one or more physical properties of the first environment include surfaces on which the user or other users have provided visible marks in the first environment. In some embodiments, the one or more physical portions of the first environment include paper, notepads, drawing boards (e.g., chalkboards and/or whiteboards), notebooks, tablets, and/or other drawing surfaces that include hand drawn and/or handwritten content (e.g., and not necessarily relevant or pertinent to the first group of objects in the first environment). In some embodiments, the one or more handwritten marks correspond to physical handwritten marks written and/or drawn on a physical drawing surface or canvas using a pen, pencil, marker, highlighter, paintbrush, or other physical drawing tool. In some embodiments, the one or more handwritten marks correspond to digital handwritten marks written and/or drawn on a digital drawing surface or canvas (e.g., a drawing tablet) using a stylus, finger, or other electronic drawing tool. Accordingly, in some embodiments, if a first drawing surface (e.g., paper, notebook, tablet, whiteboard, and/or notepad) in the first environment includes one or more handwritten marks that are visible from the viewpoint of the user in the first environment, thereby causing the first drawing surface to satisfy the one or more selection criteria, when the first group of objects is displayed in the second environment, the computer system displays a representation of the first drawing surface in the second environment (e.g., because the second environment does not include the first drawing surface or a drawing surface that is similar to the first drawing surface). In some embodiments, the representation of the first drawing surface includes representations of the handwritten marks provided on the first drawing surface in the first environment. For example, when the computer system displays the representation of the first drawing surface in the second environment, the representation of the first drawing surface includes representations of the handwritten text, drawings, sketches, notes, and/or other content provided by the user or other users in the first environment. In some embodiments, the representation of the first drawing surface is displayed at a location in the second environment that is based on (e.g., is similar to) and/or that corresponds to the location of the first drawing surface in the first environment relative to the viewpoint of the user. In some embodiments, if the one or more handwritten marks are provided on the one or more drawing surfaces while the first group of objects is not displayed in the first environment (e.g., while the first virtual workspace is not open in the first environment), the computer system determines that the one or more drawing surfaces do not satisfy the one or more selection criteria (e.g., despite the one or more handwritten marks being visible in the first environment from the viewpoint of the user). Displaying representations of important drawing surfaces including handwritten marks of a first physical environment in a second physical environment, different from the first physical environment, when a virtual workspace is displayed in the second physical environment helps preserve one or more visual characteristics of the display of content of a group of objects associated with the virtual workspace that is displayed and/or enables the handwritten marks to automatically be visible in the second physical environment, which maintains visibility and/or interactivity of the content of the group of objects relative to a viewpoint of the user in the second physical environment, thereby improving user-device interaction and preserving computing resources.

In some embodiments, in response to detecting the first input, in accordance with a determination that the respective environment corresponds to the first environment and that an input for updating one or more visual properties of the first group of objects is not detected since the last instance of the display of the first group of objects in the first environment, the computer system displays, via the one or more display generation components, the first group of objects with the one or more first visual properties in the first environment, such as the display of the virtual objects 1108, 1110, and 1114 in the three-dimensional environment 1100 that includes the first physical environment in FIG. 11A. For example, if the computer system (e.g., and the user of the computer system) is located in the same environment in which the first group of objects was last interacted with by the user when the first input is detected and the first group of objects has not been interacted with since the first group of objects was last displayed in the first environment, the computer system redisplays the first group of objects in the first environment and maintains display of the first group of objects with the one or more first visual properties discussed above. In some embodiments, the determination that an input for updating one or more visual properties of the first group of objects is not detected since the last instance of the display of the first group of objects in the first environment is in accordance with (e.g., is based on) a determination that the user of the computer system has not provided input for updating one or more visual properties of the first group of objects. In some embodiments, the determination that an input for updating the one or more visual properties of the first group of objects is not detected since the last instance of the display of the first group of objects in the first environment is in accordance with (e.g., is based on) a determination that other users, different from the user of the computer system, who have access to the first virtual workspace, including the first group of objects, have not provided input for updating the one or more visual properties of the first group of objects. Maintaining one or more visual properties of a group of objects that is associated with a virtual workspace of a first physical environment when the virtual workspace is redisplayed in the first physical environment helps automatically preserve one or more visual characteristics of the display of content of the group of objects, which reduces a number of inputs that would be needed to reposition and/or reorient the group of objects relative to the viewpoint of the user, thereby improving user-device interaction and preserving computing resources.

In some embodiments, in response to detecting the first input, in accordance with a determination that the respective environment corresponds to the first environment and that an input for updating one or more visual properties of the first group of objects is detected since the last instance of the display of the first group of objects in the first environment, such as movement of the virtual object 1108 in the three-dimensional environment 1100 in response to detecting input provided by the hand 1103 as shown in FIGS. 11I-11J, the computer system displays, via the one or more display generation components, the first group of objects with the one or more third visual properties, different from the one or more first visual properties, in the first environment, wherein the one or more third visual properties are determined based on the input, such as display of the virtual objects 1108, 1110, and 1114 with an updated spatial arrangement that is based on the movement of the virtual object 1108 in the three-dimensional environment 1100 that includes the first physical environment as shown in FIG. 11N. For example, if the computer system (e.g., and the user of the computer system) is located in the same environment in which the first group of objects was last interacted with by the user when the first input is detected and the first group of objects has been interacted with since the first group of objects was last displayed in the first environment, the computer system displays the first group of objects in the first with the one or more third visual properties. In some embodiments, the determination that an input for updating one or more visual properties of the first group of objects is detected since the last instance of the display of the first group of objects in the first environment is in accordance with (e.g., is based on) a determination that the user of the computer system has provided input for updating the one or more visual properties of the first group of objects to the one or more third visual properties. In some embodiments, the determination that an input for updating the one or more visual properties of the first group of objects is detected since the last instance of the display of the first group of objects in the first environment is in accordance with (e.g., based on) a determination that other participants, different from the user of the computer system, who have access to the first virtual workspace, including the first group of objects, have provided input for updating the one or more visual properties of the first group of objects to the one or more third visual properties. In some embodiments, displaying the first group of objects with the one or more third visual properties includes displaying the first group of objects at one or more updated locations, one or more updated sizes, and/or one or more updated orientations relative to the viewpoint of the user in the first environment. In some embodiments, the input that causes the first group of objects to have the one or more third visual properties in the first environment relative to the viewpoint of the user includes and/or corresponds to hand-based input provided by the user of the computer system or other users who have access to the first virtual workspace, such as air gestures, and/or other inputs described above and/or the inputs discussed in methods 800 and/or 1000. Providing a virtual workspace that preserves one or more visual characteristics of the display of content in a three-dimensional environment relative to a viewpoint of a user enables particular content items and the spatial arrangement of the content items to be automatically updated and preserved due to their association with the virtual workspace, which reduces a number of inputs that would be needed to reopen the content items and/or restore the content items to their previous spatial arrangement in the three-dimensional environment relative to the viewpoint of the user, thereby improving user-device interaction and preserving computing resources.

It should be understood that the particular order in which the operations in method 1200 have been described is merely exemplary and is not intended to indicate that the described order is the only order in which the operations could be performed. It should be understood that the particular order in which the operations in methods 800, 1000, and/or 1200 have been described is merely exemplary and is not intended to indicate that the described order is the only order in which the operations could be performed. One of ordinary skill in the art would recognize various ways to reorder the operations described herein. In some embodiments, aspects/operations of methods 800, 1000, and/or 1200 may be interchanged, substituted, and/or added between these methods. For example, the three-dimensional environment in methods 800, 1000, and/or 1200, the virtual content and/or virtual objects in methods 800, 1000, and/or 1200, the virtual workspaces in methods 800, 1000, and/or 12000, and/or the interactions with virtual content and/or the user interfaces associated with virtual workspaces in methods 800, 1000, and/or 1200 are optionally interchanged, substituted, and/or added between these methods. For brevity, these details are not repeated here.

The foregoing description, for purpose of explanation, has been described with reference to specific embodiments. However, the illustrative discussions above are not intended to be exhaustive or to limit the embodiments to the precise forms disclosed. Many modifications and variations are possible in view of the above teachings. The embodiments were chosen and described in order to best explain the principles of the disclosure and its practical applications, to thereby enable others skilled in the art to best use the disclosure and various described embodiments with various modifications as are suited to the particular use contemplated.

As described above, one aspect of the present technology is the gathering and use of data available from various sources to improve XR experiences of users. The present disclosure contemplates that in some instances, this gathered data may include personal information data that uniquely identifies or can be used to contact or locate a specific person. Such personal information data can include demographic data, location-based data, telephone numbers, email addresses, twitter IDs, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, the personal information data can be used to improve an XR experience of a user. Further, other uses for personal information data that benefit the user are also contemplated by the present disclosure. For instance, health and fitness data may be used to provide insights into a user's general wellness, or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of XR experiences, the present technology can be configured to allow users to select to “opt in” or “opt out” of participation in the collection of personal information data during registration for services or anytime thereafter. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, an XR experience can be generated by inferring preferences based on non-personal information data or a bare minimum amount of personal information, such as the content being requested by the device associated with a user, other non-personal information available to the service, or publicly available information.

1. A method comprising:
at a computer system in communication with one or more display generation components and one or more input devices:
while displaying, via the one or more display generation components, a first group of objects in a three-dimensional environment, wherein the first group of objects has one or more first visual characteristics, including a first spatial arrangement, wherein the first spatial arrangement is a three-dimensional arrangement of the first group of objects in the three-dimensional environment, detecting, via the one or more input devices, a first input corresponding to a request to display one or more graphical user interface objects;
in response to detecting the first input:
displaying, via the display generation component, a user interface including a plurality of graphical user interface objects in the three-dimensional environment;
while displaying the user interface that includes the plurality of graphical user interface objects, detecting, via the one or more input devices, a second input that includes selection of a respective graphical user interface object of the one or more graphical user interface objects; and
in response to detecting the second input:
in accordance with a determination that the second input includes selection of a first graphical user interface object that represents the first group of objects, redisplaying, via the one or more display generation components, the first group of objects with the one or more first visual characteristics, including the first spatial arrangement, in the three-dimensional environment; and
in accordance with a determination that the second input includes selection of a second graphical user interface object that represents a second group of objects, different from the first graphical user interface object, displaying the second group of objects in the three-dimensional environment, wherein the second group of objects has one or more second visual characteristics different from the one or more first visual characteristics, including a second spatial arrangement, wherein the second spatial arrangement is a three-dimensional arrangement of the second group of objects in the three-dimensional environment that is different from the first spatial arrangement in the three-dimensional environment.

2. The method of claim 1, further comprising:
in response to detecting the first input:
updating display, via the one or more display generation components, of the first group of objects to have one or more second visual characteristics, different from the one or more first visual characteristics.

3. The method of claim 1, further comprising:
in response to detecting the second input, in accordance with a determination that the second input includes selection of a third graphical user interface object that is selectable to initiate a process to arrange one or more respective objects in a respective spatial arrangement in the three-dimensional environment, different from the first graphical user interface object and the second graphical user interface object:
ceasing display of the user interface including the plurality of graphical user interface objects; and
forgoing display of the first group of objects with the one or more first visual characteristics in the three-dimensional environment.

4. The method of claim 3, further comprising:
in response to detecting the second input, in accordance with the determination that the second input includes selection of the third graphical user interface object, displaying, via the one or more display generation components, one or more system user interface objects in the three-dimensional environment, wherein the one or more system user interface objects have a respective spatial arrangement in the three-dimensional environment, wherein the respective spatial arrangement is a three-dimensional arrangement of the one or more system user interface objects in the three-dimensional environment.

5. The method of claim 1, wherein:
the first group of objects is associated with a first virtual workspace, and the first graphical user interface object corresponds to a representation of the first virtual workspace; and
the second group of objects is associated with a second virtual workspace, and the second graphical user interface object corresponds to a representation of the second virtual workspace.

6. The method of claim 5, further comprising:
while displaying the user interface including the plurality of graphical user interface objects in the three-dimensional environment, detecting, via the one or more input devices, a third input corresponding to a request to scroll through the plurality of graphical user interface objects; and
in response to detecting the third input:
scrolling the plurality of graphical user interface objects in the user interface, including updating display, via the one or more display generation components, of the user interface to include a third graphical user interface object corresponding to a representation of a third virtual workspace.

7. The method of claim 5, wherein:
the representation of the first virtual workspace is a first three-dimensional representation; and
the representation of the second virtual workspace is a second three-dimensional representation.

8. The method of claim 5, wherein:
the first graphical user interface object includes a first plurality of representations corresponding to the first group of objects; and
the second graphical user interface object includes a second plurality of representations corresponding to the second group of objects.

9. The method of claim 5, wherein:
in accordance with a determination that the first virtual workspace is accessible to one or more first participants, the first graphical user interface object is displayed with a visual indication of the one or more first participants; and
in accordance with a determination that the second virtual workspace is accessible to one or more second participants, the second graphical user interface object is displayed with the visual indication of the one or more second participants.

10. The method of claim 9, wherein displaying the visual indication of the one or more first participants includes:
in accordance with a determination that a first participant of the one or more first participants is currently interacting with the first virtual workspace, displaying a visual indication of the first participant with a first visual appearance; and
in accordance with a determination that the first participant of the one or more first participants is not currently interacting with the first virtual workspace, displaying the visual indication of the first participant with a second visual appearance, different from the first visual appearance.

11. The method of claim 10, wherein:
displaying the visual indication of the first participant with the first visual appearance includes displaying the visual indication within the first graphical user interface object; and
displaying the visual indication of the first participant with the second visual appearance includes displaying the visual indication outside of the first graphical user interface object.

12. The method of claim 5, wherein:
the plurality of graphical user interface objects corresponds to a plurality of virtual workspaces, including the first virtual workspace and the second virtual workspace; and
one or more virtual workspaces of the plurality of virtual workspaces were created by the user of the computer system.

13. The method of claim 5, wherein:
the plurality of graphical user interface objects corresponds to a plurality of virtual workspaces, including the first virtual workspace and the second virtual workspace; and
one or more virtual workspaces of the plurality of virtual workspaces were created by one or more respective participants, different from the user of the computer system.

14. The method of claim 5, wherein:
the first group of objects includes a first object that is also included in the second group of objects;
a first representation of the first object has a first visual appearance in the first graphical user interface object; and
a second representation of the first object has a second visual appearance, different from the first visual appearance, in the second graphical user interface object.

15. The method of claim 14, further comprising:
while displaying the first group of objects in the three-dimensional environment, wherein the first group of objects has the one or more first visual characteristics, including the first spatial arrangement, detecting, via the one or more input devices, a third input directed to the first object of the first group of objects;
in response to detecting the third input, updating display, via the one or more display generation components, of the first object in the three-dimensional environment in accordance with the third input, such that the first group of objects has one or more third visual characteristics, different from the one or more first visual characteristics;
while displaying the first group of objects in the three-dimensional environment, wherein the first group of objects has the one or more third visual characteristics, detecting, via the one or more input devices, a fourth input corresponding to a request to display the one or more graphical user interface objects; and
in response to detecting the fourth input:
displaying, via the one or more display generation components, the user interface including the plurality of graphical user interface objects in the three-dimensional environment, wherein:
the first representation of the first object has a third visual appearance, different from the first visual appearance, in the first graphical user interface object; and
the second representation of the first object has the second visual appearance in the second graphical user interface object.

16. The method of claim 14, wherein displaying the first representation of the first object with the first visual appearance includes displaying the first representation at a first location in the first graphical user interface object, and displaying the second representation of the first object with the second visual appearance includes displaying the second representation at a second location in the second graphical user interface object, the method further comprising:
while displaying the first group of objects in the three-dimensional environment, wherein the first group of objects has the one or more first visual characteristics, including the first spatial arrangement, detecting, via the one or more input devices, a third input corresponding to a request to move the first object of the first group of objects in the three-dimensional environment;
in response to detecting the third input, moving the first object in the three-dimensional environment in accordance with the third input, such that the first group of objects has one or more third visual characteristics, different from the one or more first visual characteristics, including a third spatial arrangement, different from the first spatial arrangement;
while displaying the first group of objects in the three-dimensional environment, wherein the first group of objects has the one or more third visual characteristics, detecting, via the one or more input devices, a fourth input corresponding to a request to display the one or more graphical user interface objects; and
in response to detecting the fourth input:
displaying, via the one or more display generation components, the user interface including the plurality of graphical user interface objects in the three-dimensional environment, wherein:
the first representation of the first object is displayed at a third location, different from the first location, in the first graphical user interface object; and
the second representation of the first object is displayed at the second location in the second graphical user interface object.

17. The method of claim 14, further comprising:
while displaying the first group of objects in the three-dimensional environment, wherein the first group of objects has the one or more first visual characteristics, including the first spatial arrangement, detecting, via the one or more input devices, a third input corresponding to a request to cease display of the first object of the first group of objects;
in response to detecting the third input, ceasing display of the first object in the three-dimensional environment in accordance with the third input, such that the first group of objects has one or more third visual characteristics, different from the one or more first visual characteristics;
while displaying the first group of objects in the three-dimensional environment, wherein the first group of objects has the one or more third visual characteristics, detecting, via the one or more input devices, a fourth input corresponding to a request to display the one or more graphical user interface objects; and
in response to detecting the fourth input:
displaying, via the one or more display generation components, the user interface including the plurality of graphical user interface objects in the three-dimensional environment, including:
displaying the second representation of the first object with the second visual appearance in the second graphical user interface object, without displaying the first representation of the first object with the first visual appearance in the first graphical user interface object.

18. The method of claim 1, wherein the user interface including the plurality of graphical user interface objects is displayed as a world locked object in the three-dimensional environment.

19. The method of claim 18, wherein the first graphical user interface object includes first content having a first visual appearance while a viewpoint of the user of the computer system is a first viewpoint, the method further comprising:
while displaying the user interface including the plurality of graphical user interface objects in the three-dimensional environment, including displaying the first content of the first graphical user interface object with the first visual appearance, detecting, via the one or more input devices, movement of the viewpoint of the user from the first viewpoint to a second viewpoint, different from the first viewpoint; and
in response to detecting the movement of the viewpoint of the user:
displaying, via the one or more display generation components, the user interface including the plurality of graphical user interface objects from the second viewpoint of the user, including updating display of the first content of the first graphical user interface object to have a second visual appearance, different from the first visual appearance.

20. The method of claim 1, wherein the first group of objects is accessible to one or more first participants other than a user of the computer system, the method further comprising:
while displaying the second group of objects in the three-dimensional environment in accordance with the determination that the second input includes selection of the second graphical user interface object in response to detecting the second input, detecting, via the one or more input devices, a third input corresponding to a request to display the one or more graphical user interface objects;
in response to detecting the third input, displaying, via the one or more display generation components, the user interface including the plurality of graphical user interface objects in the three-dimensional environment;
while displaying the user interface including the plurality of graphical user interface objects in the three-dimensional environment, detecting, via the one or more input devices, a fourth input including selection of the first graphical user interface object that represents the first group of objects; and
in response to detecting the fourth input:
displaying, via the one or more display generation components, the first group of objects in the three-dimensional environment, wherein:
in accordance with a determination that one or more visual characteristics of the first group of objects has been updated based on prior user activity of a respective participant of the one or more first participants, the first group of objects has one or more third visual characteristics, including a third spatial arrangement in the three-dimensional environment, wherein the third spatial arrangement is a three-dimensional arrangement of the first group of objects in the three-dimensional environment.

21. The method of claim 1, the method further comprising:
while displaying the second group of objects in the three-dimensional environment in accordance with the determination that the second input includes selection of the second graphical user interface object in response to detecting the second input, detecting, via the one or more input devices, a third input corresponding to a request to update a spatial arrangement of the second group of objects in the three-dimensional environment;
in response to detecting the third input, updating display of the second group of objects to have one or more third visual characteristics, different from the one or more second visual characteristics, including a third spatial arrangement in the three-dimensional environment based on the third input, wherein the third spatial arrangement is a three-dimensional spatial arrangement of the second group of objects in the three-dimensional environment;
while displaying the second group of objects in the three-dimensional environment, wherein the second group of objects has the one or more third visual characteristics, detecting, via the one or more input devices, a fourth input corresponding to a request to display the one or more graphical user interface objects;
in response to detecting the fourth input, displaying, via the one or more display generation components, the user interface including the plurality of graphical user interface objects in the three-dimensional environment;
while displaying the user interface including the plurality of graphical user interface objects in the three-dimensional environment, detecting, via the one or more input devices, a fifth input including selection of the second graphical user interface object that represents the second group of objects; and
in response to detecting the fifth input:
displaying, via the one or more display generation components, the second group of objects in the three-dimensional environment, wherein the second group of objects has the one or more third visual characteristics, including the third spatial arrangement in the three-dimensional environment.

22. The method of claim 1, wherein the first input includes interaction with a hardware input element of the computer system.

23. The method of claim 1, wherein the second input includes an air pinch gesture.

24. The method of claim 1, wherein:
while displaying the first group of objects with the one or more first visual characteristics in the three-dimensional environment prior to detecting the first input, the first group of objects is displayed in a virtual environment; and
displaying the user interface that includes the plurality of graphical user interface objects in the three-dimensional environment in response to detecting the first input includes displaying a representation of the virtual environment in the first graphical user interface object that represents the first group of objects.

25. The method of claim 1, wherein:
while displaying the first group of objects with the one or more first visual characteristics in the three-dimensional environment prior to detecting the first input, the first group of objects is displayed in a virtual environment that has a first level of immersion; and
displaying the user interface that includes the plurality of graphical user interface objects in the three-dimensional environment in response to detecting the first input includes displaying a representation of the virtual environment at the first level of immersion in the first graphical user interface object that represents the first group of objects.

26. The method of claim 1, wherein updating display of the first group of objects to have the one or more second visual characteristics in response to detecting the first input includes changing a size of the first group of objects relative to respective location in the three-dimensional environment.

27. A computer system that is in communication with one or more input devices and one or more display generation components, the computer system comprising:
one or more processors;
memory; and
one or more programs, wherein the one or more programs are stored in the memory and configured to be executed by the one or more processors, the one or more programs including instructions for:
while displaying, via the one or more display generation components, a first group of objects in a three-dimensional environment, wherein the first group of objects has one or more first visual characteristics, including a first spatial arrangement, wherein the first spatial arrangement is a three-dimensional arrangement of the first group of objects in the three-dimensional environment, detecting, via the one or more input devices, a first input corresponding to a request to display one or more graphical user interface objects;
in response to detecting the first input:
displaying, via the display generation component, a user interface including a plurality of graphical user interface objects in the three-dimensional environment;
while displaying the user interface that includes the plurality of graphical user interface objects, detecting, via the one or more input devices, a second input that includes selection of a respective graphical user interface object of the one or more graphical user interface objects; and
in response to detecting the second input:
in accordance with a determination that the second input includes selection of a first graphical user interface object that represents the first group of objects, redisplaying, via the one or more display generation components, the first group of objects with the one or more first visual characteristics, including the first spatial arrangement, in the three-dimensional environment; and
in accordance with a determination that the second input includes selection of a second graphical user interface object that represents a second group of objects, different from the first graphical user interface object, displaying the second group of objects in the three-dimensional environment, wherein the second group of objects has one or more second visual characteristics different from the one or more first visual characteristics, including a second spatial arrangement, wherein the second spatial arrangement is a three-dimensional arrangement of the second group of objects in the three-dimensional environment that is different from the first spatial arrangement in the three-dimensional environment.

28. A non-transitory computer readable storage medium storing one or more programs, the one or more programs comprising instructions, which when executed by one or more processors of a computer system that is in communication with one or more input devices and one or more display generation components, cause the computer system to perform a method comprising:
while displaying, via the one or more display generation components, a first group of objects in a three-dimensional environment, wherein the first group of objects has one or more first visual characteristics, including a first spatial arrangement, wherein the first spatial arrangement is a three-dimensional arrangement of the first group of objects in the three-dimensional environment, detecting, via the one or more input devices, a first input corresponding to a request to display one or more graphical user interface objects;
in response to detecting the first input:
displaying, via the display generation component, a user interface including a plurality of graphical user interface objects in the three-dimensional environment;
while displaying the user interface that includes the plurality of graphical user interface objects, detecting, via the one or more input devices, a second input that includes selection of a respective graphical user interface object of the one or more graphical user interface objects; and
in response to detecting the second input:
in accordance with a determination that the second input includes selection of a first graphical user interface object that represents the first group of objects, redisplaying, via the one or more display generation components, the first group of objects with the one or more first visual characteristics, including the first spatial arrangement, in the three-dimensional environment; and
in accordance with a determination that the second input includes selection of a second graphical user interface object that represents a second group of objects, different from the first graphical user interface object, displaying the second group of objects in the three-dimensional environment, wherein the second group of objects has one or more second visual characteristics different from the one or more first visual characteristics, including a second spatial arrangement, wherein the second spatial arrangement is a three-dimensional arrangement of the second group of objects in the three-dimensional environment that is different from the first spatial arrangement in the three-dimensional environment.

29-80. (canceled)
